(19) United States
(12) Patent Application Publication
(10) Pub. No.: US 2026/0013509 A1
(43) Pub. Date: Jan. 15, 2026

(54) ENDOPHYTE COMPOSITIONS AND METHODS FOR IMPROVED PLANT HEALTH

(71) Applicant: INDIGO AG, INC., Charlestown, MA (US)

(72) Inventors: Diana MALONEY, Raleigh, NC (US); Shib Sankar BASU, Apex, NC (US); Christopher M. DaCUNHA, Pepperell, MA (US); Laura A. SAUDER, Somerville, MA (US); Brian M. SCHUSTER, Burlington, MA (US); Kristin H. YOUNGER, Durham, NC (US); Steven E. Screen, Wake Forest, NC (US); Ni XIANG, Morrisville, NC (US); Tess E. HANDY, Raleigh, NC (US); Cesar U. VALENCIA, Durham, NC (US); Jennifer D. CALL, Durham, NC (US)

(21) Appl. No.: 18/992,763

(22) PCT Filed: Jul. 12, 2023
(86) PCT No.: PCT/US2023/070091

§ 371 Date: Jan. 9, 2025

Related U.S. Application Data
(60) Provisional application No. 63/368,247, filed on Jul. 12, 2022.
(60) Provisional application No. 63/484,188, filed on Feb. 9, 2023.

(51) Int. Cl. A01N 63/27; A01N 25/22; A01P 21/00

(52) U.S. Cl. CPC A01N 63/27; A01N 25/22; A01P 21/00

(57) ABSTRACT

This invention relates to compositions and methods for improving plant health, wherein a plant is heterologously disposed to one or more endophytes, or derived from a plant element heterologously disposed to one or more endophytes.

### CROSS REFERENCE TO RELATED APPLICATIONS

This application claims the benefit of U.S. Provisional Application No. 63/368,247, filed Jul. 12, 2022, entitled ENDOPHYTE COMPOSITIONS AND METHODS FOR IMPROVED PLANT HEALTH, and U.S. Provisional Application No. 63/484,188, filed Feb. 9, 2023, entitled, FORMULATION FOR STABILIZATION OF BIOLOGICAL MATERIALS, each of which is incorporated by reference in their entirety.

### BACKGROUND

According to the United Nations Food and Agriculture Organization, the world's population will exceed 9.6 billion people by the year 2050, which will require significant improvements in agriculture to meet growing food demands. There is a need for improved methods and agricultural plants that will enable a near doubling of food production with fewer resources and more environmentally sustainable inputs, and for plants with improved responses to various stresses.

### BRIEF DESCRIPTION OF THE DRAWINGS

FIG. 1A shows exemplary images of GFP-tagged endophyte MIC-28837 (indicated by “A” arrows) in an endophytic relationship with root tissue (indicated by “B” arrows) of 10-day old wheat seedlings. Excitation at 488 nm, and root autofluorescence and GFP detected at 650-800 nm and 500-530 nm, respectively. GFP-expressing bacteria are clearly visualized with root tissue.

FIG. 1B shows exemplary images of GFP-tagged endophyte MIC-28837 (indicated by “A” arrows) in an endophytic relationship with root tissue (indicated by “B” arrows) of 10-day old wheat seedlings. Excitation at 488 nm, and root autofluorescence and GFP detected at 650-800 nm and 500-530 nm, respectively. GFP-expressing bacteria are clearly visualized with root tissue.

FIG. 2A shows exemplary images of GFP-tagged endophyte MIC-28837 (indicated by “A” arrows) in an close relationship with root tissue (indicated by “B” arrows) of corn seedlings. GFP-expressing bacteria are shown surrounding emerging corn root hairs. Excitation at 488 nm, and root autofluorescence and GFP detected at 650-800 nm and 500-530 nm, respectively.

FIG. 2B shows a diagram representing a root, with an exemplary root hair indicated by “B” arrows.

FIG. 3A and FIG. 3B show exemplary images of GFP-tagged endophyte MIC-28837 (indicated by “A” arrows) in an close relationship with root tissue (indicated by “B” arrows) of soybeans. GFP-expressing bacteria are clearly visualized forming a layer on the exterior of the soybean root tissue. Excitation at 488 nm, and root autofluorescence and GFP detected at 650-800 nm and 500-530 nm, respectively.

FIG. 4A and FIG. 4B show exemplary images of GFP-tagged endophyte MIC-28837 (indicated by “A” arrows) surrounding soybean cyst nematode eggs (labeled B). GFP-tagged endophyte MIC-28837 slurry was standardized to 10\hat{ }5 and incubated with SCN eggs under microscope. The concentration of GFP-tagged endophyte MIC-28837 is greatest in the regions immediately surrounding the eggs, and lesser in regions farther from the eggs (an example labeled as “C” in FIG. 4B). This shows a direct interaction between MIC-28837 and the eggs.

FIG. 5A, FIG. 5B, and FIG. 5C show results of independent, repeated experiments showing a significant reduction in percent of soy knot nematode (SCN) eggs hatching in the presence of MIC-28837; measurements were taken 7 days after plating (FIG. 5A) or 9 days after plating (FIG. 5B and FIG. 5C). FIG. 5A shows a comparison of soy knot nematode (SCN) eggs hatching in the presence of MIC-28837 grown in TSB (diluted to 10\hat{ }6 CFU/mL in PBS compared) (see results labeled “Slurry”) to MIC-28837 spray dried powder resuspended in PBS (to concentration of 10\hat{ }6 CFU/mL) (see results labeled “TGAI”) compared, and to a formulation control (PBS) (see results labeled “Formulation Control”); percent hatching was measured at after 7 days. FIG. 5B and FIG. 5C show a comparison of SCN eggs hatching in the presence of MIC-28837 spray dried powder resuspended in PBS (to concentration of 10\hat{ }6 CFU/mL) (see results labeled “TGAI”) compared, and to a formulation control (PBS) (see results labeled “Formulation Control”); percent hatching was measured at after 9 days.

FIG. 6A shows an exemplary image of MIC-28837 treated soybean plants (“T”) and untreated control soybean plants (“C”) after 2 weeks growth in water deficit conditions. The line marked with an “A” approximately represents the shoot height of an untreated control soybean plant. The line marked with a “B” approximately represents the shoot height of a MIC-28837 treated soybean plant.

FIG. 6B shows an exemplary image of MIC-28837 treated soybean plants (“T”) and untreated control soybean plants (“C”) after 2 weeks growth in water deficit conditions. The line marked with an “A” approximately represents the length of roots of an untreated control soybean plant extending beyond the container within which the plant was grown. The line marked with a “B” approximately represents the root length of a MIC-28837 treated soybean plant extending beyond the container within which the plant was grown.

FIG. 7A shows percent mortality of SCN eggs in suspension when untreated (“Formulation Control”) and treated with MIC-28837 (“MIC-28837”). Measurements were made 12 days after plating. Error bars represent 90% CI. MIC-28837 used in this assay was fermented in TSB.

FIG. 7B shows percent mortality of SCN eggs in suspension in TSB (“Formulation Control”) and treated with MIC-28837 (“MIC-28837”). Measurements were made 9 days after plating. Error bars represent 90% CI. MIC-28837 used in this assay was fermented in TSB.

FIG. 8A and FIG. 8B show the number of SCN juveniles per gram of root tissue in untreated control soybean plants (“Untreated Control”) and MIC-28837 (“MIC-28837”) treated soybean plants. Error bars represent 95% confidence interval.

FIG. 9A and FIG. 9B show the number of RKN juveniles per gram of root tissue in untreated control soybean plants (“Untreated Control”) and MIC-28837 (“MIC-28837”) treated soybean plants. Error bars represent 95% confidence interval.

FIG. 10 shows an exemplary image of nematodes (indicated by arrows) infecting a root (a bracket labeled “A” indicates the width of the root).

FIG. 11A shows results of 2021-2022 USA field trials in soybean fields across 9 locations under natural nematode infestation. Root fresh weight was measured 17 full days after full emergence and compared to untreated controls. Forty-two MIC-28837 (“MIC-28837”) treated plants, fifty-two plants treated with a commercial chemical nematicide (“Chemical Control”), and fifty-two plants treated with a reference biological biotic product (“Biological Benchmark”) were measured. Untreated controls had an average fresh root weight at 17 full days after full emergence of 2.29 g/plant.

FIG. 11B shows results of 2021-2022 USA field trials in soybean fields across 9 locations under natural nematode infestation. Shoot fresh weight was measured 17 full days after full emergence and compared to untreated controls. Forty-two MIC-28837 (“MIC-28837”) treated plants, fifty-two plants treated with a commercial chemical nematicide (“Chemical Control”), and fifty-two plants treated with a reference biological biotic product (“Biological Benchmark”) were measured. Untreated controls had an average fresh shoot weight at 17 full days after full emergence of 8.75 g/plant.

FIG. 11C shows results of 2021-2022 USA field trials in soybean fields across 9 locations under natural nematode infestation. Yield was measured and compared to untreated control plots. “MIC-28837” indicates MIC-28837 treated plants; “Chemical Control” indicates plants treated with a commercial chemical nematicide; “Biological Benchmark” indicates plants treated with a reference biological biotic product. Untreated control plots had an average yield of 69.6 bu/acre. Plots treated with MIC-28837, on average, showed a 1.9 bu/acre increase in yield and a 69% win rate. Plots treated with a commercial chemical nematicide, on average, showed a 1.6 bu/acre increase in yield and a 71% win rate. Plots treated with a reference biological biotic product, on average, showed a 0.8 bu/acre increase in yield and a 57% win rate.

FIG. 12A shows results of 2021Brazil field trials in soybean fields inoculated with Heterodera glycines (SCN). Egg counts on roots were measured 45 days after planting and compared to untreated controls. Sixteen MIC-28837 (“MIC-28837”) treated plants in two dosages (1.0 g/kg seeds and 0.65 g/kg seeds), and 32 plants treated with a reference biological biotic product (“Biological Benchmark”) were measured.

FIG. 12B shows results of 2021Brazil field trials in soybean fields inoculated with Heterodera glycines (SCN). J2 juvenile counts on roots were measured 45 days after planting and compared to untreated controls. Sixteen MIC-28837 (“MIC-28837”) treated plants in two dosages (1.0 g/kg seeds and 0.65 g/kg seeds), and 32 plants treated with a reference biological biotic product (“Biological Benchmark”) were measured.

FIG. 12C shows results of 2021Brazil field trials in soybean fields inoculated with Heterodera glycines (SCN). Yield was measured and compared to untreated control plots. Untreated control plots had an average yield of 40.0 bu/acre. Plots treated with MIC-28837 at 1.00 g/kg, on average, showed a 2.4 bu/acre increase in yield and an 88% win rate. Plots treated with MIC-28837 at 0.65 g/kg, on average, showed a 2.2 bu/acre increase in yield and a 75% win rate.

FIG. 13A shows results of 2020 Brazil field trials conducted across 4 locations (16 replicates per treatment) in soybean fields inoculated with Heterodera glycines (SCN). Egg counts on roots at V8 were measured 45 days after full emergence and compared to untreated controls. Trials included MIC-28837 (“MIC-28837”) treated plants (0.65 g/kg), and plants treated with one of two reference biological biotic products (“Biological Benchmark #1” and “Biological Benchmark #2”). Treatment with MIC-28837 resulted in a highly significant (p=0.01) reduction in egg count relative to untreated controls. Untreated controls had an average egg count at 45 days after full emergence of 1.04 eggs/5 g root.

FIG. 13B shows results of 2020 Brazil field trials conducted across 4 locations (16 replicates per treatment) in soybean fields inoculated with Heterodera glycines (SCN). The number of J2 juveniles on roots at R6 were measured 75 days after full emergence and compared to untreated controls. Trials included MIC-28837 (“MIC-28837”) treated plants (0.65 g/kg), and plants treated with one of two reference biological biotic products (“Biological Benchmark #1” and “Biological Benchmark #2”). Treatment with MIC-28837 resulted in a highly significant (p<0.01) reduction in J2 count on roots relative to untreated controls. Untreated controls had an average J2 count at 75 days after full emergence of 10.06 J2/g root.

FIG. 13C shows results of 2020 Brazil field trials conducted across 4 locations (16 replicates per treatment) in soybean fields inoculated with Heterodera glycines (SCN). Yield was measured and compared to untreated controls. Trials included MIC-28837 (“MIC-28837”) treated plants (0.65 g/kg), and plants treated with one of two reference biological biotic products (“Biological Benchmark #1” and “Biological Benchmark #2”). Treatment with MIC-28837 resulted in a highly significant (p<0.01) increase in yield relative to untreated controls. Untreated controls had an average yield of 30.6 bu/acre. Plots treated with MIC-28837, on average, showed a 1.2 bu/acre increase in yield and a 69% win rate.

FIG. 14A shows results of 2020 Brazil field trials conducted across 4 locations (16 replicates per treatment) in soybean fields inoculated with Pratylenchus brachyurus (Lesion Nematodes). Egg counts on roots at V8 were measured 45 days after full emergence and compared to untreated controls. Trials included MIC-28837 (“MIC-28837”) treated plants (0.65 g/kg), and plants treated with one of two reference biological biotic products (“Biological Benchmark #1” and “Biological Benchmark #2”). Treatment with MIC-28837 resulted in a highly significant (p<0.01) reduction in egg count relative to untreated controls. Untreated controls had an average egg count at 45 days after full emergence of 20.25 eggs/5 g root.

FIG. 14B shows results of 2020 Brazil field trials conducted across 4 locations (16 replicates per treatment) in soybean fields inoculated with Pratylenchus brachyurus (Lesion Nematodes). The count of J2 juveniles on roots at R6 were measured 75 days after full emergence and compared to untreated controls. Trials included MIC-28837 (“MIC-28837”) treated plants (0.65 g/kg), and plants treated with one of two reference biological biotic products (“Biological Benchmark #1” and “Biological Benchmark #2”). Treatment with MIC-28837 resulted in a highly significant (p<0.01) reduction in J2 counts relative to untreated controls. Untreated controls had an average J2 count at 75 days after full emergence of 90.3 J2/g root.

FIG. 14C shows results of 2020 Brazil field trials conducted across 4 locations (16 replicates per treatment) in soybean fields inoculated with Pratylenchus brachyurus (Lesion Nematodes). Yield was measured and compared to untreated control plots. Trials included MIC-28837 (“MIC-28837”) treated plants (0.65 g/kg), and plants treated with one of two reference biological biotic products (“Biological Benchmark #1” and “Biological Benchmark #2”). Treatment with MIC-28837 resulted in a 3% increase in yield relative to untreated controls, and a win rate of 69%. Untreated controls had an average yield of 25.8 bu/acre.

FIG. 15 shows shows exemplary method of production and formulation of a spray dried powder intermediate product.

FIG. 16A shows the chemical structure of peniprequinolone, a nematocidal alkaloid produced by MIC-28837.

FIG. 16B shows the chemical structure of vulnibactin 3, a siderophore produced by MIC-28837.

FIG. 17 shows an approximately 4 kilobase genomic region between the region labelled “A” and the region labelled “B”. The region contains the genes: benR, a putative transcription regulator; salicylate ester/hydrocarbon outer membrane porin, SalD; salicylate esterase; and nahG, a salicylate hydroxylase. FIG. 17 shows an exemplary position of the approximately 4 kilobase region between the genes pca regulon transcriptional regulator pcaR (upstream) and 4-hydroxybenzoate transporter pcaK (downstream).

FIG. 18A shows the titer over time of a flowable powder RTU composition comprising spray dried MIC-28837 (labeled F34) applied to corn seeds at an initial dosage of 1.0E+05 CFU/seed and water dispersed formulation of MIC-28837 (labeled WD) at an initial dosage of 1.0E+05 CFU/seed. The flowable powder RTU composition comprising spray dried MIC-28837 maintained viability on corn seeds for over 2500 days whereas the water dispersed formulation of MIC-28837 lost all detectable viability in fewer than 50 days.

FIG. 18B shows the titer over time of a flowable powder RTU composition comprising spray dried MIC-28837 (labeled F34) applied to soybean seeds at an initial dosage of 1.0E+05 CFU/seed and water dispersed formulation of MIC-28837 (labeled WD) at an initial dosage of 1.0E+05 CFU/seed. The flowable powder RTU composition comprising spray dried MIC-28837 maintained viability on soybean seeds for over 250 days whereas the water dispersed formulation of MIC-28837 lost all detectable viability in fewer than 50 days.

FIG. 19 shows the titer over time of spray dried powder intermediate product (labeled MUP) comprising MIC-28837 (measured in CFU/g) and water dispersed formulation (labeled WD) MIC-28837 comprising MIC-28837 (measured in CFU/mL), at two temperatures: 4 degrees C. and 22 degrees C. The initial starting concentration of MIC-28837 MUP was 1.0E+11. The initial starting concentration of MIC-28837 WD was 1.0E+09. Testing of MIC-28837 WD was stopped at approximately 100 days due to contamination overwhelming the sample (a common problem in room temp WDs).

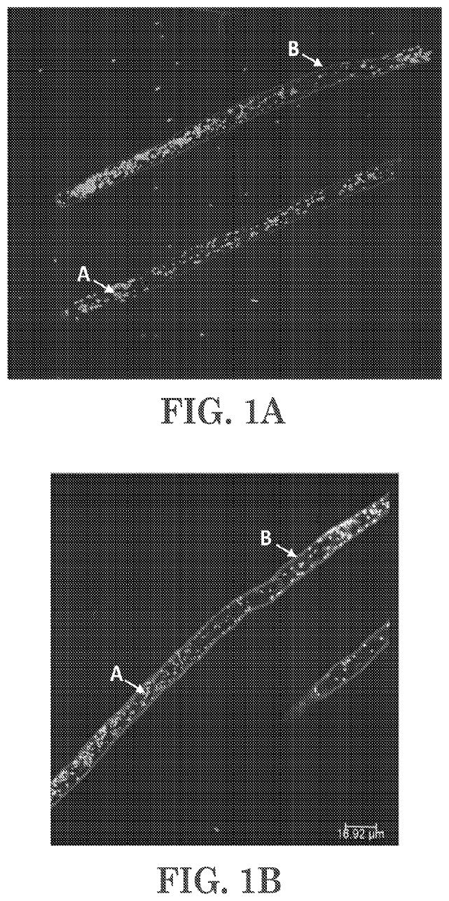

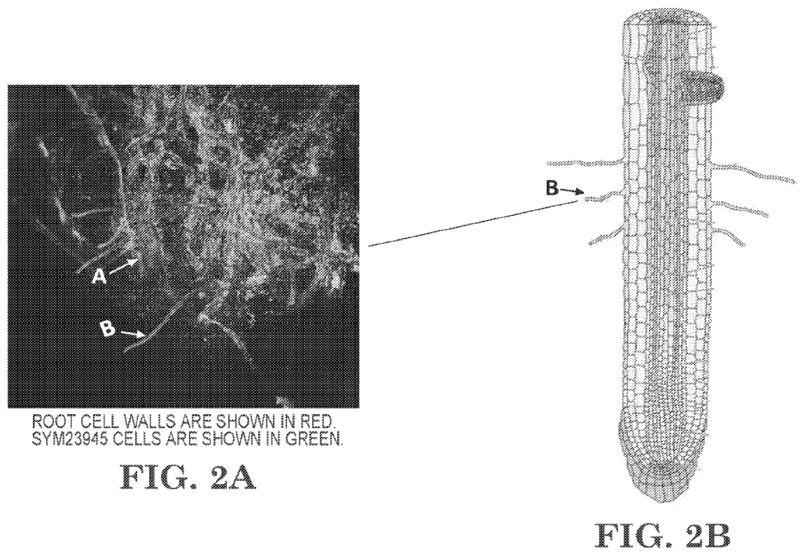

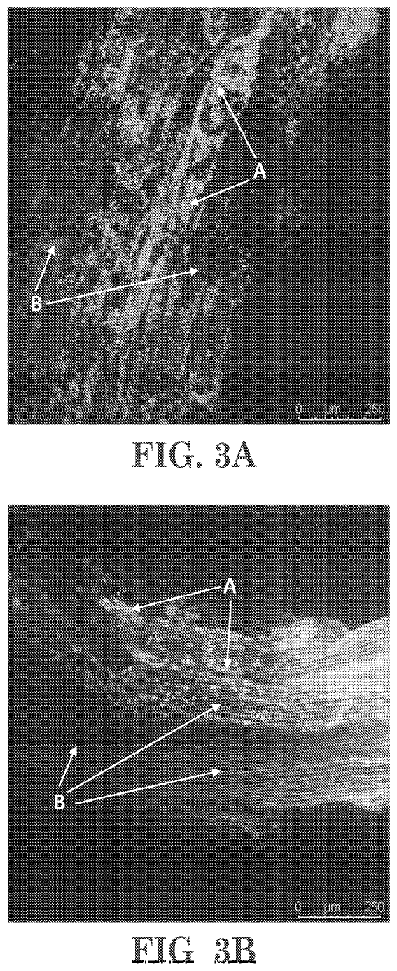

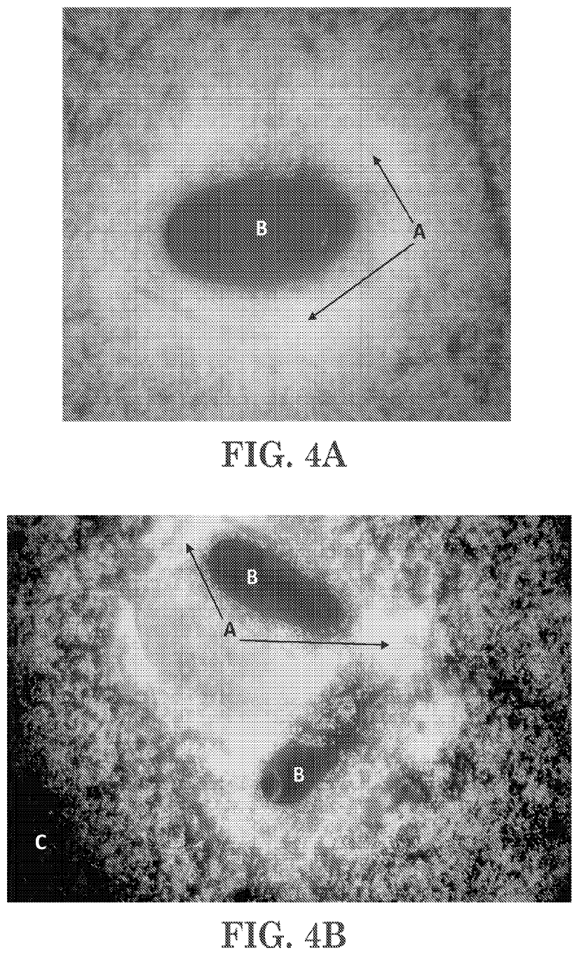

### SUMMARY OF INVENTION

Disclosed herein are methods of improving plant health, comprising heterologously disposing one or more endophytes to a plant element in an effective amount to improve a trait of agronomic importance in a plant derived from the treated plant element relative to a reference plant derived from a reference plant element, wherein the one or more endophytes comprise at least one polynucleotide sequence that is at least 97% identical to one or more polynucleotide sequences selected from the group consisting of SEQ ID NOs. 5-105, or one or more genes encoding a protein whose amino acid sequence is selected from the group consisting of SEQ ID NOs. 106-199, or combinations thereof.

In some embodiments, the method additionally comprises the step of placing the plant element in or on a growth medium. In some embodiments, the one or more endophytes are heterologously disposed to a plant element prior to placing the treated plant element in or on a growth medium. In some embodiments, the one or more endophytes are heterologously disposed to a plant element after placing the plant elements in or on a growth medium. In some embodiments, the one or more endophytes are heterologously disposed to a plant element concurrently with placing the plant elements in or on a growth medium.

In some embodiments, the one or more endophytes are heterologously disposed to a plant element at least two times. In some embodiments, the one or more endophytes are heterologously disposed to a plant element via a seed treatment or soil pre-treatment and one or more foliar applications. In some embodiments, the one or more endophytes are heterologously disposed to a plant element via a seed treatment or soil pre-treatment and one or more floral applications. In some embodiments, the one or more endophytes are heterologously disposed to a plant element via one or more seed treatments or soil pre-treatments, one or more foliar applications, and one or more floral applications. In some embodiments, the one or more endophytes are heterologously disposed to a plant element via seed treatment, root wash, seedling soak, foliar application, floral application, soil inoculum, in-furrow application, sidedress application, soil pre-treatment, wound inoculation, drip tape irrigation, vector-mediation inoculation, injection, osmopriming, hydroponics, aquaponics, aeroponics, or combinations thereof.

In some embodiments, the one or more endophytes are heterologously disposed to a plant element of a different plant variety from the variety of the plant element from which the one or more endophytes were obtained. In some embodiments, the one or more endophytes are heterologously disposed to a plant element of the same plant variety as the variety of the plant element from which the one or more endophytes were obtained. In some embodiments, the one or more endophytes are heterologously disposed to a plant element of a different plant species from the species of the plant element from which the one or more endophytes were obtained. In some embodiments, the one or more endophytes are heterologously disposed to a plant element of the same plant species as the species of the plant element from which the one or more endophytes were obtained.

In some embodiments, the plant elements are allowed to germinate. In some embodiments, the plant elements are grown to yield.

In another aspect, disclosed herein are synthetic compositions, comprising one or more endophytes heterologously disposed to a treatment formulation, wherein the one or more endophytes comprise at least one polynucleotide sequence that is at least 97% identical to one or more polynucleotide sequences selected from the group consisting of SEQ ID NOs. 5-105, or one or more genes encoding a protein whose amino acid sequence is selected from the group consisting of SEQ ID NOs. 106-199, or combinations thereof. In some embodiments, the composition additionally comprises a plant element. In some embodiments, the one or more endophytes are capable of improving a trait of agronomic importance in a plant derived from the plant element (for example, when grown from a treated seed) relative to a plant derived from a reference plant element.

In some embodiments, the synthetic composition additionally comprises one or more of a surfactant, a buffer, a tackifier, a microbial stabilizer, a fungicide, an anticomplex agent, an herbicide, a nematicide, an insecticide, a plant growth regulator, a rodenticide, a desiccant, a nutrient, an excipient, a wetting agent, a salt, and a polymer. In some embodiments, the polymer is a biodegradable polymer selected from the group consisting of alginate, agarose, agar, gelatin, polyacrylamide, chitosan, polyvinyl alcohol, and combinations thereof. In some embodiments, the biodegradable polymer is alginate, and the alginate is sodium alginate.

In some embodiments, the synthetic composition comprises one or more endophytes of the present invention and one or chemical or biological agent capable of capable of killing, impeding the feeding and or growth and or reproduction of, repelling, and or reducing the severity or extent of infection to a plant host of, a pest of a plant, including without limitation chemical or biological agents that are acetylcholinesterase (AChE) inhibitors, GABA-gated chloride channel blockers, sodium channel modulators, nicotinic acetylcholine receptor (nAChR) competitive modulators, nicotinic acetylcholine receptor (nAChR) allosteric modulators-Site I, Glutamate-gated chloride channel (GluCl) allosteric modulators, Chordotonal organ TRPV channel modulators, Nicotinic acetylcholine receptor (nAChR) channel blockers, Octopamine receptor agonists, Voltage-dependent sodium channel blockers, multi-site inhibitors. Ryanodine receptor modulators, chordotonal organ modulators (wherein the chordotonal organ modulator does not bind to the Nan-lav TRPV channel complex), GABA-gated chloride channel allosteric modulators, GABA-gated chloride channel allosteric modulators-Site II, nicotinic acetylcholine receptor (nAChR) Allosteric Modulators-Site II, Juvenile hormone mimics, Mite growth inhibitors affecting CHS1, Inhibitors of chitin biosynthesis affecting CHS1, Inhibitors of chitin biosynthesis-type 1, Moulting disruptors-Dipteran, Ecdysone receptor agonists, Inhibitors of acetyl CoA carboxylase, Inhibitors of mitochondrial ATP synthase, Uncouplers of oxidative phosphorylation via disruption of the proton gradient, Mitochondrial complex III electron transport inhibitors, Mitochondrial complex I electron transport inhibitors, Mitochondrial complex IV electron transport inhibitors, Mitochondrial complex II electron transport inhibitors, Microbial disruptors of insect midgut membranes, Host-specific occluded pathogenic viruses, other active compounds (such as Azadirachtin, Benzoximate, Bromopropylate, Chinomethionat, Dicofol, Lime sulfur, Mancozeb, Pyridalyl, Sulfur, Chlorantraniliprole, Clothianidin, Tioxazafen, Fluopyram), other active bacterial agents (such as certain Burkholderia strains including without limitation Burkholderia rinojenses, Wolbachia pipientis), other active fungal agents (such as Beauveria bassiana strains, Metarhizium anisopliae strain F52, Paecilomyces fumosoroseus Apopka strain 97), biological essence including synthetics or extracts or refined or unrefined oils (such as Dysphania ambrosioides near ambrosioides extract, fatty acid monoesters with glycerol or propanediol, neem oil), non-specific mechanical disruptors (such as Diatomaceous earth), or combinations thereof. Examples of AChE inhibitors include without limitation Carbamates (such as Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC, Xylylcarb) and Organophosphates (such as Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur. Fenamiphos, Fenitrothion, Fenthion, Fosthiazate, Heptenophos, Imicyafos, Isofenphos, Isopropyl O-(methoxyaminothio-phosphoryl) salicylate, Isoxathion, Malathion, Mecarbam, Methamidophos, Methidathion, Mevinphos, Monocrotophos, Naled, Omethoate. Oxydemeton-methyl, Parathion. Parathion-methyl, Phenthoate. Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, Vamidothion). Examples of GABA-gated chloride channel blockers include without limitation Cyclodiene Organochlorines (such as Chlordane, Endosulfan) and Phenylpyrazoles (Fiproles) (such as Ethiprole, Fipronil). Examples of sodium channel modulators include without limitation pyrethroids and pyrethrins (such as Acrinathrin, Allethrin, d-cis-trans Allethrin, d-trans Allethrin, Bifenthrin, Bioallethrin, Bioallethrin Scyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, thetacypermethrin, zeta-Cypermethrin, Cyphenothrin, (1R)-trans-isomers], Deltamethrin, Empenthrin (EZ)-(1R)-isomers], Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans-isomer], Prallethrin, Pyrethrins (pyrethrum), Resmethrin, Silafluofen, Tefluthrin, Tetramethrin, Tetramethrin [(1R)-isomers], Tralomethrin, Transfluthrin) and Methoxychlor. Examples of nAChR competitive modulators include without limitation Neonicotinoids (such as Acetamiprid, Clothianidin, Dinotefuran, Imidacloprid, Nitenpyram, Thiacloprid, Thiamethoxam), nicotine, sulfoximines (such as Sulfoxaflor), Butenolides (such as Flupyradifurone), and Mesoionics (such as Triflumezopyrim). Examples of nAChR allosteric modulators-Site I include without limitation Spinosyns (such as Spinetoram, Spinosad). Examples of GluCl allosteric modulators include without limitation Avermectins and Milbemycins (such as Abamectin, Emamectin benzoate, Lepimectin, Milbemectin). Examples of multi-site inhibitors include without limitation Alkyl halides (such as Methyl bromide and other alkyl halides), Chloropicrin, Fluorides (such as Cryolite (Sodium aluminum fluoride), Sulfuryl fluoride), Borates (such as Borax, Boric acid, Disodium octaborate, Sodium borate, Sodium metaborate), Tartar emetic, Methyl isothiocyanate generators (such as Dazomet, Metam). Examples of chordotonal organ TRPV channel modulators include without limitation Pyridine azomethine derivatives (such as Pymetrozine, Pyrifluquinazon), and Pyropenes (such as Afidopyropen). Examples of juvenile hormone mimics include without limitation juvenile hormone analogues (such as Hydroprene, Kinoprene, Methoprene), fenoxycarb, and pyriproxyfen. Examples of mite growth inhibitors affecting CHS1 include without limitation Clofentezine, Diflovidazin, Hexythiazox, and Etoxazole. Examples of microbial disruptors of insect midgut membranes include without limitation Bacillus thuringiensis (such as Bacillus thuringiensis subsp. israelensis, Bacillus thuringiensis subsp. aizawai, Bacillus thuringiensis subsp. kurstaki, Bacillus thuringiensis subsp. tenebrionis, Bacillus thuringiensis strain EX297512) and the insecticidal proteins they produce (such as Cry1Ab, Cry1Ac, Cry1Fa, Cry1A.105, Cry2Ab, Vip3A, mCry3A, Cry3Ab, Cry3Bb, Cry34Ab1/Cry35Ab1) and Bacillus sphaericus. Examples of inhibitors of mitochondrial ATP synthase include without limitation Diafenthiuron, Organotin miticides (such as Azocyclotin, Cyhexatin, Fenbutatin oxide), Propargite, and Tetradifon. Examples of uncouplers of oxidative phosphorylation via disruption of the proton gradient include without limitation Pyrroles (such as Chlorfenapyr), Dinitrophenols, and Sulfluramid. Examples of nAChR channel blockers include without limitation Nereistoxin analogues (such as Bensultap, Cartap hydrochloride, Thiocyclam, Thiosultap-sodium). Examples of inhibitors of chitin biosynthesis affecting CHS1 include without limitation Benzoylureas (such as Bistrifluron, Chlorfluazuron, Diflubenzuron. Flucycloxuron, Flufenoxuron, Hexaflumuron, Lufenuron, Novaluron, Noviflumuron, Teflubenzuron, Triflumuron). Examples of inhibitors of chitin biosynthesis-type 1 include without limitation Buprofezin. Examples of moulting disruptors (Dipteran) include without limitation Cyromazine. Examples of ecdysone receptor agonists include without limitation Diacylhydrazines (such as Chromafenozide, Halofenozide, Methoxyfenozide, Tebufenozide). Examples of octopamine receptor agonists include without limitation Amitraz. Examples of mitochondrial complex III electron transport inhibitors include without limitation Hydramethylnon, Acequinocyl, Fluacrypyrim, and Bifenazate. Examples of mitochondrial complex I electron transport inhibitors include without limitation METI acaricides and insecticides such as Fenazaquin, Fenpyroximate, Pyridaben, Pyrimidifen, Tebufenpyrad, Tolfenpyrad) and Rotenone. Examples of voltage-dependent sodium channel blockers include without limitation Oxadiazines (such as Indoxacarb) and Semicarbazones (such as Metaflumizone). Examples of inhibitors of acetyl COA carboxylase include without limitation Tetronic and Tetramic acid derivatives (such as Spirodiclofen, Spiromesifen, Spiropidion, Spirotetramat). Examples of mitochondrial complex IV electron transport inhibitors include without limitation Phosphides (Aluminium phosphide, Calcium phosphide, Phosphine, Zinc phosphide), Cyanides (such as Calcium cyanide, Potassium cyanide, Sodium cyanide). Examples of mitochondrial complex II electron transport inhibitors include without limitation Beta-ketonitrile derivatives (such as Cyenopyrafen, Cyflumetofen) and Carboxanilides (such as Pyflubumide). Examples of ryanodine receptor modulators include without limitation such as Diamides (such as Chlorantraniliprole, Cyantraniliprole, Cyclaniliprole Flubendiamide, Tetraniliprole). Examples of chordotonal organ modulators include without limitation Flonicamid. Examples of GABA-gated chloride channel allosteric modulators include without limitation Meta-diamides (Broflanilide) and Isoxazolines (such as Fluxametamide). Examples of nicotinic acetylcholine receptor (nAChR) Allosteric Modulators-Site II include without limitation GS-omega/kappa HXTX-IIv1a peptide.

In some embodiments, the synthetic composition comprises one or more endophytes of the present invention and one or chemical or biological agent capable of killing, impeding the feeding and or growth and or reproduction of, repelling, and or reducing the severity or extent of infection to a plant host of, an pathogen of a plant, including without limitation chemical or biological agents that are PhenylAmides fungicides (acylalanines, oxazolidinones, butyrolactones), hydroxy-(2-amino-) pyrimidines, heteroaromatics (such as isoxazoles, isothiazolones), carboxylic acids, Methyl-Benzimidazole-Carbamates (MBC) fungicides (such as thiophanates, benzimidazoles), N-phenyl carbamates, benzamides (such as toluamides, pyridinylmethyl-benzamides), thiazole carboxamide (such as ethylamino-thiazole-carboxamide), phenylureas, cyanoacrylates (such as aminocyanoacrylates), aryl-phenyl-ketones (such as benzophenone, benzoylpyridine), pyrimidinamines, pyrazole-METI (such as pyrazole-5-carboxamides), quinazoline, succinate-dehydrogenase inhibitors (SDHI) (such as phenyl-benzamides, phenyl-oxo-ethyl thiophene amide, pyridinyl-ethyl-benzamides, phenyl-cyclobutyl-pyridineamide, furan-carboxamides, oxathiin-carboxamides, thiazole-carboxamides, pyrazole-4-carboxamides, N-cyclopropyl-N-benzyl-pyrazole-carboxamides, N-methoxy-(phenyl-ethyl)-pyrazole-carboxamides, pyridine-carboxamides, pyrazine-carboxamides, pydiflumetofen, fluxapyroxad), quinone outside inhibitors (such as methoxy-acrylates, methoxy-acetamide, methoxy-carbamates, oximino-acetates, oximino-acetamides, oxazolidine-diones, dihydro-dioxazines, imidazolinones, benzyl-carbamates, tetrazolinones), quinone inside inhibitors (such as cyano-imidazole, sulfamoyl-triazole, picolinamides), uncouplers of oxidative phosphorylation (such as dinitrophenyl-crotonates, 2,6-dinitro-anilines), organo tin compounds (tri-phenyl tin compounds), thiophene-carboxamides, Quinone outside Inhibitor-stigmatellin binding type (such as triazolo-pyrimidylamine), anilino-pyrimidines, enopyranuronic acid antibiotic, hexopyranosyl antibiotic, glucopyranosyl antibiotic, tetracycline antibiotic, aza-naphthalenes (such as aryloxyquinoline, quinazolinone), phenylpyrroles, dicarboximides, phosphoro-thiolates, dithiolanes, aromatic hydrocarbons, chlorophenyls, nitroanilines, heteroaromatics (such as 1,2,4-thiadiazoles), carbamates, demethylation inhibitors (such as piperazines, pyridines, pyrimidines, imidazoles, triazoles, triazolinthiones), amines (such as morpholines, piperidines, spiroketal-amines), ketoreductase inhibitors (such as hydroxyanilides, amino-pyrazolinone), thiocarbamates, allylamines, polyoxins (such as peptidyl pyrimidine nucleoside), Carboxylic Acid Amides (such as cinnamic acid amides, valinamide carbamates, mandelic acid amides), melanin biosynthesis inhibitors-reductase (such as isobenzo-furanone, pyrrolo-quinolinone, triazolobenzo-thiazole), melanin biosynthesis inhibitors-dehydratase (such as cyclopropane-carboxamide, carboxamide, propionamide), melanin biosynthesis inhibitors-polyketide synthase (such as trifluoroethyl-carbamate), benzo-thiadiazole, benzisothiazole, thiadiazole-carboxamide, polysaccharides (such as laminarin), plant ethanol extracts (such as anthraquinones, resveratrol, extract from Reynoutria sachalinensis), phosphonates (such as ethyl phosphonates, fosetyl-Al, phosphorous acid and salts), isothiazole (such as isothiazolylmethyl ether), cyanoacetamide-oxime, phthalamic acids, benzotriazines, benzene-sulphonamides, pyridazinones, phenyl-acetamide, guanidines, thiazolidine (such as cyano-methylene-thiazolidines), pyrimidinone-hydrazones, 4-quinolyl-acetates, tetrazolyloximes, glucopyranosyl antibiotics, copper salts, sulphur, dithio-carbamates and relatives (such as amobam, ferbam, mancozeb, maneb, metiram, propineb, thiram, zinc thiazole, zineb, ziram), phthalimides, chloronitriles (phthalonitriles), sulfamides (such as dichlofluanid, tolylfluanid), bis-guanidines (such as guazatine, iminoctadine), triazines (such as anilazine), quinones (anthraquinones) (such as dithianon), quinoxalines (such as chinomethionat, quinomethionate), maleimide (such as fluoroimide), thiocarbamate (such as methasulfocarb), polypeptide (lectin) plant extracts (such as extract from the cotyledons of lupine plantlets), phenol and sesquiterpene and triterpenoid and coumarin plant extracts (such as extract from Swinglea glutinosa), terpene hydrocarbon and terpene alcohol and terpene phenol extracts plant extracts (such as extract from Melaleuca alternifolia, plant oils such as eugenol, geraniol, thymol mixtures thereof), Polyene (such as amphoteric macrolide antifungal antibiotic from Streptomyces natalensis or Streptomyces chattanoogensis), oxysterol binding protein homologue inhibition (piperidinyl-thiazole-isoxazolines), other active compounds (such as Fludioxonil, Mefenoxam, Sedaxane, Azoxystrobin, Thiabendazole, Ethaboxam, metalaxyl, Trifloxystrobin, Myclobutanil, Acibenzolar-S-methyl, Metconazole, tolclofos-methyl, Fluopyram, Ipconazole, Oxathiapiprolin, Difenoconazole, Prothyoconazol, Tebuconazole, Pyraclostrobin, Fluxapyroxad), and combinations thereof.

In some embodiments, the synthetic composition comprises one or more endophytes of the present invention and one or more biological agents (for example bacterial or fungal agents) including, but not limited to, those agents capable of killing, impeding the feeding and or growth and or reproduction of, repelling, and or reducing the severity or extent of infection to a plant host of, a pathogen or pest of a plant. The one or more bacterial or fungal agents may be living or dead (including without limitation by heat inactivation) bacteria or fungi, extracts and or metabolites of bacteria or fungi (including without limitation extracts and or metabolites in spent growth media), or combinations thereof. Non-limiting examples of biological agents include Trichoderma species including without limitation Trichoderma atroviride strain I-1237, Trichoderma atroviride strain LU132, Trichoderma atroviride strain SC1, Trichoderma atroviride strain SKT-1, Trichoderma atroviride strain 77B, Trichoderma asperellum strain T34, Trichoderma asperellum strain kd, Trichoderma harzianum strain T-22, Trichoderma virens strain G-41; Clonostachys species including without limitation Gliocladium catenulatum strain J1446, Clonostachys rosea strain CR-7; Coniothyrium species including without limitation Coniothyrium minitans strain CON/M/91-08; Talaromyces species including without limitation Talaromyces flavus strain SAY-Y-94-01; Saccharomyces species including without limitation Saccharomyces cerevisae strain LAS02; Bacillus species including without limitation Bacillus amyloliquefaciens strain QST713, Bacillus amyloliquefaciens strain FZB24, Bacillus amyloliquefaciens strain MBI600, Bacillus amyloliquefaciens strain D747, Bacillus amyloliquefaciens strain F727, Bacillus amyloliquefaciens strain AT-332, Bacillus amyloliquefaciens strain MBI600 Bacillus mycoides isolate J, Bacillus subtilis strain AFS032321, Bacillus subtilis strain Y1336, Bacillus subtilis strain HAI-0404); Pseudomonas species including without limitation Pseudomonas chlororaphis strain AFS009; Streptomyces species including without limitation Streptomyces griseovirides strain K61, Streptomyces lydicus strain WYEC108; Penicillium species such as Penicillium bilaiae, Penicillium bilaiae; Pasteuria species including without limitation Pasteuria nishizawae Pn1),

In some embodiments, one or more endophytes of the present invention and one or chemical or biological agents described herein are present in a synthetic composition at a weight ratio of between 1000:1 and 1:1000, 100:1 and 1:100, or 10:1 and 1:10.

In some embodiments, the synthetic composition may be stored at between 0 degrees Celsius and 4 degrees Celsius for 1 week with less than 1 log loss of CFU of the one or more endophytes. In some embodiments, the synthetic composition may be stored at between 4.1 degrees Celsius and 20 degrees Celsius for 1 week with less than 1 log loss of CFU of the one or more endophytes. In some embodiments, the synthetic composition may be stored at between 20.1 degrees Celsius and 33 degrees Celsius for 1 week with less than 1 log loss of CFU of the one or more endophytes.

In yet another aspect, described herein are methods of measuring plant health comprising determining the presence or abundance of one or more endophytes in a plant element, growth medium or growth environment, wherein the one or more endophytes comprise at least one polynucleotide sequence that is at least 97% identical to one or more polynucleotide sequences selected from the group consisting of SEQ ID NOs. 5-105, or one or more genes encoding a protein whose amino acid sequence is selected from the group consisting of SEQ ID NOs. 106-199, or combinations thereof. In some embodiments, the presence or abundance of one or more endophytes is determined relative to a reference plant element, growth medium or growth environment. In some embodiments, the one or more endophytes are not present in the reference plant element, growth medium or growth environment. In some embodiments, the one or more endophytes are less abundant in the reference plant element, growth medium or growth environment. In some embodiments, the presence or abundance of one or more endophytes is determined in a plant element and modulation of one or more traits of agronomic importance is inferred from the presence or amount of the one or more endophytes in the plant element. In some embodiments, the presence or abundance of one or more endophytes is determined in a growth medium and the capacity of the growth medium to modulate one or more trait of agronomic importance in a plant element planted therein is inferred from the presence or amount of the one or more endophytes in the growth medium. In some embodiments, the presence or abundance of one or more endophytes is determined in a growth environment and the capacity of the growth environment to modulate one or more trait of agronomic importance in a plant element grown therein is inferred from the presence or amount of the one or more endophytes in the growth environment. In some embodiments, the presence or abundance of one or more endophytes is determined by polymerase chain reaction, fluorescence in situ hybridization, or isothermal amplification.

In some embodiments, a plurality of nucleic acid probes is used to determine the presence or abundance of one or more endophytes in a plant element, growth medium or growth environment, wherein the plurality comprises complementary or reverse complementary sequences to a region of at least 10 contiguous nucleotides within one or more polynucleotide sequences selected from the group consisting of SEQ ID NOs. 5-105, or one or more genes encoding a protein whose amino acid sequence is selected from the group consisting of SEQ ID NOs. 106-199, or combinations thereof. In some embodiments, the complementary or reverse complementary region comprises at least 20 contiguous nucleotides. In some embodiments, the complementary or reverse complementary region comprises at least 30 contiguous nucleotides. In some embodiments, the complementary or reverse complementary region comprises at least 40 contiguous nucleotides. In some embodiments, the plurality of nucleic acid probes is single-stranded DNA. In some embodiments, the plurality of nucleic acid probes is attached to one or more solid supports. In some embodiments, the plurality of nucleic acid probes is attached to a plurality of beads. In some embodiments, the plurality of nucleic acid probes is attached to a contiguous solid support.

In some embodiments, the plant element is a monocot. In some embodiments, the monocot is a cereal. In some embodiments, the cereal is selected from the group consisting of wheat, rice, barley, buckwheat, rye, millet, oats, corn, sorghum, triticale, and spelt. In some embodiments, the cereal is wheat.

In some embodiments, the plant element is a dicot. In some embodiments, the dicot is selected from the group consisting of cotton, tomato, lettuce, peppers, cucumber, endive, melon, potato, and squash. In some embodiments, the dicot is a legume. In some embodiments, the legume is soy, peas, or beans.

In some embodiments, the plant element is a whole plant, seedling, meristematic tissue, ground tissue, vascular tissue, dermal tissue, seed, leaf, root, shoot, stem, flower, fruit, stolon, bulb, tuber, corm, keikis, shoot, or bud. In some embodiments, the plant element is a seed.

In some embodiments, the trait of agronomic importance is selected from the group consisting of yield, root fresh weight, shoot fresh weight, biotic stress tolerance, drought tolerance, and combinations thereof. In some embodiments, the trait of agronomic importance is biotic stress tolerance. In some embodiments, the trait of agronomic importance is improved nutrient use efficiency. In some embodiments, the trait of agronomic importance is drought tolerance.

In some embodiments, the one or more endophytes is a member of the Class Gammaproteobacteria. In some embodiments, the one or more endophytes is a member of the Order Pseudomonadales. In some embodiments, the one or more endophytes is a member of the Family Pseudomonadaceae. In some embodiments, the one or more endophytes is a member of the Genus Pseudomonas.

In some embodiments, the one or more endophytes comprises at least 2 endophytes. In some embodiments, the one or more endophytes comprises at least 3 endophytes. In some embodiments, the one or more endophytes comprises at least 4 endophytes. In some embodiments, the one or more endophytes comprises at least 5 endophytes. In some embodiments, the one or more endophytes comprises at least 10 endophytes.

In some embodiments, the one or more endophytes are encapsulated in polymeric beads. In some embodiments, the polymeric beads are less than 500 μm in diameter at their widest point. In some embodiments, the polymeric beads are less than 200 μm in diameter at their widest point. In some embodiments, the polymeric beads are less than 100 μm in diameter at their widest point. In some embodiments, the polymeric beads are less than 50 μm in diameter at their widest point. In some embodiments, the polymeric beads' average diameter at their widest point is between 500 μm and 250 μm. In some embodiments, the polymeric beads' average diameter at their widest point is between 249 μm and 100 μm. In some embodiments, the polymeric beads' average diameter at their widest point is between 100 μm and 50 μm.

In some embodiments, the one or more microorganisms are encapsulated in waxes or oils. In some embodiments, the wax or oil encapsulated microorganisms are less than 500 μm in diameter at their widest point. In some embodiments, the wax or oil encapsulated microorganisms are less than 200 μm in diameter at their widest point. In some embodiments, the wax or oil encapsulated microorganisms are less than 100 μm in diameter at their widest point. In some embodiments, the wax or oil encapsulated microorganisms are less than 50 μm in diameter at their widest point. In some embodiments, the wax or oil encapsulated microorganisms' average diameter at their widest point is between 500 μm and 250 μm. In some embodiments, the wax or oil encapsulated microorganisms' average diameter at their widest point is between 249 μm and 100 μm. In some embodiments, the wax or oil encapsulated microorganisms' average diameter at their widest point is between 100 μm and 50 μm. In some embodiments, encapsulation techniques are spray-drying, spray-chilling, freeze-drying, emulsion-based technique, extrusion-dripping, coacervation, and fluidized-bed-coating.

### DETAILED DESCRIPTION

Terms used in the claims and specification are defined as set forth below unless otherwise specified.

It must be noted that, as used in the specification and the appended claims, the singular forms “a,” “an” and “the” include plural referents unless the context clearly dictates otherwise.

This invention relates to methods and compositions for improving plant health. The present invention includes methods for improving plant health, as well as synthetic compositions comprising endophytes capable of improving plant health, and nucleic acid probes and nucleic acid detection kits that may be used to identify endophytes of the present invention.

“Plant health” is demonstrated by the improvement of a trait of agronomic importance in a plant or plant element as compared to a reference plant or plant element. A trait of agronomic importance includes, but is not limited to, drought tolerance, heat tolerance, cold tolerance, salinity tolerance, metal tolerance, herbicide tolerance, improved water use efficiency, improved nitrogen utilization, improved nitrogen fixation, improved nutrient use efficiency, improved nutrient utilization, biotic stress tolerance, yield improvement, health enhancement, vigor improvement, decreased necrosis, decreased chlorosis, decreased area of necrotic tissue, decreased area of chlorotic tissue, decreased pathogen load of tissues, growth improvement, photosynthetic capability improvement, nutrition enhancement, altered protein content, altered oil content, increased biomass, increased shoot height, increased root length, increased shoot biomass, increased root biomass, increased leaf area, increased shoot area, increased root area, improved root architecture, increased seed germination percentage, increased seed germination rate, increased seedling survival, increased survival, photosynthetic efficiency, transpiration rate, seed/fruit number or mass, plant grain or fruit yield, leaf chlorophyll content, photosynthetic rate, wilt recovery, turgor pressure, modulation of a metabolite, production of a volatile organic compound (VOC), modulation of the proteome, increased seed weight, altered seed carbohydrate composition, altered seed oil composition, altered seed protein composition, altered seed nutrient composition, and combinations thereof. The phrase “biotic stress” refers to a growth environment comprising one or more pests or pathogens. Pests can be nematodes and/or insects. In some embodiments, a pest is of the order Lepidoptera, Hemiptera, Tylenchida/Rhabditida, Dorylaimida, Heterodera, Meloidogyne, Pratylenchus, Trichinellida, Globodera, Xiphinema, Hoplolaimus, Longidorus. Rotylenchulus, Helicotylenchus, Belonolaimus, Trichodorus, Paratrichodorus, Tylenchorhynchus, Anguillulina, Merlinia, or Triplonchida. In some embodiments, a pest is of a genera Chrysodeixis, Trichoplusia, Nezara, Lygus, Aphis, Belonolaimus, Xiphenema, Trichodorus, Pratylenchus, Aphelenchoides, Meloidogyne, or Rotylenchulus. Pathogens can be fungal, viral, protist, or bacterial pathogens, for example, pathogens of vertebrates or plants. In some embodiments, a pathogen is of a genera Pythium, Rhizoctonia, Phytophthora, Fusarium, Alternaria, Stugonospora, Aspergillus, Magnaporthe, Botrytis, Puccinia, Blumeria, Erysiphe, Leveillula, Mycosphaerella, Colletotrichum. Macrophomina, Cercospora, Corynespora, or Phomopsis.

“Biomass” means the total mass or weight (fresh or dry), at a given time (for example, age or stage of development), of a plant tissue, plant tissues, an entire plant, or population of plants. The term may also refer to all the plants or species in the community (“community biomass”).

An “increased yield” can refer to any increase in seed or fruit biomass; or seed, seed pod or ear, or fruit number per plant; or seed or fruit weight; or seed or fruit size per plant or unit of production area, e.g. acre or hectare. For example, increased yield of seed or fruit biomass may be measured in units of bushels per acre, pounds per acre, tons per acre, or kilos per hectare. An increased yield can also refer to an increased production of a component of, or product derived from, a plant or plant element or of a unit of measure thereof. For example, increased carbohydrate yield of a grain or increased oil yield of a seed. Typically, where yield indicates an increase in a particular component or product derived from a plant, the particular characteristic is designated when referring to increased yield, e.g., increased oil or grain yield or increased protein yield or seed size.

“Nutrition enhancement” refers to modulation of the presence, abundance, or form of one or more substances in a plant element, wherein the modulation of the one or more substances provides a benefit to other organisms that consume or utilize said plant element.

Synthetic compositions and methods of use described herein may improve plant health by providing an improved benefit or tolerance to a plant that is of at least 0.1%, at least 0.5%, at least 1%, at least 2%, at least 3%, between 3% and 5%, at least 5%, between 5% and 10%, at least 10%, between 10% and 15%, for example at least 15%, between 15% and 20%, at least 20%, between 20% and 30%, at least 30%, between 30% and 40%, at least 40%, between 40% and 50%, at least 50%, between 50% and 60%, at least 60%, between 60% and 75%, at least 75%, between 75% and 100%, at least 100%, between 100% and 150%, at least 150%, between 150% and 200%, at least 200%, between 200% and 300%, at least 300% or more, when compared with a reference plant. A “reference plant”, “reference plant element”, “reference agricultural plant” or “reference seed” means a similarly situated plant or seed of the same species, strain, or cultivar to which a treatment, formulation, composition, or endophyte preparation as described herein is not administered/contacted. A reference plant, therefore, is identical to the treated plant except for the presence of the active ingredient to be tested and can serve as a control for detecting the effects of the treatment conferred to the plant. A plurality of reference plants may be referred to as a “reference population”.

In some embodiments, one or more endophytes and or one or more compounds produced by one or more endophytes are heterologously disposed on a plant element in an effective amount to improve plant health. In some embodiments, an improvement of plant health is measured by an increase in a trait of agronomic importance, for example root length or yield. In some embodiments, an improvement of subject health is measured by a decrease in a trait of importance, for example necrosis or chlorosis. In some embodiments, improved plant health is demonstrated by an improvement of a trait of agronomic importance or tolerance in a treated plant by at least 0.1%, at least 0.5%, at least 1%, at least 2%, at least 3%, between 3% and 5%, at least 5%, between 5% and 10%, at least 10%, between 10% and 15%, for example at least 15%, between 15% and 20%, at least 20%, between 20% and 30%, at least 30%, between 30% and 40%, at least 40%, between 40% and 50%, at least 50%, between 50% and 60%, at least 60%, between 60% and 75%, at least 75%, between 75% and 100%, at least 100%, between 100% and 150%, at least 150%, between 150% and 200%, at least 200%, between 200% and 300%, at least 300% or more, as compared to a reference plant element not further comprising said endophyte. An “effective amount” of one or more endophytes is the amount capable of improving trait of agronomic importance or tolerance by at least 0.1%, at least 0.5%, at least 1%, at least 2%, at least 3%, between 3% and 5%, at least 5%, between 5% and 10%, at least 10%, between 10% and 15%, for example at least 15%, between 15% and 20%, at least 20%, between 20% and 30%, at least 30%, between 30% and 40%, at least 40%, between 40% and 50%, at least 50%, between 50% and 60%, at least 60%, between 60% and 75%, at least 75%, between 75% and 100%, at least 100%, between 100% and 150%, at least 150%, between 150% and 200%, at least 200%, between 200% and 300%, at least 300% or more, as compared to a reference plant element not further comprising said endophyte. In some embodiments, an effective amount of treatment comprising an endophyte is at least 10 CFU per unit of plant element, at least 10\hat{ }2 CFU per unit of plant element, between 10\hat{ }2 and 10\hat{ }3 CFU per unit of plant element, at least about 10\hat{ }3 CFU per unit of plant element, between 10\hat{ }3 and 10\hat{ }4 CFU per unit of plant element, at least about 10\hat{ }4 CFU per unit of plant element, between 10\hat{ }4 and 10\hat{ }5 CFU per unit of plant element, at least about 10\hat{ }5 CFU, between 10\hat{ }5 and 10\hat{ }6 CFU per unit of plant element, at least about 10\hat{ }6 CFU per unit of plant element, between 10\hat{ }6 and 10\hat{ }7 CFU per unit of plant element, at least about 10\hat{ }7 CFU per unit of plant element, between 10\hat{ }7 and 10\hat{ }8 CFU per unit of plant element, or even greater than 10\hat{ }8 CFU per unit of plant element. A unit of a plant element may be an individual plant element, e.g., an individual seed, or a unit of area surface area of a plant element, e.g., a square inch of leaf tissue, or unit of surface area of a plant element, e.g., a cubic centimeter of root.

In some embodiments, an effective amount of treatment comprising an endophyte is at least 10 CFU per gram of synthetic composition, at least 10\hat{ }2 CFU per gram of synthetic composition, between 10\hat{ }2 and 10\hat{ }3 CFU per gram of synthetic composition, at least about 10\hat{ }3 CFU per gram of synthetic composition, between 10\hat{ }3 and 10\hat{ }4 CFU per gram of synthetic composition, at least about 10\hat{ }4 CFU per gram of synthetic composition, between 10\hat{ }4 and 10\hat{ }5 CFU per gram of synthetic composition, at least about 10\hat{ }5 CFU per gram of synthetic composition, between 10\hat{ }5 and 10\hat{ }6 CFU per gram of synthetic composition, at least about 10\hat{ }6 CFU per gram of synthetic composition, between 10\hat{ }6 and 10\hat{ }7 CFU per gram of synthetic composition, at least about 10\hat{ }7 CFU per gram of synthetic composition, between 10\hat{ }7 and 10\hat{ }8 CFU per gram of synthetic composition, at least about 10\hat{ }8 CFU per gram of synthetic composition, between 10\hat{ }8 and 10\hat{ }9 CFU per gram of synthetic composition, at least about 10\hat{ }9 CFU per gram of synthetic composition, between 10\hat{ }9 and 10\hat{ }10 CFU per gram of synthetic composition, or even greater than 10\hat{ }10 CFU per gram of synthetic composition. In some embodiments, a synthetic composition comprises an endophyte heterologously disposed in a treatment formulation at concentration of at least 10\hat{ }3 CFU per gram, at least 10\hat{ }4 CFU per gram, at least 10\hat{ }5 CFU per gram, at least 10\hat{ }6 CFU per gram, at least 10\hat{ }7 CFU per gram, at least 10\hat{ }8 CFU per gram, or at least 10\hat{ }9 CFU per gram.

In some embodiments, an effective amount of treatment comprising an endophyte is at least 10 CFU per unit of plant element, at least 10\hat{ }2 CFU per unit of plant element, between 10\hat{ }2 and 10\hat{ }3 CFU per unit of plant element, at least about 10\hat{ }3 CFU per unit of plant element, between 10\hat{ }3 and 10\hat{ }4 CFU per unit of plant element, at least about 10\hat{ }4 CFU per unit of plant element, between 10\hat{ }4 and 10\hat{ }5 CFU per unit of plant element, at least about 10\hat{ }5 CFU per unit of plant element, between 10\hat{ }5 and 10\hat{ }6 CFU per unit of plant element, at least about 10\hat{ }6 CFU per unit of plant element, between 10\hat{ }6 and 10\hat{ }7 CFU per unit of plant element, at least about 10\hat{ }7 CFU per unit of plant element, between 10\hat{ }7 and 10\hat{ }8 CFU per unit of plant element, at least about 10\hat{ }8 CFU per unit of plant element, between 10\hat{ }8 and 10\hat{ }9 CFU per unit of plant element, at least about 10\hat{ }9 CFU per unit of plant element, between 10\hat{ }9 and 10\hat{ }10 CFU per unit of plant element, or even greater than 10\hat{ }10 CFU per unit of plant element. In some embodiments, a synthetic composition comprises an endophyte heterologously disposed in a treatment formulation at concentration of at least 10\hat{ }3 CFU per gram, at least 10\hat{ }4 CFU per gram, at least 10\hat{ }5 CFU per gram, at least 10\hat{ }6 CFU per gram, at least 10\hat{ }7 CFU per gram, at least 10\hat{ }8 CFU per gram, or at least 10\hat{ }9 CFU per gram. In some embodiments, the plant element is a seed.

** The methods and compositions of the present invention are broadly applicable to cultivated plants, particularly plants that are cultivated by humans for food, feed, fiber, fuel, and/or industrial purposes. In some embodiments, plants (including seeds and other plant elements) are monocots or dicots. In some embodiments, plants used in the methods and compositions of the present invention include, but are not limited to: agricultural row, agricultural grass plants or other field crops: wheat, rice, barley, buckwheat, beans (for example: soybean, snap, dry), corn (for example: grain, seed, sweet corn, silage, popcorn, high oil), canola, sugar cane, peas (for example: dry, succulent), peanuts, safflower, sunflower, alfalfa hay, forage and cover crops (for example: alfalfa, clover, vetch, and trefoil), berries and small fruits (for example: blackberries, blueberries, currants, elderberries, gooseberries, huckleberries, loganberries, raspberries, strawberries, bananas and grapes), bulb crops (for example: garlic, leeks, onions, shallots, and ornamental bulbs), citrus fruits (for example: citrus hybrids, grapefruit, kumquat, lines, oranges, and pummelos), cucurbit vegetables (for example: cucumbers, melons, gourds, pumpkins, and squash), flowers (for example: ornamental, horticultural flowers including roses, daisies, tulips, freesias, carnations, heather, lilies, irises, orchids, snapdragons, and ornamental sunflowers), bedding plants, ornamentals, fruiting vegetables (for example: eggplant, sweet and hot peppers, tomatillos, and tomatoes), herbs, spices, mints, sugar cane, hydroponic crops (for example: cucumbers, tomatoes, lettuce, herbs, and spices), leafy vegetables and cole crops (for example: arugula, celery, chervil, endive, fennel, lettuce including head and leaf, parsley, radicchio, rhubarb, spinach, Swiss chard, broccoli, Brussels sprouts, cabbage, cauliflower, collards, kale, kohlrabi, and mustard greens), asparagus, legume vegetable and field crops (for example: snap and dry beans, lentils, succulent and dry peas, and peanuts), pome fruit (for example: pears and quince), root crops (for example: beets, sugar beets, red beets, carrots, celeriac, chicory, horseradish, parsnip, radish, rutabaga, salsify, and turnips), deciduous trees (for example: maple and oak), evergreen trees (for example: pine, cedar, hemlock and spruce), small grains (for example: rye, wheat including spring and winter wheat, millet, oats, barley including spring and winter barley, and spelt), stone fruits (for example: apricots, cherries, nectarines, peaches, plums, and prunes), tree nuts (for example: almonds, beech nuts, Brazil nuts, butternuts, cashews, chestnuts, filberts, hickory nuts, macadamia nuts, pecans, pistachios, and walnuts), oil seed crops (for example: soybeans, sunflowers, canola, copra, cottonseed, palm kernel, peanut, rapeseed, and flax), and tuber crops (for example: potatoes, sweet potatoes, yams, artichoke, cassava, and ginger). In a particular embodiment, the agricultural plant is selected from the group consisting of rice (Oryza sativa and related varieties), soy (Glycine max and related varieties), wheat (Triticum aestivum and related varieties), oats (Avena sativa and related varieties), barley (Hordeum vulgare and related varieties), corn (Zea mays and related varieties), peanuts (Arachis hypogaea and related varieties), canola (Brassica napus, Brassica rapa and related varieties), coffee (Coffea spp.), cocoa (Theobroma cacao), melons, and tomatoes (Solanum lycopsersicum and related varieties).

Plant health may be improved by treatment of a plant or plant element. A “plant element” is intended to generically reference either a whole plant or a plant component, including but not limited to plant tissues, parts, and cell types. A plant element is preferably one of the following: whole plant, seedling, meristematic tissue, ground tissue, vascular tissue, dermal tissue, seed, leaf, root, shoot, stem, flower, fruit, stolon, bulb, tuber, corm, keikis, shoot, or bud.

Plant health may be improved by treatment with a composition of the present invention, in particular compositions of the present invention comprising one or more endophytes. An “endophyte” is an organism capable of living on a plant element (e.g., rhizoplane or phyllosphere) or within a plant element, or on a surface in close physical proximity with a plant element, e.g., the phyllosphere and rhizosphere including soil surrounding roots. A “beneficial” endophyte does not cause disease or harm the host plant otherwise. Endophytes can occupy the intracellular or extracellular spaces of plant tissue, including the leaves, stems, flowers, fruits, seeds, or roots. An endophyte can be, for example, a bacterial or fungal organism, and can confer a beneficial property to the host plant such as an increase in yield, biomass, resistance, or fitness. An endophyte can be a fungus or a bacterium. As used herein, the term “microbe” is sometimes used to describe an endophyte. As used herein, the term “microbe” or “microorganism” refers to any species or taxon of microorganism, including, but not limited to, archaea, bacteria, microalgae, fungi (including mold and yeast species), mycoplasmas, microspores, nanobacteria, oomycetes, and protozoa. In some embodiments, a microbe or microorganism is an endophyte, for example a bacterial or fungal endophyte, which is capable of living within a plant.

The term “isolated” is intended to specifically reference an organism, cell, tissue, polynucleotide, or polypeptide that is removed from its original source and purified from additional components with which it was originally associated. For example, an endophyte may be considered isolated from a seed if it is removed from that seed source and purified so that it is isolated from one or more additional components with which it was originally associated. Similarly, an endophyte may be removed and purified from a plant or plant element so that it is isolated and no longer associated with its source plant or plant element.

As used herein, an isolated strain of a microbe is a strain that has been removed from its natural milieu. “Pure cultures” or “isolated cultures” are cultures in which the organisms present are only of one strain of a particular genus and species. “Mixed cultures,” are cultures in which more than one genus and/or species of microorganism are present. As such, the term “isolated” does not necessarily reflect the extent to which the microbe has been purified. A “substantially pure culture” of the strain of microbe refers to a culture which contains substantially no other microbes than the desired strain or strains of microbe. In other words, a substantially pure culture of a strain of microbe is substantially free of other contaminants, which can include microbial contaminants. Further, as used herein, a “biologically pure” strain is intended to mean the strain was separated from materials with which it is normally associated in nature. A strain associated with other strains, or with compounds or materials that it is not normally found with in nature, is still defined as “biologically pure.” A monoculture of a particular strain is, of course, “biologically pure.” As used herein, the term “enriched culture” of an isolated microbial strain refers to a microbial culture that contains more that 50%, 60%, 70%, 80%, 90%, or 95% of the isolated strain.

A “population” of endophytes, or an “endophyte population”, refers to one or more endophytes that share a common genetic derivation, e.g., one or more propagules of a single endophyte, i.e., endophytes grown from a single picked colony. In some embodiments, a population refers to endophytes of identical taxonomy. In some cases, a population of endophytes refers to one or more endophytes of the same genus. In some cases, a population of endophytes refers to one or more endophytes of the same species or strain.

A “plurality of endophytes” means two or more types of endophyte entities, e.g., of bacteria or fungi, or combinations thereof. In some embodiments, the two or more types of endophyte entities are two or more individual endophytic organisms, regardless of genetic derivation or taxonomic relationship. In some embodiments, the two or more types of endophyte entities are two or more populations of endophytes. In other embodiments, the two or more types of endophyte entities are two or more species of endophytes. In yet other embodiments, the two or more types of endophyte entities are two or more genera of endophytes. In yet other embodiments, the two or more types of endophyte entities are two or more families of endophytes. In yet other embodiments, the two or more types of endophyte entities are two or more orders of endophytes. In yet other embodiments, the two or more types of endophyte entities are two or more classes of endophytes. In yet other embodiments, the two or more types of endophyte entities are two or more phyla of endophytes. In some embodiments, a plurality refers to three or more endophytes, either distinct individual organisms or distinct members of different genetic derivation or taxa. In some embodiments, a plurality refers to four or more either distinct individual endophytic organisms or distinct members of different genetic derivation or taxa. In some embodiments, a plurality refers to five or more, ten or more, or an even greater number of either distinct individual endophytic organisms or distinct members of different genetic derivation or taxa. In some embodiments, the term “consortium” or “consortia” may be used as a collective noun synonymous with “plurality”, when describing more than one population, species, genus, family, order, class, or phylum of endophytes.

In some embodiments, a treatment may comprise a modified microbe, plant, or plant element. A microbe, plant, or plant element is “modified” when it comprises an artificially introduced genetic or epigenetic modification. In some embodiments, the modification is introduced by a genome engineering or genome editing technology. In some embodiments, genome engineering or editing utilizes non-homologous end joining (NHEJ), homology directed repair (HDR), or combinations thereof. In some embodiments, genome engineering or genome editing is carried out with a Class I or Class II clustered regulatory interspaced short palindromic repeats (CRISPR) system. In some embodiments, the CRISPR system is CRISPR/Cas9. In some embodiments, the CRISPR system is CRISPR/Cpf1. In some embodiments, the modification is introduced by a targeted nuclease. In some embodiments, targeted nucleases include, but are not limited to, transcription activator-like effector nuclease (TALEN), zinc finger nuclease (ZNF), Cas9, Cas9 variants, Cas9 homologs, Cpf1, Cpf1 variants, Cpf1 homologs, and combinations thereof. In some embodiments, the modification is an epigenetic modification. In some embodiments, the modification is introduced by treatment with a DNA methyltransferase inhibitor such as 5-azacytidine, or a histone deacetylase inhibitor such as 2-amino-7-methoxy-3H-phenoxazin-3-one. In some embodiments, the modification is introduced via tissue culture. In some embodiments, a modified microbe or plant or plant element comprises a transgene.

As used herein, the term “bacterium” or “bacteria” refers in general to any prokaryotic organism and may reference an organism from either Kingdom Eubacteria (Bacteria), Kingdom Archaebacteria (Archaea), or both. In some cases, bacterial genera have been reassigned due to various reasons (such as, but not limited to, the evolving field of whole genome sequencing), and it is understood that such nomenclature reassignments are within the scope of any claimed genus.

As used herein, the term “fungus” or “fungi” refers in general to any organism from Kingdom Fungi. Historical taxonomic classification of fungi has been according to morphological presentation. Beginning in the mid-1800's, it was recognized that some fungi have a pleomorphic life cycle, and that different nomenclature designations were being used for different forms of the same fungus. With the development of genomic sequencing, it became evident that taxonomic classification based on molecular phylogenetics did not align with morphological-based nomenclature (Shenoy B D, Jeewon R, Hyde K D. Impact of DNA sequence-data on the taxonomy of anamorphic fungi. Fungal Diversity 26 (10) 1-54. 2007). Systematics experts have not aligned on common nomenclature for all fungi, nor are all existing databases and information resources inclusive of updated taxonomies. As such, many fungi provided herein may be described by their anamorph form, but it is understood that based on identical genomic sequencing, any pleomorphic state of that fungus may be considered to be the same organism. In some cases, fungal genera have been reassigned due to various reasons, and it is understood that such nomenclature reassignments are within the scope of any claimed genus.

The degree of relatedness between microbes may be inferred from the sequence similarity of one or more homologous polynucleotide sequences of the microbes. In some embodiments, the one or more homologous polynucleotide sequences are marker genes. As used herein, the term “marker gene” refers to a conserved genomic region comprising sequence variation among related organisms. Examples of marker genes that may be used for the present invention, include but are not limited to: 16S ribosomal RNA gene (“16S”), internal transcribed spacer (“ITS”); fusA gene; largest subunit of RNA polymerase II (“RPB1”); second largest subunit of RNA polymerase II (“RPB2”); beta-tubulin or tubulin (“BTUB2” or “TUB2”); phosphoglycerate kinase (“PGK”); actin (“ACT”); long subunit rRNA gene (“LSU”); small subunit rRNA gene (“SSU”), 60S ribosomal protein L 10 (“60S_L10_L1”), atpD, Calmodulin (“CMD”), GDP gene (“GPD1_2”), etc.

The terms “sequence similarity”, “identity”, “percent identity”, “percent sequence identity” or “identical” in the context of polynucleotide sequences refer to the nucleotides in the two sequences that are the same when aligned for maximum correspondence. There are different algorithms known in the art that can be used to measure nucleotide sequence identity. Nucleotide sequence identity can be measured by a local or global alignment, preferably implementing an optimal local or optimal global alignment algorithm. For example, a global alignment may be generated using an implementation of the Needleman-Wunsch algorithm (Needleman, S. B. & Wunsch, C. D. (1970) Journal of Molecular Biology. 48 (3): 443-53). For example, a local alignment may be generated using an implementation of the Smith-Waterman algorithm (Smith T. F & Waterman, M. S. (1981) Journal of Molecular Biology. 147 (1): 195-197). Optimal global alignments using the Needleman-Wunsch algorithm and optimal local alignments using the Smith-Waterman algorithm are implemented in USEARCH, for example USEARCH version v8.1.1756_i86_osx32.

A gap is a region of an alignment wherein a sequence does not align to a position in the other sequence of the alignment. A terminal gap is a region beginning at the end of a sequence in an alignment wherein the nucleotide in the terminal position of that sequence does not correspond to a nucleotide position in the other sequence of the alignment and extending for all contiguous positions in that sequence wherein the nucleotides of that sequence do not correspond to a nucleotide position in the other sequence of the alignment. An internal gap is a gap in an alignment which is flanked on the 3′ and 5′ end by positions wherein the aligned sequences are identical. In global alignments, terminal gaps are discarded before identity is calculated. For both local and global alignments, internal gaps are counted as differences.

In some embodiments, the nucleic acid sequence to be aligned is a complete gene. In some embodiments, the nucleic acid sequence to be aligned is a gene fragment. In some embodiments, the nucleic acid sequence to be aligned is an intergenic sequence. In a preferred embodiment, inference of homology from a sequence alignment is made where the region of alignment is at least 85% of the length of the query sequence.

The term “substantial homology” or “substantial similarity,” when referring to a polynucleotide sequence or fragment thereof, indicates that, when optimally aligned with appropriate nucleotide insertions or deletions with another polynucleotide sequence (or its complementary strand), there is nucleotide sequence identity in at least about 76%, 80%, 85%, or at least about 90%, or at least about 95%, 96%, at least 97%, 98%, 99% or 100% of the positions of the alignment, wherein the region of alignment is at least about 50%, 60%, 70%, 75%, 85%, or at least about 90%, or at least about 95%, 96%, 97%, 98%, 99% or 100% of the length of the query sequence. In a preferred embodiment, the region of alignment contains at least 100 positions inclusive of any internal gaps. In some embodiments, the region of alignment comprises at least 100 nucleotides of the query sequence. In some embodiments, the region of alignment comprises at least 200 nucleotides of the query sequence. In some embodiments, the region of alignment comprises at least 300 nucleotides of the query sequence. In some embodiments, the region of alignment comprises at least 400 nucleotides of the query sequence. In some embodiments, the region of alignment comprises at least 500 nucleotides of the query sequence. In some embodiments, the terminal nucleotides are trimmed from one or both ends of the sequence prior to alignment. In some embodiments, at least the terminal 10, 15, 20, 25, 30, between 20-30, 35, 40, 45, 50, between 25-50 nucleotides are trimmed from the sequence prior to alignment.

### Synthetic Compositions for Improving Plant Health

In some embodiments, a synthetic composition comprises one or more endophytes capable of improving plant health. A “synthetic composition” comprises one or more endophytes combined by human endeavor with a heterologously disposed plant element or a treatment formulation, said combination which is not found in nature. In some embodiments, a synthetic composition comprises one or more plant elements or formulation components combined by human endeavor with an isolated, purified endophyte composition. In some embodiments, synthetic composition refers to a plurality of endophytes in a treatment formulation comprising additional components with which said endophytes are not found in nature. An endophyte is “heterologously disposed” when mechanically or manually applied, artificially inoculated or disposed onto or into a plant element, seedling, plant or onto or into a plant growth medium or onto or into a treatment formulation so that the endophyte exists on or in the plant element, seedling, plant, plant growth medium, or formulation in a manner not found in nature prior to the application of the treatment, e.g., said combination which is not found in nature in that plant variety, at that time in development, in that tissue, in that abundance, or in that growth condition (for example, drought, flood, cold, nutrient deficiency, etc.).

A “treatment formulation” (equivalently “formulation”) refers to one or more compositions that facilitate the stability, storage, and/or application of one or more endophytes. Treatment formulations may comprise any one or more agents such as: wax, oil, antioxidant, sugar, surfactant, a buffer, a tackifier, a microbial stabilizer, an antimicrobial, a fungicide, an anticomplex agent, an herbicide, a nematicide, an insecticide, a plant growth regulator, a rodenticide, a desiccant, a nutrient, an excipient, a wetting agent, a salt, a polymer. As used herein as a noun, a “treatment” may comprise one or more endophytes. In some embodiments, a treatment formulation comprises components suitable for stabilization of an endophyte through processing (for example, spray drying, lyophilization, etc.). In some embodiments, the combination of a treatment formulation and heterologously disposed microorganism is referred to as a “feedstock”. Optionally, a feedstock may be subjected to a drying process such as spray drying or lyophilization. In some embodiments, a treatment formulation comprises components suitable for stabilization of an endophyte on a plant element without further processing.

In some embodiments, a formulation refers to the one or more excipients. A formulation may comprise one or more excipients in liquid or dry format. For example, a formulation may comprise a plurality of excipients in a dehydrated state which may be reconstituted with an aqueous solution.

Various formulations arc contemplated; several non-limiting examples are provided here. An example formulation referred to herein as comprises, by % of non-microorganism solid contents: 34.9-41.7% maltodextrin, 4-8.3% ascorbic acid, 2.2-5.9% sodium bicarbonate. In some embodiments, the formulation additionally comprises 4% casamino acids, 4.5-5.5% sorbitol, 2-3% cysteine, 2-3% glutathione, 12-14% whey, and 25-28% kaolin clay. In some embodiments, the formulation additionally comprises 18.5-19.5% peptone, and 30-35% kaolin clay. In some embodiments, the formulation additionally comprises 15-17.5% peptone, 6-9% cysteine, and 25-30% kaolin clay.

An example formulation referred to herein as comprises, by % of non-microorganism solid contents: 14-19.5% peptone, 4-8.5% ascorbic acid, 2.2-4.5% sodium bicarbonate, and 27-33% kaolin clay. In some embodiments, the formulation additionally comprises 36-42% maltodextrin. In some embodiments, the formulation additionally comprises 35-37% maltodextrin, 4-5% casamino acids, 5-7% sorbitol, and 5-7% trehalose. In some embodiments, the formulation additionally comprises 35-37% maltodextrin, and 5-7% cysteine.

The dry powder resulting from drying a feedstock is sometimes referred to as a manufacture use product (“MUP”). MUP is a stable composition that may be further processed into one or multiple products, for example, an end use product such as a pharmaceutical composition (for example, a probiotics), a food product, a seed treatment, a fertilizer composition, etc. A ready-to-use composition comprising MUP is sometimes referred to as “RTU formulation”, “RTU composition” or simply as “RTU”. In some embodiments a synthetic composition is a RTU composition.

In some embodiments, the treatment formulation and or synthetic composition comprises one or more antioxidant, pH modifier, bulking agent, stabilizer, and solid diluent. An antioxidant is any substance capable of delaying or preventing oxidation of a substrate, for example (without limitation) a vitamin or amino acid. pH modifiers include acidifying, alkalizing and buffering agents. A bulking agent may be any substance which adds volume to the formulation. In some embodiments, the bulking agent is a saccharide. In some embodiments the bulking agent is also a stabilizing agent, for example maltodextrin, sucrose, lactose, trehalose, etc. In some embodiments, the stabilizer is a protein hydrolysate, for example a hydrolyzed vegetable protein from soy. A solid diluent may be any inert solid carrier. In some embodiments, the solid diluent is a silica-based material. In some embodiments, a solid diluent has a density of at least 1.0 g/cm\hat{ }3, at least 1.2 g/cm\hat{ }3, at least 1.5 g/cm\hat{ }3, at least 1.7 g/cm\hat{ }3, at least 2.0 g/cm\hat{ }3, at least 2.2 g/cm\hat{ }3, at least 2.5 g/cm\hat{ }3, at least 2.7 g/cm\hat{ }3, at least 3.0 g/cm\hat{ }3, at least 3.2 g/cm\hat{ }3, or at least 3.5 g/cm\hat{ }3. In some embodiments, a solid diluent has a density of between 1.0-3.0 g/cm\hat{ }3, between 1.0-2.0 g/cm\hat{ }3, or between 2.0-3.0 g/cm\hat{ }3.

In some embodiments, the formulation comprises multiple components wherein at least one component is selected from each of the following categories: an antioxidant, a pH modifier, a polysaccharide, a protein hydrolysate, and a silica-based inert solid. In some embodiments the treatment formulation comprises multiple components wherein at least one component is selected from each of the following categories: a vitamin, an amino acid, a pH modifier, a polysaccharide, a protein hydrolysate, and a silica-based inert solid.

In some embodiments the formulation comprises one or more of: at least one antioxidant selected L-ascorbic acid or creatine; at least one amino acid selected from cysteine or glutathione; at least one pH modifier selected from sodium bicarbonate or sodium hydroxide; at least one saccharide selected from maltodextrin, sucrose, lactose, trehalose, or microcrystalline cellulose; at least one protein hydrolysate selected from peptone, casamino acids, or a hydrolyzed vegetable protein, for example, from soy; and at least one inert solid selected from kaolin clay, magnesium stearate, or microcrystalline cellulose.

In some embodiments, a microorganism is heterologously disposed to a treatment formulation comprising one or more of: at least one antioxidant selected L-ascorbic acid or creatine, wherein the at least one antioxidant is present in the treatment formulation at a concentration of between 4.4-8.4% by dry weight; at least one amino acid selected from cysteine or glutathione, wherein the at least one amino acid is present in the treatment formulation at a concentration of between 0.0-7.0% by dry weight; at least one pH modifier selected from sodium bicarbonate or sodium hydroxide, wherein the at least one pH modifier is present in the treatment formulation at a concentration of between 2.1-3.9% by dry weight; at least one saccharide selected from maltodextrin, sucrose, lactose, trehalose, or microcrystalline cellulose, wherein the at least one saccharide is present in the treatment formulation at a concentration of between 33.8-41.4% by dry weight; at least one protein hydrolysate selected from peptone, casamino acids, or a hydrolyzed vegetable protein, for example, from soy, wherein the at least one protein hydrolysate is present in the treatment formulation at a concentration of between 14.6-19.1% by dry weight; and at least one inert solid selected from kaolin clay, magnesium stearate, or microcrystalline cellulose, wherein the at least one inert solid is present in the treatment formulation at a concentration of between 26-31.8% by dry weight. In some embodiments, maltodextrin has a dextrose equivalent (DE) value between 4 and 20.

In some embodiments, the treatment formulation comprises one or more of: at least one antioxidant selected from L-ascorbic acid or creatine, wherein the at least one antioxidant is present in the treatment formulation at a concentration of about 6.6% by dry weight; at least one amino acid or peptide selected from cysteine or glutathione, wherein the at least one amino acid is present in the treatment formulation at a concentration of about 3.7% by dry weight; at least one pH modifier selected from sodium bicarbonate or sodium hydroxide, wherein the at least one pH modifier is present in the treatment formulation at a concentration of about 3.1% by dry weight; at least one saccharide selected from maltodextrin, sucrose, lactose, or trehalose, wherein the at least one saccharide is present in the treatment formulation at a concentration of about 38.9% by dry weight; at least one protein hydrolysate selected from peptone, casamino acids, or a hydrolyzed vegetable protein, for example, from soy, wherein the at least one protein hydrolysate is present in the treatment formulation at a concentration of about 17.9% by dry weight; and at least one inert solid selected from kaolin clay, magnesium stearate, or microcrystalline cellulose, wherein the at least one inert solid is present in the treatment formulation at a concentration of about 29.9% by dry weight. In some embodiments, maltodextrin has a dextrose equivalent (DE) value between 4 and 20.

In some embodiments, the treatment formulation comprises one or more of: at least one antioxidant selected from cysteine, glutathione, L-ascorbic acid, or creatine, wherein the at least one antioxidant is present in the treatment formulation at a concentration of between 1.5-3% by wet weight; at least one pH modifier selected from sodium bicarbonate or sodium hydroxide, wherein the at least one pH modifier is present in the treatment formulation at a concentration of about 0.7% by wet weight; at least one saccharide selected from maltodextrin, sucrose, lactose, or trehalose, wherein the at least one saccharide is present in the treatment formulation at a concentration of about 13% by wet weight; at least one protein hydrolysate selected from peptone, casamino acids, or a hydrolyzed vegetable protein, for example, from soy, wherein the at least one protein hydrolysate is present in the treatment formulation at a concentration of between 1.5-6% by wet weight; and at least one inert solid selected from kaolin clay, magnesium stearate, or microcrystalline cellulose, wherein the at least one inert solid is present in the treatment formulation at a concentration of about 10% by wet weight. In some embodiments, maltodextrin has a dextrose equivalent (DE) value between 4 and 20.

In some embodiments, the treatment formulation comprises one or more of: at least one antioxidant selected from cysteine, glutathione, L-ascorbic acid, or creatine, wherein the at least one antioxidant is present in the treatment formulation at a concentration of between 1.5-3% by wet weight; at least one pH modifier selected from sodium bicarbonate or sodium hydroxide, wherein the at least one pH modifier is present in the treatment formulation at a concentration of about 0.7% by wet weight; at least one saccharide selected from maltodextrin, sucrose, lactose, trehalose, or microcrystalline cellulose, wherein the at least one saccharide is present in the treatment formulation at a concentration of about 13% by wet weight; at least one protein hydrolysate selected from peptone, casamino acids, or a hydrolyzed vegetable protein, for example, from soy, wherein the at least one protein hydrolysate is present in the treatment formulation at a concentration of between 1.5-6% by wet weight; at least one sugar alcohol such as sorbitol, wherein the at least one sugar alcohol is present in the treatment formulation at a concentration of about 2% by wet weight; at least one non-reducing sugar such as trehalose, wherein the at least one non-reducing sugar is present in the treatment formulation at a concentration of about 2% by wet weight; and at least one inert solid selected from kaolin clay, magnesium stearate, or microcrystalline cellulose, wherein the at least one inert solid is present in the treatment formulation at a concentration of about 10% by wet weight. In some embodiments, maltodextrin has a dextrose equivalent (DE) value between 4 and 20.

In some embodiments, the treatment formulation comprises one or more of: at least one antioxidant selected from cysteine, glutathione, L-ascorbic acid, or creatine, wherein the at least one antioxidant is present in the treatment formulation at a concentration of between 1.5-3% by wet weight; at least one pH modifier selected from sodium bicarbonate or sodium hydroxide, wherein the at least one pH modifier is present in the treatment formulation at a concentration of about 0.7% by wet weight; at least one saccharide selected from maltodextrin, sucrose, lactose, trehalose, or microcrystalline cellulose, wherein the at least one saccharide is present in the treatment formulation at a concentration of about 13% by wet weight; at least one protein hydrolysate selected from peptone, casamino acids, or a hydrolyzed vegetable protein, for example, from soy, wherein the at least one protein hydrolysate is present in the treatment formulation at a concentration of between 1.5-6% by wet weight; at least one sugar alcohol such as sorbitol, wherein the at least one sugar alcohol is present in the treatment formulation at a concentration of about 2% by wet weight; and at least one inert solid selected from kaolin clay, magnesium stearate, or microcrystalline cellulose, wherein the at least one inert solid is present in the treatment formulation at a concentration of about 10% by wet weight. In some embodiments, maltodextrin has a dextrose equivalent (DE) value between 4 and 20.

In some embodiments, the treatment formulation comprises one or more of: at least one antioxidant selected from cysteine, glutathione, L-ascorbic acid, or creatine, wherein the at least one antioxidant is present in the treatment formulation at a concentration of between 1.5-3% by wet weight; at least one pH modifier selected from sodium bicarbonate or sodium hydroxide, wherein the at least one pH modifier is present in the treatment formulation at a concentration of about 0.7% by wet weight; at least one saccharide selected from maltodextrin, sucrose, lactose, trehalose, or microcrystalline cellulose, wherein the at least one saccharide is present in the treatment formulation at a concentration of about 13% by wet weight; at least one protein hydrolysate selected from peptone, casamino acids, or a hydrolyzed vegetable protein, for example, from soy, wherein the at least one protein hydrolysate is present in the treatment formulation at a concentration of between 1.5-6% by wet weight; at least one non-reducing sugar such as trehalose, wherein the at least one non-reducing sugar is present in the treatment formulation at a concentration of between 1.2-2.0% by wet weight; and at least one inert solid selected from kaolin clay, magnesium stearate, or microcrystalline cellulose, wherein the at least one inert solid is present in the treatment formulation at a concentration of about 10% by wet weight. In some embodiments, maltodextrin has a dextrose equivalent (DE) value between 3 and 8.

In some embodiments, the synthetic composition comprises one or more of: a microorganism, wherein the at least one microorganism is present in the treatment formulation at a concentration of between 6.7-7.6% by dry weight; at least one antioxidant selected L-ascorbic acid or creatine, wherein the at least one antioxidant is present in the treatment formulation at a concentration of between 4.4-7.8% by dry weight; at least one amino acid selected from cysteine or glutathione, wherein the at least one amino acid is present in the treatment formulation at a concentration of between 0.0-6.5% by dry weight; at least one pH modifier selected from sodium bicarbonate or sodium hydroxide, wherein the at least one pH modifier is present in the treatment formulation at a concentration of between 2.1-3.6% by dry weight; at least one saccharide selected from maltodextrin, sucrose, lactose, trehalose, or microcrystalline cellulose, wherein the at least one saccharide is present in the treatment formulation at a concentration of between 33.8-38.4% by dry weight; at least one protein hydrolysate selected from peptone, casamino acids, or a hydrolyzed vegetable protein, for example, from soy, wherein the at least one protein hydrolysate is present in the treatment formulation at a concentration of between 15.6-17.7% by dry weight; and at least one inert solid selected from kaolin clay, magnesium stearate, or microcrystalline cellulose, wherein the at least one inert solid is present in the treatment formulation at a concentration of between 26.0-29.5% by dry weight. In some embodiments, maltodextrin has a dextrose equivalent (DE) value between 4 and 20.

In some embodiments, the synthetic composition comprises one or more of: a microorganism, wherein the at least one microorganism is present in the treatment formulation at a concentration of about 7.2% by dry weight; at least one antioxidant selected from L-ascorbic acid or creatine, wherein the at least one antioxidant is present in the treatment formulation at a concentration of about 6.1% by dry weight; at least one amino acid selected from cysteine or glutathione, wherein the at least one amino acid is present in the treatment formulation at a concentration of about 3.4% by dry weight; at least one pH modifier selected from sodium bicarbonate or sodium hydroxide, wherein the at least one pH modifier is present in the treatment formulation at a concentration of about 2.9% by dry weight; at least one saccharide selected from maltodextrin, sucrose, lactose, trehalose, or microcrystalline cellulose, wherein the at least one saccharide is present in the treatment formulation at a concentration of about 36.1% by dry weight; at least one protein hydrolysate selected from peptone, casamino acids, or a hydrolyzed vegetable protein, for example, from soy, wherein the at least one protein hydrolysate is present in the treatment formulation at a concentration of about 16.7% by dry weight; and at least one inert solid selected from kaolin clay, magnesium stearate, or microcrystalline cellulose, wherein the at least one inert solid is present in the treatment formulation at a concentration of about 27.8% by dry weight. In some embodiments, maltodextrin has a dextrose equivalent (DE) value between 4 and 20.

In some embodiments, maltodextrin has a low dextrose equivalent (DE) value, for example about 4. In some embodiments, maltodextrin has a moderate DE value, for example about 10. In some embodiments, maltodextrin has a high DE value, for example about 18. In some embodiments, maltodextrin has a DE value between 4 and 10. In some embodiments, maltodextrin has DE value between 10 and 20. In some embodiments maltodextrin has DE value of at least 4, a DE value of at least 6, a DE value of at least 8, a DE value of at least 10, or a DE value of at least 18. In some embodiments, a DE value is an average DE value.

In some embodiments, the antioxidant is water soluble. In some embodiments, the antioxidant is L-ascorbic acid, creatine, citric acid, uric acid, glutathione, etc., In some embodiments, the protein hydrolysates are vegetable based (for example, soybean, etc.), animal protein based (e.g. eggs, casein, etc.), fungal based (for example, yeast extract, hyphal biomass, etc.). In some embodiments, the protein hydrolysate is readily water soluble. In some embodiments, the formulation additionally comprises a yeast extract and or whey powder. In some embodiments, the saccharide component is maltodextrin. In some embodiments, the maltodextrin is derived from a plant such as rice, corn, wheat, potato, cassava (for example, tapioca), etc. In some embodiments, the saccharide component is a polymeric saccharide. In some embodiments the polymeric saccharide is branching or non-branching.

In some embodiments, a synthetic composition comprises: one or more of: at least one saccharide present in the synthetic composition in a ratio of at least 2 parts saccharide dry weight for each 1 part microbial biomass, at least one protein hydrolysate present in the synthetic composition in a ratio of at least 1 part of protein hydrolysate by dry weight for each 1 part microbial biomass, and at least one antioxidant present in the synthetic composition in a ratio of at least 0.2 part of antioxidant by dry weight for each 1 part microbial biomass.

In some embodiments, a feedstock (referred to as F27) comprises the following components by wet weight: maltodextrin 13%, peptone at 6%, ascorbic acid at 1.5%, sodium bicarbonate at 0.7% (or as needed to achieve final pH of approximately 7), kaolin clay 10%, approximately 30% microbial biomass (for example, between 20-50%), and 38.8% water (if amount of microbial biomass changes adjust water in opposite direction to maintain total mass).

In some embodiments, a treatment formulation may comprise one or more polymeric beads comprising one or more endophytes. In some embodiments, a treatment formulation may consist of one or more polymeric beads comprising one or more endophytes. A polymeric bead may contain a biodegradable polymer such as alginate, agarose, agar, gelatin, polyacrylamide, chitosan, and polyvinyl alcohol. In some embodiments, the polymeric beads are less than 500 μm in diameter at their widest point. In some embodiments, the polymeric beads' average diameter at their widest point is between 500 μm and 250 μm, between 249 μm and 100 μm, 100 μm or less, between 100 μm and 50 μm, or 50 μm or less.

In some embodiments, an “agriculturally compatible carrier” can be used to formulate an agricultural formulation or other composition that includes a purified endophyte preparation. As used herein an “agriculturally compatible carrier” refers to any material, other than water, that can be added to a plant element without causing or having an adverse effect on the plant element (e.g., reducing seed germination) or the plant that grows from the plant element, or the like.

In some embodiments, the formulation can include a tackifier or adherent. Such agents are useful for combining the bacterial population of the invention with carriers that can contain other compounds (e.g., control agents that are not biologic), to yield a coating composition. Such compositions help create coatings around the plant or seed to maintain contact between the microbe and other agents with the plant or plant part. In some embodiments, adherents are selected from the group consisting of: alginate, gums, starches, lecithins, formononetin, polyvinyl alcohol, alkali formononetinate, hesperetin, polyvinyl acetate, cephalins, Gum Arabic, Xanthan Gum, Mineral Oil, Polyethylene Glycol (PEG), Polyvinyl pyrrolidone (PVP), Arabino-galactan, Methyl Cellulose, PEG 400, Chitosan. Polyacrylamide, Polyacrylate, Polyacrylonitrile, Glycerol, Triethylene glycol, Vinyl Acetate, Gellan Gum, Polystyrene, Polyvinyl, Carboxymethyl cellulose, Gum Ghatti, and polyoxyethylene-polyoxybutylene block copolymers.

The formulation can also contain a surfactant. Non-limiting examples of surfactants include nitrogen-surfactant blends such as Prefer 28 (Cenex), Surf-N (US), Inhance (Brandt), P-28 (Wilfarm) and Patrol (Helena); esterified seed oils include Sun-It II (AmCy), MSO (UAP), Scoil (Agsco), Hasten (Wilfarm) and Mes-100 (Drexel); and organo-silicone surfactants include Silwet L77 (UAP), Silikin (Terra), Dyne-Amie (Helena), Kinetic (Helena), Sylgard 309 (Wilbur-Ellis) and Century (Precision). In one embodiment, the surfactant is present at a concentration of between 0.01% v/v to 10% v/v. In another embodiment, the surfactant is present at a concentration of between 0.1% v/v to 1% v/v.

In certain cases, the formulation includes a microbial stabilizer. Such an agent can include a desiccant. As used herein, a “desiccant” can include any compound or mixture of compounds that can be classified as a desiccant regardless of whether the compound or compounds are used in such concentrations that they in fact have a desiccating effect on the liquid inoculant. Such desiccants are ideally compatible with the bacterial population used, and should promote the ability of the microbial population to survive application on the seeds and to survive desiccation. Examples of suitable desiccants include one or more of trehalose, sucrose, glycerol, and Methylene glycol. Other suitable desiccants include, but are not limited to, non-reducing sugars and sugar alcohols (e.g., mannitol or sorbitol). The amount of desiccant introduced into the formulation can range from about 5% to about 50% by weight/volume, for example, between about 10% to about 40%, between about 15% and about 35%, or between about 20% and about 30%.

In some embodiments the formulation includes, for example, solid carriers such as talc, fullers earth, bentonite, kaolin clay, pyrophyllite, bentonite, montmorillonite, diatomaceous earth, acid white soil, vermiculite, and pearlite, and inorganic salts such as ammonium sulfate, ammonium phosphate, ammonium nitrate, urea, ammonium chloride, and calcium carbonate. Also, organic fine powders such as wheat flour, wheat bran, and rice bran may be used. The liquid carriers include vegetable oils such as soybean oil and cottonseed oil, glycerol, ethylene glycol, polyethylene glycol, propylene glycol, polypropylene glycol, etc.

In some embodiments, the flowable powder endophyte formulations comprises MIC-28837 at a minimum concentration of 1E7 CFU/g. In some embodiments, the flowable powder MIC-28837 formulation is applied as a seed treatment at a use rate of 0.28-1.14 ounces/cwt (unit of mass equal to 100 pounds) of seed. The flowable powder endophyte formulations comprises MIC-28837 may be stored at temperatures below 75 degrees Fahrenheit for 24 months without appreciable degradation of product efficacy.

In some embodiments, the abundance of an endophyte can be estimated by methods well known in the art including, but not limited to, qPCR, community sequencing, flow cytometry, and/or counting colony-forming units. As used herein, a “colony-forming unit” (“CFU”) is used as a measure of viable microorganisms in a sample. A CFU is an individual viable cell capable of forming on a solid medium a visible colony whose individual cells are derived by cell division from one parental cell.

In some embodiments, the synthetic composition of the present invention comprises one or more of the following: antimicrobial, fungicide, nematicide, bactericide, insecticide, or herbicide.

In some embodiments, the time to 1 log loss in CFU of an endophyte in formulation is at greater than or equal to 1000 days, greater than or equal to 730 days, greater than or equal to 365 days, greater than or equal to 168 days, greater than or equal to 150 days, greater than or equal to 125 days, greater than or equal to 100 days, greater than or equal to 75 days, greater than or equal to 50 days, greater than or equal to 20 days at 4 degrees Celsius. In some embodiments, the time to 1 log loss in CFU of an endophyte in formulation is at least 1000 days, at least 730 days, at least 365 days, 140 days, at least 90 days, at least 60 days, at least 50 days, at least 30 days, at least 20 days, at 22 degrees Celsius. In some embodiments, the time to 2 log loss in CFU of an endophyte on a seed is at least 3 days, at least 5 days, at least 10 days, at least 20 days, at least 21 days, at least 22 days, at least 23 days, at least 24 days, at least 25 days, at least 30 days, at least 60 days, at least 90 days, at least 120 days at 22 degrees Celsius.

In some embodiments, a treatment is applied mechanically or manually or artificially inoculated to a plant element in a seed treatment, root wash, seedling soak, foliar application, floral application, soil inoculum, in-furrow application, sidedress application, soil pre-treatment, wound inoculation, drip tape irrigation, vector-mediation via a pollinator, injection, osmopriming, hydroponics, aquaponics, aeroponics, and combinations thereof. Application to the plant may be achieved, for example, as a powder for surface deposition onto plant leaves, as a spray to the whole plant or selected plant element, as part of a drip to the soil or the roots, or as a coating onto the plant element prior to or after planting. Such examples are meant to be illustrative and not limiting to the scope of the invention.

In some embodiments, the invention described herein provides a synthetic composition comprising one or more endophytes capable of improving plant health, wherein the one or more endophytes is a member of the Class Gammaproteobacteria. In some embodiments, the one or more endophytes is a member of the Order Pseudomonadales. In some embodiments, the one or more endophytes is a member of the Family Pseudomonadaceae. In some embodiments, the one or more endophytes is a member of the Genus Pseudomonas. In some embodiments, the one or more endophytes are selected from Table 3. In some embodiments, the one or more endophytes comprise one or more a polynucleotide sequences at least 95%, at least 96%, at least 97%, at least 97%, at least 98%, at least 99%, or 100% identical to one or more polynucleotide sequences selected from the group consisting of SEQ ID NOs. 5-105, or one or more genes encoding a protein whose amino acid sequence is selected from the group consisting of SEQ ID NOs. 106-199, or combinations thereof.

In some embodiments, the one or more endophytes comprise one or more a polynucleotide sequences that are 100% identical to a subregion within one or more of SEQ ID NOs. 5-105, wherein the subregion is a 100, 200, 300, 400, 500, 600, 700, or 800 nucleotides in length.

In some embodiments, the one or more endophytes comprise one or more a polynucleotide sequences that are 100% identical to a subregion within one or more of SEQ ID NOs. 83, 84, 85, 86, wherein the subregion is 100 nucleotides in length. In some embodiments, the one or more endophytes comprise one or more a polynucleotide sequences that are 100% identical to a subregion within one or more of SEQ ID NOs. 83, 84, 85, 86, wherein the subregion is 200 nucleotides in length. In some embodiments, the one or more endophytes comprise one or more a polynucleotide sequences that are 100% identical to a subregion within one or more of SEQ ID NOs. 83, 84, 85, 86, wherein the subregion is 400 nucleotides in length. In some embodiments, the one or more endophytes comprise one or more a polynucleotide sequences that are 100% identical to a subregion within one or more of SEQ ID NOs. 83, 84, 85, 86, wherein the subregion is 600 nucleotides in length.

In some embodiments, the one or more endophytes comprise one or more a polynucleotide sequences that are 100% identical to a subregion within one or more of SEQ ID NOs. 67, 68, 69, 70, 71, 72, 73, 74, 75, 76, 77, 78, 79, 80, 81, 82, wherein the subregion is 100 nucleotides in length. In some embodiments, the one or more endophytes comprise one or more a polynucleotide sequences that are 100% identical to a subregion within one or more of SEQ ID NOs. 67, 68, 69, 70, 71, 72, 73, 74, 75, 76, 77, 78, 79, 80, 81, 82, wherein the subregion is 200 nucleotides in length. In some embodiments, the one or more endophytes comprise one or more a polynucleotide sequences that are 100% identical to a subregion within one or more of SEQ ID NOs. 67, 68, 69, 70, 71, 72, 73, 74, 75, 76, 77, 78, 79, 80, 81, 82, wherein the subregion is 400 nucleotides in length. In some embodiments, the one or more endophytes comprise one or more a polynucleotide sequences that are 100% identical to a subregion within one or more of SEQ ID NOs. 67, 68, 69, 70, 71, 72, 74, 75, 76, 77, 78, 79, 80, 81, 82, wherein the subregion is 600 nucleotides in length.

In some embodiments, the one or more endophytes comprise one or more a polynucleotide sequences that are 100% identical to a subregion within one or more of SEQ ID NOs. 87, 88, 89, 90, 91, 92, 93, 94, 95, 96, 97, 98, 99, 100, 101, 102, 103, 104, 105, wherein the subregion is 100 nucleotides in length. In some embodiments, the one or more endophytes comprise one or more a polynucleotide sequences that are 100% identical to a subregion within one or more of SEQ ID NOs. 87, 88, 89, 90, 91, 92, 93, 94, 95, 96, 97, 98, 99, 100, 101, 102, 103, 104, 105, wherein the subregion is 200 nucleotides in length. In some embodiments, the one or more endophytes comprise one or more a polynucleotide sequences that are 100% identical to a subregion within one or more of SEQ ID NOs. 87, 88, 89, 90, 91, 92, 93, 94, 95, 96, 98, 100, 101, 102, 103, 104, wherein the subregion is 400 nucleotides in length. In some embodiments, the one or more endophytes comprise one or more a polynucleotide sequences that are 100% identical to a subregion within one or more of SEQ ID NOs. 88, 89, 90, 92, 93, 94, 95, 96, 98, 102, 104, wherein the subregion is 600 nucleotides in length.

In some embodiments, the one or more endophytes comprise one or more a polynucleotide sequences that are 100% identical to a subregion within one or more of SEQ ID NOs. 22, 23, 24, 25, 26, 27, 28, 29, 30, wherein the subregion is 100 nucleotides in length. In some embodiments, the one or more endophytes comprise one or more a polynucleotide sequences that are 100% identical to a subregion within one or more of SEQ ID NOs. 22, 23, 24, 25, 26, 27, 28, 29, 30, wherein the subregion is 200 nucleotides in length. In some embodiments, the one or more endophytes comprise one or more a polynucleotide sequences that are 100% identical to a subregion within one or more of SEQ ID NOs. 22, 23, 24, 25, 26, 27, 28, 29, 30, wherein the subregion is 400 nucleotides in length. In some embodiments, the one or more endophytes comprise one or more a polynucleotide sequences that are 100% identical to a subregion within one or more of SEQ ID NOs. 22, 23, 26, 27, 28, 29, 30, wherein the subregion is 600 nucleotides in length.

In some embodiments, the one or more endophytes comprise one or more a polynucleotide sequences that are 100% identical to a subregion within one or more of SEQ ID NOs. 40, 41, 42, 43, wherein the subregion is 100 nucleotides in length. In some embodiments, the one or more endophytes comprise one or more a polynucleotide sequences that are 100% identical to a subregion within one or more of SEQ ID NOs. 40, 41, 42, 43, wherein the subregion is 200 nucleotides in length. In some embodiments, the one or more endophytes comprise one or more a polynucleotide sequences that are 100% identical to a subregion within one or more of SEQ ID NOs. 40, 41, 42, 43, wherein the subregion is 400 nucleotides in length. In some embodiments, the one or more endophytes comprise one or more a polynucleotide sequences that are 100% identical to a subregion within one or more of SEQ ID NOs. 41, 42, 43, wherein the subregion is 600 nucleotides in length.

In some embodiments, the one or more endophytes comprise one or more a polynucleotide sequences that are 100% identical to a subregion within one or more of SEQ ID NOs. 13, 14, wherein the subregion is 100 nucleotides in length. In some embodiments, the one or more endophytes comprise one or more a polynucleotide sequences that are 100% identical to a subregion within one or more of SEQ ID NOs. 13, 14, wherein the subregion is 200 nucleotides in length. In some embodiments, the one or more endophytes comprise one or more a polynucleotide sequences that are 100% identical to a subregion within one or more of SEQ ID NOs. 13, 14, wherein the subregion is 400 nucleotides in length. In some embodiments, the one or more endophytes comprise one or more a polynucleotide sequences that are 100% identical to a subregion within one or more of SEQ ID NOs. 13, 14, wherein the subregion is 600 nucleotides in length.

In some embodiments, the one or more endophytes comprise one or more a polynucleotide sequences that are 100% identical to a subregion within one or more of SEQ ID NOs. 15, 16, 17, 18, 19, 20, 21, wherein the subregion is 100 nucleotides in length. In some embodiments, the one or more endophytes comprise one or more a polynucleotide sequences that are 100% identical to a subregion within one or more of SEQ ID NOs. 15, 16, 17, 18, 19, 20, 21, wherein the subregion is 200 nucleotides in length. In some embodiments, the one or more endophytes comprise one or more a polynucleotide sequences that are 100% identical to a subregion within one or more of SEQ ID NOs. 15, 16, 17, 18, 19, 20, 21, wherein the subregion is 400 nucleotides in length. In some embodiments, the one or more endophytes comprise one or more a polynucleotide sequences that are 100% identical to a subregion within one or more of SEQ ID NOs. 15, 16, 18, 19, 20, 21, wherein the subregion is 600 nucleotides in length.

In some embodiments, the one or more endophytes comprise one or more a polynucleotide sequences that are 100% identical to a subregion within one or more of SEQ ID NOs. 31, 32, 33, 34, 35, 36, 37, 38, 39, wherein the subregion is 100 nucleotides in length. In some embodiments, the one or more endophytes comprise one or more a polynucleotide sequences that are 100% identical to a subregion within one or more of SEQ ID NOs. 31, 32, 33, 34, 35, 36, 37, 38, 39, wherein the subregion is 200 nucleotides in length. In some embodiments, the one or more endophytes comprise one or more a polynucleotide sequences that are 100% identical to a subregion within one or more of SEQ ID NOs. 31, 32, 33, 34, 35, 36, 37, 38, 39, wherein the subregion is 400 nucleotides in length. In some embodiments, the one or more endophytes comprise one or more a polynucleotide sequences that are 100% identical to a subregion within one or more of SEQ ID NOs. 31, 32, 33, 34, 35, 36, 37, 38, 39, wherein the subregion is 600 nucleotides in length.

In some embodiments, the one or more endophytes comprise one or more a polynucleotide sequences that are 100% identical to a subregion within one or more of SEQ ID NOs. 44, 45, 46, 47, 48, 49, 50, 51, 52, 53, 54, 55, wherein the subregion is 100 nucleotides in length. In some embodiments, the one or more endophytes comprise one or more a polynucleotide sequences that are 100% identical to a subregion within one or more of SEQ ID NOs. 44, 45, 46, 47, 48, 49, 50, 51, 52, 53, 54, 55, wherein the subregion is 200 nucleotides in length. In some embodiments, the one or more endophytes comprise one or more a polynucleotide sequences that are 100% identical to a subregion within one or more of SEQ ID NOs. 44, 45, 46, 47, 48, 49, 50, 51, 52, 53, 54, 55, wherein the subregion is 400 nucleotides in length. In some embodiments, the one or more endophytes comprise one or more a polynucleotide sequences that are 100% identical to a subregion within one or more of SEQ ID NOs. 46, 47, 48, 49, 50, 51, 54, 55, wherein the subregion is 600 nucleotides in length.

In some embodiments, the one or more endophytes comprise one or more a polynucleotide sequences that are 100% identical to a subregion within one or more of SEQ ID NOs. 57, 58, 59, 60, 61, 62, 63, 64, wherein the subregion is 100 nucleotides in length. In some embodiments, the one or more endophytes comprise one or more a polynucleotide sequences that are 100% identical to a subregion within one or more of SEQ ID NOs. 57, 58, 59, 60, 61, 62, 63, 64, wherein the subregion is 200 nucleotides in length. In some embodiments, the one or more endophytes comprise one or more a polynucleotide sequences that are 100% identical to a subregion within one or more of SEQ ID NOs. 57, 58, 59, 60, 61, 62, 63, 64, wherein the subregion is 400 nucleotides in length. In some embodiments, the one or more endophytes comprise one or more a polynucleotide sequences that are 100% identical to a subregion within one or more of SEQ ID NOs. 58, 59, 60, 61, 62, 63, 64, wherein the subregion is 600 nucleotides in length.

In some embodiments, the one or more endophytes comprise one or more a polynucleotide sequences that are 100% identical to a subregion within one or more of SEQ ID NOs. 65, 66, wherein the subregion is 100 nucleotides in length. In some embodiments, the one or more endophytes comprise one or more a polynucleotide sequences that are 100% identical to a subregion within one or more of SEQ ID NOs. 65, 66, wherein the subregion is 200 nucleotides in length. In some embodiments, the one or more endophytes comprise one or more a polynucleotide sequences that are 100% identical to a subregion within SEQ ID NOs. 65, wherein the subregion is 400 nucleotides in length. In some embodiments, the one or more endophytes comprise one or more a polynucleotide sequences that are 100% identical to a subregion within SEQ ID NOs. 65, wherein the subregion is 600 nucleotides in length.

In some embodiments, the one or more endophytes comprise one or more a polynucleotide sequences that are 100% identical to a subregion within SEQ ID NO. 12, wherein the subregion is 100 nucleotides in length. In some embodiments, the one or more endophytes comprise one or more a polynucleotide sequences that are 100% identical to a subregion within SEQ ID NO. 12 wherein the subregion is 200 nucleotides in length. In some embodiments, the one or more endophytes comprise one or more a polynucleotide sequences that are 100% identical to a subregion within SEQ ID NO. 12, wherein the subregion is 400 nucleotides in length. In some embodiments, the one or more endophytes comprise one or more a polynucleotide sequences that are 100% identical to a subregion within SEQ ID NO. 12, wherein the subregion is 600 nucleotides in length.

In some embodiments, the one or more endophytes comprise one or more a polynucleotide sequences that are 100% identical to a subregion within SEQ ID NO. 56, wherein the subregion is 100 nucleotides in length. In some embodiments, the one or more endophytes comprise one or more a polynucleotide sequences that are 100% identical to a subregion within SEQ ID NO. 56, wherein the subregion is 200 nucleotides in length.

In some embodiments, the subregion is the first 100, 200, 300, 400, 500, 600, 700, or 800 nucleotides. In some embodiments, the subregion is the last 100, 200, 300, 400, 500, 600, 700, or 800 nucleotides of the polynucleotide sequence. In some embodiments, the subregion is 100, 200, 300, 400, 500, 600, 700, or 800 nucleotides of the polynucleotide sequence beginning from the 20th nucleotide in the polynucleotide sequence.

In some embodiments of any of the synthetic compositions described herein, the synthetic compositions comprise at least 2, 3, 4, 5, 6, 7, 8, 9, 10, 15 or 20 or more endophytes. In some embodiments, the one or more endophytes comprise at least 2, 3, 4, 5, 6, 7, 8, 9, 10, 15 or 20 or more endophytes. In some embodiments, the one or more endophytes are distinct individual organisms or distinct members of different genetic derivation or taxa.

In some embodiments, the synthetic composition is contained within packaging. The packaging can be constructed out of a number of materials suitable for storing a solid (e.g., powder) seed treatment. The packaging may be comprised of a metallized polyester and linear low density polyethylene bag. In some embodiments, the packaging comprises a moisture barrier, reduced gas exchange (for example, oxygen transmission), block (partially or fully) UV and light transmission, are impact resistant, and/or tear resistant. In some embodiments, the packaging comprises at least one exterior surface between 0.025-10 mm in thickness. In some embodiments, the packaging comprises an exterior surface having an average thickness of between 0.025-10 mm. In some embodiments, the packaging comprises an exterior surface having a nearly uniform thickness (e.g. variation in thickness of plus or minus 5 mm or less, variation in thickness of plus or minus 1 mm or less, variation in thickness of plus or minus 0.5 mm or less, variation in thickness of plus or minus 0.05 mm or less, variation in thickness of plus or minus 0.5 mm or less, variation in thickness of plus or minus 0.05 mm or less, variation in thickness of plus or minus 0.005 mm or less, variation in thickness of plus or minus 0.001 mm or less). In some embodiments, the packaging comprises an exterior surface having a nearly uniform thickness except for one or more support regions comprising thicker or more rigid material (where the material of the support region may be the same or different from the material comprising the remainder of the walls). In some embodiments, the packaging comprises an exterior surface having a nearly uniform thickness except for one or more regions having one or more significantly thinner region, for example engineered to break when force is applied. In some embodiments, the packaging comprises one or more polyesters, polyethylene, polystyrene, polyamides (nylon), polyacrylonitrile butadiene (ABS), polylactic acid, aluminum (e.g., foils or sheet), stainless steel, silicone, polylactic acid (PLA), bio-composite (for example, bio-composites comprising polylactic acid and microcrystalline cellulose, polylactic acid and cellulose nanocrystal, gelatin, etc.), and combinations thereof. In some embodiments, the packaging comprises one or more layers, for example an adhesive laminated material having high oxygen and moisture barrier properties. Examples of the packaging comprising multiple layers include metallized polyester and linear low-density polyethylene, polyester, aluminum foil, and linear low-density polyethylene. In some embodiments, the packaging acts as a moisture barrier having a moisture vapor transmission rate (MVTR) of 0.2 g per 100 sq. inches per 24 hours, or lower. In some embodiments, the packaging is constructed from a material having a moisture vapor transmission rate (MVTR) 0.2 g per 100 sq. inches per 24 hours, or lower. In some embodiments, the packaging acts as a moisture barrier having a moisture vapor transmission rate (MVTR) of 0.02 g per 100 sq. inches per 24 hours, or lower. In some embodiments, the packaging is constructed from a material having a moisture vapor transmission rate (MVTR) 0.02 g per 100 sq. inches per 24 hours, or lower. In some embodiments, the packaging has a moisture vapor transmission rate (MVTR) of between 0.002 g per 100 sq. inches per 24 hours and 0.2 g per 100 sq. inches per 24 hours. In some embodiments, the packaging is constructed from a material having a moisture vapor transmission rate (MVTR) of between 0.002 g per 100 sq. inches per 24 hours and 0.2 g per 100 sq. inches per 24 hours. In some embodiments, the packaging has an oxygen transmission rate (OTR) of between 0.0001-1 cubic centimeters per 100 sq. inches per 24 hours. In some embodiments, the packaging is constructed from a material having an oxygen transmission rate of between 0.0001-1 cubic centimeters per 100 sq. inches per 24 hours. In some embodiments, the packaging has an oxygen transmission rate (OTR) of between 0.0005-0.06 cubic centimeters per 100 sq. inches per 24 hours. In some embodiments, the packaging is constructed from a material having an oxygen transmission rate of between 0.0005-0.06 cubic centimeters per 100 sq. inches per 24 hours. In some embodiments, the packaging has an oxygen transmission rate (OTR) of 0.06 cubic centimeters per 100 sq. inches per 24 hours, or lower. In some embodiments, the packaging is constructed from a material having an oxygen transmission rate of 0.06 cubic centimeters per 100 sq. inches per 24 hours, or lower. In some embodiments, the packaging has an oxygen transmission rate (OTR) of less than 0.001 cubic centimeters per 100 sq. inches per 24 hours. In some embodiments, the packaging is constructed from a material having an oxygen transmission rate of less than 0.001 cubic centimeters per 100 sq. inches per 24 hours. OTR values described herein are measured at 65% relative humidity and 20 degrees Celsius.

### Methods for Improving Plant Health

In some embodiments, the invention provides methods of improving plant health comprising heterologously disposing one or more endophytes to a plant element in an effective amount to increase a trait of agronomic importance in the plant derived from the treated plant element relative to a plant derived from a reference plant element. In some embodiments, the one or more endophytes are a component of a treatment formulation. In some embodiments, the one or more endophytes are a component of a synthetic composition.

In some embodiments, the invention provides methods of improving plant health comprising creating any of the synthetic compositions described herein, wherein the synthetic composition comprises any of the plant elements of any of the plants described herein and any of the one or more endophytes described herein. In some embodiments, the synthetic composition comprises any of the treatment formulations described herein and any of the one or more endophytes described herein. In some embodiments, the synthetic composition additionally comprises a growth medium or growth environment. A growth environment is a natural or artificially constructed surrounding capable of supporting life of a plant. In some embodiments, the growth medium is soil. In some embodiments, the growth medium is a culture fluid suitable for propagation of an endophyte or plant tissue culture. In some embodiments, the method comprises a step of applying the synthetic composition to a growth medium. In some embodiments, the synthetic composition is applied before one or more plant elements are placed in or on the growth medium. In some embodiments, the synthetic composition is applied after one or more plant elements are placed in or on the growth medium. In some embodiments, the method comprises a step of germinating the plants. In some embodiments, the method comprises a step of growing the plants. For example, the plants may be grown in the plant vigor assays described in the Examples below. In some embodiments, the method comprises a step of growing the plants to maturity. In some embodiments, where the plants are commercially produced, maturity is the stage at which the plant is normally harvested.

In some embodiments of any of the methods described herein, plant health may be improved for plants in a stress condition. In some embodiments, the stress condition is a biotic or abiotic stress, or a combination of one or more biotic or abiotic stresses. In some embodiments of any of the methods described herein, the stress condition is one or more of the following abiotic stresses: drought stress, salt stress, metal stress, heat stress, cold stress, low nutrient stress (alternately referred to herein as nutrient deficiency or growth in nutrient deficient conditions), and excess water stress, and combinations thereof. In some embodiments of any of the methods described herein, the stress condition is one or more of the following biotic stresses: insect infestation, nematode infestation, complex infection, fungal infection, bacterial infection, oomycete infection, protozoal infection, viral infection, herbivore grazing, and combinations thereof. In some embodiments, the biotic stress condition is presence of one or more of soybean cyst nematode (e.g. Heterodera glycines), root-knot nematode (e.g. Meloidogyne incognita), root lesion nematode (e.g. Pratylenchus brachyurus), cyst nematode (e.g. Heterodera and Globodera spp.), dagger nematode (e.g. Xiphinema spp.), lance nematode (e.g. Hoplolaimus galeatus), lesion nematode (e.g. Pratylenchus spp.), needle nematode (e.g. Longidorus spp.), reniform nematode (e.g. Rotylenchulus reniformis), spiral nematode (e.g. Helicotylenchus spp.), sting nematode (e.g. Belonolaimus longicaudatus), stubby-root nematode (e.g. Trichodorus and Paratrichodorus spp.), and stunt nematode (e.g. Tylenchorhynchus spp., Anguillulina spp., and Merlinia) spp.).

Stress tolerance is exemplified by improvement of one or more other traits of agronomic importance when compared with a reference plant, reference plant element, or reference population. For example, biotic stress tolerance may be shown by one or more of decreased pathogen load of tissues, decreased area of chlorotic tissue, decreased necrosis, improved growth, increased survival, increased biomass, increased shoot height, increased root length, relative to a reference.

### Methods for Measuring Plant Health

The present invention includes methods of measuring plant health, comprising determining the presence or abundance of one or more endophytes in a plant element, growth medium and or growth environment. In some embodiments, the abundance or presence of the one or more endophytes in a plant element in an effective amount to improve a trait of agronomic importance is an indicator of plant health. In some embodiments, the abundance or presence of the one or more endophytes in a growth medium and or growth environment in an effective amount to improve a trait of agronomic importance of a plant element grown in the growth environment or growth medium may be used as a measure or predictor of plant health in a plant grown in that growth environment or growth medium. In some embodiments, the presence or abundance of one or more endophytes in a plant element, growth medium or growth environment can be detected before an improvement of a trait of agronomic importance can otherwise be observed or detected. In some embodiments, the presence or abundance of one or more endophytes is determined by polymerase chain reaction, fluorescence in situ hybridization, or isothermal amplification.

### Nucleic Acid Probes and Detection Kits

The present invention includes one or more nucleic acid probes that are markers of improved plant health. These probes include single and double stranded nucleic acids, engineered polymers such as peptide nucleic acids, or combinations thereof. In some embodiments, there are a plurality of nucleic acid probes. In some embodiments, the nucleic acid probes are attached to one or more solid supports. In some embodiments, the nucleic acid probes are reversibly attached to one or more solid supports. In some embodiments, the nucleic acid probes are attached to a contiguous solid support. In some embodiments, the nucleic acid probes are attached to a plurality of particles, for example beads. In some embodiments, only one unique sequence is attached to each particle. In some embodiments, nucleic acid probes attached to a solid support are physically separated from non-identical probes by an indentation or raised portion of the solid support. In some embodiments, the invention described herein provides a nucleic acid detection kit comprising any of the plurality of nucleic acid probes described herein.

In some embodiments, the one or more nucleic acid probes of the present invention may comprise sequences complementary or reverse complementary to one or more polynucleotide sequences selected from the group consisting of SEQ ID NOs. 5-105, or one or more genes encoding a protein whose amino acid sequence is selected from the group consisting of SEQ ID NOs. 106-199, or combinations thereof. In some embodiments, the one or more nucleic acid probes of the present invention may comprise nucleic acid sequences complementary or reverse complementary to a nucleic acid sequence that is at least 97% identical to one or more polynucleotide sequences selected from the group consisting of SEQ ID NOs. 5-105, or one or more genes encoding a protein whose amino acid sequence is selected from the group consisting of SEQ ID NOs. 106-199, or combinations thereof. In some embodiments, the one or more nucleic acid probes of the present invention may comprise sequences complementary or reverse complementary to the entire length of one or more polynucleotide sequences selected from the group consisting of SEQ ID NOs. 5-105, or one or more genes encoding a protein whose amino acid sequence is selected from the group consisting of SEQ ID NOs. 106-199, or combinations thereof. In some embodiments, the one or more nucleic acid probes of the present invention may comprise sequences complementary or reverse complementary to a region within one or more polynucleotide sequences selected from the group consisting of SEQ ID NOs. 5-105, or one or more genes encoding a protein whose amino acid sequence is selected from the group consisting of SEQ ID NOs. 106-199, or combinations thereof. In some embodiments, the region to which the nucleic acid probe is complementary or reverse complementary is a contiguous region. In some embodiments, the region to which the nucleic acid probe is complementary or reverse complementary is at least 5 nucleotides (nt) in length, at least 10 nt in length, at least 15 nt, between 10 nt and 30 nt, between 10 and 20 nt, between 15 and 50 nt, at least 20 nt, between 20 and 60 nt, at least 25 nt, at least 30 nt, at least 40 nt, at least 50 nt, between 50 nt and 100 nt, at least 60 nt, at least 70 nt, at least 80 nt, at least 100 nt in length. In some embodiments, the regions to which the nucleic acid probe is complementary or reverse complementary is not a contiguous region.

In some embodiments, a nucleic acid probe is capable of hybridizing to one or more polynucleotide sequences selected from the group consisting of SEQ ID NOs. 5-105, or one or more genes encoding a protein whose amino acid sequence is selected from the group consisting of SEQ ID NOs. 106-199, or combinations thereof, or a reverse complement thereof. In some embodiments, the nucleic acid probe is capable of hybridizing under moderate conditions. “Moderate conditions” are 0.165M-0.330M NaCl and 20-29 degrees Celsius below the melting temperature of the nucleic acid probe. In some embodiments, the nucleic acid probe is capable of hybridizing under stringent conditions. “Stringent conditions” are 0.0165M-0.0330M NaCl and 5-10 degrees Celsius below the melting temperature of the nucleic acid probe.

In some embodiments, the nucleic acid probes are a component of a nucleic acid detection kit. In some embodiments, the nucleic acid probes are a component of a DNA detection kit. In some embodiments, the nucleic acid detection kit comprises additional reagents. In some embodiments, the contents of the nucleic acid detection kit are utilized in performing DNA sequencing.

In some embodiments, the one or more nucleic acid probes comprises at least 2, 3, 4, 5, 6, 7, 8, 9, or 10 probes.

The invention will be further described in the following examples, which do not limit the scope of the invention described in the claims.

### EXAMPLES

### Example 1. Isolation and Identification of Endophytes

Endophytes of the present invention were isolated as described in Table 1 and Table 2.

TABLE 1
Sources of microbes

| MICID | Taxonomy | Isolated From |
|---|---|---|
| MIC-28837 | Pseudomonas oryzihabitans | Thespesia populnea |
| MIC-87992 | Pseudomonas oryzihabitans | Zea mays |
| MIC-61317 | Pseudomonas fulva | Gossypium hirsutum |
| MIC-68350 | Pseudomonas fulva | Gossypium hirsutum |
| MIC-12479 | Pseudomonas oryzihabitans | Oryza sativa |
| MIC-56767 | Pseudomonas fulva | Gossypium hirsutum |
| MIC-83040 | Pseudomonas fulva | Gossypium hirsutum |

TABLE 2
Method of isolating microbes

| MIC ID | Isolation Method |
|---|---|
| MIC-28837 | Seeds of Thespesia populnea trees were collected at |
| | Luquillo, Puerto Rico and Rincón, Puerto Rico. |
| | Thespesia populnea seeds were surface sterilized |
| | with 4% NaOCl for 20 minutes, rinsed three times |
| | with sterile water, placed on potato dextrose agar |
| | (PDA) plates and incubated at room temperature for |
| | 72 hours. |
| MIC-87992 | Endophytes were isolated from corn (Zea mays) |
| | growing in Alabama, USA. |
| MIC-61317 | Endophytes were isolated from cotton (Gossypium |
| | hirsutum) seedlings at collectedemergence in |
| | Alabama, USA. |
| MIC-68350 | Endophytes were isolated from cotton (Gossypium |
| | hirsutum) seedlings collected at emergence in |
| | Alabama, USA. |
| MIC-12479 | Endophytes were isolated from rice (Oryza sativa) |
| | plants growing in an environment in Texas, USA |
| | affected by disease pressure. |
| MIC-56767 | Endophytes were isolated from young cotton |
| | (Gossypium hirsutum) plants collected at |
| | approximately 42 days after emergence in |
| | Alabama, USA. |
| MIC-83040 | Endophytes were isolated from young cotton |
| | (Gossypium hirsutum) plants collected at |
| | approximately 42 days after emergence in |
| | Alabama, USA. |

### Phylogenetic and Genomic Analysis of Endophytes

Phylogenetic and genomic analyses for bacterial strains. According to the manufacturer's protocol, DNA was extracted from pure cultures using the Omega Mag-Bind Universal Pathogen Kit with a final elution volume of 60 μl (Omega Biotek Inc., Norcross, GA). DNA samples were quantified using a Qubit fluorometer (ThermoFisher Scientific, Waltham, MA) and normalized to 100 ng. DNA was prepared using the Nextera DNA Flex Library Prep Kit according to the manufacturer's instructions (Illumina Inc., San Diego, CA). DNA libraries were quantified via qPCR using the KAPA Library Quantification kit (Roche Sequencing and Life Science, Wilmington, MA) and combined in equimolar concentrations into one 24-sample pool. Libraries were sequenced on a MiSeq using pair-end reads (2×200 bp). Reads were trimmed of adapters and low-quality bases using Cutadapt (version 1.9.1) and assembled into contigs using MEGAHIT (version 1.1.2) (Li, D., Liu, C.-M., Luo, R., Sadakane, K., and Lam, T.-W. 2015. MEGAHIT: an ultra-fast single-node solution for large and complex metagenomics assembly via succinct de Bruijn graph. Bioinformatics. 31:1674-1676). Reads were mapped to contigs using Bowtie2 (version 2.3.4) (Langmead, B., and Salzberg. S. L. 2012. Fast gapped-read alignment with bowtie 2. Nat Methods. 9 Available at: doi.org/10.1038/nmeth.1923.), and contigs were assembled into scaffolds using BESST (2.2.8) (Sahlin, K., Vezzi, F., Nystedt, B., Lundeberg, J., and Arvestad, L. 2014. BESST-efficient scaffolding of large fragmented assemblies. BMC bioinformatics. 15:281).

Genomic analysis methods Key genomic features were identified using standard bioinformatic analysis including BLAST search, presence of known protein domains within the translated gene product, homology to members of protein families, and homology to functional orthologs. Key features include: presence of cytokinin synthesis genes miaA (SEQ ID: 42 and 136), Nif3-Family Protein, a putative nematocidal protein (SEQ ID: 56 and 150); miaB (SEQ ID: 43 and 137), miaE (SEQ ID: 41 and 135) and LONELY GUY (LOG) cytokinin-activating enzyme family (for example, cytokinin riboside 5′-monophosphate phosphoribohydrolase) (SEQ ID: 40, 134) which affect biocontrol activity against phytopathogens; gene for a putative salicylate hydroxylase (nahG) (SEQ ID: 86 and 180) a salicylic acid degrading enzyme; biosynthetic genes for 2,3-butanediol biosynthesis (for example, (R,R)-butanediol dehydrogenase, bdhA, SEQ ID: 12 and 106); putative elicitors of plant defense responses (for example, B-type flagellin, fliC, SEQ IDs: 65, 159 and type III effector, hopJ, SEQ IDs: 66, 160); two ACC deaminase genes acdS 1 (SEQ IDs: 13, 107) and acdS 2 (SEQ IDs: 14, 108), ACC deaminase degrades a precursor of plant stress hormone ethylene; encodes for multiple catalases, peroxidases and superoxide dismutase that can scavenge reactive oxygen produced under stress: Alkyl hydroperoxide reductase, bcp (SEQ IDs: 44, 138), Alkyl hydroperoxide reductase C ahpC (SEQ IDs: 45, 139), Alkyl hydroperoxide reductase subunit F ahpF (SEQ IDs: 46, 140), Catalase A catA (SEQ IDs: 47, 141), Catalase B catB (SEQ IDs: 48, 142), Catalase HPII katE (SEQ IDs: 49, 143), Catalase X katX (SEQ IDs: 50, 144), Catalase-peroxidase katG (SEQ IDs: 51, 145), Organic hydroperoxide resistance protein ohr (SEQ IDs: 52, 146), Superoxide dismutase sodC (SEQ IDs: 53, 147), superoxide dismutase, Fe—Mn sodA (SEQ IDs: 54, 148), and Vegetative catalase katA (SEQ IDs: 55, 149); genes for cellulose synthesis including: Cellulose synthase catalytic subunit [UDP-forming] bcsA (SEQ IDs: 34, 128), bcsB (SEQ IDs: 31, 125), bcsC_1 (SEQ IDs: 32, 126), bcsC_2 (SEQ IDs: 33, 127), and wss (SEQ ID: 35, 129); =genes related to biofilm formation including Pel polysaccharide biosynthesis and export genes pel gene cluster (pelABCDEFG) (SEQ ID: 64, 158, 62, 156, 57, 151, 60, 154, 59, 153, 58, 152, 63, 157)); and other genes listed in Table 3.

TABLE 3
Genomic features of endophytes.

| | | Locus | |
|---|---|---|---|
| Sequence Category | SEQ ID | Abbreviation | Sequence Description |
| 2,3-butanediol synthesis | 12 | bdhA | (R,R)-butanediol dehydrogenase |
| ACC deaminase, cleaves | 13, 14 | acdS_1, | 1-aminocyclopropane-1-carboxylate deaminase |
| ethylene precursor | | acdS_2 | |
| Alginate biosynthesis & | 15 | algA | Alginate biosynthesis protein AlgA |
| regulation genes | 16 | algB | Alginate biosynthesis transcriptional regulatory |
| | | | protein AlgB |
| | 17 | rseA | An anti-sigma factor for extracytoplasmic |
| | | | function (F) sigma factor sigma-E (RpoE) |
| | 18 | algC | phosphomannomutase |
| | 19 | algR | Positive alginate biosynthesis regulatory protein |
| | 20 | algU | RNA polymerase sigma-H factor - regulates |
| | | | alginate biosynthesis |
| | 21 | algZ | signal transduction protein with a C-terminal |
| | | | ATPase domain |
| Carotene biosynthetic | 22 | crtE | Belongs to the FPP GGPP synthase |
| gene cluster | 23 | crtX | Belongs to the UDP-glycosyltransferase |
| | 24 | crtZ | Beta-carotene hydroxylase |
| | 25 | | dehydrogenase |
| | 26 | fni | Isopentenyl-diphosphate delta-isomerase |
| | 27 | | Lycopene cyclase |
| | 28 | crtI | Phytoene desaturase (lycopene-forming) |
| | 29 | crtB | Phytoene squalene synthetase |
| | 30 | | putative lipid kinase YegS-like |
| Cytokinin biosynthetic | 40 | PA4923 | Cytokinin riboside 5′-monophosphate |
| genes | | | phosphoribohydrolase |
| | 41 | miaE | Hydroxylase for synthesis of 2-methylthio-cis- |
| | | | ribozeatin in tRNA |
| | 42 | miaA | tRNA isopentenyltransferase |
| | 43 | miaB | RNA-2-methylthio-N(6)- |
| | | | dimethylallyladenosine synthase |
| Nif3-Family Protein, a | 56 | | Nif3-Family Protein, a putative nematocidal |
| putative nematocidal | | | protein |
| protein | | | |
| Putative siderophore | 67 | cbrD | Achromobactin transport ATP-binding protein |
| (Achromobactin-like) | | | CbrD |
| biosynthetic gene cluster | 68 | cbrB_3 | Achromobactin transport system permease |
| | | | protein CbrB |
| | 69 | cbrC | Achromobactin transport system permease |
| | | | protein CbrC |
| | 70 | cbrA_2 | Achromobactin-binding periplasmic protein |
| | 71 | | aldolase |
| | 72 | | aldolase |
| | 73 | fccL | Belongs to the sigma-70 factor |
| | 74 | | putative decarboxylase |
| | 75 | | Putative FecR, involved in regulation of iron |
| | | | dicitrate transport, Fe(2+)-dicitrate sensor, |
| | | | transmembrane component |
| | 76 | dat | putative secondary metabolism biosynthetic |
| | | | enzyme |
| | 77 | | Putative sideophore receptor |
| | 78 | IucA/IucC | siderophore biosynthesis |
| | 79 | frgA | siderophore biosynthesis protein |
| | 80 | | siderophore biosynthesis protein |
| | 81 | | siderophore-iron reductase |
| Salicylate degradation | 83 | benR | AraC-binding-like domain, putative |
| genes | | | transcription regulator |
| | 84 | | Putative salicylate esterase |
| | 85 | | Putative transporter for aromatic hydrocarbon, |
| | | | salicylate ester/hydrocarbon outer membrane |
| | | | porin, SalD |
| | 86 | nahG | Salicylate hydroxylase |
| Secondary metabolite | 87 | fabA1 | 3-hydroxylacyl-(Acyl carrier protein) |
| (arylpolyene) biosynthetic | | | dehydratase |
| gene cluster | 88 | | Acyltransferase |
| | 89 | VP0886 | exporter |
| | 90 | | Nucleotide-diphospho-sugar transferases |
| | 91 | lola3 | Participates in the translocation of lipoproteins |
| | | | from the inner membrane to the outer |
| | | | membrane |
| | 92 | hutH_1 | Phenylalanine ammonia-lyase and Histidine |
| | | | ammonia lyase; involved in the biosynthesis of |
| | | | a wide variety of secondary metabolites such as |
| | | | flavanoids and furanocoumarin phytoalexins |
| | 93 | | putative Beta-ketoacyl synthase |
| | 94 | | putative NRPS-like protein biosynthetic cluster |
| | 95 | fabF1 | putative PKS/NRPS-like protein biosynthetic |
| | | | cluster |
| | 96 | fabF2 | putative PKS/NRPS-like protein biosynthetic |
| | | | cluster |
| | 97 | acpP2 | putative secondary metabolism biosynthetic |
| | | | enzyme |
| | 98 | fabG 2 | putative secondary metabolism biosynthetic |
| | | | enzyme |
| | 99 | RS00794 | putative secondary metabolism biosynthetic |
| | | | enzyme |
| | 100, 101, | | |
| | 102, 103, | | |
| | 104, 105 | | |
| Cellulase Synthase operon | 31 | bcsB | Cellulose synthase |
| genes | 32 | bcsC_1 | Cellulose synthase |
| | 33 | bcsC_2 | Cellulose synthase |
| | 34 | bcsA | Cellulose synthase catalytic subunit [UDP- |
| | | | forming] |
| | 35 | wssA | cellulose synthase operon protein YhjQ |
| | 36 | wssF | lipolytic protein G-D-S-L |
| | 37 | wssH | MBOAT, membrane-bound O-acyltransferase |
| | 38 | algF | Putative Alginate O-acetyl transferase AlgF |
| | 39 | wssI | SGNH hydrolase-like domain, acetyltransferase |
| | | | AlgX |
| Enzymes to neutralize | 44 | bcp | Alkyl hydroperoxide reductase |
| oxidative stress | 45 | ahpC | Alkyl hydroperoxide reductase C |
| | 46 | ahpF | Alkyl hydroperoxide reductase subunit F |
| | 47 | catA | Catalase A |
| | 48 | catB | Catalase B |
| | 49 | katE | Catalase HPII |
| | 50 | katX | Catalasc X |
| | 51 | katG | Catalase-peroxidase |
| | 52 | ohr | Organic hydroperoxide resistance protein |
| | 53 | sodC | Superoxide dismutase |
| | 54 | sodA | superoxide dismutase, Fe—Mn |
| | 55 | katA | Vegetative catalase |
| Pel polysaccharide | 57 | pelC | cAMP biosynthetic process |
| biosynthesis and export | 58 | pelF | Glycosyl Transferase |
| genes | 59 | pelE | lyase activity |
| | 60 | pelD | PelD GGDEF domain |
| | 61 | wza | polysaccharide export |
| | 62 | pelB | polysaccharide lyase 1 protein |
| | 63 | pelG | Putative exopolysaccharide exporter |
| | 64 | pelA | putative pectin lyase A |
| Putative elicitors of | 65 | fliC | B-type flagellin |
| plant defense responses | 66 | hopJ | type III effector |

Genes for phylogenetic analyses were extracted from genome assemblies using barrnap (Seemann, T. 2019. barrnap 0.9: rapid ribosomal RNA prediction. Available at: github.com/tseemann/barrnap) or blast (Altschul, S. F., Madden, T. L., Schäffer, A. A., Zhang, J., Zhang, Z., Miller, W., et al. 1997. Gapped BLAST and PSI-BLAST: A new generation of protein database search programs. Nucleic Acids Research. 25:3389-3402). Homologous DNA sequences from types or other, likely correctly identified strains were retrieved from GenBank and aligned using MAFFT (Katoh, K., and Standley, D. M. 2013. MAFFT multiple sequence alignment software version 7: improvements in performance and usability. Molecular Biology and Evolution. 30:772-780), or other software. Single or multilocus phylogenetic analyses were performed using PAUP (Swofford, D. L. 2002. PAUP*. Phylogenetic Analysis Using Parsimony (*and Other Methods). Version 4. Sunderland, Massachusetts: Sinauer Associates) or similar software.

16S rRNA gene sequences were extracted from genome assemblies using barrnap (Seemann 2019). Phylogenomic analyses were performed using GToTree (Lee, M. D. 2019. Applications and considerations of GToTree: a user-friendly workflow for phylogenomics. Evolutionary Bioinformatics. 15:1176934319862245) with default settings. Average nucleotide identity analyses were performed using the pyani ANIm algorithm (Richter, M., and Rosselló-Móra, R. 2009. Shifting the genomic gold standard for the prokaryotic species definition. Proceedings of the National Academy of Sciences. 106:19126-19131) implemented in the MUMmer package (Kurtz, S., Phillippy, A., Delcher, A. L., Smoot, M., Shumway, M., Antonescu, C., et al. 2004. Versatile and open software for comparing large genomes. Genome biology. 5: R12) retrieved from github.com/widdowquinn/pyani.

Identification of bacterial strains. A bacteria is identified at the species level, if: its average nucleotide identity (ANI) was >95% to the genome of a single species represented by its type strain downloaded from GenBank. Phylogenomic analyses were also performed if a bacteria had >1 species with >95% ANI, or the gap between the top two ANI hits was <3%, in this case, the bacteria is identified at the genus and species if it had a single sister group with >70% bootstrap support.

### Identification of Endophytes by Sequencing of Marker Genes

The endophytes were characterized by the sequences of genomic regions. Primers that amplify genomic regions of the endophytes of the present invention are listed in Table 4. Sanger sequencing was performed at Genewiz (South Plainfield, NJ). Raw chromatograms were converted to sequences, and corresponding quality scores were assigned using Trace Tuner v3.0.6beta (U.S. Pat. No. 6,681,186). These sequences were quality filtered, aligned and a consensus sequence generated using Geneious v 8.1.8 (Biomatters Limited, Auckland NZ).

TABLE 4
Primer sequences useful in identifying
microbes of the present invention

| Seq | Pri- | | |
|---|---|---|---|
| ID | mer | Description | Sequence |
| 1 | 27f | 16S ribosomal RNA | AGAGTTTGATYMTGGCTCAG |
| 2 | 1492r | 16S ribosomal RNA | GGTTACCTTGTTACGACTT |
| 3 | 515f | 16S ribosomal RNA | GTGYCAGCMGCCGCGGTAA |
| 4 | 806r | 16S ribosomal RNA | GGACTACNVGGGTWTCTAAT |

MIC-28837 was deposited with ______ as Deposit ID ______.

### Example 2. Identification of Compounds Produced by Endophytes

Ethylacetate extracts of a full broth from a shake flask culture of the endophytes are prepared in triplicate. HPLC/MS was utilized for a fingerprint analysis of all compounds in the extract and compared with a curated library of microbial compounds and secondary metabolites in the extract were identified. The whole genome of the endophytes are analyzed to confirm presence of pathways to produce the family of compounds suggested from the HPLC/MS analysis. Notable compound matches identified in MIC-28837 were vulnibactin 3 (a siderophore) and peniprequinolone (a nematocidal alkaloid).

### Example 3. Characterization of Endophytes

Phosphate solubilization. Agar plates were prepared with Pikovsaya's Agar medium (Pikovsaya's Agar contains an insoluble form of phosphate—calcium phosphate—that makes the plates opaque), and pH sensitive dye (bromocresol purple). Pikovsaya's Agar medium was prepared by suspending 31.3 grams in 1000 ml of distilled water. A 0.5% stock solution of dye was prepared by suspending 0.5 g of bromocresol purple dye into 100 ml 70% ethanol. 2 ml of the prepared stock solution was added into 1 L Pikoviskaya's Agar medium and the PH adjusted to 7±0.2 using NaOH or HCl. The solution was autoclaved and stirred before plates were prepared in sterile conditions. Endophyte cultures are prepared, rinsed in 1×PBS, and normalized to a target OD of 0.3OD. Each prepared plate is inoculated with 2 μl of normalized endophyte in 3 dispersed positions on the plate. The plates were sealed with Breathe-Easy seals, inverted, and stored at 24C for 3 to 5 days. The endophytes were positive for phosphate solubilization if a clearing zone (e.g. a halo) was present around the culture/colony, an additional indicator (but not alone sufficient) indicator of phosphate solubilization is a color change (indicating the production of production of organic acids, so we also record whether the culture is capable of acidifying the media (“color change”).

### ACC Deaminase Activity

Microbes were assayed for growth with ACC as their sole source of nitrogen. Prior to media preparation all glassware was cleaned with 6 M HCl. A 2 M filter sterilized solution of ACC (#1373A, Research Organics, USA) was prepared in water. 2 μl/mL of this was added to autoclaved LGI broth (see above), and 250 μL aliquots were placed in a brand new (clean) 96 well plate. The plate was inoculated with a 96 pin library replicator, sealed with a breathable membrane, incubated at 28° C. without shaking for 5 days, and OD600 readings taken. Only wells that were significantly more turbid than their corresponding nitrogen free LGI wells were considered to display ACC deaminase activity.

Results of endophyte characterization are shown in Table 5.

TABLE 5
Characterization of endophytes

| | | MIC- | MIC- | MIC- | MIC- | MIC- | MIC- | MIC- |
|---|---|---|---|---|---|---|---|---|
| | | 28837 | 61317 | 87992 | 12479 | 68350 | 83040 | 56767 |
| Catalase | | Yes | — | — | — | — | — | — |
| IAA | | Yes | Yes | Yes | Yes | No | No | — |
| Biofilm | Production of biofilms to | Yes | No | — | Yes | Yes | No | — |
| | help bacteria colonize | | | | | | | |
| | surfaces; microaerophilic | | | | | | | |
| | environment where | | | | | | | |
| | nitrogen fixation can | | | | | | | |
| | occur | | | | | | | |
| Biofilm (TSB | | Yes | No | No | No | — | — | — |
| assay) | | | | | | | | |
| Biofilm (R2A | | No | No | Yes | Yes | — | — | — |
| assay) | | | | | | | | |
| Biofilm (PDB | | No | No | Yes | — | — | — | — |
| assay) | | | | | | | | |
| ACC Deaminase | Ability to break down | Yes | No | Yes | Yes | No | No | No |
| | precursor of plant stress | | | | | | | |
| | molecule, ethylene. | | | | | | | |
| Phosphate | Solubilization of calcium | No | Yes | No | Yes | No | No | No |
| solubilization - | phosphate on solid | | | | | | | |
| Halo | medium; formation of | | | | | | | |
| | halo around colony. | | | | | | | |
| Phosphate | Solubilization of calcium | No | Yes | No | Yes | — | — | Yes |
| solubilization - | phosphate on solid | | | | | | | |
| pH | medium; change of media | | | | | | | |
| | pH, formation of halo | | | | | | | |
| | around colony. | | | | | | | |
| Potassium | Solubilization of | Yes | Yes | Yes | No | — | — | — |
| solubilization - | potassium alumino | | | | | | | |
| Halo | silicate on solid medium; | | | | | | | |
| | formation of halo around | | | | | | | |
| | colony. | | | | | | | |
| Potassium | Solubilization of | Yes | Yes | No | Yes | — | — | Yes |
| solubilization - | potassium alumino | | | | | | | |
| pH | silicate on solid medium; | | | | | | | |
| | change of media pH | | | | | | | |
| | formation of halo around | | | | | | | |
| | colony | | | | | | | |

### Example 4. Production of Microbial Treatments

Preparation of endophyte biomass: approximately 0.5 ml cryopreserved culture was transferred via pipette into 50-100 ml media in a 125-250 ml seed culture flask with a baffled bottom and aerated lid. The seed flask was incubated at 24C or 30C for a period of 24 h to 7 days (depending on the microbial strain). While seed flasks were growing, bioreactors were batched with appropriate growth medium. Following incubation, seed flasks were checked for purity via microscopic examination and used to inoculate bioreactors (at a rate of 0.1-10%). Bioreactors were run with conditions appropriate for the organism, generally at a pH of 5-7, a temperature of 24-37° C., and an elapsed fermentation time of 24 h to 7 days. Bioreactors were then harvested, and biomass was concentrated to a concentrate (typically 8-30×) via centrifugation or tangential flow filtration. This concentrate was used for subsequent steps in the process.

### Example 5. Formulation of Endophyte Treatments

Method of Treating Seeds with Wettable Powder Formulations

Wettable powder endophyte formulations comprise endophyte biomass, a clay carrier, sugar, protein, dispersant, and/or surfactant. The volume of seeds was used to determine the volume of endophyte slurry needed for the target dose per seed, where the total slurry comprises 95% water and 5% wettable powder. The calculated volume of water was added to the mix tank, and the endophyte in wettable powder was added to a clean mix tank. The contents of the tank were mixed for five minutes to ensure the powder was well dispersed in the tank. Agitation was maintained in the mix tank during seed treatment to limit settling of the product. The required volume of slurry was then applied to the seeds and the seeds were gently mixed until the slurry was evenly dispersed.

Method of Treating Seeds with Water Dispersed Formulations

Water dispersed endophyte formulations comprise endophyte biomass in liquid fermentation broth that may be diluted in a buffered carrier such as phosphate buffered saline as well as a preservative and/or a pH adjusting agent. The volume of seeds was used to determine the volume of endophyte in water dispersion formulation needed for the target dose per seed. The calculated volume of endophyte formulation was added to the seeds in a clean mixing vessel. The seeds and endophyte formulation were mixed for at least 30 seconds to ensure the endophyte formulation was well dispersed on the seeds.

Method of Treating Seeds with Oil Dispersed Formulations

Oil dispersion formulations comprise endophyte biomass, a vegetable oil based carrier, a dispersant, and/or a rheology modifier. The volume of seeds is used to determine the volume of endophyte in oil dispersion formulation needed for the target dose per seed. The oil dispersed endophyte formulation is thoroughly agitated to resuspend the endophyte throughout the formulation. The calculated volume of endophyte formulation is added to the seeds in a clean mixing vessel. The seeds and endophyte formulation are mixed to ensure the endophyte formulation was well dispersed on the seeds.

Method of Treating Seeds with Flowable Powder Formulations

Flowable powder endophyte formulations comprise talc, mineral oil base, desiccant (optionally), and spray dried or solid state fermentation produced endophyte. The volume of seeds was used to determine the volume of endophyte in a flowable powder formulation needed for the target dose per seed. The seed to be treated were added to a clean mixing vessel. The calculated volume of endophyte formulation for the desired dose was added to the seeds in a clean mixing vessel. The seeds and endophyte formulation were mixed for at least 30 seconds to ensure the endophyte formulation was well dispersed on the seeds.

### Example 6. Additional Methods for Creating Synthetic Compositions

### Osmopriming and Hydropriming

One or more endophytes are inoculated onto seeds during the osmopriming (soaking in polyethylene glycol solution to create a range of osmotic potentials) and/or hydropriming (soaking in de-chlorinated water) process. Osmoprimed seeds are soaked in a polyethylene glycol solution containing one or more endophytes for one to eight days and then air dried for one to two days. Hydroprimed seeds are soaked in water for one to eight days containing one or more endophytes and maintained under constant aeration to maintain a suitable dissolved oxygen content of the suspension until removal and air drying for one to two days. Talc and/or flowability polymer are added during the drying process.

### Foliar Application

One or more endophytes are inoculated onto aboveground plant tissue (leaves and stems) as a liquid suspension in dechlorinated water containing adjuvants, sticker-spreaders, and UV protectants. The suspension is sprayed onto crops with a boom or other appropriate sprayer.

### Soil Inoculation

One or more endophytes are inoculated onto soils in the form of a liquid suspension, either pre-planting as a soil drench, during planting as an in-furrow application, or during crop growth as a side-dress. One or more endophytes are mixed directly into a fertigation system via drip tape, center pivot, or other appropriate irrigation system.

### Hydroponic and Aeroponic Inoculation

One or more endophytes are inoculated into a hydroponic or aeroponic system either as a powder or liquid suspension applied directly to the rockwool substrate or applied to the circulating or sprayed nutrient solution.

### Vector-Mediated Inoculation

One or more endophytes are introduced in powder form in a mixture containing talc or other bulking agent to the entrance of a beehive (in the case of bee-mediation) or near the nest of another pollinator (in the case of other insects or birds). The pollinators pick up the powder when exiting the hive and deposit the inoculum directly to the crop's flowers during the pollination process.

### Root Wash

The method includes contacting the exterior surface of a plant's roots with a liquid inoculant formulation containing one or more endophytes. The plant's roots are briefly passed through standing liquid microbial formulation or liquid formulation is liberally sprayed over the roots, resulting in both physical removal of soil and microbial debris from the plant roots, as well as inoculation with microbes in the formulation.

### Seedling Soak

The method includes contacting the exterior surfaces of a seedling with a liquid inoculant formulation containing one or more endophytes. The entire seedling is immersed in standing liquid microbial formulation for at least 30 seconds, resulting in both physical removal of soil and microbial debris from the plant roots, as well as inoculation of all plant surfaces with microbes in the formulation. Alternatively, the seedling can be germinated from seed in or transplanted into media soaked with the microbe(s) of interest and then allowed to grow in the media, resulting in soaking of the plantlet in microbial formulation for much greater time, for example: hours, days, or weeks. Endophytic microbes likely need time to colonize and enter the plant, as they explore the plant surface for cracks or wounds to enter, so the longer the soak, the more likely the microbes will successfully be installed in the plant.

### Wound Inoculation

The method includes contacting the wounded surface of a plant with a liquid or solid inoculant formulation containing one or more endophytes. Plant surfaces are designed to block entry of microbes into the endosphere, since pathogens attempt to infect plants in this way. One way to introduce beneficial endophytic microbes into plant endospheres is to provide a passage to the plant interior by wounding. This wound can take several forms, including but not limited to, pruned roots, pruned branches, puncture wounds in the stem breaching the bark and cortex, puncture wounds in the tap root, puncture wounds in leaves, or puncture wounds seed allowing entry past the seed coat. Wounds for physical penetration of plant tissue can be made using tools such as needles, or biological vectors. Microwounds may also be introduced by sonication. The microbial inoculant, as liquid, as powder, inside gelatin capsules, in a pressurized capsule injection system, or in a pressurized reservoir and tubing injection system, can then be contacted into the wound, allowing entry and colonization by microbes into the endosphere. Alternatively, the entire wounded plant can be soaked or washed in the microbial inoculant for at least 30 seconds, giving more microbes a chance to enter the wound, as well as inoculating other plant surfaces with microbes in the formulation—for example pruning seedling roots and soaking them in inoculant before transplanting is a very effective way to introduce endophytes into the plant.

### Injection

The method includes injecting microbes into a plant to successfully install them in the endosphere. Plant surfaces are designed to block entry of microbes into the endosphere, since pathogens attempt to infect plants in this way. In order to introduce beneficial endophytic microbes to endospheres, we need a way to access the interior of the plant which we can do by puncturing the plant surface with a needle and injecting microbes into the inside of the plant. Different parts of the plant can be inoculated this way including the main stem or trunk, branches, tap roots, seminal roots, buttress roots, and even leaves. The injection can be made with a hypodermic needle, a drilled hole injector, or a specialized injection system, and through the puncture wound can then be contacted the microbial inoculant as liquid, as powder, inside gelatin capsules, in a pressurized capsule injection system, or in a pressurized reservoir and tubing injection system, allowing entry and colonization by microbes into the endosphere.

### Example 7. Viability Over Time of Endophytes

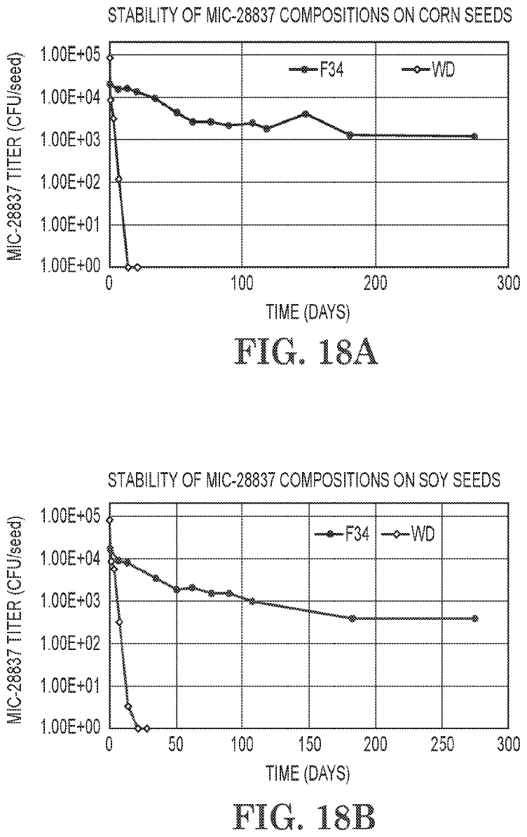

This example and the following table describe exemplary and target application rates for endophytes. Endophytes were quantified and loaded into synthetic compositions, and in some cases synthetic compositions containing endophytes were loaded onto seeds (FIGS. 18A and 18B). The endophytes were reisolated from the synthetic compositions or seeds, on the day of treatment and each following period, and the CFU recorded according to the method of Example 8.

### Example 8. Viability Over Time of Endophytes in Synthetic Fertilizer Compositions

This example describes an exemplary method by which compatibility of synthetic compositions comprising endophytes and fertilizers may be evaluated.

Application rates. Fertilizer compositions may be granular or liquid in form and comprise nitrogen, phosphorous, sulfur, zinc, micronutrients, urease inhibitors, monoammonium phosphate (MAP), and/or triple superphosphate (TSP). Flowable powder (FP) endophyte treatments, prepared as described above, have a target application rate of 3.6 grams per acre. Water dispersal (WD) endophyte treatments, prepared as described above, have a target application rate of 13 grams per acre. Synthetic compositions are prepared using concentrations of endophyte and fertilizer (% w/w), representing between 5-50 times the target application rate. Synthetic compositions are blended and stored at either 22° C. with between 20-60% relative humidity or 30° C. with 80% relative humidity. The endophytes were reisolated from the synthetic compositions or seeds, on the day of treatment and each following period and the CFU recorded.

### Example 9. Assessment of Improved Plant Characteristics: Vigor Assay

### Assay of Soybean Seedling Vigor

Seed preparation: The lot quality of soybean seeds is first assessed by testing germination of 100 seeds. Seeds are placed, 8 seeds per petri dish, on filter paper in petri dishes, 12 ml of water is added to each plate and plates are incubated for 3 days at 24° C. The process should be repeated with a fresh seed lot if fewer than 95% of the seeds have germinated. One thousand soybean seeds are then surface sterilized by co-incubation with chlorine gas in a 20×30 cm container placed in a chemical fume hood for 16 hours. Percent germination of 50 seeds, per sterilization batch, is tested as above and confirmed to be greater than 95%.

Preparation of endophyte treatments: Spore solutions are made by rinsing and scraping spores from agar slants which have been growing for about 1 month. Rinsing is done with 0.05% Silwet. Solutions are passed through Miracloth to filter out mycelia. Spores per ml are counted under a microscope using a hemocytometer. The stock suspension is then diluted into 10\hat{ }6 spores/ml utilizing water. 3 μl of spore suspension is used per soy seed (˜10\hat{ }3 CFUs/seed is obtained). Control treatments are prepared by adding equivalent volumes of sterile water to seeds.

Assay of seedling vigor: Two rolled pieces of germination paper are placed in a sterile glass gar with 50 ml sterile water, then removed when completely saturated. The papers are then separated and inoculated seeds are placed at approximately 1 cm intervals along the length of one sheet of moistened germination paper, at least 2.5 cm from the top of the paper and 3.8 cm from the edge of the paper. The second sheet of saturated germination paper is then placed on top of the soy seeds and the layered papers and seeds are loosely rolled into a tube. Each tube is secured with a rubber band around the middle and placed in a single sterile glass jar and covered loosely with a lid. For each treatment, three jars with 15 seeds per jar are prepared. The position of jars within the growth chamber is randomized. Jars are incubated for 4 days at 60% relative humidity, 22° C. day with 12 hours light, and 18° C. night with 12 hours dark, after which the lids are removed, and the jars are incubated for an additional 7 days. The germinated soy seedlings are then weighed and photographed, and root length and root surface area are measured.

Dirt, excess water, seed coat and other debris is removed from seedlings to allow accurate scanning of the roots. Individual seedlings are laid out on clear plastic trays, and trays are arranged on an Epson Expression 11000XL scanner (Epson America, Inc., Long Beach CA). Roots are manually arranged to reduce the amount of overlap. For root measurements, shoots are removed if the shape of the shoot causes it to overlap the roots.

The WinRHIZO software version Arabidopsis Pro2016a (Regents Instruments, Quebec Canada) is used with the following acquisition settings: greyscale 4000 dpi image, speed priority, overlapping (1 object), Root Morphology: Precision (standard), Crossing Detection (normal). The scanning area is set to the maximum scanner area. When the scan is completed, the root area is selected, and root length and root surface area are measured.

Statistical analysis is performed using R (R Core Team, 2016. R: A language and environment for statistical computing. R Foundation for Statistical Computing, Vienna, Austria. R-project.org/) or a similar statistical software program.

### Assay of Corn Seedling Vigor

Seed preparation: The lot quality of corn seeds is first evaluated for germination by transfer of 100 seeds with 3.5 ml of water to a filter paper lined petri dish. Seeds are incubated for 3 days at 24° C. The process should be repeated with a fresh seed lot if fewer than 95% of the seeds have germinated. One thousand corn seeds are then surface sterilized by co-incubation with chlorine gas in a 20×30 cm container in a chemical fume hood for 12 hours. Percent germination of 50 seeds, per sterilization batch, is tested as above and confirmed to be greater than 95%.

Optional reagent preparation: 7.5% PEG 6000 (Calbiochem, San Diego, CA) is prepared by adding 75 g of PEG to 1000 ml of water, then stirred on a warm hot plate until the PEG is fully dissolved. The solution is then autoclaved.

Preparation of endophyte treatments: Spore solutions are made by rinsing and scraping spores from agar slants which have been growing for about 1 month. Rinsing is done with 0.05% Silwet. Solutions are passed through Miracloth to filter out mycelia. Spores per ml are counted under a microscope using a hemocytometer. The stock suspension is then diluted into 10\hat{ }6 spores/ml utilizing water. 3 μl of spore suspension is used per corn seed (˜10\hat{ }3 CFUs/seed is obtained). Control treatments are prepared by adding equivalent volumes of sterile water to seeds.

Assay of seedling vigor: Either 25 ml of sterile water or, optionally, 25 ml of PEG solution as prepared above, is added to each CygTM germination pouch (Mega International, Newport, MN) and placed into pouch rack (Mega International, Newport, MN). Sterile forceps are used to place corn seeds prepared as above into every other perforation in the germination pouch. Seeds are fitted snugly into each perforation to ensure they do not shift when moving the pouches. Before and in between treatments, forceps are sterilized using ethanol and flame, and workspaces are wiped down with 70% ethanol. For each treatment, three pouches with 15 seeds per pouch are prepared. The germination racks with germination pouches are placed into plastic tubs and covered with perforated plastic wrap to prevent drying. Tubs are incubated at 60% relative humidity, 22° C. day with 12 hours light, and 18° C. night with 12 hours dark for 6 days to allow for germination and root length growth. Placement of pouches within racks and racks/tubs within the growth chamber is randomized to minimize positional effect. At the end of 6 days the corn seeds are scored manually for germination, root, and shoot length.

Statistical analysis is performed using R or a similar statistical software program.

### Assay of Wheat Seedling Vigor

Seed preparation: The lot of wheat seeds is first evaluated for germination by transfer of 100 seeds and with 8 ml of water to a filter paper lined petri dish. Seeds are incubated for 3 days at 24° C. The process should be repeated with a fresh seed lot if fewer than 95% of the seeds have germinated. Wheat seeds are then surface sterilized by co-incubation with chlorine gas in a 20×30 cm container in a chemical fume hood for 12 hours. Percent germination of 50 seeds, per sterilization batch, is tested as above and confirmed to be greater than 95%.

Optional reagent preparation: 7.5% polyethylene glycol (PEG) is prepared by adding 75 g of PEG to 1000 ml of water, then stirring on a warm hot plate until the PEG is fully dissolved. The solution is then autoclaved.

Preparation of endophyte treatments: Spore solutions are made by rinsing and scraping spores from agar slants which have been growing for about 1 month. Rinsing is done with 0.05% Silwet. Solutions are passed through Miracloth to filter out mycelia. Spores per ml are counted under a microscope using a hemocytometer. The stock suspension is then diluted into 10\hat{ }6 spores/ml utilizing water. 3 μl of spore suspension is used per wheat seed (˜10\hat{ }3 CFUs/seed was obtained). Seeds and spores are combined in a 50 ml falcon tube and gently shaken for 5-10 seconds until thoroughly coated. Control treatments are prepared by adding equivalent volumes of sterile water to seeds.

Assay of seedling vigor: Petri dishes are prepared by adding four sheets of sterile heavy weight seed germination paper, then adding either 50 ml of sterile water or, optionally, 50 ml of PEG solution as prepared above, to each plate then allowing the liquid to thoroughly soak into all sheets. The sheets are positioned and then creased so that the back of the plate and one side wall are covered. Two sheets are then removed and placed on a sterile surface. Along the edge of the plate across from the covered side wall, 15 inoculated wheat seeds are placed evenly at least one inch from the top of the plate and half an inch from the sides. Seeds are placed smooth side up and with the pointed end of the seed pointing toward the side wall of the plate covered by germination paper. The seeds are then covered by the two reserved sheets, and the moist paper layers smoothed together to remove air bubbles and secure the seeds, and then the lid is replaced. For each treatment, at least three plates with 15 seeds per plate are prepared. The plates are then randomly distributed into stacks of 8-12 plates and a plate without seeds is placed on the top. The stacks are incubated at 60% relative humidity, 22° C. day with 12 hours light, and 18° C. night with 12 hours dark for 24 hours. Each plate is then turned to a semi-vertical position with the side wall covered by paper at the bottom. The plates are incubated for an additional 5 days. The wheat seeds arc then scored manually for germination, root and shoot length, root and shoot surface area, seedling mass, and seedling length.

Statistical analysis is performed using R or a similar statistical software program.

### Assay of Rice Seedling Vigor

Seed preparation: The lot of rice seeds is first evaluated for germination by transfer of 100 seeds and with 8 ml of water to a filter paper lined petri dish. Seeds are incubated for 3 days at 24° C. The process should be repeated with a fresh seed lot if fewer than 95% of the seeds have germinated. Rice seeds are then surface sterilized by co-incubation with chlorine gas in a 20×30 cm container in a chemical fume hood for 12 hours. Percent germination of 50 seeds, per sterilization batch, is tested as above and confirmed to be greater than 95%.

Optional reagent preparation: 7.5% polyethylene glycol (PEG) is prepared by adding 75 g of PEG to 1000 ml of water, then stirring on a warm hot plate until the PEG is fully dissolved. The solution is then autoclaved.

Preparation of endophyte treatments: Spore solutions are made by rinsing and scraping spores from agar slants which have been growing for about 1 month. Rinsing is done with 0.05% Silwet. Solutions are passed through Miracloth to filter out mycelia. Spores per ml are counted under a microscope using a hemocytometer. The stock suspension is then diluted into 10\hat{ }6 spores/ml utilizing water. 3 μl of spore suspension is used per rice seed (˜10\hat{ }3 CFUs/seed was obtained). Seeds and spores are combined in a 50 ml falcon tube and gently shaken for 5-10 seconds until thoroughly coated. Control treatments are prepared by adding equivalent volumes of sterile water to seeds.

Assay of seedling vigor: Petri dishes are prepared by adding four sheets of sterile heavy weight seed germination paper, then adding either 50 ml of sterile water or, optionally, 50 ml of PEG solution as prepared above, to each plate then allowing the liquid to thoroughly soak into all sheets. The sheets are positioned and then creased so that the back of the plate and one side wall are covered. Two sheets are then removed and placed on a sterile surface. Along the edge of the plate across from the covered side wall 15 inoculated rice seeds are placed evenly at least one inch from the top of the plate and half an inch from the sides. Seeds are placed smooth side up and with the pointed end of the seed pointing toward the side wall of the plate covered by germination paper. The seeds are then covered by the two reserved sheets, and the moist paper layers smoothed together to remove air bubbles and secure the seeds, and then the lid is replaced. For each treatment, at least three plates with 15 seeds per plate are prepared. The plates are then randomly distributed into stacks of 8-12 plates and a plate without seeds is placed on the top. The stacks are incubated at 60% relative humidity, 22° C. day with 12 hours light, and 18° C. night with 12 hours dark for 24 hours. Each plate is then turned to a semi-vertical position with the side wall covered by paper at the bottom. The plates are incubated for an additional 5 days. The rice seeds are then scored manually for germination, root and shoot length.

Statistical analysis is performed using R or a similar statistical software program.

### Example 10. Greenhouse Assessment of Improved Plant Characteristics Under Water Deficit

This example describes an exemplary method by which improved plant health of endophyte treated plants may be shown in a growth environment comprising a water deficit.

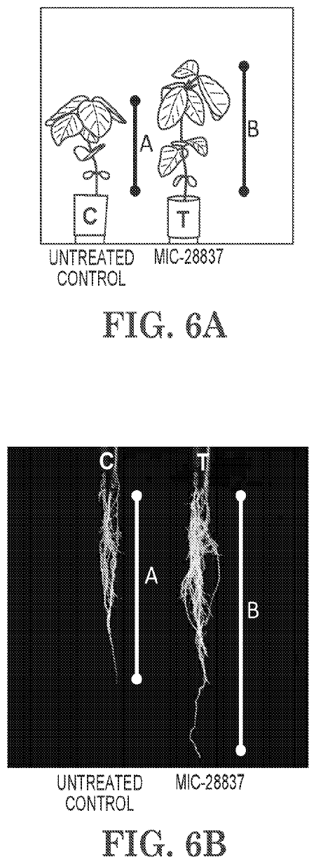

Greenhouse assay setup: This greenhouse assay was conducted in individual plastic containerss, containers were filled with soil. The soil-filled containers for the stress condition were not moistened. The soil-filled containers for the non-stress condition were thoroughly moistened by top watering with approximately 5 L of water as well absorbing water from the bottom of the containers (approximately 3 L) for at least 1 hour prior to planting. Stress treatment containers were watered with 1L of water immediately before planting. An additional container was prepared for each container to be planted, these containers were filled with 30 cc of pea gravel. The soil-filled containers were each placed into a gravel filled container (also referred to as a secondary container). This greenhouse assay was conducted using soybean seeds treated with a commercial Bradyrhizobiym seed treatment and Bradyrhizobiym treated seeds were either coated with MIC-28837 or left untreated as untreated controls (lacking formulation and the one or more heterologously disposed endophyte) as described herein. Seeds were placed onto each pot and lightly covered with potting mix. Replicated containers of each treatment and stress condition were placed in container racks in a Latin square design. The trays of containers were lightly covered and placed in a growth chamber. 48 hours after planting the covers were removed from the trays and all treatments were watered from the top with 1L of water. At 48 hours the container tray containing all treatments were watered from the bottom with 3.5L water. The water level just reached the drain holes of the secondary containers, and the water level was maintained at this level throughout the experiment. Plants were harvested at 13-14 days post planting. The mass of the root tissue extending from the soil container was trimmed and weighted for each plant, and plant height observed. Representative images of MIC-28837 treated plants and untreated controls are shown in FIGS. 6A and 6B.

### Example 11. Greenhouse Assessment of Improved Plant Characteristics Under Nitrogen Deficit

This example describes an exemplary method by which improved plant health of endophyte treated plants may be shown in a growth environment comprising a nitrogen deficit.

Greenhouse assay setup: This greenhouse assay is conducted in individual plastic pots, filled with moistened potting soil. This greenhouse assay is conducted using seeds (optionally, chemically treated) coated with one or more endophytes described herein and formulation control (lacking the one or more heterologously disposed endophytes) and untreated controls (lacking formulation and the one or more heterologously disposed endophyte) as described in Example 3. Seeds are placed into each pot and lightly covered with potting soil. Replicated pots of each treatment are set up and placed on a greenhouse bench using a random block design. For example, 18 replicates are planted for each treatment and control. Nitrogen deficit is introduced by reducing the Nitrogen in the Hoagland's solution (3 mM N), which is used to water the plants. Plants are monitored daily for emergence and watered as necessary to maintain a moist but not saturated soil surface (for example, plants are watered with 125 ml Hoagland's solution (3 mM N) per pot on every Monday, Wednesday, and Friday).

The following growth and vigor metrics are collected for each treatment: percentage emergence at Day 4, 5, 7 (for soybean, winter wheat and cotton) or Day 3, 4, 5 (for corn), leaf count (the number of fully expanded leaves on the main stem) at Days 10, 17, and 24 (all crops).

Additional vigor and growth metrics may be collected including shoot height, leaf area, number of chlorotic leaves, chlorophyll content, number of live leaves, etc. At harvest, plants are gently removed from pots, washed with tap water to remove dirt, and photographed. Plant tissue is collected for nutrient composition analysis. Plants are put into a paper bag and dried in an oven. Optionally, the plant is separated into shoot and root tissue prior to drying. The dry weight of each individual plant, or shoot or root thereof, is recorded.

### Example 11. Greenhouse Assessment of Improved Plant Characteristics Under Phosphorus Deficit

This example describes an exemplary method by which improved plant health of endophyte treated plants may be shown in a growth environment comprising a phosphorus deficit.

This greenhouse assay is conducted in individual plastic pots, filled with moistened potting soil. This greenhouse assay is conducted using seeds (optionally, chemically treated) coated with one or more endophytes described herein and formulation control (lacking the one or more heterologously disposed endophytes) and untreated controls (lacking formulation and the one or more heterologously disposed endophyte) as described in Example 4. Seeds are placed onto each pot and lightly covered with potting soil. Replicated pots of each treatment are set up and placed on a greenhouse bench using a random block design. For example, 16 replicates are planted for each treatment and control. Phosphorus deficit is introduced by removing Phosphorus from the Hoagland's solution (0 mM P), which is used to water the plants. Plants are monitored daily for emergence and watered as necessary to maintain a moist but not saturated soil surface (for example, plants are watered with 125 ml Hoagland's solution (0 mM P) per pot on every Monday, Wednesday, and Friday).

The following growth and vigor metrics are collected for each treatment: percentage emergence at Day 4, 5, 7 (for soybean, winter wheat and cotton) or Day 3, 4, 5 (for corn), leaf count (the number of fully expanded leaves on the main stem) at Days 10, 17, and 24 (all crops).

Additional vigor and growth metrics may be collected including shoot height, leaf area, coloration of leaves, number of live leaves, etc. At harvest, plants are gently removed from pots, washed with tap water to remove dirt, and photographed. Plant tissue is collected for nutrient composition analysis. Plants are put into a paper bag and dried in an oven. Optionally, the plant is separated into shoot and root tissue prior to drying. The dry weight of each individual plant, or shoot or root thereof, is recorded.

### Example 13. Greenhouse Assessment of Improved Plant Health Under Biotic Stress

This example describes an exemplary method by which improved plant health of endophyte treated plants may be shown in a growth environment comprising the crop pathogen Rhizoctonia solani and/or Pythium ultimum, one of the causal agents of seedling damping off disease. This assay may utilize dicots or monocots, including, for example, soybean or wheat.

Preparation of pathogen inoculum A stock of Rhizoctonia solani anastomosis group 4 or Pythium ultimum var. ultimum is grown on a standard potato dextrose agar plate. Plugs of fresh mycelium are then transferred into standard potato dextrose broth. After sufficient growth is achieved, the culture is poured though cheesecloth to capture the fungal biomass, which is subsequently rinsed with water. After removing excess rinsate, a roughly equivalent volume of water is added to the fungal biomass before blending to create a slurry. The resulting slurry is further diluted to the required concentration necessary to observe desired level of symptoms.

Greenhouse assay setup The greenhouse assay is conducted in a commercial potting mix. A divot is placed in the center of a pot containing wetted soil using a standardized dibble. An appropriate volume of slurry is added to the center of each divot. An equivalent volume of water is added for control treatments.

This greenhouse assay is conducted using seeds (optionally, chemically treated) coated with one or more endophytes described herein and formulation control (lacking the one or more heterologously disposed endophytes) and untreated controls (lacking formulation and the one or more heterologously disposed endophyte). Seeds are placed onto each divot after addition of the inoculum. The seeds are then covered with uninoculated soil and again watered. High soil moisture levels are maintained throughout the course of the experiment. Enough replicates are included in a randomized design to obtain sufficient statistical power for analysis. Plants are grown in a controlled environment until approximately 4 days post emergence of control plants. Two metrics are measured on a per plant basis: emergence and shoot fresh weight. A visual rating of per plant disease symptoms may also be applied.

### Example 14. Greenhouse Assessment of Improved Plant Health Under Biotic Stress

This example describes an exemplary method by which improved plant health of endophyte treated plants may be shown in a growth environment comprising the crop pathogen Fusarium sp., one of the causal agents of seedling damping off disease. This assay may utilize dicots or monocots, including, for example, soybean or wheat.

Preparation of Fusarium sp. inoculum A stock of Fusarium sp. is grown on a standard potato dextrose agar plate. Plugs of fresh mycelium are then transferred into breathable bag containing a sterile mixture of water and grain such as sorghum or millet. After sufficient growth is achieved, the culture is removed from the bags and dried. After drying the biomass is coarsely ground.

Greenhouse assay setup The greenhouse assay is conducted in a media mixture consisting of a commercial potting mix and a minimum of 50% inert inorganic material such as calcined clay or vermiculite or pearlite. An appropriate volume of ground pathogen is added to the soil mixture to obtain desired level of symptoms.

This greenhouse assay is conducted using seeds (optionally, chemically treated) coated with one or more endophytes described herein and formulation control (lacking the one or more heterologously disposed endophytes) and untreated controls (lacking formulation and the one or more heterologously disposed endophyte). A seed is added to the surface of the infested media. The seed is then covered with media lacking pathogen and again watered. High soil moisture levels are maintained throughout the course of the experiment. Enough replicates are included in a randomized design to obtain sufficient statistical power for analysis. Plants are grown in a controlled environment until approximately 4 days post emergence of control plants. At this point, two metrics are measured on a per plant basis: emergence and shoot fresh weight. A visual rating of per plant disease symptoms may also be applied.

### Example 15. In Vitro Assessment of Production of Antibiotic Metabolites Using Live Endophyte Cultures

This example describes an exemplary method by which microbes may be shown to inhibit the growth of hyphal phytopathogens in vitro. Such phytopathogens can be members of the “true” fungi, phylum Eumycota, or from other taxonomic groups with a similar growth habit such as members of the phylum Oomycota. Hyphal growth can be described as organism growth along thread-like structures composed of connected cells. Such growth is found commonly among fungi and oomycetes, and even some genera of bacteria. In this assay, the hyphal growth should be in a roughly uniform, radial manner. This assay is comprised of a Petri plate containing an agar-based media and a hyphal phytopathogen grown concomitantly a live endophyte.

Testing with Live Endophyte Cultures

Preparation of Hyphal Phytopathogen A Petri plate containing a media suitable for the growth of the target hyphal pathogen is inoculated with the target hyphal pathogen. The initial inoculum should be from an axenic culture, but non-axenic cultures containing stable endophytes may also be used. Any media can be used that supports healthy growth of the hyphal pathogen. After inoculation on the media-containing Petri plate, the culture is allowed to grow until reaching the edge of the Petri plate. A test pathogen sample will be collected from this plate.

Preparation of the test sample A microbial sample for testing, also referred to as a test sample, can be produced in multiple ways. For testing the effect of a colony forming microbe, a liquid culture is commonly created, or a small sample from an agar plate can be collected. For testing of a live, hyphal microbe, the method described in Preparation of Hyphal Phytopathogen may also be used for test sample production. Alternatively, a liquid culture of either type of microbe can be grown, and viable material is removed by various methods including, but not limited to, filtration or autoclaving. This later method of testing a non-viable test sample is best used when the test microbe displays a much faster rate of radial growth than the hyphal pathogen being tested. This later method is also more sensitive at differentiating between the passive production of antimicrobial metabolites versus an active biological process such a mycophagy.

Assay Set-Up A Petri dish containing a solid agar test media is obtained. This will be referred to as the test plate. A sterile instrument is used to remove a test pathogen plug from the hyphal pathogen plate culture described in Preparation of Hyphal Phytopathogen. This test pathogen plug is placed on a fresh solid agar plate. Next a test sample is applied to the test plate at a distance such that the test sample and test plate come into physical contact after more than one day of growth. If testing a live hyphal microbe, a similar plug is placed on the test plate. If testing a live colony-forming microbe, a drop of liquid culture or re-suspended agar plate-grown sample is applied to the test plate. For assaying a non-viable test sample, an agar plug is removed from the test plate using a sterile instrument to create a well to hold the test sample. The well is then filled with the non-viable test sample, and the sample is absorbed into the agar media.

Use of Multiple Growth Media Test microbe growth under various environmental conditions are expected to result in differential production of metabolites. Similarly, pathogens grown under various environmental conditions are expected to show differential sensitivity to those metabolites. For this reason, this assay is performed on multiple media types. Medias are chosen to vary important growth inputs such as carbon source, presence and concentration of various salts, and presence of extracts from different plant species or organs.

Assessment After setting up, hyphal pathogens are allowed to grow for sufficient time such that the hyphal front meets or just passes the test sample. In cases where anti-pathogen metabolites are produced and secreted, a restriction of growth of the hyphal front around the test sample is commonly observed. Often this will also result in an area of clearing around the test sample. In these cases, the morphology of the hyphal pathogen near the test sample will often also be dissimilar from areas away from the test sample. Alternatively, when anti-pathogen metabolites are not produced and secreted, the hyphal pathogen will grow over the test sample with little to no visible effect on growth.

### Example 16. In Vitro Assessment of Production of Antibiotic Metabolites Using Filtered or Dead Endophyte Cultures

This example describes an exemplary method by which microbes may be shown to produce metabolites that inhibit the growth of hyphal phytopathogens in vitro. Such phytopathogens can be members of the “true” fungi, phylum Eumycota, or from other taxonomic groups with a similar growth habit such as members of the phylum Oomycota. Hyphal growth can be described as organism growth along thread-like structures composed of connected cells. Such growth is found commonly among fungi and oomycetes, and even some genera of bacteria. In this assay, the hyphal growth should be in a roughly uniform, radial manner. This assay is comprised of a Petri plate containing an agar-based media and a hyphal phytopathogen grown in the presence of the spent media from a previously grown endophyte.

Preparation of Hyphal Phytopathogen A Petri plate containing a media suitable for the growth of the target hyphal pathogen is inoculated with the target hyphal pathogen. The initial inoculum should be from an axenic culture, but non-axenic cultures containing stable endophytes may also be used. Any media can be used that supports healthy growth of the hyphal pathogen. After inoculation on the media-containing Petri plate, the culture is allowed to grow until reaching the edge of the Petri plate. A test pathogen sample will be collected from this plate.

Preparation of the test sample A microbial sample for testing, also referred to as a test sample, can be produced in multiple ways. A liquid culture of hyphal or colony forming microbe is grown in liquid culture, and viable material is removed by various methods including, but not limited to, filtration. Alternately, or in addition to filtration, a test sample may be autoclaved and a non-viable test sample may be used. This later method of testing a non-viable test sample is used when the test microbe displays a much faster rate of radial growth than the hyphal pathogen being tested, to identify production of antimicrobial metabolites, for example not as a part an active biological process such a mycophagy.

Assay Set-Up A Petri dish containing a solid agar test media is obtained. This will be referred to as the test plate. A sterile instrument is used to remove a test pathogen plug from the hyphal pathogen plate culture and placed on the test plate. For assaying a non-viable test sample, an agar plug is removed from the test plate using a sterile instrument to create a well to hold the test sample. The well is then filled with the non-viable test sample, and the sample is absorbed into the agar media. A chemical compound capable of impeding the growth of the pathogen is included as a control.

Use of Multiple Growth Media Pathogens grown under various environmental conditions are expected to show differential sensitivity to those metabolites. For this reason, this assay is performed on multiple media types. Medias are chosen to vary important growth inputs such as carbon source, presence and concentration of various salts, and presence of extracts from different plant species or organs.

Assessment After setting up, hyphal pathogens are allowed to grow for sufficient time such that the hyphal front meets or just passes the test sample. In cases where anti-pathogen metabolites are produced and secreted, a restriction of growth of the hyphal front around the test sample is commonly observed. Often this will also result in an area of clearing around the test sample. In these cases, the morphology of the hyphal pathogen near the test sample will often also be dissimilar from areas away from the test sample. Alternatively, when anti-pathogen metabolites are not produced and secreted, the hyphal pathogen will grow over the test sample with little to no visible effect on growth.

### Example 17. Nematode Egg Inoculum Preparation

This example describes an exemplary method for obtaining nematode eggs for use in stock population maintenance, in planta screening assays, and for hatching for in vitro assays. The nematode species utilized were Meloidogyne incognita (Southern root-knot nematode, “RKN”), Heterodera glycines (Soybean cyst nematode, “SCN”), and Rotylenchulus reniformis (Reniform nematode, “REN”). Populations of nematodes may be obtained, for example from a stock crop of corn for RKN, cotton for REN, and soybean for SCN.

Experimental Preparation Eggs were extracted from nematode stock crops; RKN and REN were collected from plants that are ˜60-75 days old, and SCN were collected from plants that were ˜70-85 days old. The above ground biomass was removed and discarded, taking precautions to prevent cross contamination of nematode species.

RKN and REN Egg Extraction from Roots Soil was washed from the roots of infected stock crops and the roots were placed in a prepared container. To extract the nematodes, 0.625% NaOCl solution was added to the container and the roots were agitated for 4 minutes using an orbital shaker set at approximately 100-120 rpm.

The NaOCl extraction solution was then poured through an 8″ diameter 25 μm pore sieve with an 8″ diameter 75 μm pore sieve stacked on top to sift out debris. The roots were manually scrubbed over the sieve stack while running water over them. Alternately the roots were placed in a blender with water and pulsed until macerated. If a blender was used, the contents were poured back through the sieve stack. The 75 μm pore sieve was rinsed into the 25 μm pore sieve. Eggs were captured on the 25 μm pore sieve. The 25 μm pore sieve was held at an angle and gently rinsed with water to collect the eggs into a small pool at the bottom. The eggs were collected and placed into a storage container using a wash bottle.

SCN Cyst Extraction from Soil. Soil was washed from the roots of infected stock crops, and collected soil and rinse water were placed in a small bucket. The roots were manually scrubbed to remove cysts that remained visibly stuck to the roots. Eight-inch sieves were stacked on top of a separate small bucket. An 850 μm pore sieve was placed on top and a 250 μm pore sieve was placed underneath. The collected soil and rinse water were mixed and then allowed to settle for 3 seconds before the liquid portion of the soil mixture was poured through the sieve stack. Water was added to the retained soil, and the mixing, settling, and pouring steps were repeated. After the second wash the remaining soil was discarded.

The 850 μm pore sieve was rinsed into the 250 μm pore sieve. Cysts were captured on the 250 μm pore sieve. The 250 μm pore sieve was held at an angle and gently rinsed with water to collect all the eggs into a small pool at the bottom. The cysts were carefully collected into a storage container using a wash bottle and minimal amount of water.

SCN Egg Extraction from Cysts. Collected cysts were placed into a mortar, and thoroughly ground using a pestle. An 8″ 75 μm pore sieve was stacked on top of an 8″ 25 μm pore sieve and the mortar contents were washed through the sieves. The eggs were collected from the 25 μm pore sieve by rinsing the 75 μm pore sieve into the 25 μm pore sieve. Eggs were captured on the 25 μm pore sieve. The 25 μm pore sieve was held at an angle and gently rinsed with water to collect all the eggs into a small pool at the bottom. The eggs were carefully collected into a storage container using a wash bottle. The cyst mixture remaining on the 75 μm pore sieve was collected again and the grinding, sieving, and rinsing steps were repeated until the remaining cysts are extracted.

Egg Centrifugation. Eggs were further separated from small debris by centrifugation with sucrose. A sucrose solution was made by adding 495 g of white cane sugar into a 1L bottle and filling up to the 1L measurement with DI water. The mixture was stored at 4° C. until ready to use. Approximately 25 ml of sucrose solution was added to each 50 ml conical tube. Then the egg inoculum was mixed to evenly distribute eggs and the inoculum was poured into the prepared conical tubes until the total inoculum volume was distributed. The tubes were then centrifuged at 1040 rpm for 1 minute. Nematode eggs float at the top of the solution in the centrifuged tubes. A sieve stack was made using 3″ diameter sieves, with a 75 μm pore sieve on top of a 25 μm pore sieve. The top half of the tube contents were poured though the sieves and rinsed with water to wash away the sugar solution. The eggs were collected from the 25 μm pore sieve by rinsing the 75 μm pore sieve into the 25 μm pore sieve. Eggs were captured on the 25 μm pore sieve. The 25 μm pore sieve was held at an angle and gently rinsed with water to collect all the eggs into a small pool at the bottom. The eggs were carefully collected into a storage container using a wash bottle. The eggs were enumerated at 40× magnification using an inverted microscope. Eggs to be used for in planta screening were standardized to 2000 eggs/mL.

### Example 18. In-Vitro Nematode Supernatant Assay

RKN and SCN eggs were collected as described above. A hatching environment was prepared by lining a small sterile container with a clean wood fiber based delicate task tissue and saturating the tissue with deionized water. The collected eggs were mixed with a sugar solution and centrifuged at 240 g for one minute. The supernatant containing the eggs was poured through a 25 μm pore sieve. Sterilized deionized water was used to collect eggs from the 25 μm pore sieve into a sterile 100 mL glass beaker, and the egg concentration was standardized to 100±10 per 10 μL with sterile deionized water. A control treatment was prepared by adding 2 μL abamectin to 78 μL of sterile deionized water per replicate.

In-vitro Screening Protocol One negative control (media lacking endophyte) well was prepared for each plate. Sterilized deionized water and then endophytes (Total volume: 80 μL) were aliquoted in each treatment well of the 96 well plate.

Two days before the plates were read, the plates were moved to a chemical fume hood, and 10 μL of propidium iodide (0.2 mM) was added to each treatment and control well. The plates were resealed with two layers of parafilm and the plates were incubated in the dark for an additional two days.

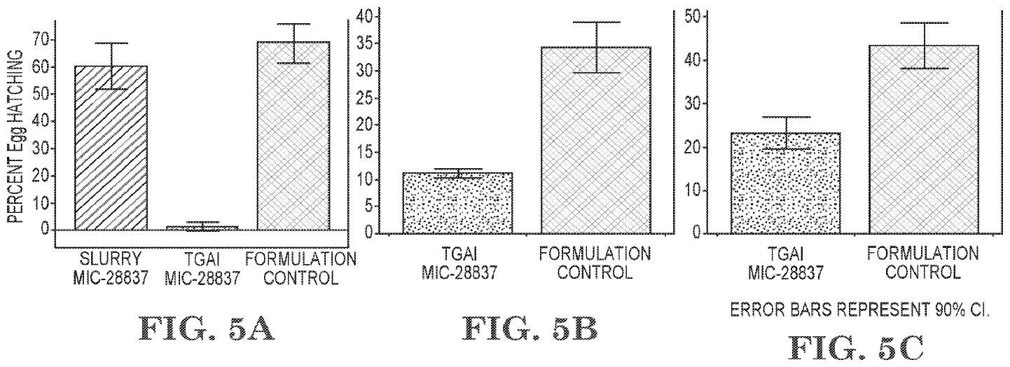

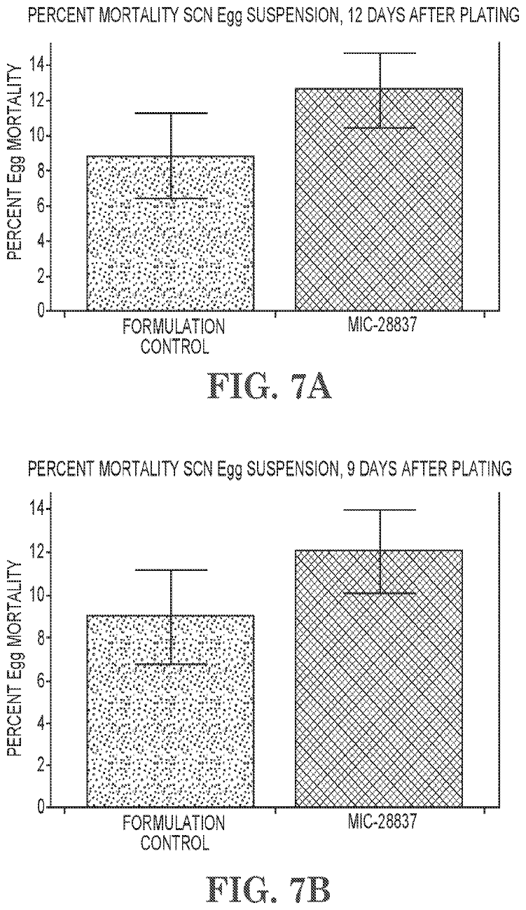

Each well was reviewed manually using the bright field filter on a BioTek Cytation 5 Cell Imaging Multimode Reader (Agilent, Santa Clara, CA, USA), and the number of J2 juveniles was counted and recorded as “J2 hatched”. If any juveniles were initially recorded in that well, the count of prior juveniles was subtracted “J2 hatched” so that the metric value only includes juveniles hatched during the incubation period of the test. The well was then surveyed using the propidium iodide filter on the BioTek Cytation and the number of dead eggs counted. Propidium iodide (which binds to dead cells) causes dead eggs to fluoresce red through the center of the eggs. Samples which were not easily viewed were diluted with 100 μL DI water and the entire contents of the well visualized and counted as above. The percent mortality and percent hatched were calculated for each well. Two independent experiments found an increase in egg mortality for SCN eggs treated with MIC-28837 (see FIG. 7A and FIG. 7B). Three independent experiments found a decrease in egg hatch rate for SCN eggs treated with MIC-28837 (see FIG. 5A, FIG. 5B, and FIG. 5C). No activity (increase in egg mortality or decrease in egg hatching rate) was observed in RKN eggs.

### Example 19. Greenhouse Assessment of Improved Plant Health Under Biotic Stress (Soybean Cyst Nematode)

This example describes an exemplary method by which improved plant health of endophyte treated plants may be shown in a growth environment comprising the crop pest soybean cyst nematode (Heterodera glycines).

Greenhouse assays were conducted using soybean seeds (treated with Bradyrhizobium at half commercially applicable application rate) coated with one or more of the endophytes described herein and formulation control (lacking the one or more heterologously disposed endophytes), chemical controls (a commercially available chemical nematicide), and no-stress controls (lacking the one or more heterologously disposed endophyte, plants not grown under stress conditions). All seeds were treated with a half strength Bradyrhizobium prior to endophyte treatment. Each endophyte treatment and each control was replicated fourteen times.

Bradyrhizobium treatment was prepared by adding 60 μL of Bradyrhizobium (normalized to a concentration to 10\hat{ }6 CFU per mL) to 16 μL of microbial extender comprising sugars, proteins, oil, an emulsifier, and 72 μL sterile deionized water. Seeds were treated 100 at a time by adding 18 μL of the Bradyrhizobium treatment, shaking the seeds to ensure even distribution of the Bradyrhizobium treatment. Endophyte treatments were normalized to a concentration to 10\hat{ }6 CFU per mL, and 3 μL per soybean seed endophyte solution was added to each batch of 100 seeds and well mixed.

Sand growing media was prepared for the containers by thoroughly combining 10.5 L sand, 100 mL garden lime, and 900 mL of water in a cement mixer. When thoroughly mixed, the sand mixture was dispensed to each container to obtain the needed number of containers. The container was placed in a deep pan and water was added until the soil in the cones is saturated. One soybean seed was planted 1.5 cm deep in each container.

Eggs were extracted from nematode population stock pots and diluted to approximately 8000 eggs/mL for new screening, or 4000 eggs/mL for repeated assays. A repeater pipette was used to mix the sample. One ml containing the suspended nematode eggs was pipetted into each cone at planting. The containers were covered in plastic wrap and moved to a growth chamber. Plastic was removed after 1-2 days and automated irrigation begun. Plants were grown for approximately 28-32 days.

Phenotyping was performed as follows.

A Phenospex automated phenotyping system (Phenoxpex, Heerlen, The Netherlands) was used to scan plants. 14 plants per treatment were placed the appropriate locations (to match the 2×7 layout) in a set of empty containers on a table under the camera unit. The plants were adjusted so that leaves would not overlap of fall outside the frame. A scan was be initiated from the computer and each scan to ensure no overlapping images, and the time of the scan, experiment number, and plant plot numbers (a unique plant identifier corresponding to a specific treatment) for the scan were recorded.

After all scans were complete the image data would be exported from the Phenospex. The data included NDVI average, PSRI average, NDVI plant, Digital Biomass, and Greenness Average. The measurements for individual plants for each treatments were averaged.

TABLE 6
Improved plant health under biotic stress (soybean cyst nematode)

| | | Metric | Treatment | treatmet_{—} |
|---|---|---|---|---|
| Treatment | Metric | unit | mean | stderr |
| MIC-12479 | Cysts per Root weight | count/g | 284 | 10 |
| MIC-28837 | Cysts per Root weight | count/g | 82 | 9 |
| MIC-68350 | Cysts pcr Root weight | count/g | 258 | 16 |
| MIC-87992 | Cysts per Root weight | count/g | 237 | 25 |
| MIC-56767 | Digital Biomass | mm4 | 227342 | 47723 |
| MIC-61317 | Digital Biomass | mm5 | 0.3 | 0.01 |
| MIC-68350 | Digital Biomass | mm4 | 0.22 | 0.02 |
| MIC-83040 | Digital Biomass | mm3 | 750325 | 93021 |
| MIC-87992 | Digital Biomass | mm3 | 0.23 | 0.02 |
| MIC-56767 | Greenness Average | index | 0.14 | 0.02 |
| MIC-83040 | Greenness Average | index | 0.27 | 0.01 |
| MIC-56767 | NDVI average | index | 0.21 | 0.04 |
| MIC-83040 | NDVI average | index | 0.57 | 0.01 |
| MIC-12479 | NDVI plant | index | 0.54 | 0.03 |
| MIC-28837 | NDVI plant | index | 0.58 | 0.03 |
| MIC-61317 | NDVI plant | index | 0.64 | 0.04 |
| MIC-68350 | NDVI plant | index | 0.68 | 0.01 |
| MIC-87992 | NDVI plant | index | 0.66 | 0.02 |
| MIC-56767 | PSRI average | index | 0.16 | 0.02 |
| MIC-61317 | PSRI average | index | 0.24 | 0.02 |
| MIC-68350 | PSRI average | index | 0.23 | 0.02 |
| MIC-83040 | PSRI average | index | 0.1 | 0.01 |
| MIC-87992 | PSRI average | index | 0.26 | 0.03 |

### Example 20. In-Planta Screening Assay with Nematodes

This example describes an exemplary method by which improved plant health of endophyte treated plants may be shown in a growth environment comprising the crop pest soybean cyst nematode (Heterodera glycines) and or root knot nematode (Meloidogyne sp.).

Greenhouse assays were conducted using soybean seeds coated with one or more of the endophytes described herein and formulation control (lacking the one or more heterologously disposed endophytes), chemical controls (a commercially available chemical nematicide), and no-stress controls (lacking the one or more heterologously disposed endophyte, plants not grown under stress conditions). Each endophyte treatment and each control was replicated ten times per treatment.

Endophyte treatments were normalized to a concentration to 10\hat{ }6 CFU per mL, and 3 μL per soybean seed endophyte solution was added to each batch of 100 seeds and well mixed.

Sand growing media was prepared for the containers by thoroughly combining 10.5 L sand, 100 mL garden lime, and 900 mL of water in a cement mixer. When thoroughly mixed the sand mixture was dispensed to each container to obtain the needed number of containers. The container is placed in a deep pan and water is added until the soil in the cones is saturated. One soybean seed was planted 1.5 cm deep in each container.

Eggs were extracted from nematode population stock pots and diluted to approximately 8000 eggs/mL for new screenings, or 4000 eggs/mL for repeated assays. A repeater pipette was used to mix the sample. One ml containing the suspended nematode eggs was pipetted into each cone at planting. The containers were covered in plastic wrap and moved to a growth chamber. Plastic was removed after 1-2 days and automated irrigation begun. Plants were grown for 7 days, after which roots were harvested, weighed, cleared with bleach, and stained with Fuchsin and acetic acid. Juveniles were manually counted under a dissecting stereoscope and data analyzed with LME. The number of juveniles per gram of fresh root tissue was measured for each plant.

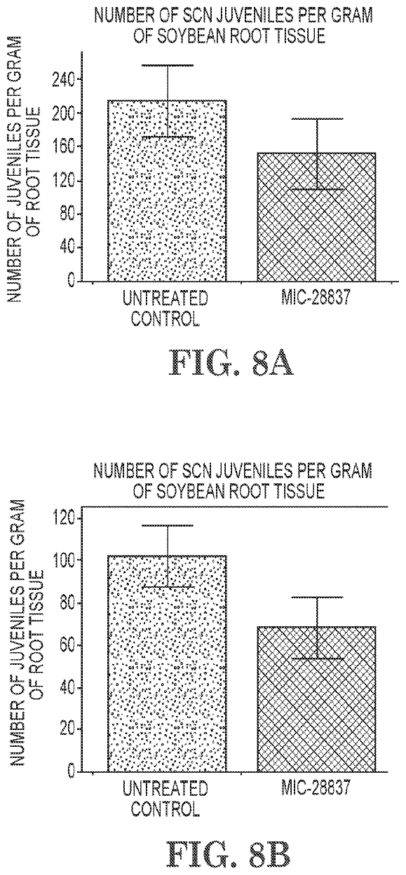

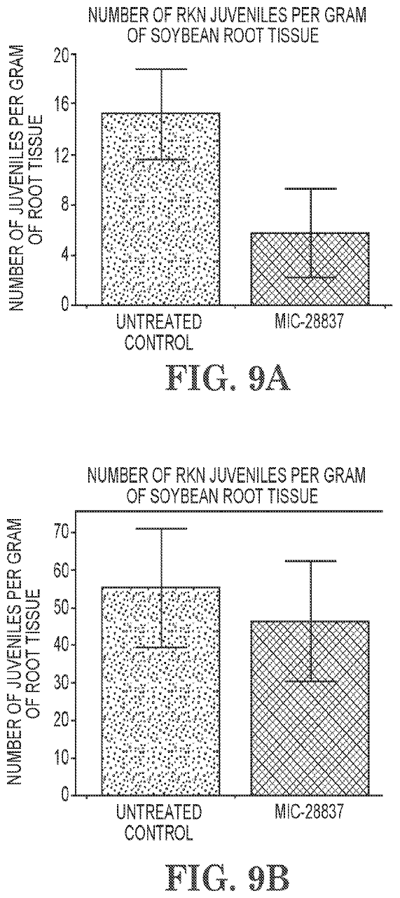

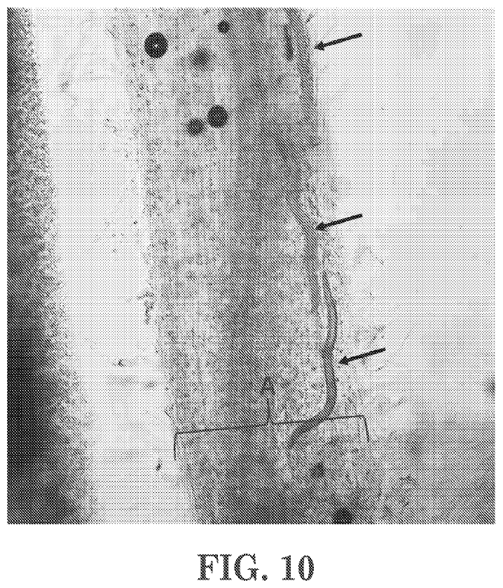

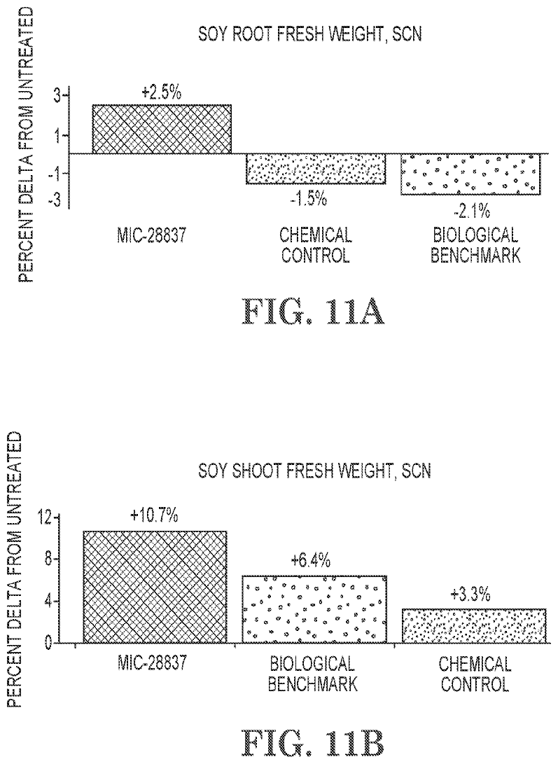

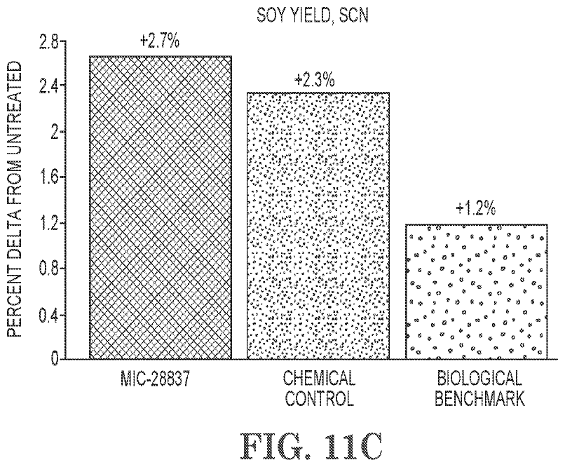

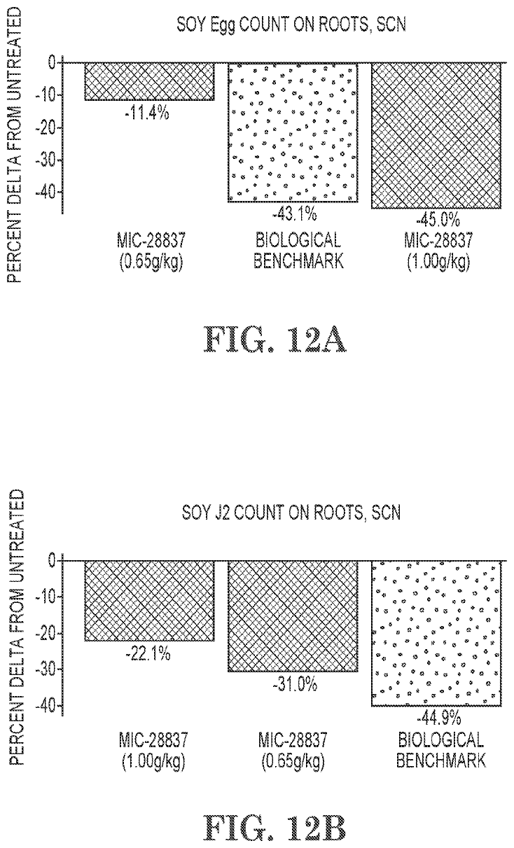

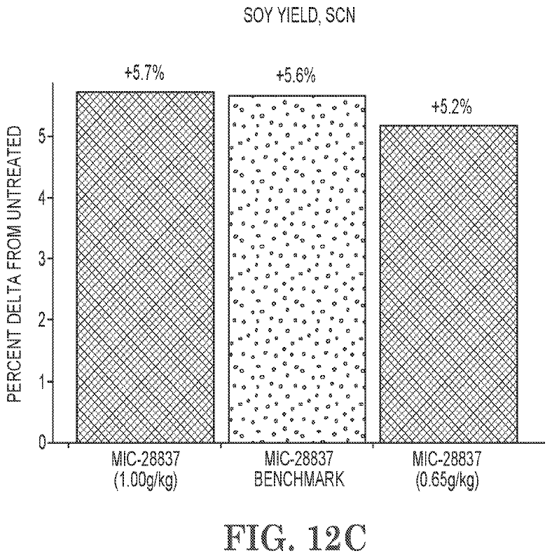

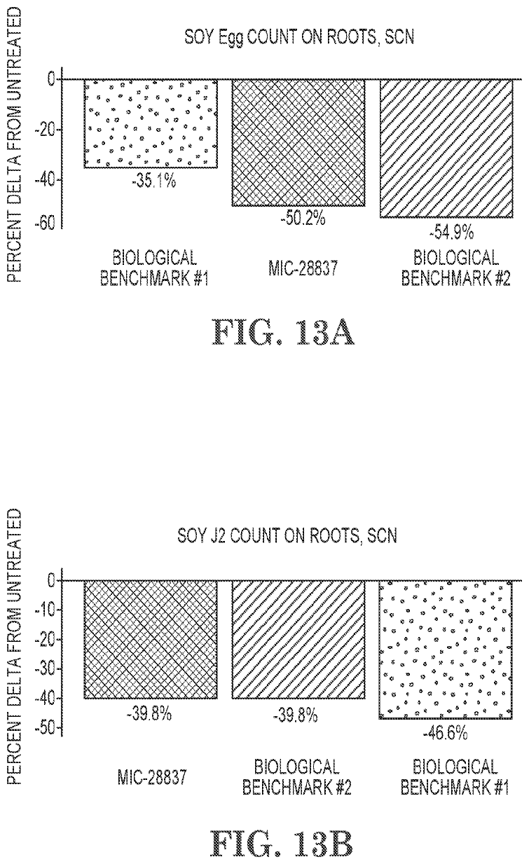

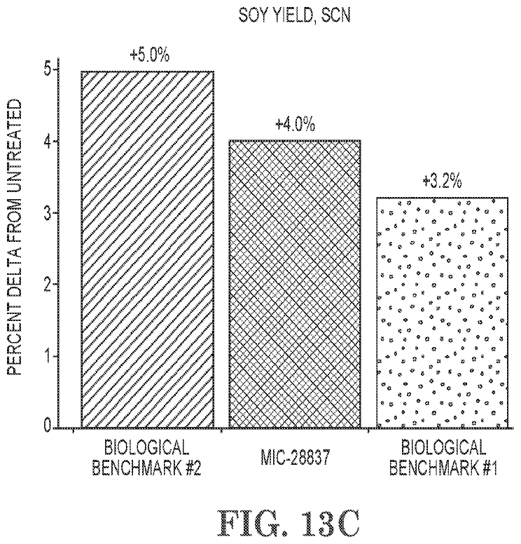

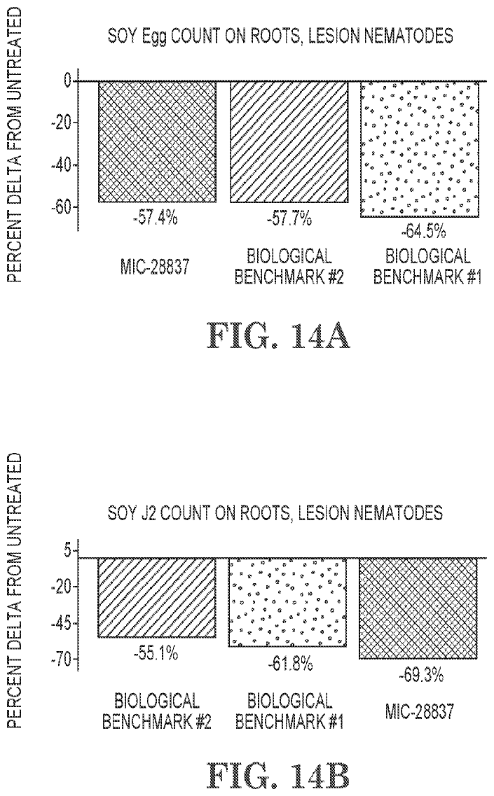

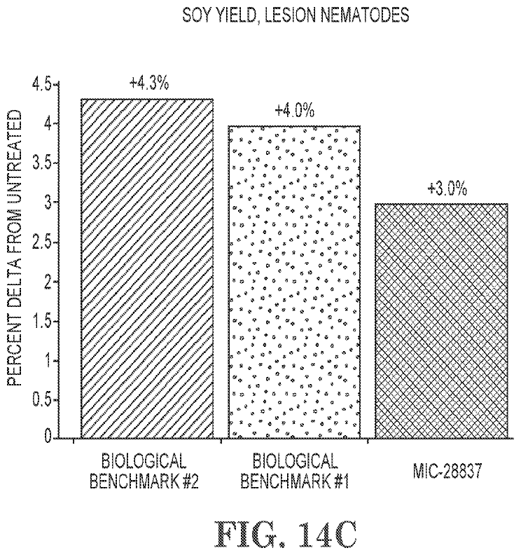

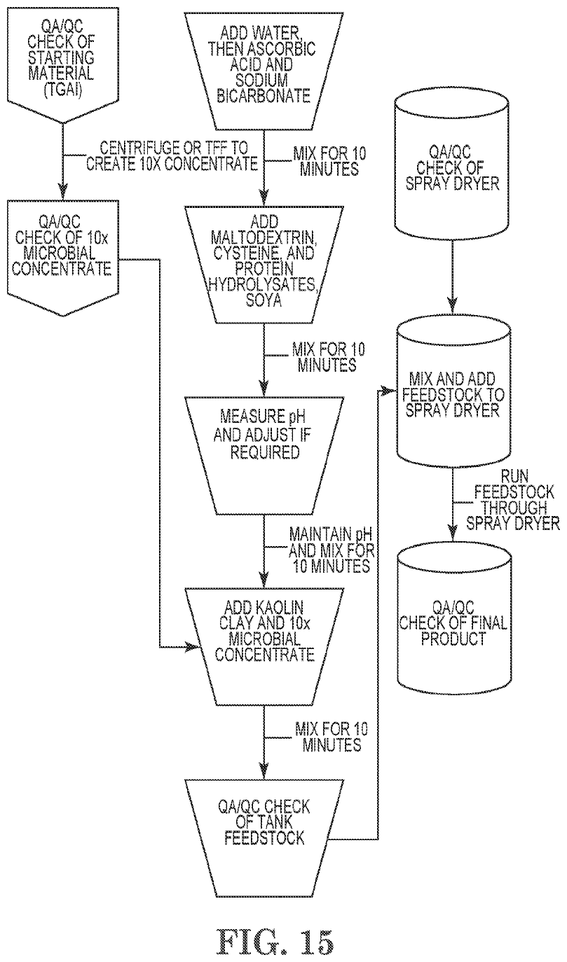

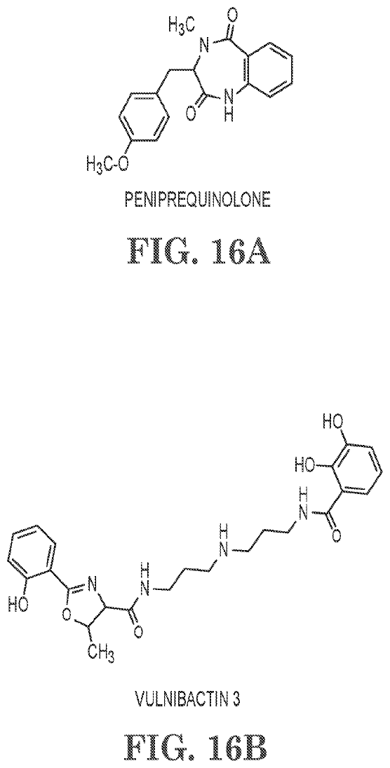

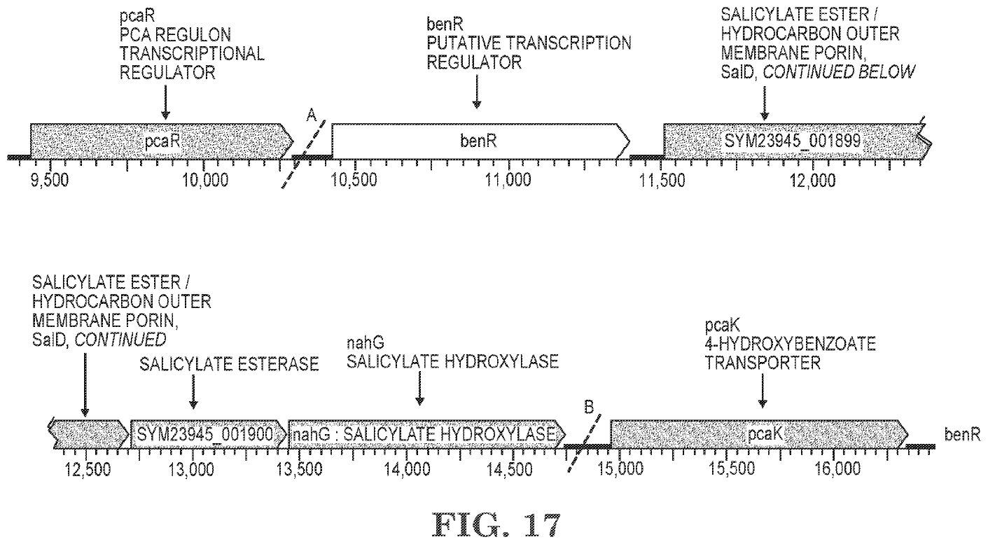

The experiment was repeated 3 times with SCN, and 2 times with RKN. Treatment with MIC-28837 significantly (p-value less than or equal to 0.05) reduced the number of juveniles per gram of fresh root tissue in two out of three SCN experiments (see FIG. 8A and FIG. 8B). Treatment with MIC-28837 significantly (p-value less than or equal to 0.05) reduced the number of juveniles per gram of fresh root tissue in one out of two RKN experiments (see FIG. 9A and FIG. 9B).

### Example 21. Greenhouse Assessment of Improved Plant Health Under Biotic Stress (Soybean Aphid)

This example describes an exemplary method by which improved plant health of endophyte treated plants may be shown in a growth environment comprising the crop pest soybean aphid (Aphis glycines).

Greenhouse assays are conducted using soybean seeds (optionally, chemically treated soybean seeds) coated with one or more of the endophytes described herein and formulation control (lacking the one or more heterologously disposed endophytes) and untreated controls (lacking formulation and the one or more heterologously disposed endophyte) as described in herein. Microbe treated soybean seeds are planted, infected with soybean aphids (Aphis glycines), maintained in grow rooms, and phenotyped.

In one embodiment, the following method is used. 98 cones are placed in each container to obtain the needed number of containers. Masks are placed over cones and cones are filled with potting medium or soil. The container is placed in a deep pan and water is added until the soil in the cones is saturated. One soybean seed is planted in each container. Each container is placed in a growth tub and watered.

A community of soybean aphids is maintained on a stock of soybean plants. To prepare for infestation of the experimental plants, leaves are removed from infested soybean plants from the stock community. One or more leaves are examined under a stereoscope to make sure the aphids are alive and vigorous. Infested leaf cutlets are placed in square plates to keep leaves alive until the treatment plants are infested with aphids. In some embodiments, 20 infested leaf cutlets are used per each 98-cone tray used in the experiment. The infested leaf cutlets are introduced to the growth environment of the experimental plants at planting or the desired number of days after planting, in some embodiments, 9 days after planting. The experimental containers are infested following an infestation pattern to allow for aphid choice feeding in planta. The infested experimental plants are maintained in their growth environment until phenotyping.

The plants may be phenotyped at one or more times after infestation, for example 1 day, 4 days, 7 days or more after infestation. Measurement of one or more traits of agronomic importance is performed as follows. The height of each plant is measured, e.g., by placing the ruler on the lip of a cell and measuring the plant's height to the nearest millimeter or using an automated tool such as a Phenospex PlantEye 3D laser scanner (Phenospex B. V., Heerlen, The Netherlands). Other traits of agronomic importance, for example the greenness of the plants and the leaf and/or above ground plant area, may be measured either manually or using a tool such as the Phenospex PlantEye 3D laser scanner. The mass of each plant may be measuredvia destructive sampling, for example, by cutting the plant at the soil surface, placing the shoot in the weighing container, allowing the weight to stabilize, and autorecording the mass via the scale's software. The experimental plants may be maintained through their reproductive stages, and traits of agronomic importance such as number of flowers, number of pods and number of seeds per pod may be measured.

### Example 22. Field Assessment of Improved Plant Health of Soy Under Biotic Stress

This example describes an exemplary method by which improved plant health of endophyte treated plants were shown in a growth environment comprising Heterodera glycines or Pratylenchus brachyurus. This assay utilized soybeans and corn.

Field trials were conducted using soybeans and corn seeds coated with one or more of the endophytes described herein and controls (untreated). Replicate plots were planted per endophyte or control treatment in a randomized complete block design. Each plot consisted of an approximately 7.62 m (25 ft.) by 0.76 m (2.5 ft.) row. The following growth metrics were measured: yield, egg count on root at V8 (measured at 45 days after full emergence), J2 count on root at R6 (75 days after full emergence), root fresh weight (measured at 17 days after full emergence), and shoot fresh weight (measured at 17 days after full emergence).

At the end of the field trial employing endophyte treatment and control treatment plants, plants were randomly dug out from each row, kept in a plastic bag, and brought back to lab for metric measurements. For each seedling, shoot and root were separated by cutting the seedling 3 cm from the first branch of the root.

Summary statistics are generated using ggplot2 package of R (R Core Team, 2016. R: A language and environment for statistical computing. R Foundation for Statistical Computing, Vienna, Austria. R-project.org/).

TABLE 7
Plant phenotypes under biotic stress of endophyte-treated and control plants in field conditions.

| | Experimental | N Per | | | Value | | Treatment | | |
|---|---|---|---|---|---|---|---|---|---|
| Treatment | Replicates | Replicate | Metric | Value | Descriptor | Formulation | Concentration | Crop | Condition |
| MIC- | 4 | 16 | yield | 4 | percent change | flowable | 1.91E+05 | Soybeans | Heterodera |
| 28837 | | | | | untreated | powder (FP) | CFU/seed | | glycines |
| | | | | | control | | | | |
| MIC- | 4 | 16 | yield | 1.2 | bushel/acre | flowable | 1.91E+05 | Soybeans | Heterodera |
| 28837 | | | | | average change | powder (FP) | CFU/seed | | glycines |
| | | | | | vs untreated | | | | |
| | | | | | control | | | | |
| MIC- | 4 | 16 | yield | 82 | kg/hectacre | flowable | 1.91E+05 | Soybeans | Heterodera |
| 28837 | | | | | average change | powder (FP) | CFU/seed | | glycines |
| | | | | | vs untreated | | | | |
| | | | | | control | | | | |
| MIC- | 4 | 16 | yield | 69 | percent | flowable | 1.91E+05 | Soybeans | Heterodera |
| 28837 | | | | | win rate | powder (FP) | CFU/seed | | glycines |
| MIC- | 4 | 16 | egg count | −50.2 | percent change | flowable | 1.91E+05 | Soybeans | Heterodera |
| 28837 | | | on root | | untreated | powder (FP) | CFU/seed | | glycines |
| | | | at V8 | | control | | | | |
| MIC- | 4 | 16 | J2 count | −39.8 | percent change | flowable | 1.91E+05 | Soybeans | Heterodera |
| 28837 | | | on root | | untreated | powder (FP) | CFU/seed | | glycines |
| | | | at R6 | | control | | | | |
| MIC- | 4 | 16 | yield | 4 | percent change | flowable | 1.91E+05 | Soybeans | Pratylenchus |
| 28837 | | | | | untreated | powder (FP) | CFU/seed | | brachyurus |
| | | | | | control | | | | |
| MIC- | 4 | 16 | yield | 1 | bushel/acre | flowable | 1.91E+05 | Soybeans | Pratylenchus |
| 28837 | | | | | average change | powder (FP) | CFU/seed | | brachyurus |
| | | | | | vs untreated | | | | |
| | | | | | control | | | | |
| MIC- | 4 | 16 | yield | 69 | kg/hectacre | flowable | 1.91E+05 | Soybeans | Pratylenchus |
| 28837 | | | | | average change | powder (FP) | CFU/seed | | brachyurus |
| | | | | | vs untreated | | | | |
| | | | | | control | | | | |
| MIC- | 4 | 16 | yield | 69 | percent | flowable | 1.91E+05 | Soybeans | Pratylenchus |
| 28837 | | | | | win rate | powder (FP) | CFU/seed | | brachyurus |
| MIC- | 4 | 16 | egg count | −57.7 | percent change | flowable | 1.91E+05 | Soybeans | Pratylenchus |
| 28837 | | | on root | | untreated | powder (FP) | CFU/seed | | brachyurus |
| | | | at V8 | | control | | | | |
| MIC- | 4 | 16 | J2 count | −61.8 | percent change | flowable | 1.91E+05 | Soybeans | Pratylenchus |
| 28837 | | | on root | | untreated | powder (FP) | CFU/seed | | brachyurus |
| | | | at R6 | | control | | | | |
| MIC- | 3 | 18 | yield | 4.9 | percent change | water | 2.97E+04 | Soybeans | Heterodera |
| 28837 | | | | | untreated | dispersion | CFU/seed | | glycines |
| | | | | | control | (WD) | | | (natural |
| | | | | | | | | | infestation) |
| MIC- | 3 | 18 | yield | 3.9 | bushel/acre | water | 2.97E+04 | Soybeans | Heterodera |
| 28837 | | | | | average change | dispersion | CFU/seed | | glycines |
| | | | | | vs untreated | (WD) | | | (natural |
| | | | | | control | | | | infestation) |
| MIC- | 3 | 18 | yield | 89 | percent | water | 2.97E+04 | Soybeans | Heterodera |
| 28837 | | | | | win rate | dispersion | CFU/seed | | glycines |
| | | | | | | (WD) | | | (natural |
| | | | | | | | | | infestation) |
| chemical | 3 | 18 | yield | 2.3 | percent change | water | 2.97E+04 | Soybeans | Heterodera |
| nematicide | | | | | untreated | dispersion | CFU/seed | | glycines |
| control | | | | | control | (WD) | | | (natural |
| | | | | | | | | | infestation) |
| chemical | 3 | 18 | yield | 1.8 | bushel/acre | water | 2.97E+04 | Soybeans | Heterodera |
| nematicide | | | | | average change | dispersion | CFU/seed | | glycines |
| control | | | | | vs untreated | (WD) | | | (natural |
| | | | | | control | | | | infestation) |
| chemical | 3 | 18 | yield | 78 | percent | water | 2.97E+04 | Soybeans | Heterodera |
| nematicide | | | | | win rate | dispersion | CFU/seed | | glycines |
| control | | | | | | (WD) | | | (natural |
| | | | | | | | | | infestation) |
| MIC- | 3 | 18 | root fresh | 4.1 | percent change | water | 2.97E+04 | Soybeans | Heterodera |
| 28837 | | | weight | | untreated | dispersion | CFU/seed | | glycines |
| | | | | | control | (WD) | | | (natural |
| | | | | | | | | | infestation) |
| MIC- | 3 | 18 | root fresh | −13.2 | percent change | water | 2.97E+04 | Soybeans | Heterodera |
| 28837 | | | weight | | untreated | dispersion | CFU/seed | | glycines |
| | | | | | control | (WD) | | | (natural |
| | | | | | | | | | infestation) |
| MIC- | 3 | 18 | shoot fresh | 7.7 | percent change | water | 2.97E+04 | Soybeans | Heterodera |
| 28837 | | | weight | | untreated | dispersion | CFU/seed | | glycines |
| | | | | | control | (WD) | | | (natural |
| | | | | | | | | | infestation) |
| MIC- | 3 | 18 | shoot fresh | −16.5 | percent change | water | 2.97E+04 | Soybeans | Heterodera |
| 28837 | | | weight | | untreated | dispersion | CFU/seed | | glycines |
| | | | | | control | (WD) | | | (natural |
| | | | | | | | | | infestation) |
| MIC- | 2 | 15 | yield | 5.7 | percent | flowable | 1.96E+05 | Corn | Heterodera |
| 28837 | | | | | change | powder (FP) | CFU/seed | | glycines |
| | | | | | untreated | | | | (natural |
| | | | | | control | | | | infestation) |
| MIC- | 2 | 15 | yield | 11.6 | bushel/acre | flowable | 1.96E+05 | Corn | Heterodera |
| 28837 | | | | | average change | powder (FP) | CFU/seed | | glycines |
| | | | | | vs untreated | | | | (natural |
| | | | | | control | | | | infestation) |
| MIC- | 2 | 15 | yield | 80 | percent | flowable | 1.96E+05 | Corn | Heterodera |
| 28837 | | | | | win rate | powder (FP) | CFU/seed | | glycines |
| | | | | | | | | | (natural |
| | | | | | | | | | infestation) |

### Example 23. Field Assessment of Improved Plant Health

This example describes an exemplary method by which improved plant health of endophyte treated plants were shown in field conditions.

Field trials were conducted using soybeans coated with one or more of the endophytes described herein and controls (untreated). Replicate plots were planted per endophyte or control treatment in a randomized complete block design. Each plot consisted of an approximately 7.62 m (25 ft.) by 0.76 m (2.5 ft.) row. Plots were under drought stress through reproductive growth. Drought stress was characterized as 2 inches or less of required water in the 21 days preceding flowering and 3.5 inches or less of required water from flowering through physiological maturity. The following growth metrics were measured: yield.

Summary statistics are generated using ggplot2 package of R (R Core Team, 2016. R: A language and environment for statistical computing. R Foundation for Statistical Computing, Vienna, Austria. R-project.org/).

TABLE 8
Plant phenotypes of endophyte-treated and control plants in field conditions.

| | Experimental | N Per | | | Value | | Treatment |
|---|---|---|---|---|---|---|---|
| Treatment | Replicates | Replicate | Metric | Value | Descriptor | Formulation | Concentration |
| MIC- | 36 | 143 | yield | 0.01 | percent change | water | 2.97E+04 |
| 28837 | | | | | untreated | dispersion | CFU/seed |
| | | | | | control | (WD) | |
| MIC- | 36 | 143 | yield | 0 | change from | water | 2.97E+04 |
| 28837 | | | | | untreated | dispersion | CFU/seed |
| | | | | | bushel/acre | (WD) | |
| MIC- | 36 | 143 | yield | 52 | percent win | water | 2.97E+04 |
| 28837 | | | | | rate | dispersion | CFU/seed |
| | | | | | | (WD) | |

### Example 24. Method of Determining Seed Nutritional Quality Trait Component: Fat

Seed samples from harvested plants are obtained as described herein. Analysis of fat is conducted on replicate samples according to the Association of Official Agricultural Chemists Reference Method AOAC 920.39, of the Official Methods of Analysis of AOAC International, 20th Edition (2016), herein incorporated by reference in its entirety. Samples are weighed onto filter paper, dried, and extracted in hot hexane for 4 hours, using a Soxlhet system. Oil is recovered in pre-weighed glassware, and % fat is measured gravimetrically. Mean percent changes between the treatment (endophyte-treated seed) and control (seed treated with the formulation but no endophyte) are calculated.

### Example 25. Method of Determining Seed Nutritional Quality Trait Component: Ash

Seed samples from harvested plants are obtained as described herein. Analysis of ash is conducted on replicate samples according to the Association of Official Agricultural Chemists Reference Method AOAC 920.39, of the Official Methods of Analysis of AOAC International, 20th Edition (2016). Samples are weighed into pre-weighed crucibles, and ashed in a furnace at 600° C. for 3 hours. Weight loss on ashing is calculated as % ash. Mean percent changes between the treatment (one or more heterologously disposed endophytes) and control (lacking the one or more heterologously disposed endophytes) with the formulation but no endophyte are calculated

### Example 26. Method of Determining Seed Nutritional Quality Trait Component: Fiber

Seed samples from harvested plants are obtained as described herein. Analysis of fiber is conducted on replicate samples according to the Association of Official Agricultural Chemists Reference Method AOAC 920.39, of the Official Methods of Analysis of AOAC International, 20th Edition (2016). Samples are weighed into filter paper, defatted and dried, and hydrolyzed first in acid, then in alkali solution. The recovered portion is dried, weighed, ashed at 600° C., and weighed again. The loss on ashing is calculated as % Fiber. Mean percent changes between the treatment (one or more heterologously disposed endophytes) and control (lacking the one or more heterologously disposed endophytes) with the formulation but no endophyte are calculated.

### Example 27. Method of Determining Seed Nutritional Quality Trait Component: Moisture

Seed samples from harvested plants are obtained as described herein. Analysis of moisture is conducted on replicate samples according to the Association of Official Agricultural Chemists Reference Method AOAC 920.39, of the Official Methods of Analysis of AOAC International, 20th Edition (2016). Samples are weighed into pre-weighed aluminum dishes, and dried at 135° C. for 2 hours. Weight loss on drying is calculated as % Moisture. Mean percent changes between the treatment (one or more heterologously disposed endophytes) and control (lacking the one or more heterologously disposed endophytes) with the formulation but no endophyte are calculated.

### Example 28. Method of Determining Seed Nutritional Quality Trait Component: Protein

Seed samples from harvested plants are obtained as described herein. Analysis of protein is conducted on replicate samples according to the Association of Official Agricultural Chemists Reference Method AOAC 920.39, of the Official Methods of Analysis of AOAC International, 20th Edition (2016). Samples are combusted and nitrogen gas is measured using a combustion nitrogen analyzer (Dumas). Nitrogen is multiplied by 6.25 to calculate % protein. Mean percent changes between the treatment (one or more heterologously disposed endophytes) and control (lacking the one or more heterologously disposed endophytes) with the formulation but no endophyte) are calculated.

### Example 29. Method of Determining Seed Nutritional Quality Trait Component: Carbohydrate

Seed samples from harvested plants are obtained as described herein. Analysis of carbohydrate is determined for replicate samples as a calculation according to the following formula: Total Carbohydrate=100%−% (Protein+Ash+Fat+Moisture+Fiber), where % Protein is determined according to the method described herein, % Ash is determined according to the method described herein, % Fat is determined according to the method described herein, % Moisture is determined according to the method described herein, and % Fiber is determined according to the method described herein. Mean percent changes between the treatment (one or more heterologously disposed endophytes) and control (lacking the one or more heterologously disposed endophytes) are calculated.

### Example 30. Method of Determining Seed Nutritional Quality Trait Component: Calories

Seed samples from harvested plants are obtained as described herein. Analysis of Calories is determined for replicate samples as a calculation according to the following formula: Total Calories=(Calories from protein)+(Calories from carbohydrate)+Calories from fat), where Calories from protein are calculated as 4 Calories per gram of protein (as determined according to the method described herein), Calories from carbohydrate are calculated as 4 Calories per gram of carbohydrate (as determined according to the method described herein), and Calories from fat are calculated as 9 Calories per gram of fat (as determined according to the method described herein). Mean percent changes between the treatment (one or more heterologously disposed endophytes) and control (lacking the one or more heterologously disposed endophytes) are calculated.

### Example 31. Preparation of RTU Formulations

### Water Dispersed RTU Formulation

Water dispersed endophyte formulations comprise microorganism biomass in liquid fermentation broth that may be diluted in a buffered carrier such as phosphate buffered saline as well as a preservative and/or a pH adjusting agent. Water dispersed RTU formulation comprising MIC-28837 was prepared for the formulation stability assay at an initial concentration of 1E+09 CFU/mL. When applied to seeds, the volume of seeds was used to determine the volume of endophyte in water dispersion formulation needed for the target dose per seed. A target dose of 1E+05 CFU/seed was prepared for the on-seed stability assay (results shown in FIGS. 18A and 18B). The calculated volume of endophyte formulation was added to the seeds in a clean mixing vessel. The seeds and endophyte formulation were mixed for at least 30 seconds to ensure the endophyte formulation was well dispersed on the seeds.

### Oil Dispersed RTU Formulations

Oil dispersion formulations comprise microorganism biomass, a vegetable oil-based carrier, and one or more of a dispersant, and/or a rheology modifier.

### Flowable Powder RTU Formulations

Flowable powder microorganism formulations comprise talc, mineral oil base, and spray dried, lyophilized, or solid-state fermentation produced endophyte. A target dose of 1E+05 CFU/seed was prepared for the on-seed stability assay (results shown in FIGS. 18A and 18B).

### Example 32. Preparation of Dried Powder Intermediate Compositions

### Spray Dried Intermediate Compositions

This example describes a method for producing a spray dried powder intermediate product (MUP) used for shipping and storage stability of biological compositions.

Cell Concentration. Concentration of TGAI material was confirmed using a liquid viability protocol consisting of: 1) making series of serial dilutions from the whole culture produced in Example 4, using a buffer at physiological pH (e.g. PBS, 50 mM MOPS-Buffered Saline, Tris) as a diluent, and 2) plating 100 μl from the target dilutions onto sterile Nutrient Agar (Table 9) or Tryptic Soy Agar petri plates, and 3) incubating plates at 20-30° C. for 24-48 h, and 4) counting colonies to calculate CFU/mL.

TABLE 9
Nutrient Agar

| Component name | CAS | g/L |
|---|---|---|
| Beef extract | 68990-09-0 | 3 |
| Peptone | 73049-73-7 | 5 |
| Sodium chloride | 7647-14-5 | 5 |
| Agar | 9002-18-0 | 15 |

A 10× cell concentrate was then produced, either by batch centrifugation or continuous centrifugation or tangential flow filtration. If using batch centrifugation, the fermentation broth from Example 4 was centrifuged at 5,000-15,000×g for 15-20 minutes at 4-20° C. Ninety percent of the original volume was decanted and the pellet resuspend in the remaining supernatant by vortexing or shaking until the concentrate appeared homogenous. The Liquid Viability Protocol described above was used to confirm 10× microbial concentration. If using continuous centrifugation or tangential flow filtration (TFF) 10× concentration of effluent is targeted based on volume and confirmed using the Liquid Viability Protocol described above.

Feedstock Preparation. Feedstock was prepared by adding the components of the feedstock listed in Table 10 as follows. The required water was added to a mixing tank equipped with a mixer. The required water is the mass of water needed to bring the sum of components in the feedstock to 1 kg. While mixing, the ascorbic acid and sodium bicarbonate were added and mixed for at least 10 minutes (or longer if required for complete dissolution by visual inspection). The maltodextrin, peptone, and cysteine were added and mixed for at least 10 minutes or longer as required for completed dissolution by visual inspection. The pH of the formulation was measured and adjusted to 6.5-7.0 with sodium bicarbonate and/or ascorbic acid, and the mass calculated, and final pH were recorded. The final pH was measured after 10 minutes to ensure the final pH was stable. The kaolin clay and 10× microbial concentrate were stirred into the spray dry formulation, and stirred for at least 10 minutes before proceeding to the spray drying process. The resulting mixture of cells and formulation is referred to as the spray drying feedstock.

TABLE 10
Spray drying feedstock components

| | | F34 for MIC-28837 |
|---|---|---|
| Component | CAS | g/1 kg composition |
| Water | 7732-18-5 | 363 |
| Ascorbic Acid | 50-81-7 | 25-30 |
| Sodium bicarbonate | 144-55-8 | 7-15 |
| Maltodextrin | 9050-36-6 | 130 |
| Peptone | 68607-88-5 | 60 |
| Cysteine | 52-90-4 | 15-25 |

Adjust to pH 6.5-7.0 with sodium bicarbonate or ascorbic acid

| | | |
|---|---|---|
| Kaolin Clay | 1332-58-7 | 100 |
| Microbial concentrate | NA | 300 |

Spray Drying. The spray drying feedstock was constantly mixed during spray drying to prevent settling of insoluble components. The concentration of spray drying feedstock was confirmed using the Liquid Viability Protocol. The spray drying parameters in Table 11 were used.

TABLE 11
Spray drying parameters

| Parameter | Setpoint |
|---|---|
| Inlet Temperature | 90° C.-140° C. |
| Target Outlet Temperature | 60° C. (55° C.-65° C. is acceptable) |

The spray dryer was run to steady state without feedstock, before starting to feed water and again waiting until steady state was reached. Then the spray drying feedstock was begun and maintained to ensure constant feeding to the spray dryer. The final concentration of the spray dried powder was determined using the following Powder Viability Assay: 0.04 to 0.8 g of spray dried powder was weighed into a microcentrifuge tube and the actual weight added was recorded. One mL of sterile 50 mM MOPS-Buffered Saline was added to the powder and vortexed for >5 minutes to ensure the powder was dissolved. Serial dilutions were prepared from the dissolved powder and 100 μl from the target dilutions was plated onto sterile Nutrient Agar petri plates, in triplicate. The plates were incubated at 30° C. for 24-48 h, and colonies counted to calculate CFU/mL. Survival through spray drying process was determined by comparing the concentration of active ingredients in the spray dried powder to the concentration of microbe that is added into the feedstock and accounting for the solids content to determine what the microbe concentration should be when the water is removed. Results of survival through the spray drying process are shown in Table 12.

TABLE 128
Spray drying survival of representative microorganisms. Survival score of 1
represents excellent survival (>75%). A survival score of 2 represents
good survival (40-75%). A survival score of 3 represents fair survival (20-40%).

| | | Formulation | Survival | | | |
|---|---|---|---|---|---|---|
| Strain | Taxonomy | code | score | 4 C. | RT | 35 C. |
| MIC- | Pseudomonas | F27 | 1 | >1000 [177] | >1000 [177] | 940 [177] |
| 28837 | oryzihabitans | | | | | |
| [symbol] | [symbol] | [symbol] | [symbol] | [symbol] | [symbol] | [symbol] |

[symbol]

indicates data missing or illegible when filed

### Lyophilized Intermediate Compositions

Lyophilization. Lyophilization feedstocks are prepared as defined in Table 10 with the omission of kaolin clay. Additional water can be added to the composition to decrease the pre-lyophilization feedstock buffer total solids, but the final powder composition will not be changed. The feedstock is first frozen at −50° C. to −30° C. for a minimum of 4 hours. Primary drying occurs under vacuum as either a ramped temperature or static cycle between −40° C. and 0° C. until greater than 90% of the water is sublimated. Secondary drying is then ramped up to 20° C. and proceeded until the lyophilized cake has a moisture content less than or equal to 5%. The vacuum is broken with ambient air and the lyophilized cake is removed and pulverized manually or milled.

### Packaging and Storage (Optional)

Optionally the powder intermediate product is stored in a heat sealed pouch form, containing desiccant packs approximately 20% of the mass of the spray dried powder. The powders may be stored at refrigeration temperatures between (4-10° C.) or at room temperature.

### Example 5. Procedure for Determining Concentration of Microorganisms

### Plating Spray-Dried and Lyophilized Powders

This example describes an exemplary method for weighing powder synthetic compositions (for example, spray-dried or lyophilized powders) and resuspending powders into a slurry and plating for CFU.

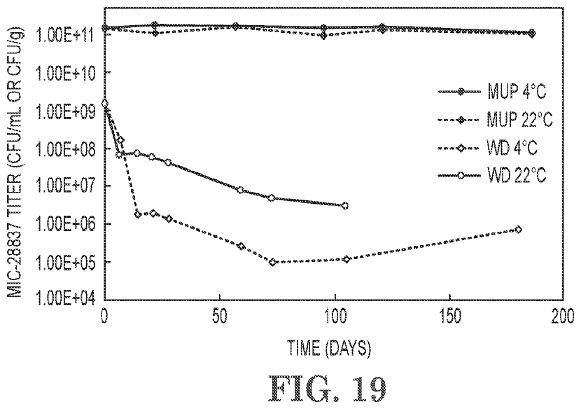

First, 0.0500 g+/−0.0200 g of powder synthetic compositions were aseptically added to a sterile microcentrifuge tube, and the weight of the powder recorded. One mL of sterile buffer (alternate buffers include MOPS, PBS, tris, etc.) was added to the pre-weighed tubes. The tubes were vortexed at high speed for 5-15 minutes. The powder slurry was serially diluted within 30 minutes of resuspending the powder and plated on agar plates for CFU within one hour of the PBS addition. Agar plate types could include TSA, PDB, NA, R2B, etc. depending on the organism. Plates were incubated at room temperature to 37° C. for 1-5 days, colonies were counted, and CFU/g was calculated. The concentration of microorganisms in the MUP powders was measured at repeated intervals by isolating and plating samples collected from the stored samples. Results are shown in Table 13 and FIG. 19.

### Water Dispersed Samples

Water dispersed MIC-28837 RTU samples were serially diluted and plated on TSA plates for CFU. Agar plate types could include TSA, PDB, NA, or R2B, depending on the organism. Plates were incubated at room temperature to 37° C. for 1-5 days, colonies were counted, and CFU/g was calculated. Results are shown in FIG. 19.

### On Seed

Viability of RTU compositions on seeds was determined by the following methods. A 3-gram sample was collected from stored samples of RTU treated seed and placed in a 50 mL falcon tube. 10 mL of sterile buffer (e.g. 1×PBS) was added to each tube and the cap secured. The tubes were then vortexed for 30 minutes, the vortex was observed to ensure that all seeds in the falcon tubes were moving freely. Three 1 mL samples of the solution were transferred to a 96-well plate and plated for CFU as described above. Results for seeds treated with MIC-28837 water dispersed RTU and MIC-28837 flowable powder RTU are shown in FIG. 18A and FIG. 18B.

TABLE 13
Predicted time to 1 log loss of representative microorganisms
stored at 4 C., room temperature (RT), and 35 C.

| | | | Predicted number of days to 1 | | |
|---|---|---|---|---|---|
| | | | log loss [days measured] | | |
| MIC-ID | Formulation | Taxonomy | 4 C. | RT | 35 C. |
| MIC- | F27 | Pseudomonas | >1000 | >1000 | 940 |
| 28837 | | oryzihabitans | [177] | [177] | [177] |
| MIC- | F27 | Pseudomonas | 582 | 522 | 188 |
| 12479 | | oryzihabitans | [183] | [183] | [183] |

The numbers in brackets indicate the day on which the most recent measurement occurred (where the day is the number of days post spray drying). If the days to 1 log loss is less that the number of days in the last measurement this indicates the observed number of days to 1 log loss.
GN = Gram negative bacteria

### Example 31. Production of a Ready to Use Powder Synthetic Composition Suitable for Treating Plants

Spray Dried Intermediate Powder is Combined with Talc and Mineral Oil Base.

### Example 32. Production of Synthetic Fertilizer Compositions

This example describes an exemplary method by which compatibility of synthetic compositions comprising microorganisms and fertilizers is evaluated.

Application rates. Fertilizer compositions are granular in form. Flowable powder (FP) microorganism treatments have a target application rate of 3.6 grams per acre. Synthetic compositions are prepared using different concentrations of microorganism and fertilizer (% w/w), representing between 5-50 times application rate of microorganism to seeds. The FP microorganism treatments are prepared as 0.01% w/w (microorganism/fertilizer), corresponding to an application rate of 0.15 fluid oz (0.28 dry oz.) of microorganism per hundred weight of fertilizer composition, and 0.10% w/w, corresponding to an application rate of 1.54 fluid oz (2.8 dry oz.) of microorganism per hundred weight of fertilizer composition. Synthetic compositions are blended and stored at either 22° C. with between 20-60% relative humidity or 30° C. with 80% relative humidity. Viability of synthetic compositions comprising fertilizer are measured at repeated intervals (for example, 1 week, or 1-month intervals) by isolating and plating samples collected from the stored samples.

### Example 33. Viability Over Time of Microorganisms in Synthetic Fertilizer Compositions

This example describes an exemplary method by which stability of synthetic compositions comprising microorganisms and treatment formulations is evaluated.

Application rates. Fertilizer compositions are granular in form. Flowable powder (FP) microorganism treatments have a target application rate of 3.6 grams per acre. Synthetic compositions are prepared using different concentrations of microorganism and fertilizer (% w/w), representing between 5-50 times application rate of microorganism to seeds. The FP microorganism treatments are prepared as 0.01% w/w (microorganism/fertilizer), corresponding to an application rate of 0.15 fluid oz (0.28 dry oz.) of microorganism per hundred weight of fertilizer composition, and 0.10% w/w, corresponding to an application rate of 1.54 fluid oz (2.8 dry oz.) of microorganism per hundred weight of fertilizer composition. Synthetic compositions are blended and stored at either 22° C. with between 20-60% relative humidity or 30° C. with 80% relative humidity. Viability of synthetic compositions comprising fertilizer are measured at repeated intervals (for example, 1 week, or 1-month intervals by isolating and plating samples collected from the stored samples.

### Example 34. Method of Treating Seeds with Flowable Powder Synthetic Composition

Flowable powder microorganism formulations comprise talc, mineral oil base and spray dried microorganism. The volume of seeds is used to determine the volume of microorganism in a powder formulation needed for the target dose per seed (for example, a powder treatment formulation may comprise 3×10\hat{ }9 CFU/g and be applied at a rate of 1 fl. oz./cwt seed). The seeds to be treated are added to a clean vessel (e.g. a bucket, seed bag, seed box, seed drill, planter box, or seed tender). The calculated volume of microorganism formulation for the desired dose is added to the seeds in the clean vessel. Optionally, the microorganism formulation is mixed for at least 30 seconds to ensure the microorganism formulation is well dispersed on the seeds.

Having illustrated and described the principles of the present invention, it should be apparent to persons skilled in the art that the invention can be modified in arrangement and detail without departing from such principles. It is to be understood that while the invention has been described in conjunction with the detailed description thereof, the foregoing description is intended to illustrate and not limit the scope of the invention, which is defined by the scope of the appended claims. Other embodiments, advantages, and modifications are within the scope of the following claims.

1. A synthetic composition comprising an endophyte of the genus Pseudomonas as an active ingredient, and at least one antioxidant, and at least one saccharide, wherein:
a. the at least one antioxidant is present in the synthetic composition in a ratio of at least 0.1 part antioxidant for each 1 part endophyte biomass by dry weight, and
b. the at least one saccharide is present in the synthetic composition in a ratio of at least 2 parts saccharide by for each 1 part endophyte biomass dry weight.

2. The synthetic composition of claim 1, wherein the endophyte comprises at least one polynucleotide sequence that is at least 97% identical to one or more of SEQ ID NOs. 5-105, or combinations thereof.

3. The synthetic composition of claim 1, wherein the endophyte comprises at least one polynucleotide sequence that is at least 97% identical to one or more of SEQ ID NOs. 5-10, or combinations thereof.

4. The synthetic composition of claim 1, wherein the endophyte comprises one or more genes encoding a protein whose amino acid sequence is selected from SEQ ID NOs. 106-199.

5. The synthetic composition of claim 1, wherein the endophyte is capable of producing at least one siderophore.

6. The synthetic composition of claim 1, wherein the siderophore is vulnibactin 3.

7. The synthetic composition of claim 1, wherein the endophyte genome comprises an region of approximately 5 kilobases in length comprises a polynucleotide sequence that is at least 97% identical SEQ ID NO 83 a polynucleotide sequence that is at least 97% identical SEQ ID NO 85, a polynucleotide sequence that is at least 97% identical SEQ ID NO 84, and a polynucleotide sequence that is at least 97% identical SEQ ID NO 86.

8. The synthetic composition of claim 7, wherein the polynucleotide sequences having at least 97% identical SEQ ID NO 83, SEQ ID NO 84, SEQ ID NO 85, and SEQ ID NO 86 are under common transcriptional control.

9. The synthetic composition of claim 7, wherein the at least 5 kilobase region is located between genes 4-hydroxybenzoate transporter pcaK and pca regulon transcriptional regulator pcaR.

10. The synthetic composition of claim 7, wherein the at least 5 kilobase region is located between a gene encoding a protein having one or more domains having InterPro accession numbers IPR004746, IPR005829, IPR011701, IPR020846, or IPR036259 and gene encoding a protein having one or more domains having InterPro accession numbers IPR005471, IPR012794, IPR014757, IPR029016, IPR036388, or IPR036390.

11. The synthetic composition of claim 7, wherein the least 5 kilobase region is located between genes encoding 4-hydroxybenzoate transporter pcaK and pca regulon transcriptional regulator pcaR.

12. The synthetic composition of claim 7, wherein the pca regulon transcriptional regulator pcaR is located upstream of the at least 5 kilobase region.

13. The synthetic composition of claim 7, wherein the at least 5 kilobase region is approximately 4 kilobases in length.

14. The synthetic composition of claim 1, wherein the endophyte is capable of producing peniprequinolone.

15. The synthetic composition of claim 1, wherein the endophyte is capable of one or more of solubilizing potassium, solubilizing phosphate, producing ACC deaminase, producing a biofilm, producing IAA, or producing catalase.

16. The synthetic composition of claim 1, wherein the endophyte is present in an amount capable of improving a trait of agronomic importance in a plant.

17. The synthetic composition of claim 16, wherein the trait of agronomic importance is selected from the group consisting of yield, root fresh weight, shoot fresh weight, biotic stress tolerance, drought tolerance, and combinations thereof.

18. The synthetic composition of claim 17, wherein the trait of agronomic importance is biotic stress tolerance.

19. The synthetic composition of claim 18, wherein biotic stress tolerance is a growth environment comprising nematodes.

20. The synthetic composition of claim 18, wherein the biotic stress tolerance is shown by decreased pathogen load of a plant tissue.

21. The synthetic composition of claim 20, wherein decreased pathogen load is a decrease in egg count or juvenile count.

22. The synthetic composition of claim 19, wherein the nematode is of the genus Heterodera, Meloidogyne, Pratylenchus, Globodera, Xiphinema, Hoplolaimus, Longidorus, Rotylenchulus, Helicotylenchus, Belonolaimus, Trichodorus Paratrichodorus, Tylenchorhynchus, Anguillulina, or Merlinia.

23. The synthetic composition of claim 1, wherein the endophyte is present in the synthetic composition in a concentration of at least 1.0E+6 CFU/g.

24. The synthetic composition of claim 1, wherein the endophyte is present in the synthetic composition in a concentration of at least 1.0E+7 CFU/g.

25. The synthetic composition of claim 1, wherein the endophyte is present in the synthetic composition in a concentration of at least 1.0E+8 CFU/g.

26. The synthetic composition of claim 1, wherein the endophyte is present in the synthetic composition in a concentration of at least 1.0E+9 CFU/g.

27. The synthetic composition of claim 1, wherein the at least one antioxidant is a vitamin or amino acid.

28. The synthetic composition of claim 1, wherein the at least one antioxidant is ascorbic acid, creatine, cysteine, glutathione, or combinations thereof.

29. The synthetic composition of claim 1, wherein ascorbic acid is L-ascorbic acid.

30. The synthetic composition of claim 1, wherein the at least one antioxidant is present in the treatment formulation at a ratio of 0.2-1.5 part antioxidant to 1 part endophyte biomass by dry weight.

31. The synthetic composition of claim 1, wherein the at least one antioxidant comprises at least L-ascorbic acid or creatine and at least cysteine or glutathione.

32. The synthetic composition of claim 31, wherein the at least one antioxidant comprises at least ascorbic acid, cysteine, and glutathione.

33. The synthetic composition of claim 32, wherein the at least one antioxidant is ascorbic acid.

34. The synthetic composition of claim 33, wherein the ascorbic acid is present in the synthetic composition at a ratio of 0.7-1.4 part ascorbic acid to 1 part endophyte biomass by dry weight, wherein the cysteine is present in the synthetic composition at a ratio of 0.4-0.7 part cysteine to 1 part endophyte biomass by dry weight, and wherein the glutathione is present in the synthetic composition at a ratio of 0.4-0.7 part glutathione to 1 part endophyte biomass by dry weight.

35. The synthetic composition of claim 1, wherein the at least one saccharide is present in the synthetic composition in a ratio of 4-7.5 parts saccharide to 1 part endophyte biomass by dry weight.

36. The synthetic composition of claim 1, wherein the at least one saccharide is maltodextrin, sucrose, lactose, trehalose, microcrystalline cellulose, or combinations thereof.

37. The synthetic composition of claim 36, wherein the at least one saccharide is maltodextrin and maltodextrin is present in the synthetic composition at a ratio of 4.3-7.1 parts maltodextrin to 1 part endophyte biomass by dry weight.

38. The synthetic composition of claim 1, further comprising at least one protein hydrolysate.

39. The synthetic composition of claim 38, wherein the at least one protein hydrolysate is present in the synthetic composition in a ratio of at least 1 part protein hydrolysate for each 1 part endophyte biomass by dry weight.

40. The synthetic composition of claim 38, wherein the at least one protein hydrolysate is present in the synthetic composition in a ratio of 2-3 parts protein hydrolysate to 1 part endophyte biomass by dry weight.

41. The synthetic composition of claim 38, wherein the at least one protein hydrolysate is one or more amino acids, a peptone, casamino acids, hydrolyzed vegetable protein, or combinations thereof.

42. The synthetic composition of claim 38, wherein the at least one protein hydrolysate is a peptone, and the peptone is present in the synthetic composition at a ratio of 2-2.5 parts pcptonc to 1 part cndophyte biomass by dry weight.

43. The synthetic composition of claim 1, further comprising an inert solid.

44. The synthetic composition of claim 43, wherein the at least one inert solid is present in the synthetic composition in a ratio of at least 2 parts inert solid to 1 part endophyte biomass by dry weight.

45. The synthetic composition of claim 43, wherein the at least one inert solid is present in the synthetic composition in a ratio of at least 2-5 parts inert solid to 1 part endophyte biomass by dry weight.

46. The synthetic composition of claim 43, wherein the inert solid is kaolin clay, magnesium stearate, microcrystalline cellulose, or combinations thereof.

47. The synthetic composition of claim 1, further comprising a pH modifier.

48. The synthetic composition of claim 47, wherein the at least one pH modifier is selected from sodium bicarbonate or sodium hydroxide.

49. The synthetic composition of claim 47, wherein the at least one pH modifier is sodium bicarbonate, and the sodium bicarbonate is present in the synthetic composition at a ratio of 0.5-0.9 parts sodium bicarbonate to 1 part endophyte biomass by dry weight.

50. The synthetic composition of claim 1, further comprising at least of talc and mineral oil.

51. The synthetic composition of claim 1, further comprising a plant element.

52. The synthetic composition of claim 1, wherein the plant element is a monocot.

53. The synthetic composition of claim 52, wherein the monocot is a cereal.

54. The synthetic composition of claim 53, wherein the cereal is selected from the group consisting of wheat, rice, barley, buckwheat, rye, millet, oats, corn, sorghum, triticale and spelt.

55. The synthetic composition of claim 53, wherein the cereal is corn.

56. The synthetic composition of claim 1, wherein the plant element is a dicot.

57. The synthetic composition of claim 56, wherein the dicot is selected from the group consisting of cotton, tomato, lettuce, peppers, cucumber, endive, melon, potato, and squash.

58. The synthetic composition of claim 56, wherein the dicot is a legume.

59. The synthetic composition of claim 59, wherein the legume is soy, peas or beans.

60. The synthetic composition of claim 1, wherein the one or more endophytes comprises at least 2 endophytes.

61. The synthetic composition of claim 51, wherein the plant element is a whole plant, seedling, meristematic tissue, ground tissue, vascular tissue, dermal tissue, seed, leaf, root, shoot, stem, flower, fruit, stolon, bulb, tuber, corm, keikis, shoot, or bud.

62. The synthetic composition of claim 51, wherein the plant element is a seed.

63. The synthetic composition of claim 1, wherein the endophyte is dead.

64. A method of treating an agricultural plant, comprising heterologously disposing a plant element or planting media with a synthetic composition comprising an endophyte of the genus Pseudomonas, and at least one antioxidant, and at least one saccharide, wherein:
a. the at least one antioxidant is present in the synthetic composition in a ratio of at least 0.1 part antioxidant for each 1 part endophyte biomass by dry weight, and
b. the at least one saccharide is present in the synthetic composition in a ratio of at least 2 parts saccharide by for each 1 part endophyte biomass dry weight.

65. The method of claim 64, wherein the endophyte comprises at least one polynucleotide sequence that is at least 97% identical to one or more of SEQ ID NOs. 5-105, or combinations thereof.

66. The method of claim 65, wherein the endophyte comprises at least one polynucleotide sequence that is at least 97% identical to one or more of SEQ ID NOs. 5-10, or combinations thereof.

67. The method of claim 64, wherein the endophyte comprises one or more genes encoding a protein whose amino acid sequence is selected from SEQ ID NOs. 106-199.

68. The method of claim 64, wherein the endophyte is capable of producing at least one siderophore.

69. The method of claim 68, wherein the siderophore is vulnibactin 3.

70. The method of claim 64, wherein the endophyte genome comprises a region of approximately 5 kilobases in length comprises a polynucleotide sequence that is at least 97% identical SEQ ID NO 83 a polynucleotide sequence that is at least 97% identical SEQ ID NO 85, a polynucleotide sequence that is at least 97% identical SEQ ID NO 84, and a polynucleotide sequence that is at least 97% identical SEQ ID NO 86.

71. The method of claim 70, wherein the polynucleotide sequences having at least 97% identical SEQ ID NO 83, SEQ ID NO 84, SEQ ID NO 85, and SEQ ID NO 86 are under common transcriptional control.

72. The method of claim 70, wherein the at least 5 kilobase region is located between genes 4-hydroxybenzoate transporter pcaK and pca regulon transcriptional regulator pcaR.

73. The method of claim 70, wherein the at least 5 kilobase region is located between a gene encoding a protein having one or more domains having InterPro accession numbers IPR004746, IPR005829, IPR011701, IPR020846, or IPR036259 and gene encoding a protein having one or more domains having InterPro accession numbers IPR005471, IPR012794, IPR014757, IPR029016, IPR036388, or IPR036390.

74. The method of claim 70, wherein the least 5 kilobase region is located between genes encoding 4-hydroxybenzoate transporter pcaK and pca regulon transcriptional regulator pcaR.

75. The method of claim 70, wherein the pca regulon transcriptional regulator pcaR is located upstream of the at least 5 kilobase region.

76. The method of claim 70, wherein the at least 5 kilobase region is approximately 4 kilobases in length.

77. The method of claim 64, wherein the endophyte is capable of producing peniprequinolone.

78. The method of claim 64, wherein the endophyte is capable of one or more of solubilizing potassium, solubilizing phosphate, producing ACC deaminase, producing a biofilm, producing IAA, or producing catalase.

79. The method of claim 64, wherein the endophyte is present in an amount capable of improving a trait of agronomic importance in a plant.

80. The method of claim 79, wherein the trait of agronomic importance is selected from the group consisting of yield, root fresh weight, shoot fresh weight, biotic stress tolerance, drought tolerance, and combinations thereof.

81. The method of claim 80, wherein the trait of agronomic importance is biotic stress tolerance.

82. The method of claim 81, wherein biotic stress tolerance is a growth environment comprising nematodes.

83. The method of claim 81, wherein the biotic stress tolerance is shown by decreased pathogen load of a plant tissue.

84. The method of claim 81, wherein decreased pathogen load is a decrease in egg count or juvenile count.

85. The method of claim 82, wherein the nematode is of the genus Heterodera, Meloidogyne, Pratylenchus, Globodera, Xiphinema, Hoplolaimus, Longidorus, Rotylenchulus, Helicotylenchus, Belonolaimus, Trichodorus Paratrichodorus, Tylenchorhynchus, Anguillulina, or Merlinia.

86. The method of claim 64, wherein the endophyte is present in the synthetic composition in a concentration of at least 1.0E+6 CFU/g.

87. The method of claim 64, wherein the endophyte is present in the synthetic composition in a concentration of at least 1.0E+7 CFU/g.

88. The method of claim 64, wherein the endophyte is present in the synthetic composition in a concentration of at least 1.0E+8 CFU/g.

89. The method of claim 64, wherein the endophyte is present in the synthetic composition in a concentration of at least 1.0E+9 CFU/g.

90. The method of claim 64, wherein the at least one antioxidant is a vitamin or amino acid.

91. The method of claim 64, wherein the at least one antioxidant is ascorbic acid, creatine, cysteine, glutathione, or combinations thereof.

92. The method of claim 91, wherein ascorbic acid is L-ascorbic acid.

93. The method of claim 64, wherein the at least one antioxidant is present in the treatment formulation at a ratio of 0.2-1.5 part antioxidant to 1 part endophyte biomass by dry weight.

94. The method of claim 64, wherein the at least one antioxidant comprises at least L-ascorbic acid or creatine and at least cysteine or glutathione.

95. The method of claim 64, wherein the at least one antioxidant comprises at least ascorbic acid, cysteine, and glutathione.

96. The method of claim 95, wherein the at least one antioxidant is ascorbic acid.

97. The method of claim 96, wherein the ascorbic acid is present in the synthetic composition at a ratio of 0.7-1.4 part ascorbic acid to 1 part endophyte biomass by dry weight, wherein the cysteine is present in the synthetic composition at a ratio of 0.4-0.7 part cysteine to 1 part endophyte biomass by dry weight, and wherein the glutathione is present in the synthetic composition at a ratio of 0.4-0.7 part glutathione to 1 part endophyte biomass by dry weight.

98. The method of claim 64, wherein the at least one saccharide is present in the synthetic composition in a ratio of 4-7.5 parts saccharide to 1 part endophyte biomass by dry weight.

99. The method of claim 64, wherein the at least one saccharide is maltodextrin, sucrose, lactose, trehalose, microcrystalline cellulose, or combinations thereof.

100. The method of claim 64, wherein the at least one saccharide is maltodextrin and maltodextrin is present in the synthetic composition at a ratio of 4.3-7.1 parts maltodextrin to 1 part endophyte biomass by dry weight.

101. The method of claim 64, further comprising at least one protein hydrolysate.

102. The method of claim 101, wherein the at least one protein hydrolysate is present in the synthetic composition in a ratio of at least 1 part protein hydrolysate for each 1 part endophyte biomass by dry weight.

103. The synthetic composition of claim 101, wherein the at least one protein hydrolysate is present in the synthetic composition in a ratio of 2-3 parts protein hydrolysate to 1 part endophyte biomass by dry weight.

104. The method of claim 64, wherein the at least one protein hydrolysate is one or more amino acids, a peptone, casamino acids, hydrolyzed vegetable protein, or combinations thereof.

105. The method of claim 64, wherein the at least one protein hydrolysate is a peptone, and the peptone is present in the synthetic composition at a ratio of 2-2.5 parts peptone to 1 part endophyte biomass by dry weight.

106. The method of claim 64, further comprising an inert solid.

107. The method of claim 106, wherein the at least one inert solid is present in the synthetic composition in a ratio of at least 2 parts inert solid to 1 part endophyte biomass by dry weight.

108. The method of claim 106, wherein the at least one inert solid is present in the synthetic composition in a ratio of at least 2-5 parts inert solid to 1 part endophyte biomass by dry weight.

109. The method of claim 106, wherein the inert solid is kaolin clay, magnesium stearate, microcrystalline cellulose, or combinations thereof.

110. The method of claim 64, further comprising a pH modifier.

111. The method of claim 111, wherein the at least one pH modifier is selected from sodium bicarbonate or sodium hydroxide.

112. The method of claim 111, wherein the at least one pH modifier is sodium bicarbonate, and the sodium bicarbonate is present in the synthetic composition at a ratio of 0.5-0.9 parts sodium bicarbonate to 1 part endophyte biomass by dry weight.

113. The method of claim 64, further comprising at least of talc and mineral oil.

114. The method of claim 64, further comprising a plant element.

115. The method of claim 64, wherein the plant element is a monocot.

116. The method of claim 115, wherein the monocot is a cereal.

117. The method of claim 116, wherein the cereal is selected from the group consisting of wheat, rice, barley, buckwheat, rye, millet, oats, corn, sorghum, triticale and spelt.

118. The method of claim 117, wherein the cereal is corn.

119. The method of claim 114, wherein the plant element is a dicot.

120. The method of claim 119, wherein the dicot is selected from the group consisting of cotton, tomato, lettuce, peppers, cucumber, endive, melon, potato, and squash.

121. The method of claim 119, wherein the dicot is a legume.

122. The method of claim 121, wherein the legume is soy, peas or beans.

123. The method of claim 64, wherein the one or more endophytes comprises at least 2 endophytes.

124. The method of claim 114, wherein the plant element is a whole plant, seedling, meristematic tissue, ground tissue, vascular tissue, dermal tissue, seed, leaf, root, shoot, stem, flower, fruit, stolon, bulb, tuber, corm, keikis, shoot, or bud.

125. The method of claim 114, wherein the plant element is a seed. The method of claim 64, wherein the endophyte is dead.

126. The method of claim 64, wherein:
the one or more endophytes are heterologously disposed to a plant element prior to placing the treated plant element in or on a growth medium,
the one or more endophytes are heterologously disposed to a plant element after placing the plant elements in or on a growth medium,
the one or more endophytes are heterologously disposed to a plant element concurrently with placing the plant elements in or on a growth medium,
the one or more endophytes are heterologously disposed to a plant element at least two times,
the one or more endophytes are heterologously disposed to a plant element via a seed treatment or soil pre-treatment and one or more foliar applications,
the one or more endophytes are heterologously disposed to a plant element via a seed treatment or soil pre-treatment and one or more floral applications,
the one or more endophytes are heterologously disposed to a plant element via one or more seed treatments or soil pre-treatments, one or more foliar applications, and one or more floral applications,
the one or more endophytes are heterologously disposed to a plant element via seed treatment, root wash, seedling soak, foliar application, floral application, soil inoculum, in-furrow application, sidedress application, soil pre-treatment, wound inoculation, drip tape irrigation, vector-mediation inoculation, injection, osmopriming, hydroponics, aquaponics, or aeroponics,
the one or more endophytes are heterologously disposed to a plant element of a different plant variety from the variety of the plant element from which the one or more endophytes were obtained,
the one or more endophytes are heterologously disposed to a plant element of the same plant variety as the variety of the plant element from which the one or more endophytes were obtained,
the one or more endophytes are heterologously disposed to a plant element of a different plant species from the species of the plant element from which the one or more endophytes were obtained,
the one or more endophytes are heterologously disposed to a plant element of the same plant species as the species of the plant element from which the one or more endophytes were obtained, or
the one or more endophytes are heterologously disposed as described in one or more of the above.

127. The synthetic composition of claim 1, wherein the the one or more endophytes comprise one or more a polynucleotide sequences that are 100% identical to a subregion within one or more of SEQ ID NOs. 5-105, wherein the subregion is a 100, 200, 300, 400, 500, 600, 700, or 800 nucleotides in length.

128. The method claim 1, wherein the the one or more endophytes comprise one or more a polynucleotide sequences that are 100% identical to a subregion within one or more of SEQ ID NOs. 5-105, wherein the subregion is a 100, 200, 300, 400, 500, 600, 700, or 800 nucleotides in length.


SEQUENCE LISTING (199 sequences)

SEQ ID NO: 1 - DNA, 20 bp, synthetic construct
  source 1..20: mol_type = other DNA
agagtttgatymtggctcag

SEQ ID NO: 2 - DNA, 19 bp, synthetic construct
  source 1..19: mol_type = other DNA
ggttaccttgttacgactt

SEQ ID NO: 3 - DNA, 19 bp, synthetic construct
  source 1..19: mol_type = other DNA
gtgycagcmgccgcggtaa

SEQ ID NO: 4 - DNA, 20 bp, synthetic construct
  misc_feature 8: note = n is a, c, g, or t
  source 1..20: mol_type = other DNA
  misc_feature 9: note = v is not T (A, C or G)
ggactacnvgggtwtctaat

SEQ ID NO: 5 - DNA, 1466 bp, Pseudomonas oryzihabitans
  source 1..1466: mol_type = genomic DNA
gctcagattgaacgctggcggcaggcctaacacatgcaagtcgagcggatgagaggagcttgctcttcgattcagcggcggacgggtgagtaatgcctaggaatctgcctagtagtgggggacaacgtttcgaaaggaacgctaataccgcatacgtcctacgggagaaagtgggggatcttcggacctcacgctattagatgagcctaggtcggattagctagttggtagggtaaaggcctaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggccttcgggtcgtaaagcactttaagttgggaggaagggctcatagcgaatacctgtgagttttgacgttaccaacagaataagcaccggctaacttcgtgccagcagccgcggtaatacgaagggtgcaagcgttaatcggaattactgggcgtaaagcgcgcgtaggtggcttgataagttggatgtgaaatccccgggctcaacctgggaactgcatccaaaactgtctggctagagtgcggtagagggtagtggaatttccagtgtagcggtgaaatgcgtagatattggaaggaacaccagtggcgaaggcgactacctggactgacactgacactgaggtgcgaaagcgtggggagcaaacaggattagataccctggtagtccacgccgtaaacgatgtcaactagccgttgggatccttgagatcttagtggcgcagctaacgcattaagttgaccgcctggggagtacggccgcaaggttaaaactcaaatgaattgacgggggcccgcacaagcggtggagcatgtggtttaattcgaagcaacgcgaagaaccttacctggccttgacatgctgagaactttccagagatggattggtgccttcgggaactcagacacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggccagggctacacacgtgctacaatggtcggtacaaagggttgccaagccgcgaggtggagctaatcccataaaaccgatcgtagtccggatcgcagtctgcaactcgactgcgtgaagtcggaatcgctagtaatcgtgaatcagaacgtcacggtgaatacgttcccgggccttgtacacaccgcccgtcacaccatgggagtgggttgctccagaagtagctagtctaaccttcgggaggacggttaccacggagtgattcatgactggggtga

SEQ ID NO: 6 - DNA, 1384 bp, Pseudomonas oryzihabitans
  source 1..1384: mol_type = genomic DNA
gggagcttgctcctcgattcagcggcggacgggtgagtaatgcctaggaatctgcctagtagtgggggacaacgtttcgaaaggaacgctaataccgcatacgtcctacgggagaaagtgggggatcttcggacctcacgctattagatgagcctaggtcggattagctagttggtagggtaaaggcctaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggccttcgggtcgtaaagcactttaagttgggaggaagggctcatagcgaatacctgtgagttttgacgttaccaacagaataagcaccggctaacttcgtgccagcagccgcggtaatacgaagggtgcaagcgttaatcggaattactgggcgtaaagcgcgcgtaggtggcttgataagttggatgtgaaatccccgggctcaacctgggaactgcatccaaaactgtctggctagagtgcggtagagggtagtggaatttccagtgtagcggtgaaatgcgtagatattggaaggaacaccagtggcgaaggcgactacctggactgacactgacactgaggtgcgaaagcgtggggagcaaacaggattagataccctggtagtccacgccgtaaacgatgtcaactagccgttgggatccttgagatcttagtggcgcagctaacgcattaagttgaccgcctggggagtacggccgcaaggttaaaactcaaatgaattgacgggggcccgcacaagcggtggagcatgtggtttaattcgaagcaacgcgaagaaccttacctggccttgacatgctgagaactttccagagatggattggtgccttcgggaactcagacacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggccagggctacacacgtgctacaatggtcggtacaaagggttgccaagccgcgaggtggagctaatcccataaaaccgatcgtagtccggatcgcagtctgcaactcgactgcgtgaagtcggaatcgctagtaatcgtgaatcagaacgtcacggtgaatacgttcccgggccttgtacacaccgcccgtcacaccatgggagtgggttgctccagaagtagctagtctaaccttcggggaggacgg

SEQ ID NO: 7 - DNA, 1396 bp, Pseudomonas fulva
  source 1..1396: mol_type = genomic DNA
ctaacacatgcaagtcgagcggatgacgggagcttgctccttgattcagcggcggacgggtgagtaatgcctaggaatctgcctggtagtgggggacaacgtttcgaaaggaacgctaataccgcatacgtcctacgggagaaagcaggggaccttcgggccttgcgctatcagatgagcctaggtcggattagcttgttggtgaggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggttgtagattaatactctgcaattttgacgttaccgacagaataagcaccggctaactctgtgccagcagccgcggtaatacagagggtgcaagcgttaatcggaattactgggcgtaaagcgcgcgtaggtggtttgttaagttggatgtgaaagccccgggctcaacctgggaactgcatccaaaactggcaagctagagtacggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttggaatccttgagattttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatgcagagaactttccagagatggattggtgccttcgggaactctgacacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggcctgggctacacacgtgctacaatggtcggtacagagggttgccaagccgcgaggtggagctaatctcacaaaaccgatcgtagtccggatcgcagtctgcaactcgactgcgtgaagtcggaatcgctagtaatcgcgaatcagaatgtcgcggtgaatacgttcccgggccttgtacacaccgcccgtcacaccatgggagtgggttgcaccagaagtagctagtctaac

SEQ ID NO: 8 - DNA, 1406 bp, Pseudomonas fulva
  source 1..1406: mol_type = genomic DNA
ggcggcaggcctaacacatgcaagtcgagcggatgacgggagcttgctccttgattcagcggcggacgggtgagtaatgcctaggaatctgcctggtagtgggggacaacgtttcgaaaggaacgctaataccgcatacgtcctacgggagaaagcaggggaccttcgggccttgcgctatcagatgagcctaggtcggattagcttgttggtgaggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggttgtagattaatactctgcaattttgacgttaccgacagaataagcaccggctaactctgtgccagcagccgcggtaatacagagggtgcaagcgttaatcggaattactgggcgtaaagcgcgcgtaggtggtttgttaagttggatgtgaaagccccgggctcaacctgggaactgcatccaaaactggcaagctagagtacggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttggaatccttgagattttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatgcagagaactttccagagatggattggtgccttcgggaactctgacacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggcctgggctacacacgtgctacaatggtcggtacagagggttgccaagccgcgaggtggagctaatctcacaaaaccgatcgtagtccggatcgcagtctgcaactcgactgcgtgaagtcggaatcgctagtaatcgcgaatcagaatgtcgcggtgaatacgttcccgggccttgtacacaccgcccgtcacaccatgggagtgggttgcaccagaagtagctagtctaac

SEQ ID NO: 9 - DNA, 1400 bp, Pseudomonas oryzihabitans
  source 1..1400: mol_type = genomic DNA
cgtcctcccgagggttagactagctacttctggagcaacccactcccatggtgtgacgggcggtgtgtacaaggcccgggaacgtattcaccgtgacgttctgattcacgattactagcgattccgacttcacgcagtcgagttgcagactgcgatccggactacgatcggttttatgggattagctccacctcgcggcttggcaaccctttgtaccgaccattgtagcacgtgtgtagccctggccgtaagggccatgatgacttgacgtcatccccaccttcctccggtttgtcaccggcagtctccttagagtgcccaccataacgtgctggtaactaaggacaagggttgcgctcgttacgggacttaacccaacatctcacgacacgagctgacgacagccatgcagcacctgtgtctgagttcccgaaggcaccaatccatctctggaaagttctcagcatgtcaaggccaggtaaggttcttcgcgttgcttcgaattaaaccacatgctccaccgcttgtgcgggcccccgtcaattcatttgagttttaaccttgcggccgtactccccaggcggtcaacttaatgcgttagctgcgccactaagatctcaaggatcccaacggctagttgacatcgtttacggcgtggactaccagggtatctaatcctgtttgctccccacgctttcgcacctcagtgtcagtgtcagtccaggtagtcgccttcgccactggtgttccttccaatatctacgcatttcaccgctacactggaaattccactaccctctaccgcactctagccagacagttttggatgcagttcccaggttgagcccggggatttcacatccaacttatcaagccacctacgcgcgctttacgcccagtaattccgattaacgcttgcacccttcgtattaccgcggctgctggcacgaagttagccggtgcttattctgttggtaacgtcaaaactcacaggtattcgctatgagcccttcctcccaacttaaagtgctttacgacccgaaggccttcttcacacacgcggcatggctggatcaggctttcgcccattgtccaatattccccactgctgcctcccgtaggagtctggaccgtgtctcagttccagtgtgactgatcatcctctcagaccagttacggatcgtcgccttggtaggcctttaccctaccaaccagctaatccgacctaggctcatctaatagcgtgaggtccgaagatcccccactttctcccgtaggacgtatgcggtattagcgttcctttcgaaacgttgtcccccactactaggcagattcctaggcattactcacccgtccgccgctgaatcgaggagcaagctcctctcatccgctcgactgca

SEQ ID NO: 10 - DNA, 1409 bp, Pseudomonas fulva
  misc_feature 19: note = n is a, c, g, or t
  misc_feature 1396: note = n is a, c, g, or t
  misc_feature 1406..1408: note = n is a, c, g, or t
  source 1..1409: mol_type = genomic DNA
tgcagtcgagcggatgacngggagcttgctccttgattcagcggcggacgggtgagtaatgcctaggaatctgcctggtagtgggggacaacgtttcgaaaggaacgctaataccgcatacgtcctacgggagaaagcaggggaccttcgggccttgcgctatcagatgagcctaggtcggattagcttgttggtgaggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggttgtagattaatactctgcaattttgacgttaccgacagaataagcaccggctaactctgtgccagcagccgcggtaatacagagggtgcaagcgttaatcggaattactgggcgtaaagcgcgcgtaggtggtttgttaagttggatgtgaaagccccgggctcaacctgggaactgcatccaaaactggcaagctagagtacggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttggaatccttgagattttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatgcagagaactttccagagatggattggtgccttcgggaactctgacacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggcctgggctacacacgtgctacaatggtcggtacagagggttgccaagccgcgaggtggagctaatctcacaaaaccgatcgtagtccggatcgcagtctgcaactcgactgcgtgaagtcggaatcgctagtaatcgcgaatcagaatgtcgcggtgaatacgttcccgggccttgtacacaccgcccgtcacaccatgggagtgggttgcaccagaagtagctagtctaaccttcgggnggacggtacnnng

SEQ ID NO: 11 - DNA, 1373 bp, Pseudomonas fulva
  source 1..1373: mol_type = genomic DNA
ggagcttgctccttgattcagcggcggacgggtgagtaatgcctaggaatctgcctggtagtgggggacaacgtttcgaaaggaacgctaataccgcatacgtcctacgggagaaagcaggggaccttcgggccttgcgctatcagatgagcctaggtcggattagcttgttggtgaggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggttgtagattaatactctgcaattttgacgttaccgacagaataagcaccggctaactctgtgccagcagccgcggtaatacagagggtgcaagcgttaatcggaattactgggcgtaaagcgcgcgtaggtggtttgttaagttggatgtgaaagccccgggctcaacctgggaactgcatccaaaactggcaagctagagtacggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttggaatccttgagattttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatgcagagaactttccagagatggattggtgccttcgggaactctgacacaggtgctgcatggctgtcgtcagctcgtgtcgtgagatgttgggttaagtcccgtaacgagcgcaacccttgtccttagttaccagcacgttatggtgggcactctaaggagactgccggtgacaaaccggaggaaggtggggatgacgtcaagtcatcatggcccttacggcctgggctacacacgtgctacaatggtcggtacagagggttgccaagccgcgaggtggagctaatctcacaaaaccgatcgtagtccggatcgcagtctgcaactcgactgcgtgaagtcggaatcgctagtaatcgcgaatcagaatgtcgcggtgaatacgttcccgggccttgtacacaccgcccgtcacaccatgggagtgggttgcaccagaagtagctagtctaaccttcg

SEQ ID NO: 12 - DNA, 753 bp, Pseudomonas oryzihabitans
  source 1..753: mol_type = genomic DNA
atggacctcaccggcaagaccgccctggtcaccggctccaccagcggcatcggcctgggcatcgcccagcgcctggccgccgctggcgccaccctcatcctcaacggcttcggcgatcccgctgcggcccaggccagcctgcccggccgcagtggcttccacggcgccgacctgtccaggccggaggagatcgaagagctcttcgcctacgcccagcgcgacttcggcggcgtggacatcctggtcaacaacgccggcatccagcacgtggcgccggtggaagactttccggtggagcgctgggacgcggtgatcgcactcaatctctcggccgtcttccacaccacccgcctggcgctgccgggcatgcgcgagcgcgactgggggcgcatcatcaacatctcttcggtgcatggcctggtggcctccaccggcaaggccgcctatgtggccgccaagcatggggtggtgggcctgaccaaggtcaccgccctggagaccgcccgcaccggcatcacctgcaacgcgctctgcccgggtttcgtgctcaccccgctgatccagcagcagctggacagccgtggcagcgatcccgaccaggcgcggcgcgacctgctcagcgaaaagcagccgtcgcaggaattcgtcaccccctcccagttgggcgaactggcgctgttcctctgcagccaggccgctgctcaggtacggggcgccgcctggaccatggacggcggctggaccgcccaataa

SEQ ID NO: 13 - DNA, 1014 bp, Pseudomonas oryzihabitans
  source 1..1014: mol_type = genomic DNA
atgtccctggatctcgaaaagcgttttccccgcatcaagctcggttatttcccgtcacccctgcacaagctggaacgcatgtcgaaggacctcggtatcgaactctgggccaagcgtgacgacgtctcctccggcctcgcctatggcggcaacaaggtgcgcaagctggaatggctggccgccgacgccctggcgcagggctgcgataccctggtgtccatcggcaacatccaatccaaccacacgcgccaggtagccgccgtcgctgcggtgctgggcatgaagtgccggctggtccaggaggaatggaccaagtgggaagacccggtctacgacaaggtcggcaacatcctgctgtcccgcctgatgggcgcccagacgctgctggaaggcgagggctattccaccgcggtgaaggcgacctgggagcgcgcgctggacgaggtgcggcgtgaaggcggcaagccctacgccattcccgccggcgcctcggaccatcctcttgggggcctgggctatgcgcatttcgctgacgagctggcggcgcaggagcgcgaccagggcctcttcttcgataccgtggtcacggccacctgcaccggttcgacccaaggcggcatggtggtgggctttcgcgcccaggagcgcgagcgtcgcctgatcggtatcgacacggcggcggacgccgggatgacccgcgccgcggtgaccaagatcgcgcgcaacaccgccgagatgattggcctggacaaggagatccgcgacgaggacgtcatcatcgagccgcgtttctgcggccccgactacggcttgccggatggccccaccgtcgaggccatccgctataccgcgcagatggaggggatgctcaccgatccggtctacgagggcaaatccatggccgggctgatcgccatggcgcgcagtggcgagatcgccaagggcagccgggtgctctatgttcacctcgggggcgcaccggcgctcaacgcctatcacaacgccttcgcctga

SEQ ID NO: 14 - DNA, 924 bp, Pseudomonas oryzihabitans
  source 1..924: mol_type = genomic DNA
atgacctctctcccacccgccgcgctgcaggaggtgcagctcgccgccctggcggcgcgcgacctgcgcctggcggtgctgcgcctggatcagcgcccggccgcgcataacggcaacaagggctacaagctgcggccctggcgcgaacgcctggcccggggcgagggccgtgggctcatcagtctcggcggtgcccactccaatcatttgcatgcgctggccgccctgggccggacggaaggcttcgtcaccgtcggcctgctgcgcggcgaaccctgcctgacgcccaccgtccaggatctgcagggcaagggcatgaccctgcactggctcggctatggcggctatcgccgtcgccatgacgccgacttctggcagccctggcaggcgcgctatcccgggttgctgcccattcccgaaggcggctgcgacgagcaggccgccgcggcctgcgcggccatcgtcacggagttgcgccagggcctcgccgccctggattggcccgattgccagcaagtctggctggccgccggcaccggcaccaccctggccggggtgatccgcgccgccgatcccgcctggcaggtggtgggcggcctggcggtgccgccggggcacggcgtcgaagccaacctcgaccggttgctggcccagcacatggccccgaactggcgcctgctggacgccagccgcggtggcttcggccgcctcgatgccgaagtggcccgggccatggcggagttcgaggcgcagaccgggatcgccctggagccgctctataccggcaagctctggctggcgctgcgccaggccattgagggtggggcaatagcaccgggcagtcgcctggtgctgatccacagcggtggcctccaaggccgtcgcgcgctgcagcctcagctggcgaagtgggtcggcggctga

SEQ ID NO: 15 - DNA, 1461 bp, Pseudomonas oryzihabitans
  source 1..1461: mol_type = genomic DNA
atgattcccgtcatcctgtccggtggtagcggctcgcgactctggcccctctcgcgcaagctctaccccaagcagttcctggcgctgaccagcgagcagaccatgttccaggagaccatcaatcgcctgggctgcgagggcagcatcgattgccccatcatcgtctgcaacgccgaacaccgctacctggtggaagagcagctcaaggccgtcgactgcaagccgcaggcgctgatcatggagcccttcggtcgcaacaccgcaccggccgtggccatcgccgccatgcaactggtcgctgacggcaaggacgacctgatgctggtgctgcccgccgatcacgtgatcgaggacgaagccgaattcaaggccgccctgcaacaggccgccgccgccgccgagcgtggcgagatggtgctgttcggtatcccggctaccgcgcccgagaccggctacggctacatcaagaccggttccaacgacggcctgccccagggcgtgtcccgcgtcgagcgcttcgtcgagaagcccgatgccgtcaccgccaccgaatacgtggcctccggcgactactgctggaacagcggcatcttcctgttccgcgccagccgtttcctggaagagctgaagaagcacgataccgacatctatgacacctgcctgttggcgctggagcgcagcagcatcgacggcatcaacatcagcatcgatgccgccaccttcgccgtctgcccggacaattccatcgactacgccgtgatggaaaagaccacccgcgcctgcgtggtgcccatgaccgccggctggaacgacgtcggttcctggtccgcgctgtgggatgtgcatgccaaggacaacaacggcaacgtcatcaagggcgacgtcgtcctgcatgacagccgcaactgcctggtgcacggcaatggcaagctggtgaccctggtcggtctggacgacgtggtcgtggtggaaaccaaggacgccgtcatgatcgcccacaaggacaaggtccaggacgtcaagaagctggtcaacaccctcgagaagcagaaccgcaacgaggtcaaggctcaccaggaagtcttccgtccctggggttcctacgactccatcgacatgggccagcgcttccaggtcaagcgcatcaccgtcaagccgggcgcccaactgtcgctgcagatgcaccaccaccgtgccgagcactggatcgtggtctcgggtaccgccgaggtcacctgtgacgacaaggtcttcctgctgaccgaaaaccagtccacctacctgccgatgacctccgtgcaccgcctggccaaccccggcaaggtaccgctggagctgatcgaagtgcagtccggtggctacctgggcgaggacgacatcgtccgcttcgaagacatctacggccgcgtcgacacccaggccctggaagtcgccaaggcaggcaaggcgtcgacccgctaa

SEQ ID NO: 16 - DNA, 1350 bp, Pseudomonas oryzihabitans
  source 1..1350: mol_type = genomic DNA
atggaacaaaccagcggtcgtatccttcttgtggatgacgaagccgccatcctgcggacctttcgtttctgcctggaagacgccggctacagcgtggccacggccaacagcgcggcccaggccgaggccctgctgctgcgccaggtctacgacctctgctttctcgacctgcgcctgggcgcggacaacggtctggacgtgctgcagcagatgcgcatccaggcgccctggatgcgggtggtgatcgtcaccgcccactcggccatcgacaccgcggtggacgccatgcaggccggcgccgccgactacctagtgaagccctgcagccccgaccagctgcgcatggcggcggccaagcagctggaattccgccagctctcggcgcgcctggaggccctcgagggcgaggtacgcaagtccaacgccggtctcgattcgcgcagcccggcgatgatgagcatcctggagaccgcccgacaggtcgccaccaccgatgccaacgtgctgatcctcggcgagtccggttccggcaagggcgaactggcccgcgccatccacgcctggagtcggcgcgccaagaagaccttcgtcaccatcaactgcccgtcgctgtccgccgatctgatggaaagcgagatgttcggccatacccgcggcgccttcaccggcgccagcgagagcaccctcggccgggtcagccaggccgatggcggcaccctcttcctcgacgagatcggcgacttccccctggccctgcagcccaagctcttgcgcttcatccaggacaaggaatacgagcgcgtcggcgatccggtgacccgccgcgctgacgtgcgcatcctcgccgccaccaaccgcaacctggaacagatggtggcggaaaacgaattccgcgaagacctgctctatcgcctcaacgtcatcgtgctcaacctgccgccgctgcgcgagcgcaaggaagacatcgtcgatctggccgagcgctttctcgcccgcttcgtcaaggactacaacagacccgcccatggcttcagcgaggcggccctggacgccctgcgcaactatggctggccgggcaacgtccgcgagctgcgcaacgtcatcgagcgggcgagcatcatctgcggccaggacctggtggacgtcaaccacctgggcctgggtgacagcccggccagcagcggcgccgccagcgcaccgcgggtcggcgaggcgctgagtctggaagccttggagcgcgcccacatcgccgcggtgatggccaccagcgagaccctcgaccaggccgccaagacgctgggcatcgacgcctccacgctctatcgaaaacgcaagcagtacgggctatga

SEQ ID NO: 17 - DNA, 528 bp, Pseudomonas oryzihabitans
  source 1..528: mol_type = genomic DNA
atgagtcgtgaagccctgctggaatccctgtccgctgttatggataacgaagcggacgaattcgaaacccggcgtgtcatcgccgaggtcagcaaggacccggaattgcgcgccacctggtcgcgctacgccatggtcagcgccgtgattcgcggtgagcccatgctgccgaatctggatatcgccaaaggcgtcaccaccacgctggagcgtgatgaggccgtcgcagccccggcagcgcccgtcgttgcccaggcgcgcaagagtggctggtcgagtctgggtcgtgtcgcggtcgccgcgtccgtgaccttcgccgtattggcaggcgtgcggatgtacaaccagtccgacgtctccacccagggtctggcccagcaggcgccaagccagctgaccgtgccgcaacccgcgcgtagcccggccgtgctggccagcttcagcgaagaaagcaccaaggcgaatgccgaagccaaggctgacaagccgatggcaggtgaaaagcaggaagcccctgcccagcgttga

SEQ ID NO: 18 - DNA, 2562 bp, Pseudomonas oryzihabitans
  source 1..2562: mol_type = genomic DNA
atggcaaggggcaagaacgacaaggatgtgcgcaaggcggccccgcgggtcgctggcttgcccggcatgggcgcgggactgctgctggcgctcgccggcctgttgctggccgcgctgctgctgtggttcctggtgttgcagccgcagggcgcgcgcaatcaggagcagcaggcggatcaggcgctgcaggcgcaggcgacctccctcaatcagctgctggtcggcctgacccgccggctgcagggtgtcgccggggatgccctggtgttgcaggccctgcagggcgacgatccggcggcgcgcgcggcggcggaaagccagctgcgcgagcgcctcggcgtggtcgacgtgctggtggtgccggccggcatgcgccagatcgaagacgatcgccccggcccgctcaactatgccgccctcgatctgctcaagcgcctggaaagcggccagcggaccccgccggaagcctatcgactgggcgatcgctggctggtctacagcgcccagcccatccgccgcggcgatcaactgcttggcagcgccgtactggtggaagacctcccggccgtcttgcagggctgggccacgccaccggcgaacgtcggccagtggcgcctgctgcagcaatttcccggtggcagcgtgcaggtgctggccagtggcggcagccccggtgatccggcgctgatgcggcggctcgccaccggcagcccgctctggacgctggagttggcacccgccgccgaggccggcgccgatacaccgctgggcatccccctggtggcgctgctgctggcgctgtttggcgtgctggcgggcttttggctgttttcccgggagctgtcacgccggctccgtgacgacgtccgcagtctgacggcctatgccgaggaactagaagccaatcagatagccaaaagcccgactttgcgcctggcggtaatggaacccgtggccaagtcgacggcccgattggccagccgatcggccgggtcgtcgccggacctgtacgccaccgctcccagcgatgcggtggccaagaccctggcggagtttgccgacagaggccgctcgcagcagagcgagccgctgttccagaccaccgacatcctcgatatcagtatcctcgacgaagaccaggatctcctgggattggagaaacccccgatgagcactaccccgcaagccccccaactcaacgccagcatcttccgcgcctacgacatccgtggcgtggtgggtgactccctgaccgccgaagccgcctactggatcgggcgcgccatcggctcggagagcctggcacgtggcgagcccaacgtggccgtcggccgtgacggccgcctgtccggccccgagctggtcgcccaactgatcaagggcgtggccgacagcggcgccaatgtcagcgatgtcggcatggtgccgaccccggtgctctactacgccgccaacgtgctcgaaggcaagtccggcgtcatgctgaccggcagccacaacccgccggactacaacggcttcaagatcgtcatcgccggcgagaccctggccaacgaatccatccagcgtctgcgcgagcgcatcgagaccggtgacgtggccagcggccagggccagatcaagcaggtcgacgtgctcaagagctacgccgactacatccgcaacgacgtggtactggccaagaagctcaaggtggtggtggacgccggcaacggcgtggccgcggtcaacgcgccccagctgatcgagtccctgggctgcgaggtcatcccgctgttctgcgaggtggacggcaacttccccaaccaccatccggatccgggcaagcccgagaacctggaagacctgatcgccaaggtcaaggaaaccggtgccgacctgggcctggcctttgacggcgacggcgaccgcgtcggcgtggtgaccaacgaaggcaagatcatctatcccgaccagctgctgatgctgttcgccaaggacgtggtctcccgcaaccctggcgccgacatcatcttcgacgtcaagtgcacccgccgcctgaacaacctcatcgccggctacggcggtcgtcccatcatgtggaagaccggccactcgctgatcaagaagaagatgaaggaaaccggcgctctgctggccggcgagatgagcggccacgtgttcttcaaggagcgctggttcggtttcgacgacggcatctacagcgccgtgcgtctgctggagatcctcagccaggagaagaacagcgcccaacaggtgttcgataccttcccggtagacatctccaccccggagatcaatatccaggtgaccgaagagaacaagttcggcatcatcgaaaccctgcagcgcgacgcccagtggggcgatgcccagatcaccaccctggacggcgtccgcgtcgattaccagaacggttggggcctggtgcgtgcgtccaacaccacgccggtgctggtgctgcgcttcgaggcggaaaccctcgaagagctggagcgcatcaagacggtgttccgcaagcagctgctggcggtacagccggatctgaatctgccgttctga

SEQ ID NO: 19 - DNA, 747 bp, Pseudomonas oryzihabitans
  source 1..747: mol_type = genomic DNA
atgaatgtcctgatcgtcgatgacgaacccttggcgcgcgagcgtctggcccgtctggtggggcaactggacggttacaccgccctggagccaacagccaccaacggtgaggaagccctcgctttggttgaaaacctcaagcccgatatcgtcctgctcgacatccgcatgccgggtctggacggtctgcaggtggccgcgcgtctctgcgagcgcgaatcgccgcccgcggtgatcttcgtgaccgcccacgacgaatacgcgctcgacgccttccaggtcagcgccgtgggctatctggtcaagccggtgcggcaggaggacctggccgctgccctgagcaaggcccagcgacccaaccggatgcagctggccgccctgaccaagccgccggccagcggtggccctggcccgcgcagccatatcagcgcccggacccgcaagggcatcgagctgatccctctggatgacgtggtctatttcatcgccgaccacaagtacgtgaccctgagacactccggtggcgaggtgctgctggatgaaccgctcaaggcgctggaagacgaattcggtgagcgcttcgtgcgcatccaccgcaatgcgctggtttcccgcgagcgcatcgagcgcctgcagcgcacgcccctgggccacttccagttgttcctcaagggcatgaacggcgacgccctgaccgtcagccgccgtcatgtggccggtgtgcgccgcctgatgcacagcatctga

SEQ ID NO: 20 - DNA, 666 bp, Pseudomonas oryzihabitans
  source 1..666: mol_type = genomic DNA
gtgcaacagcccagtctagcagcgcgcgtcgatagtgaaagcaaggacgataccgagctgcaagccaaggacagcaagcaagccctgcccacccaggagcaggatcaacaactggtcgagcgcgtacagcgcggcgacaagcgtgccttcgatctgctggtgctcaagtatcagcacaagattctcggtctgatcgtgcgtttcgtccacgatacccaggaagcccaggacgtcgctcaggaggctttcatcaaagcctatcgcgcgctcgggaacttccgtggcgatagtgctttctacacctggctctatcgcatcgccatcaacacggcaaagaaccatctggttgcccggggtcgtcgtccaccggacagcgacgtcagtgccgaagatgcggaattttatgaaggcgaccatgctctaaaggatatcgagtccccagagcggtcccttttgcgggatgagatcgaggccactgtgcatcggaccattcagcagctcccggaagatctgcgcaccgcgctgacccttcgtgagttcgaaggcctcagctacgaggacattgcgaacgtcatgcaatgtccggtgggaacggttcggtctcggattttccgagctcgggaagcgatagacaaagcattgcagcccctgctgcgtgatgcatag

SEQ ID NO: 21 - DNA, 1077 bp, Pseudomonas oryzihabitans
  source 1..1077: mol_type = genomic DNA
atgatactcgaacgccgcaaaaccccccgaccggtaaaggtcgacgacttcttcgtcccggcgctctgcgaaccggaggccctgctcgtgctggtggtgctggccgagctgctggtgctggtcctggtgctggcagagcccttcaccctgcagttcaactggatccgcctggcgctggtgtcgctgttcgtgcagtggatcgtgctgctgtcggcggcgctgctctgtcgcctgcggccctggctggcacgccatagaccggtggtggcgggcggtttctgctgcgccatcgtggtggccctgaccctgctctgcaccctggtggccgactggctgcagctggccggaccgctgcagcgggtcggcgaggtgcggctgtacatgaggcacgcgctgatcgccctgatcatgtccatgctgctgctgcgctacttctggctacagagccagtggcgccgccagcagcaggccgaattgcaggcgcgcatcgagtcgctacaggcgcgcatccgtccgcatttcctgttcaacagcctgaacagcatcgccagcctggtcgccctggacgccgacaaggccgagcgtgcggtgctggacctttcggcgctgttccgcgccagcctcgcccagcccggcaccaaggtgcgctgggtcgaggagctggagctgtcgcggcgctatctggagatcgagcgcctgcgcctgggcgatcgtctgcagttgcagtgggacgtggacggggtgccggcggatctgccgattccccagctgacgctgcagccgctgttggaaaacgccctgatctatggtgtggcgccgcgcatcgaagggggcctggtcaccatcttcgccacctaccgggagggggtgttcgagctggtcatcagcaacccctatgaccccgaggtggagcagcagccacgcccacccaagggcacccgtcaggctttaagcaatatcgaggcgcgattgacggcacttttcggaccagctgcgagtctcaaaatcgaacgccgcgaccagcggcatacaacgtctcttcgctatccatgcgagcgactcatgcgggaagcctga

SEQ ID NO: 22 - DNA, 882 bp, Pseudomonas oryzihabitans
  source 1..882: mol_type = genomic DNA
atggcgaccgtattagtgccgaacgcgacagacaattttgccgctgcgctgcaatggcagcgtacccgtatcgacgagcgtctggcagagctgttaccggccggcagcgatccggtcgccgcagcgattcgcagtggtgtcctggcacccggcaagcggctgcgtccgctgctgatggtgctggccgccgaggacctgggtcaggccgacgaggccgtcctcgacctgggctgcgccgtggaaatggtgcacgccgcctcgctgttcctcgacgacatgccctgcatggacgacgctcgcctacgccgcgggcggccgaccctgcacgtcgagttcggcgaggacgtcgccatgctggctgccgtagccctgctcagccacgccctgcgcctggtcgcgggcctcgccggggtaccggcggaaacccgcacccagatggtctgccaactggccgatgcggtcggcaccgccgggctggtctgcggccagtaccatgacctgcacggtggccgtcaggcgcgcccggccgatgccatcgccctgaccaaccagctcaagaccggcgcgctgttctccgcggccctggccatggccggtgccaccctggtcaccaccgccgtgcagcgcgaggccttccacgtcttcgcctgccagctcggcctggccttccaattgctcgacgatctcgacgacggcaagggcctgggcaaggacgccggcaaggatggcgacaagtccaccctggtcagcctgctcggccgcgaccatgcgcaacgccagctgcacagtcatctcaaacaggcccgcgaggctctggcccaggcagattgcgccgacggcgccctggccggcctgctggatatcgtctttcgtccgcgttag

SEQ ID NO: 23 - DNA, 1269 bp, Pseudomonas oryzihabitans
  source 1..1269: mol_type = genomic DNA
atgcatgtcgccctgatctcgccgccgctgccgagccacctgtccacccatctggtgctgggcgaggcgctggtcgcgctcggccaccgggtcaccctgctgcatcaggtagaggtgggagaccgggcgctgccggcgggcatcgagttccaggcgataggcgcgaccagtcatccgcgtggcagcctggcgccgctgctggcgcgtaccgccagcagcaagccctggtcggtgttcggggtgatcgccgacatggcgcgcaataccgaattgttctgccgcgaaggcccggccgccttgcgtgacctgggtgttgactgcctgatcgccgaccagatggaaccggccgggggcctgctcggcgaccacctgggcctgccctatgcgtccctggcctgcgccgtgccgatgaatcgcgagccccatctgccgctgcccaccctgcccttcgcctatcccgccagcgagcgggaaaggcagatcgtccagggcgccacccaggtgttcgacctgatgatgcgcggccagggcaaggtcatccagcgccaggcccaggccttcggcctcggcgaccgccagaccctcgacgactgcttttcgccctatctgcagctgagtcagtgcctgccgggcttcgactttccgcgtcgtgccccgccgccgcatttccacgaggtcgggccgctgcgttcgccggcggtgcgcgagcaacgactggagctggagatcgatccgcgccggcccttcgtcttcgcctcctttggcaccctgcagggtggccggctagcgctgttccgccgcatcgcccaggcctgtcgccaactgggcgtccaggtgctgatcgcccactgcgggcgtctggatgccagcggcgaacgccgcctgctcgacgacggcgccacctgggtcaccgacttcgcgccccaggaagcggccatcgcccgcgccgatgccgtgatcacccatggtggcttcaataccgtgctggacgccctggcggctggcaagcccatgctcgccctacccatggtgttcgaccagccgggcatcgcccggcgcctggagcgggtcggcgccggcatctgcctggcaccgcggctggccagcaaggcccgcctgacccaggccctgggcgccgtgctggccgacccaggctatcgccaggcggccgaacgcttcgtgcccatcgccagagcggcaggcggcgtcgccacggccgctcgcctggtggatgccctggcccagcgaggactcgagcgtgcgtcctga

SEQ ID NO: 24 - DNA, 528 bp, Pseudomonas oryzihabitans
  source 1..528: mol_type = genomic DNA
ttggagctactgatcaatgcgggaatcgtgctggccaccgtggccggcatggaagctttcgcctggtggtcgcacaagtacatcatgcatggctgggggtggggctggcatgagtcccaccaccgcccgcgtaccggctggttcgagaagaacgatctctatgcggtggtcttcgctggcctcgcgatcctgctgatcgccctgggcaacgccggctactggcgcctgcagtggatcggcgccggcatgaccctctatggcctgctgtatttcatcgcccacgacggcctggtgcatcagcgctggccgtttcgctacatcccgcgcagcggctatctgaagcggctctatcaggcgcatcgcatgcatcatgcggtggatggcaaggacggctgcgtatccttcggtttcctgttggcgccgactacccggcaactcaagcagcagctgcgcgagatacacggcggcgccctggattcctcgcgcgaacgcaaggcgcgggatcaggtgcaggaaggcgcggactag

SEQ ID NO: 25 - DNA, 534 bp, Pseudomonas oryzihabitans
  source 1..534: mol_type = genomic DNA
atgcacaagacggaaacggctgtttcacacgatcgcttcgctgcctcctcgtcactacttgcccttggcctttccgctaacgcgcagtccggttacaagcccgaattcttcaacgccacccagtggcgcaccctggtcgccctctgcgctcacctgcaggccgacagcgagcaggccgatgcccggctgcccgagttcatcgatcgccacatgctgactccctatgcccacggcgaccgctccaacatcgtcgatcccttcgacgagcaggcccaggtccaacagggcgccaacctgcgcgatctgctgcgtgacggtctggccgtggtggacagctattgcaccgagcgtctgggtgccggcttcgccgaactggcagccggtgaacaagcccaggtggtcaccgccgccgaagcgggtaccctgaatccgccggccaaggaattcatcgatctgctgcgcaacgaaagcgaacgcagtcagtatgcccattcgctattcgccgcttacgacgacacccccgccgtcgcctga

SEQ ID NO: 26 - DNA, 1050 bp, Pseudomonas oryzihabitans
  source 1..1050: mol_type = genomic DNA
atggtggattgggaactggcaagccgcaagaacgatcatctggacatcgtgctggatccccacaaggcccgcagcgccgtcaccacgggcttcgacgcctaccgcttcacgcattgcgccctgcccgagctgaacctcgacgagatcgacctcggcacccgcctgttcgagcgtcccctggccgcgccgctgctgatcagctccatgaccggcggcccagagcgcgccgcgctgatcaatcgccatctcgccgaagcggcccagaccctgggcatcgccctggcggtcgggtcccaacgcatcgccctgcagcagggtggcgaccagggtctcaccggtgaattgcgccgcctggcgccggacgtgccgctgctggccaacttcggcgccgcgcagctggtggccggctacggcctcgatgaagcccgccgcgcggtggagatgatcgaggcagacgccctgatcgtgcatctcaatcccctgcaggaagccgtgcaggccggtggcgatcgccgctggcacggcattctcctcgccctggaaaatctggttacacaactggccgtgccggtcgtcgtcaaggaagtcggtgctgggttgtcgggccgagtcgccacgcaattgttggaggctggtgtggcggtgctggatgtcgccggcgccggaggcaccagctgggcagcggtggaagccgaacgggcccgtgacgaccagcagcgcgccattgcccgggccttcaccgactggggtatccccaccgccgatagcctgcgccaggtgcgcaccgcctgcccccaggcgacggtgatcgcctcgggggggatccgcgatggcatcgacgtggccaaggctatccgtctcggcgccgacctggccggccaggccgccgcggccctgcccggcgccaccgaatccaccgaggcggtgatcgcgcatttccaggtggtgatcgaacagttgcgcatcgcctgcttctgcaccggctcggccgatctggccggcttgcgccaggccgagttgctggacgccgcatcgctgcggtgcccatag

SEQ ID NO: 27 - DNA, 1167 bp, Pseudomonas oryzihabitans
  source 1..1167: mol_type = genomic DNA
gtgcgtcctgacctgctgatcgtcggcggcggcctggccggcggcctgctcgccctgcgcctggccgaaacccgcccggagctggactggcgcctggtggaagccggtccgcgcctgggcggcaaccacacctggtccttccacgagccggacctcaccgcgccgcagcatgcctggatcgatccgctggtcgcccatcgctggccgggctacgaggtgcgcttcccccagcgccagcggcaactcggtagcggctacgccagcatcagcgccgaacgcttccatgaggtattgagcgcgcgcctgcccgccgagcgcctgctgctgggacgcgaggtgctgcgcctgcaggacgatggcgtggtcttcgccgatggctacaccctggccgccggcgcggtgatcgacgcccgcggaccgcgacccgatccggcgctctggctcggctatcagaaatttctcggtcaggaggtacgcctcacgcggccccatggcctgaccgaacccatcgtgatggacgccaccgtcgatcagttggacggctatcgcttcgtctacagcctgcccctggcccccgaccggctgctgatcgaagacacctactatgccgatggcgagagcctgccggtcgagcgcctgcgccagcacctggccgactatgccgggcagcagggctgggagatcgccgaggtgctgcgcgaggaacagggcgtgctgcccatcaccctgggcggcgatcttgaccgctactgggacaacgtcaccgccggcgcccccattggcctggccgccgggctgttccaccccaccaccggctattcgctgcccgaagcggtacgcctggcggagcacctggccgcccagcccttcacctccagcgccgtgctgcgcgatagcctgcgccagtacgcccagagccgctggcagggccagggcttcttccgcctgctcaatcgcatgctctttctcgccggccgccccgagcaccgggtgcgcgtcatgcaaaggttctacggcctcggagaaccgctgatccagcgcttctacgccggccgcctcaccgccttcgatcggctgcgcatcctgtccggcaaaccgccggtgccgctgaaaccggccctggatgccgcgctggctcgtcctcctcagttcaaggaagcaccatga

SEQ ID NO: 28 - DNA, 1497 bp, Pseudomonas oryzihabitans
  source 1..1497: mol_type = genomic DNA
atgacccaaggtaacgcgcccaagcgggccatcgtcatcggcgccggctttggcggtatcgccctggcgatccgtctgcagtcggccggcatcgccaccaccctcatcgagggccgcgacaagcctggcggccgtgcctacgtctacgaggacgcgggcttcaccttcgacgccggtccgaccgtcatcaccgatccctcggccctggaagagctgttcaccctcagtggtcggcagatgcgcgactatgtggagctgctgccggtcagccccttctaccagctgtgctgggaagacggcacccgcttcgactacgtcaacgaccaggcccgcctggacgagcagatccgcgccctggagccggacgacgtggccggctaccagcgcttcctggcctattcccaggcagtgttcgaagaaggctacatccgcctcggcgccaagcccttcctcaaggtcggcgacatgctcgccgccggtcccaagctggcccagctcagcgcctggcgcagcgtctacacccaggtgtcgcgcttcgtgaagagcgagaagctgcgccagacgctgtccttccataccctgctggtagggggcaatcccttcgccacttcctcgatctatgcgctgatccatgcgctggaacgcaagtggggcgtctggttcgccaagggcggtacccaccagctggtgctcggtctgctgaagctctttaccgacctcggcggcgaggtgcggctgaacgcgccggtggagcgcatcctcaccgaaggcaatcgcgccaccggcgtctgcctggccgatggcagccagctcgcggccgatctggtggcttccaacgccgacgtggtgcacacctatcgcaagctgctcggccatcacacccatggcgtggtcgagggcaatcgcctcaagcgcaagagacacagcatgtcgctgttcgtcatccacttcggcctgagccagccgccggtgggtctcgagcaccacatggtctgcttcggccagcgctatcgcggcctgatcgacgaactgttcaagggcccgggcgtgccggacgacttctcgctctacctgcactcgccctgcgtcaccgatccgtcgctggcaccgcccgggcacagctcccactacgtgctggcgccggtgccgcacctgggcaatgccgacgtcgactggggcgtggagggcccgcgcctgagagacaagatcttcgcctacctggaagagcgctacatgcccggtctgagggcaaacctggtcacctcgcgcatcttcaccccggccgatttccgccaggaactcaatgcccatgtcggctcggccttctccctggagcccatccttacccagagcgcctggttccggccgcacaatcgcgatagtgtcattcccaacctctacctggtcggcgcgggcacccatcccggggccggcgttccgggcgtggtcggctcggccaaggccaccgccagcgtcatcctcgaggagcacggttag

SEQ ID NO: 29 - DNA, 936 bp, Pseudomonas oryzihabitans
  source 1..936: mol_type = genomic DNA
atgccagccacccctgacgtcgtcgaccacgccgaacagagcatcgccgtcggttccaagagctttgccgcggccgccaagctgttcgacccagaaacccgcgagagcgcggtgctcctctatgcctggtgtcgccactgcgacgacgtcatcgatggccaggaactgggccatggccaggtcgagggcgatcgtcgcgccggacaggaacgcctggccgagctggaacgcctgacccgcgccgcctacggcgaggagccgctgcaggatccggccttcgccgccttccagcgggtggtcaggcgccacggcattcccctggccctgccgctggatcacctggccggctttcgcatggacgtcgaggaacgcgtctatgtggagctggaagacaccctggagtactgctaccacgtcgcgggggtggtcggggtgatgatggcgcgcatcatgggcgccgaagacgaggaaaccctggatcgcgcctgcgacctgggcatggccttccagctcactaacatcgcccgcgacatcgtcgaggacgcccgtatcggccgcctctatctgccgcggctatggctcgacgaactcggggtgccggcggacgaactggccgcgccgcgccatcgcgaagccgtcgcccagctggccgagcgcctggtgcgtctggccgagccctactacgactcggcgcgccagggcctggccgccctgcccctgcgctcggcctgggccatcgccaccgcccgtggcgtctatcgcgagatcggcgtgcaggtactgcacctgggcgcccatgcctgggatcagcgggtcagcaccagcaccgccgacaagctgcgcctggtctgccgcggcgccgcccgcgccatgctgtcccgccaccagcgcgacgagccacgcgcgagcgagctctggacccggccgcggcgctga

SEQ ID NO: 30 - DNA, 945 bp, Pseudomonas oryzihabitans
  source 1..945: mol_type = genomic DNA
atgacgacgacaggcaccctggctgacgcagccctggtcattctcaatggcaaggaaaccggtaacgaggacgttcgggaggccattctcgaacggcgtgcggccggtcatcgcatcgatgtgcgggtgacctgggaagaagacgatgctgcgcgcttcgtcgagcaagcgacccgcgaaggctacggcaccctggtcgcggccggcggcgacggcaccctgagggcggtagccgaagccatggcgcagaatcacagccaggcccgtctcggcctgctgcccctgggcaccgccaatgatttcgccaatgccgccggagtacctctggagcccgctgcggccctggcgctgttggatggaccgaccagcaccatcgacctgatcgaagcggacggtcagctattcctcaacatggccaccggtggcttcggttcccaggtcaccgccaacaccccaggcgaactcaagcgcctgctgggtggcgcggcctacttcctcaccggcctgacccgcttcgccgaggtgcattcggcccatggccgtttccgcggtcccggtttcgaatgggaaggcgaattcctcgccctgggcatcggcaacggtcgccaggccgggggtggtcacgtgctctgtcccaccgccgtggtcaacgatggcctgctcgacgtgggtatcctgccggcgtcccaggacgtgctcggcaccttgggcgaattcctcagcaagggcttcagcaccgaggagatgttcatccgcgcgcggctgccctgggtggagctggaagccgccgaaggcctggacatgaacctcgatggcgaaccggtcaaacgagaccgggtgagattcgaggtacgtccgggtatcctgcaggtctgtctaccggtggattcgcccctgctgggcgagaccgccggcaccctggctgagccggcggcgacgtcctga

SEQ ID NO: 31 - DNA, 2229 bp, Pseudomonas oryzihabitans
  source 1..2229: mol_type = genomic DNA
atgaccgtgtcgctacgtctcgcccccctgctgctcgccaccctgggtgccgcgcccgctttcaccctggcccagaatgcgccgccggtggcggtggccggcagcggctacgacaacagcttcaagcagctcggcgcggtctatcccttcaatctgcgcggcatcgacagccgggacggagtcggctttgacattcgcgccgacgagatcgtcagcgccgccaaggtgacgctgaactacacctattccccggcgctgctgccggagttgtcccagctcaatgtgctggtcaacgacgaggtcgccgccagcattccgctgcccaaggaaggcgccggcacgccccagacccgggtggtggacatcccgccgcggctgatcaccgaattcaaccggctgagcatccagctgatcggccactacaccatgcagtgcgaagacccgctgcactccagcctctgggccaaggtgagcaatggcagccgcctggacatccaggtcagtcgcctggacctggcaccggacctggcgcgcctgccgcagccgttcttcgatcgccgcgatgcccggcagctggagctgcccttcgtcatcgccggtgcggccgacaacggcaccctggaggccgccggcaccctgtcgtcctggttcagcgccctggccagctatcgcggcgcccgctttcccagcagccagaacgccctgccggccaagggcaatgcggtggtgctggtcaccagcgaagagcgcgccaagaccctcggcctgagtctgccggcaccggcgacggcgcgggtcgacatcctggccaaccccttcgaccctcaaggtcagctgctggtgatctccggccgcgatgccaacgaactcaagcgcgccgcaagcgccgtggccctgggtcaccagaccctctccggccagagcatgaccttcgacaccctgcaggcgctgcaaccgcgcaagccctacgatgcgcccaactggctgcccagcgaccgaccggtacgcctgggcgaactggccacgcccaagcaactggccgtctccggctatgactcgggtaccctgagcgtgccgctgcggctgccgccggatctgttcctctggcgcaaccaggggctgccgctgcacctcaggtaccgctacaccccacagccggtggcgaccaattcctcgctgctggtgagtttcaacgaccgcttcgtgcagtccatcgccctgccgtcccaggaacacctggaccagagcctgctggggctgatcaaggacgaggaactgccccgcgaagccgaggtgcggctgccgctggagggcgaggcgctgcaggcccgcctgcaattccgcttcatgtacgactacctcaagcagggcgaatgccgcgacgtcatcatcgacaacatgcgcggcaccctggaaccggattcgaccctggatctctccggctatcggcacttcatcgccctgcccaacctgggcgtgttcaaggacagtggctttcccttcactcgcctggcggacctgagcgaaaccgcggtgatcctgcccgatgcgcccagcgcggcggagatcgacacctacctcaacgtgctcggccgcttcggcagctccaccggctatcccgccaccgcggtcaccgtggcccgtgccggcgaagtcgacggcctggccgacaaggatctgctgctgatcgccagcggcgccgaccagccgctgctgcaacgctgggccgcccagctgcccgccggcttcaccggcaacggccagcgcttcgaggtttccgacctggcgttcaaggtgcgccagtggttcggcagcgacaacgccgccagtctggaacgcagtcgcgcggccctgagtgccagtggcggtgccggtacggccttcgtcaccggcttcgaatcgccgctcaggagcgggcgtagcgtggtggccctggtcgccgcccgcccggaaggtctggccgacatcagccgcgccctgaccacccgggaagactatgcccaggcattgcagggcagcctggccacggtgcgtggccagcaggtggaaagcctagtggccgacgagacctatcatgtcggcagcctcgggccgctgctctacgtccgctggcaactggctcgccacccgctgttgatgctgggcctgagcgccctgggcgtggccctgctggccggcctgctccatgcggcgctgcgcgcccgcgcccgtcagcggctggagcgctag

SEQ ID NO: 32 - DNA, 3783 bp, Pseudomonas oryzihabitans
  source 1..3783: mol_type = genomic DNA
atgacccgtgcaccgctgctggctaccctggtgaccggtctgctgctgccgccgctggcccaggcggccggtacccccgaagcgctgctcctcgagcagggtcacttctggcaggcgcgcaagaatgcgccccgcgcccaggagacctggaacaagctgctcgaactggatgcgcagcagcccgaggcgctgtacggcctgggactgatcgaggtgcaggccgaccggctgccgaccgcccaggcctatctgcggcgcctgcaggcgctcaagcccgtgcctcagcaggccctgcaactggagcaggacatcgccctggccagtggcgacaatccgcagcgcctggtggatgcccgccagctggtcagcgaagaaaagccggtgcaggcactggcgctctatcgtcagctgtttggcggccgcctgccccagggtgatctggcgcgggagtactatgacatcctcgcctatacccccaatggctggcaggaagccggtccgggcatcgagcgtctgcgcaagctgcagcccagcgacccggcgctgatgctgatccaggccaagcacctggcgcgctttccggccagtcgcagccgcggcatccaggccctggcggagctgagcacgcgcaaggacatcggcggcgaagccgccgaatactggcgccaggccctggtctggagcggtccgcccggtccggccgaggcgccgctgttcgaggcctatctgcgtcagcaccccgatgacgccgagttgcgcgcccagctggaaaagggccgcgccctgagtcgcagcggcggtctggatccgcaactggcccgcggcatcgacgccttgcgccgcaatgagctgggcgctgccgaaagcgccttccaggcgcgcctcaaggcggcgccagaggatgccaacgccctgggcggcctgggcatcgtccgtcagcgccaggaacgcttcgacgaagccgaagcgctgctgaaccgcgccacccgccagccaggcggggcgcgctggcaggcgccgctggccgaggtacgctactgggcgctgctcgcccaggcccgcaaggcccagcaggccaacgacttcagcaccgcccgtgcccgcgtggaacaggcgttgcggctagacgccaagcgcccggaagcaccgctggccctggccggactgcaggcccagaccggtcagctggacgccgccgaggccgcttatcgacggatcctgcagcaggatccgcgcaatctcgaagcccgtcggagcctgatcgatctgctcgccgagagcgagcgtccggccgaggccctgcgcctgctcgacaccctgaccccggccgaacgcgccaggctcggcaacctggatcggctcaaggccacccaggccctgcaggaagccaagctggccgagggccgtggcgatctccagggggcccgtcgcgccctggaagacgcccgacgcgccgatccggacgatgtctggacactgctggccctggcccgcctgcagctgcgccagggtcaggaggcggccgcccgccagaccctggacagcggtctggccaaggacccccagcgcccggaagcgctctatgtccgcgccctgttcgccctggagcagcgggatcccaccgcggcgcgcgcgctgctagggcgcatcccgccggcccagcgcacgccggccatgacagggctggccgccgatctcgacttcgatgcccgggtaagcgccgcccgtgacctggcccgccgcggccagcagcaggccgcgcggcgccagctggcggccctggagccgcaagccggcgagcgccccgccgccctgggtggcctggcggcggcctatgccgaggccggtgacccggaacgcgggctgcgcctgctgcgcgatgtcctggcccgcgaacgcacgcccgatcccgccctgcgcctgcaatacggcgaggtgctgctgcgcagtggcgccgacgacgaggtcaatgccctgctgcacgatctgcagggacagcgcctgaccgccgcgcagcgccagggttatgacgacctgctctatcgctaccgggtgcgtcaggccgaccagctgcgcgagcgcggcgatctggtcaccgcctacgacaccctggcaccggccctggcccagcgcccggacgatgacctggccaacgccgccctggcgcggctgtacctggccaatggcgaggccgacaaggcgctgcgcctctatgaacccctgctgcgccgcgcccccgacaacccccggctgcaactgggtgcggccgatgccgccgtgcgcgcccgggacaacgcctatgccgagcgcgccctcgaacgcgccgtcaccctaggcgccgacgacgtcggggtgttgaccgaggccgcgcgcctctatcgcgccctgggtcgcgacggtcgggccaccgagctgctgcgccaggtggtggcggtggagcgccgcgacgccgagaccgcgcggcccctggccagcgccccggccaatcccttcggcccgcgccgcggcagcgccaccctggccagccaggccattccgccgaccgccgaccagttgctggcggcggccaaggccgcacccctggcggatgcgcccgtcgctccgcaggacagtgccgccgagcgcgccctcgacgacctgctgcagacccgcagcgcgcgggtcacccagggcctgacggtgcgcagcaacgacaacgaacgcggcctcggcaagctcaccgacgtggaagcgccgctggagatcgacttcccgctgggcgatgtgcgcctggccgtgcgggtgaccccggtcagcctgactgccggcagtgtcggcagcgacgcccgcagtcgcttcggtggcggcccggccgctacccaggccgcgccggacgccgcgccgggcagccagagcgacagcggcgtgggcctggcggtggcctacagcgatccccagctcggcctcaaggccgacgccggcaccacgcccctgggctttctctataccactccggtgggcggggtgagcctggagcgaccgctgaccgaccacagccgctacagcctctcggcctcgcgccgggcggtgatcgacagcctgacctcctttgccggcagcgaagacgcccgcaccggccagcaatggggtggcgtgaccgccaatggcgtgcgcggccagcttggctacgacgacagccagttcggtgcctatgcctatgcctcctggtaccggctgctgggcaaccatgtcgccgacaacagccgtaccgagctgggcaccgggctgtaccgctacctgatcaacagcgaagacagtcgcctgaccctgggcctgtcgctcaccggcatcgcctacgacaacaaccaggccttcttcacctatggccatggcggctacttcagtccgcagcgcttctatgccctgggcgtgcccctgacctggtcgcagcgcaccgatcgctggacctggcagctgcgcggcgcggtgggcctgcaacgcatcgagcaggacggcgccgacttctacccgaccgacgcccgcctgcaggccgcggcgagccaggcgctcggcgccccggcggtctatggcggccagagcaagaccagtctcggctacagcctctacggcgccaccgaataccagctcggtcgccagctgttcgtcggcggcaacctcggcgtcgacaacggtcgcgatttccaacagctcaatggcggcgtctatctgcgctatgcgctggaaccccaggaccgtgcactcgccctgccggtcagtccctatcgttccccctacgacaactga

SEQ ID NO: 33 - DNA, 3018 bp, Pseudomonas oryzihabitans
  source 1..3018: mol_type = genomic DNA
atgcccaagcacctcaccctgtcccttggtctgctcgccctgctgattcatgccgacgcgacctgggccgccgctgccgacgccgcgccgagcgcggccgccgtccaggccctggaagcccagctgaagaagacgccccaggatccggacgccctgggcaagctgggcagtgcccggctggcgcagcagcgctggaccgatgccgagcagctgctgacccaggccgtgcagaaaggcggcaagacctggcagccggcgctggacgaggcgcgctaccaccatctgctggaacgcgcccatgccgccgagaacaagcgcgagctggaccaggcgcgggatctcagcgtggaagccatccgcctgaagcccgaagcggtcgaggcgcagctgttcctggccggtatccagagccagaagcgccaatgggaactggccgaggccacctaccgccaggtgctgatgcgcgagccggccaacgtcgatgcctactacggacgcatcgccgcgctcaacgagctgggccgcaccgaagaagccctgcaactcaccaagaatctgcagccgagcgccaagaatcaggtcaagggcctggatcgcctgcgcgccggccaggccatgcaggaggccgaagccgccgaggcgcggggcgatctgcagggtgcctcgcgcctgctggaacaggcgcgccaggagtccccggaggatccctggctgcgcctggcccaggctcgcctggaggtccgccagggccggccgcgcgccgcccgcgacttggtggacagcctggtcaaggatggcgcccagcgccccgaggtgctctatgccagcgccctgctgtccaacgagctgggtgaatacccgcgcgccatgcagaccctgatgcgcattccccaggcgcagcgttcgccggacatgaacgccctggccgcgcgcatcaccttcaacgaacaactggccgagaccgtggccctggccaagcagggtcgccgcgaggaagcgcgcagcctgatgcagcgcctggaagcccgcgccggtcgcaatccggatctgatcggcgacctggccgaggccttcgccaccgccggcgaccccgagcacggcctggccctgctcaagccgatgatcaccggcgatacccgcccggcgcccgccatgcagctgcactacgccagcatccagctgcagctgaaccaggaccagaccgtgggcaacgtcctgcgcgacctgcagggcgtggtgctcgacagcggcgagaagcagcagtacgacgacctcctcgcgcgctatcgcatccgtcaggccgaccgcctcaccgatcagggcaagctggccgccgcatacgacaccctggccccggcgctcaaggcccgtcccgacgacaaggccgcccaggccgccctggcgcgcatgtacctggccagcggcgacacccagaaggcgcgccagctctatcgcgacgtgctcagcgaccagccgaaggacgccgagctctatctgggcgccgccgagatcgccgccaagtcccaggacagcgtcaccgcccgccagtacctggaccaggcggtcaagctaggccagagcgatcccctggtgctgcgccgcgccgccctgctctaccgcgacatcggcatggccggtaccgccaccggcctgctggagcaggtggtccaggtggagcgcaaggatcgcgaatccgcggcccgcgccgccggtgccagcgacaaccccttcgccgccctgcccggccagacccgcagcgataacgccctggccgccgttccggccgccgcgggtggcaacgccagcagcgccgactacgcctggagcgatccgctgcaggcgcagaaggctgccaacaaccccttcagcgacctgtccgtggtgcccaccagcagcctgtcgagcagcctggccaccgagcagatcctcggccagctgcagcgcgagcgcagcatccgcatcacccagggcctcagcgtacgcagctacgaccccagtggcagttcgcgccagaccaccgtcagcgcgccgctggagatctccttccccgccggcgaccagcgcctggccgtgcgcgtcaccccgacgcgcatcaacgacagcagcagcgacggcagccagaaggaaaacggcgtggcggcgtccatcgccgtggaagacgcgggccgcgggctcaagggcgacatcggcgtctcgccggtgggcctgagatacagcaccgtggttggcggcgcgaccctggagcgcccgctgagcagcctcagcgagaacctactctatgccctgagcgtatcgcgccgttcggtgaccgattccctggcgtcctatggcggcatccgcgatccgcgcaccggccaggagtggggcggcgtcaccgccaacggcggcctggcgcggctgagatacgacgacggtcgctacggctcctacatctatggcgcggcccatcgcctgaccggccacgacgtcaaggacaacgaccgcttcgagatcggcaccggcgtctactactacctgcgcaatggcccggacagcctgttcaccgtgggcctctcggccaccgcgatcggctacgacaacaaccagaaccacctgacctacggccatggcggctacttcagcccgcagcgctacttcgccatcggcgtacccctggtgtgggcgcagcgcggcgatctctgggcctaccaggtgcagggcatgctgggcgtgcagaccattcgccaggacgccgcggatcgctatccggacgacgccgccctgcaggcggccgcggaagccgccggcgaaggccagtacggcagcaagagcaagaccggcgttgcctacagcctctccgccaatggcgaataccgcctcagcgggcaattcgccctgggcggtcgcctgggcctggacaacgcccaggatgagcgcgacgtcaacggcaacctctatctgcgctacttcttcgaagagcaggaaggccgaccgcaactctcgcggccgcagccctaccgctcgcgcaacgaggaataa

SEQ ID NO: 34 - DNA, 2199 bp, Pseudomonas oryzihabitans
  source 1..2199: mol_type = genomic DNA
atgagctttctcgaccgcctggaacaggttcgccagcgccgcgcggcgcgcgctgccgacgcccagccggtgccgcccgcggcgccgctgtggctgcagctgttcgcctggacggccgccgcgttgctgggcgccctgctggtgagcgtgcccctggcgctagaagaacaggcggcgttcgccgtcggctgcttcggcgcggccctgttgctgcgtcgactgcccggacggctgccagtgatcgcgctgatcctactgtcgctgctggcgtcgctgcgctatctctactggcgcctgaccagcaccctgggcttcgagacgccgctggagatggtgctcggctacgggctggtggccgccgaactctatgccctggcggtgctggtgttcggctacctgcagaccatctggccgctacgccgcacgccggtcccgctgcccgccgacccggccgcctggcccaccgtggacgtcttcatccccacctacaacgaagccctgagcatcgtgaagctgtcgatcctggcggcccaggccatcgactggccacgcgacaagctgcgggtgcacgtactcgatgacggtcgtcgcgaggacttccgccacttctgcgcgaccgccggcgtctcctacctggtgcgcgagaacaacgagcacgccaaggccggcaatctcaatgcggcgctcaaggtgaccgacggcgagtacatcgccatcttcgatgccgaccacgtgccgacccgctccttcctgcaagtctgcctgggctggttcctcaaggacccgcagctggccatgctgcagaccccgcacttcttcttttccccggatcccttcgagaagaatctcaagacctttcgcaccgtgcccaacgagggcgagctgttctacgggctggtgcaggatggcaacgacctgtggaatgccaccttcttctgcggctcctgcgcggtgatccggcgcaccatgctggaagaggtcggcggcgtggccaccgagacggtgaccgaggatgcccacaccgcgctcaagctcaaccggctcggctacaacaccgcctacctgggcattccccaggccgccggcctggccaccgagagcctgtcgcgtcatatcgcccagcgaatccgctgggcccgcggcatggcgcagatctttcgcatggacaatccgctgctgggcaagggcctcgccctcggccagcggctctgctacctcaacgccatgctgcacttcttctatggcctgccgcggctggtgttccttaccgcaccgctggcctatctgctgttcagcgcgcagatcttccatgcctcggcgctgctgatcacctgctatgtgctgccccatgtgctgcactcgaacctgaccaactcgcgcatccagggcgaattccgccactccttctggaacgaggtctacgagacggtactggcctggtacatcctgaggcccacgctgctggcgctgatcaacccgcggctgggcaagttcaacgtcaccgacaagggcggcatcatcgccagcgactacttcgactgggagctggcgcgcccctacatcgtgctgctggcgctcaatctgctcggcctgggcgtgggtatcgctcggctgttcttaggcgatcccgaggcggtgaccacggtcgccatcaacctggtctggaccctctacaacctggtgatcgccagtgccgcggtggccgtggccagcgagacgcgccaggtgcgcgccgaaccgcgggtggccgccacgctgccggccggactcgtgctcgccgatggcagccgcctggaatgcagcaccctggacttttcccagagcggcatcggcctgaagttgcccgcgggcctgcatctgcccgagggcagcgcggtagaggtggaactcagccgcaacgggcgcagccgtcgcttcccggccaccgtggccttcagccgcgccggcgccgtgggcacccgcttcgccgaactcagcgtcaccgaacagcgcgaactggtgcgcatgaccttttcccgtgccgatctctgggccgaggcctggggcaatcaccgtccggattccctgctgggctcgctgcgcgaggtcagtcagatcggcctgcgcggcatcgccgatctcaatcgcaacgtctggcgcctgagccgaccttcccggcgcacggcgccctcctcctccgcctccctggaccgcccatga

SEQ ID NO: 35 - DNA, 1056 bp, Pseudomonas oryzihabitans
  source 1..1056: mol_type = genomic DNA
atggtccgttcgctggatattgccaatctgttccgctccttcggcggtgatccccagcgctaccatgagttcgaagcccccgagccggtgccccacgaagccctcttgccagccacagctcagccgcagcctgcgccgagcgcccaggtcgaagcggtcgtcgcggtggccgaggcggccgctcaggctgaaccggacgccctgcccccgctgtcgcggcagctggcgcagctgcacagcagccgccaggccaaccaggcggtcgccgccctggaccaggcgctgagccgcacgctgccgcggttggccggtccggtgctggcactgatgtcggcccggggcggcaccggcaagacagtcatcgccgcgggcctggcccaggcgttgagccgcagcggccagccggtgctgctggtggagctggacagtcagaacgtgctgtcttcgctgctgctgcaggaagcgtcgtccaccaccggctcggtcagggcgccgctttccgtctgcctggcagtggacgagcgcctgcgcctggtgccctttggcgcccccgacgagctggatctgcaggctctggagcaggccctggccaccgacacccagtggctgacccgccgcctgcaggcgctggacgtcccggccgataccctggtgatcctcgactgccccacgggctcgacgcccctgagtcgtcaggccctggccctggccacccggattctgggggtgacaaccgcggacgcgaccggttacgccagtctgccgcgcctcgaacgccaatggcagcgctgcagcggccaggtcactccgctgcacctgctcaaccgggtcgatcccgcccgccccctgagccaggacatcgccgccatcgtggcgcaatcctggggcgaacgcctgctgggcgtactgccggaaagccccgatctggagcaggccctggcgctgggccagggtctggccagcgtccaggacgcctgggcgcgtggcgtggccgagctgggtgaggccttgctcggcgatctccgctcgcccgtgcagcacgccgcgcgcgcctag

SEQ ID NO: 36 - DNA, 666 bp, Pseudomonas oryzihabitans
  source 1..666: mol_type = genomic DNA
atggcagccagcctcctcaccggcctcaccattctcatgatcggcgacagccatctggccacccccgactacctgatcggcaccctgcaggacagcctggtgcagcagggcgccaaggtgcacaccctgggtatctgcgggaccaacgccggcgactggctcaaggtcacccccggcacctgcggtggcgccgagcggcgcaacggcgacaaggccgtggtgcttggcggcaaggcggcgacccagccgatcaatgagctcatcgccgccgacaagcccgatctggtgctgatcgtcatgggcgacaccatggccagctacaccaatcccagctttcccaagacctgggtctggcagcagaccaccagcctgaccaaggccatcgccgccaccaagacccactgcgcctgggtcggtccgacctggggcaccgagggcggcaagtacggcaagaccttcgagcgggtcaagctgatgtccggctttctcgccagcaacgtcgcgccctgcagctacatcgactccctgagcttcgccaagcccggccagtgggccaccatcgacggccagcacctgaccggtccgggctacaagtcctggagttcggccatcgtcgaggccctgaacaagctgcccgccgacaagctcaagggagccgcccagtga

SEQ ID NO: 37 - DNA, 1416 bp, Pseudomonas oryzihabitans
  source 1..1416: mol_type = genomic DNA
atggtcttcgcctcgctggaattcctcaccctcttcctgccgctgttcctgctggtctacgccctggcgcggcccggcgggcgcaacggggtgctgctggtgggcagctggctgttctatggctggctaagtccgctgttcctgctgctgcacatggccctggcgctgctggcctggatcggcgggctgctggtggatcgcgcgcgcgaaggctcgaggacccggctgcagctgctcgccgggctgatcgtgatcaacctggcggtgctctgctggtacaagtacgccaacatcgtcgccgccacctggagccaggtgctggtgaccgccggcgccctgccgctggactggcagaaggtggccttgccggccgggctgtcctttatcgtgctgcaggccatctcctacctggtggacgtccatcgccacgtggtgccggtggagcgcagcttcgtcaactacgccacctacatctccatgttcggccattccatcgccgggccgatcatccgctacgactgggtgcgccgcgaactcaaccagcgctggttcaatcgcgagaacttcgccctcggcgcgcgccgcttcatgatcggcctgtgcatgaaggtgctggtggccgacaccctgtcgccgctggtggacgtggccttccacctcgatcagccgtccttcgtcgacgcctggatcggttgcctggcctattcgctgcaactgttcttcgacttcgccggctacagcgctatggccatcggcctgggcctgatgctgggcttccactttccggaaaacttcaaccggccctatctcgcccgcagcatccaggatttctggcggcgctggcacctgtcgctgtccagctggctgcgcgactacctctacatctccctgggcggcaatcgcggcggtcgctggcgcacctatcgcaacctcttcctgaccatggccatcgccggtctctggcacggtggcgacagctggaactacctgctctggggcatgctgcacggcctggcgctgtgcctggaccggctctgggacgaactcggcggtcggccgctgccgcggcccctggcccatggcctgaccctgctgttcgtggccctggcctggacactgttccgcgcgccggacttcgccacggcgctgtcgctgtacgccggccagttcggtctgcacggcttcgccctgggcgatgccctggccgtgaccctgagaccggtgcacggcctggccgccgccctgggcgtggcctgcatcctggctccgttgtggcagtcgcggatcgaggcgcgcctgcccggtagcgtcctgctgcgcgtcctcggcgccgcctggccggtggccggcttcctgctctgcttcgcgctgatcgccagtcgcgaagccgtgcccttcctctacttccagttctga

SEQ ID NO: 38 - DNA, 651 bp, Pseudomonas oryzihabitans
  source 1..651: mol_type = genomic DNA
gtgaaggccctgctgctgctcggtctgctggtgggcggggtcgcccaggccgaggtgtccctctaccccaccggccccagcgaagactcggccttcctccgcttcgtcaacgccgacagccagcccctggcgctgcaggcctccggctccgccgcgcgactgcagctggaggccgccaagccggtctccgattacctgatcgtgccggcgaccaaggccatcaagggcgaactggtccagggcgctgccaaggctccgctggagctgaccgtggccgccggtgaattcgccaccctggtggtgctgcccggcaccccgctggtccagcgcctggtgcgcgagcaacccgacgacttcaatgcgctcaaggcctcgctggccttctacagcctggatccgcagtgcgcgaccccgggcctgcaggcggccgggcgcaatgccgagatcttcaaggacgtggccgacggcaccctgcagcgccgcagtctcaatgccgtggcgctcaaggtgcagctgacctgcgccggccaggccacgggcgtagcgctggacctgggcgaactcaaggccggcgagcgctacagcgtgctgctgctgcctggcgccagcggtccgcggctgctcgccacccaggacgctatcgcccactaa

SEQ ID NO: 39 - DNA, 1146 bp, Pseudomonas oryzihabitans
  source 1..1146: mol_type = genomic DNA
atgagcgctcccgccctgccgccctcacccgcaccgcaaccgcccagcgccagcaacgcgcggttggccccgctcgccggagtggtcttcgccctgttcctggcgatcggcctgctgtcctgcgcctgggcgctgctcaccgatcgcctctcgctctggccggaaagggtggatcgccacgccctgctcgacggcgagatcacccaccacatcgccaaggagctggccaaggcgccattgccggaagcggccgcccgcctggaacgcggcgcaagctggctgctgctgggggacagcggaccgcgggtgcgccagggctgccccggctggctgtttctcgccgaagaattcgaggtcccgcgccaggccgccgccaatgcccgggcccgcgcccagacggtgatcgaactgcgccagcaactggccgcccggcacatccagttgctggtcgccgtggtgccggacaagagccgcatcgccgccgaccagctgtgcggactgcgacgccccgccgcctttgccactcgggtcgccgactggacgcggatgctgactgccgcgcgggtaccggtgctcgacctgaccacggcgctcacgcccctgggcagcgccgccttcctgcgcaccgatacccactggaacgaggccggtgccgaggccgcggcccgcgccctggcgctgcgcatccaggcactgcccttccaggccagcccggcacgggctttcactcgcacgctgctggcgccggcaccgcgacccggtgacctggtgcgcctggccggcctggactggctgccgccgcgcctgcagccgacccccgaggtgctgcgcctgacccaggtcgacagccgcgccgcggctggcgccagcgatgacctgttcggcgatggcgatctgcccaacgtcgcgctcatcggcacctccttctcgcgcaattccaatttcctgccgttcctggagcaggccctgggggccagcgtcgggcatttcgccaaggacggcgggcacttcgccggtgcggcgcgggactatttcgccagtcctgccttccgacaaaccccgccacagttattggtctgggaaattcccgagcgcgatttacaatcccccggccccgaggcgttgcgtctcgatccgcgtccttga

SEQ ID NO: 40 - DNA, 588 bp, Pseudomonas oryzihabitans
  source 1..588: mol_type = genomic DNA
atgtcgctgaaaaccgtctgtgtcttctgtggtgccaagcccggcgcctcgccggtcttcgccgaagcggccgcgcacctcgggcgcaccctcgccgagcgcggcctcaccctggtctatggcggtggcaaggtcggcctgatgggtgtggtcgccgatgccgccctggccgccggtggcgaagtcatcggcatcattccccagagtctcaagaccgccgaactgggccatacgggctgcactcggctggaggtggtcgacggtatgcatgcgcgcaaggcgcggatggcggagctggccgatgccttcatcgccctgcccggcggcctgggcaccctggaagaactcttcgaggtctggacctgggggcagctcggctatcacgccaagcccatgggcctgctggaggtagacggtttctatgcccagttggagggcttcctcgatcacctggtcgcccagggcttcgtcgccgcgccgcaccgcgccatgctgcaggtggaggcttcgccaaccgccctgctagacgccctcgccgcctggcagcccacggtgccgccgcgctgggccgaagcggcaccgcgctag

SEQ ID NO: 41 - DNA, 609 bp, Pseudomonas oryzihabitans
  source 1..609: mol_type = genomic DNA
atgtccttgcccgagatgaacgaattcctcggttgccgtacgccggatgcctgggtcgaggccgcgctgcaggatctgccgacgctgctgcaggatcacgccaacaacgagaagaaggccgccggcgccgccttccactatctgttcacctattccaatcgcgccgaactgtcctggaagatgtcgcgcatcgcccgtgaagaattgcgccatttcgaacaggtgctgcagatcatgaagcgccgcggcatcgagcatcgcaacgtcagctcggcgcgctatgccggcgctctgcgcaagctctgccgcaaccatgagccgctgaagctgaccgacagcctggtgatcggtgccttcatcgaatgccgctcctgcgagcgcttcggtgcggtggcgcctcatctggacgcggagctgggcaagttctatagcggcctgctggcctccgaagcccggcatttccaggactatctcaagctcgcctatctctatggcgagcgcgacgacgtcgacgccaagatcgccgaggtccgcgccctggaggtggaactgatcacctcaagcgatagcgagctgagattccacagcggtattccaaccgctgcctga

SEQ ID NO: 42 - DNA, 981 bp, Pseudomonas oryzihabitans
  source 1..981: mol_type = genomic DNA
atgaccgcccctctgccgcccgccatctttctcatggggccgaccgcctccggcaagaccgatctcgccatcgagctggcgcggctgctgcccatcgagctgatcagcgtggattcggcgctcatctatcgcggcatggacataggcaccgccaagcccggcgccgagctgctggccgcccatccgcaccggctggtggacatccgcgaccccgcggagagctattccgccgccgagtttcgcgccgatgccctggcggccatggccgagatcaccgcggccggacgcatcccgctgctggtgggtggcaccatgctctacttcaaggccctgctcgaaggcctggccgacatgcccggtgccgacgccgaggtgcgggccgagatcgaggcgctggcggccacggccggctggggcgagatccaccggcaactggccgaggtcgatccggtatcggccgcgcgcatccatcccaacgacccccagcgcctcctgcgtgcgctcgaggtgtatcgcgtcagcggccagtcgatgaccgagcaccgcgcgctgcaattgcgcgccaatgccgattcgaacggggcgccccagacgcaattaccctatactgtggcccaattgatcctggcgcccggccggcgtgaggtgctccatgcgcgtatcgccgagcgcttcagcctgatgctggaacagggcttcatcgacgaagtctcagccttgcgggaacgtcccgatctgcatcctggtctgccgtccatgcgatccgtaggctatcgtcaggtgtgggagttcctggaaggggattgcacgcgggaagagatggtggcgcgtggcgttgcggcgacgcggcagttggcgaagcggcagttgacctggttgcgtggctggcccgccgcacacaccttcgacagcctggcttgtgacaatctgccgcggatcttgaaatgcctggccggtgacaccatatcgccccgcagctga

SEQ ID NO: 43 - DNA, 1410 bp, Pseudomonas oryzihabitans
  source 1..1410: mol_type = genomic DNA
atgcgcggtccactcgccaccgactccctgccgcgcatgtccaagaagctctatatcgaaacccatggctgccagatgaacgaatacgattcgtcgcgcatggtcgacctgctcggcgaacgggagccgctggaagtcacccagaatccggccgaggccgacgtcatcctgctcaacacctgctcgatccgcgagaaggcgcaggaaaaggtgttttcccagctcggtcgctggcgcgaactcaagctggagaatcccgacctggtgatcggcgtcggcggttgcgtggccagccaggaaggcgccgccatccgtgatcgcgcgccctatgtcgacgtggtcttcggcccgcagaccctgcatcgcctgccggaaatgatcgacgccgcgcgcaccacccgggcgccccaggtggacatctccttccccgagatcgagaagttcgaccgcctgcccgagccgcgcatcgacggccccagcgccttcgtctccatcatggaaggctgcagcaagtactgcaccttctgcgtggtcccctatacccgcggtgaagaggtcagccggccgctggacgacgtcctcgccgagatcatccatctcgccgaacacggcgtgcgcgaggtgaccctgctgggccagaacgtcaacggctatcgcggcgccaccggcgacggccgcatcgccgacttcgccgagctgctctatgtggtggcggcggtggacggcatcgaccgcatccgctacaccacctcgcacccgctggaattctccgacgccctaatccaggcccacgccgagattccggaactggtgaaattcgtccacctgccggtgcaggccggttcggatcgcatcctggcggccatgaagcgcaaccacacggcgctggagtacaagtcgcgcatccgcaagctcaaggcggcggtgcccgacatctgcatcagctcggacttcatcgtcggcttccccggcgagaccgagaaggacttcgagcagaccatgaaactgatcgaggacgtcggtttcgacttctccttctccttcatctacagcgcccgccccggcaccccggcggcggacctggtcgacgacacccccgacgaactcaagaagcagcgcctgcagatcctgcagacgcgcatccaccagcagggcttcgagatcagccggcgcatggctggcagcgtccagaccatcctggtgagcgacttctccaagcgcgatcccggcatgctgcagggccgcaccgagaacaatcgcatcgtcaacttccgctgcagcgatgccagcctgatcggccagttcgtccaggtgcacatcgacgaggccctgccgcactccctgcgcggcaccctgctggcccccgtcgccagcggtgcgcgcccgcccgtcgccgtcgcgctggcctga

SEQ ID NO: 44 - DNA, 474 bp, Pseudomonas oryzihabitans
  source 1..474: mol_type = genomic DNA
atgagcgtgaccctcgaccaaccgcttccggatttccaggcccaggccaccagcggcctcgaggtctcgcccaccagcctgcgcggtcgccaggcggtgctgtacttctatcccaaggacaacacccccggctgcaccacccagggccagggctttcgtgatctgcacgagcagttccaggcggccgacaccctgatcctgggcgtcagccgtgacagcctgcgcacccacgagaatttccgcaccaagcagggctttcccttcgagctgatcagcgacaaggacgagaccctctgccagctgttcgacgtgatgcgacagaagaagctctatggcaaggactacatcggcgtggatcgcagcaccttcctcatcgaccgggaaggcgtggtgcgccagatctggcgcggcgtgaaggtccccgggcacgtcgccgaggtcctggccgccgcccaggcgctgaacaaggcctga

SEQ ID NO: 45 - DNA, 564 bp, Pseudomonas oryzihabitans
  source 1..564: mol_type = genomic DNA
atgtccctgatcaacaccgaagtgaagcctttcaccgcgaccgcctaccacaacggcaaattcgtccaggtgaccgaggccgatctgaagggcaagtggtccgccatcgtgttctacccggccgacttcaccttcgtgtgccccaccgagctggaagaccttgctgacctgtaccccgagttccagaagctgggcgtggagatctacggcgtgtcctgcgacacccacttcgcgcacaaggcctggcacgacacctcggaagccatcaagaaggtcaactacccgctggtaggcgatcccaccgctcgcctggcacgcaacttcgaagtgctgatcgaagaagaaggcctggccctgcgcggcaccttcctgatcaacccggaaggccagatcaagctgtgcgaaatccacgacaacggcatcggccgtgacgccagcgaactgctgcgcaaggtccgcgccgcccagtacgtcgccaaccacccgggcgaagtctgccccgccaagtggaaagaaggcgaagcgaccctgaccccctcgctggacctggtcggcaagatctaa

SEQ ID NO: 46 - DNA, 1560 bp, Pseudomonas oryzihabitans
  source 1..1560: mol_type = genomic DNA
atgttggacgccaatctgaaagctcagctcaagacctacctcgaacgcgtcacgcgccccatcgagatcgtcgcgtccctcgacgatggcgcgaagtcccgtgaaatgcacagcctgctgcaggatattgccagcctgtccgatcaggtcagcctcagcaccgacggcaccgatgcgcgtcgtccctccttcgccctgctgacccccggtcagaacatcgacctgcgcttcgccggtctgcccatgggccacgaattcacctccctggtactggccctgctgcaggtgggcggtcatccgtccaaggccagccaggacgtcatcgagcaggtcaaggcgctcgacggcgactaccagttcgaaacctatttctccctctcctgccagaactgcccggacgtggtgcaggccctgaacctcatggccgtgctcaatccccgggtcaagcacgtcgccgtcgacggcgccctgttccaggacgaggtcgagcgccgccagatcatggccgtgcccagcgtctacctgaacggcgaacccttcggccagggccgcatgggcctggaagagatcgtcgccaagctcgacatcggcgccgccgcccgctccgccgacaagctcaacgccaaggacgccttcgacgtcctggttatcggcggtggcccggctggcgctgccgctgccgtctatgccgcacgcaagggcatccgtaccggcgtcgccgccgagcgtttcggcggccaggtactggataccctcgccatcgagaacttcatctccatcaaggagaccgaagggccgaagctggccatggcgctggaagagcacgtcaagcagtacgaagtcgacatcatgaacctgcagcgcgccgagcagctgattccggcccacgaagccggcggcctgcacgaagtccgcttcaccgatggcggctcgctcaaggccaagacactgatcctggccaccggcgctcgctggcgcgagatgaacgtccccggtgagcgggaataccgcaaccgcggcgtggcctactgcccgcactgcgatggccccctgttcaagggcaagcgcgtcgccgtgatcggtggcggcaactcgggtgtcgaggcggccatcgacctcgccggcatcgtcgcccaggtcaccctgatcgagtacgacggccagctgcgtgccgacgccgtgctgcagcgcaagctgttcagcctgcccaacgtgaccgttatcaccagcgccctcaccagcgaagtcaagggggacggccagaaggtcaacggcctggtctacaaggatcgcaactccagcgagttccaccacctcgacctggaaggcgtcttcgtgcagatcggcctggtgcccaacaccgactggctcaagggtaccgtcgagctgtcgccgcgcggcgagatcgaagtggacgcccgctgccagacctccctgcccggcgtcttcgccgcgggcgacgtcaccaccgtgccctacaagcagatcgtcatcgccctgggcgaaggcgccaaggcctccctggccgccttcgatcacctgatccgcaccagcgcctga

SEQ ID NO: 47 - DNA, 936 bp, Pseudomonas oryzihabitans
  source 1..936: mol_type = genomic DNA
atgaccctagccctttcccagaccgccgatgtgcagaagttcttcgaagtcgccagcggcttcgagcagaccgccggcaatccgcgcctcaagaccttggtgcaccgcatcctcaccgacagcatccgcctcatcgaggacctggaggtgacgcccgaggaattctggcaggcggtgagctacttcaacgacttgggcgcgcgccaggaagccggactgctggtcgccggcctcggcctggagcactacctggatctgctgctggatgcccaggacgaacaggccggccgcaccggtggcaccccgcgcaccatcgaaggtccgctctatgtggccggtgcccctctgtgcgaaggcgaagcccggctcgatgatggccaggacgccggcgtgccgctgttcatgaccggccaggtgcgcgacaccaagggtcgcccgctggccggcgccctggtggacgtctggcacgccaacaccggcggcacctattcctacttcgatccggcgcagtccgaattcaacctgcgccgacgcatccgcaccgacgccgagggccgctacgccttccgcagtatcgtgccctccggctacggctgcccgccggacggccccacccagcgcctgctcgacggcctcggccgccatggccagcgcccggcgcacatccacttcttcatctctgctcccggccatcgccacctgactacccagatcaacctggccggcgacaagtacctgcacgatgacttcgcctacgccacccgcgacgaactcatcgccgacatccacttccacgacgacgccaacgccgcccgcgcgcgcggtctcgacggcagccagttcgccgagatcgacttcgacttcgaactgcagcccgccgaagagcccaccgccgaacagcgtagcgcccgcccgcgcgccctcgaagaagcttga

SEQ ID NO: 48 - DNA, 1143 bp, Pseudomonas oryzihabitans
  source 1..1143: mol_type = genomic DNA
atgatcagcatcgaacgcctggacacctgcctcgtcgacctgcccaccatccgcccgcacaagctggccatgcataccctgcagcggcagaccctggtgctgttgcgcctgacctgcagcgacggcagccagggcctcggcgaggccaccaccatcggcggcctggcctacgccggggagagcccggaaagcatcaagaccaacctcgacacctatctggcgcccctggtgatcggtcaagacgccgacaacctcaatgccgtgatgcagcgcgtggagcgcaacgtgcgcgccaataccttcgccaagtcggccctggagaccgccctgctcgatgcccagggccagcgtcgcggcctgggcatcgccgaactgctcggcggccgggtacaacagggactggaggtggcttggaccctggccagcggcgataccgccaaggacgtcgccgaagccgaacgcatgctcgacctgcgccgccatcgccatttcaaactcaagatcggcgcggccgaaccggcccgggacatcgcccatgtggcggccatcaagcgcgctctgggcgatcgcgccagcgtgcgggtcgacgtcaaccaagcctggagcgaaggcgtggccctgcgcgcctgccaggccctggccgacgccggggtggagttgatcgaacagccggtgccgcgtcatgacgtccaggccctggcccgggtcagtacccgcagtccggcgccggtgatggccgacgaagccatcgagagcctccccgacgccttcgccctggcccgtgccggtgccgccccggtattcgcgctcaagatcgccaagaccggcggtccgcgggcggtgctcaaggtggctcacctggcccaggcagccggcatcggcctctatggcggcaccatgctcgaaggcagcatcggcaccctggcctcggcccatgccttcgctaccctggagcggctggactggcacagcgaactgttcgggccgctgctgctcaccgaggacatcctcgtcgagccgccgacctatcgcgacttccagttgctgctgccccagggccccgggctcggcgtcagcctcgacgaagaccgtcttgcccatttccgtcgcgatcgcagcagactcgccgtcgccaccgcctga

SEQ ID NO: 49 - DNA, 2130 bp, Pseudomonas oryzihabitans
  source 1..2130: mol_type = genomic DNA
atggctacgccccccaagagtgaactcgccggtaccgacaccctggatcgccagaacacctcgaagaaaatcgagcaactggagcaatttcgctccgatgccaccggccaggcactgcgcaccaaccatggcgtgaagatcgctgacaatcagaattcgctgcgcgccggcacccgcggtccttccctgctcgaagacttcatcatgcgggagaagatcacccacttcgaccacgagcgcatcccggagcggatcgtccatgcccgcggcaccggcgcctacggctacttccagccctaccaggactggtccgacctgaccaaggccgcgctcttccgcgaccccaaccaccagaccccggtgttcgtgcgcttctccaccgtgcagggcccgcgcggctccggcgataccgtacgcgacgtgcgtggcttcgccatcaagttctacaccgaggaaggcaactgggacatggtcggcaacaacatgccggtcttcttcatccaggacgccatcaagttccccgacttcgtccatgcggtgaagcctgagccgcacaacgagatccccaccggcggcagcgcccacgacaccttttgggacttcgtctccctggtgcccgagtcggcgcacatggtgctctggaccatgaccgaccgcgccatcccggtgaatctgcgcagcatgcagggcttcggcatccacaccttccgcatgatcaacaccgccggcaagggcgtcttcgtcaagatccacctcaagccagccggtggcgtgcgctccctggtgtgggacgaagcccagaagctggccggcaaggacactgacgcccaccgtcgcgacctctgggaagccatcgaggccggtgactaccccgagtgggaattcggcgtgcagatcattcccgaggaagacgagcacaagttcgactgggacatcctcgacgccaccaagatcatccccgaggagctggtgcccatcaccccgctgggcaagctggtgctcaatcgcaacccggacaactacttcgccgagaccgagcaggtggccttctgccccggccatgttgtgcccggtatcgacttcagcaacgatcccctgctgcagggtcggctgttctcctacaccgacacccagatcagccgtctcggtgggccgaacttccacgagctgccggtcaaccgcccggtggtgccgaaccacaacggccagcgtgacgccaagtaccgcatgaccatcgacaagggtcgcgcctcctacgagcccaattccatcgatggcggctggcccaaggaaaccccgccggcgccccaggatggtggcttcgagagctactacgagcgcatcgacggccacaaggtgcgtgagcgcagcgagaccttcggcgaccacttctcccaggccacgctgttctacaacagcctgtcggaagccgagcaggcgcacgtcgccgatgcctacagcttcgagctgggcaaggtcgagcgcatgtggattcgcgagcgccaggtcaacgagatcctcgccaacatcgatctggagctggcgcagaaggtcgccaagaaggtcggcgtgaccccgcccaccgcccccaccgtgcagccgcgcaaggtctccatcgacaagtcgccggcgctgagccagctcaacctgctgtccggcaacatcaagggcttcaaggtggcggtgctggtgggtgacggcgtcatcgccagcgaggtggacgccatcaagcaggcgctcaaggccgaaggggcccatgtcaaggtgctcggccccaccgccggcccggtcaaggccgccgacggcagcgaagtggccgtggacggctccgccgaaggcatgccttcggtggcgctggacgcggtctatgtgccgggcggtgccgagagcgtcaaggccatgctcgacgacggcgtgatcaagcactacctgctggaagcctacaagcacctcaaggccatcgccctcaccggcgaagccgagcagttgctcaaggcggtctacctggacaccgacgaggcgctgctcaccggcagtgacttcaaggcggtccagcaggacttcttcgctgccatcgccaagcaccgttgctgggcgcggatgccgaagatcaagtccatcccggcctaa

SEQ ID NO: 50 - DNA, 1569 bp, Pseudomonas oryzihabitans
  source 1..1569: mol_type = genomic DNA
atgagcgacgacaagatcactctcacgacccgccagggtcatccggtacgggacaatcagagcctgcgcagcgtgggcgagcggggtcctgccacactggaaaactaccagttcatcgagaagatcacccatttcgatcgggaacggatgcccgagcgggtggtgcatgcccggggcaccgccgcccatggctggttcgaggcctatggcaccatcggcgacgaacccgccagccgctacacctgtgccaaggtgctgaccaaaaccggggtgaagacgccggtcttcctgagattctccaccgtcattggggccaaggagtcgcccgagaccgcgcgcgatccgcggggcttcgcgatcaagttctataccgaggacggcaactgggatctggtgggcaacaacctcaaggtgttcttcattcgcgacgccatcaagtttcccgacatgatccatgccttcaagcccgaccccatcaccaatcgccaggagccctggcgcttctacgatttcgtccagcatcacccggaagctttgcacatggtgacctgggtgaagagcccctggggcatcccggcggactatcggcacatgcagggttccagcgtgaatacctacaagctggtcaacgaccagggcgtggcggtgctgtgcaagttctccttcgagcccaagcagggcatccggaatctcaccagcgagcaggcggccgagatccagaagtatgatgtgggccatgccagtcgcgatctctacgacgccatcgaacgcggcgatcatcccgagtgggagatgtgcgtgcagatcatgacggacgaggcgcacgacgaactgcccttcgatcccctggacgacaccaagcgctggccggaagaccagtttcccctgttgccggtgggccggctggtgctggatcgcaatccctcgaacgtcttcgccgaaaccgagcaggccgccttcggcacgggggtgctggtggagggcatcgacttttccgacgacaagatgttgcaggggcggaccctgtcctattccgatacccagcgctatcgggtcggcgccaactatctgcagttgccgatcaatgcgcccaaatgtccctacgccaccaatcagcgcgatggccagatggcgctgcaggtggatcgcagcgggagcaatccacacgtcaattacgagcccagctcccagggtggcctgagcgaggcgccgcggccgcagcacgagtatcgtcaatggatcgaaggccatctggggcgctatcaatcccgcaagacggctgccgactaccagcagaccggtgcacgctatcgcagcttcgaagactgggaaagggacgatcttatcgccaacctggtcgccgacatgcaggcctgtcccgcagacatccagttgcgcatggtctggcacttctggcactgcgatccggactatggcacccgggtggcccggggcgccggcatcgacctggaaaaggccaaggcgctaccgaatctgccgggccatcctgcgccaaacgaggacgtggctgaacccacctaccagggtggggagctggaaagccgttga

SEQ ID NO: 51 - DNA, 2262 bp, Pseudomonas oryzihabitans
  source 1..2262: mol_type = genomic DNA
atgtcgaccgaatccaagtgcccgttcaatcacgccgccggcggcggtaccaccaacaaggattggtggccgaaccagctcaatctcaacttcctgcaccagcattcctcgctctccgatcccatgggcgaagagttcgactacgccactgaattcaagagcctcgacctggaagcggtaaaggccgacctgcgcgccgtgatgaccgattcccaggactggtggccggccgacttcggtcactatggcccgctgttcgtgcgcatggcctggcacagcgccggcacctatcgcgtcggtgacggccgtggcggcgccggtcagggtcagcagcgcttcgcgccgctcaacagctggccggacaacgtcagcctggacaaggcgcgccggctgatctggccggtcaagcagaagtatggccgcaagatctcctgggccgacctcatcgtgctcaccggcaacgttgccctggaatccatgggcttcaagaccttcggcttttccggcggtcgccaggacgtctgggaaccggacgacgcggtgttctggggctcggagaccgtctggctggggggcgatgtccgctacggcgagcacaagcagatggagcagcccggtgacggcgtgctgaccgcacagcccgagcagcatccggtcgagcagagccgcaacctgggttccagccgcctgctggagaacccgctggctgccgtgcagatgggcctgatctacgtgaaccccgaaggtcccaacggcaaccccgatccggtggcctcggcccacgacattcgcgaaacctttggccgcatggccatgaacgacgaggaaaccgtcgccctgatcgccggcggccacgccttcggcaagacccacggtgcgggcccggccaccagcgttggtgccgagccggaagcggccgacctggaacagcagggcttcggctggcagaacagctatggcaccggcaagggcgccgacaccatcaccagcggcctcgaagtgacctggacctccacgccgacccgctggagcaacgaatacttcgagaacatgttcaagttcgagtgggaactgttcaagagcccggccggtgcccaccagtggcggccgaaggatggcgccggcgccaatgccgtgcccgatgcccacgatcccagcaagcgtcaccagccgaccatgctgacctcggacctggcgctgcgcttcgatccggcctacgagaagatctcccggcgcttcctggaaaatccggaccagctggccgatgccttcgcccgtgcctggttcaagctgacccacagggatatggggccgctggcccgttacctgggcccggaaaccccggccgaagagctgctctggcaggacccgctgcccaaggccgcaggcgcgcccctaggcgaagccgaggtcaaggcgctcaaggacaagctggccgcatccggcctgagcgtgtccgaactggtcggcaccgcctgggcggcggcgtccaccttccgcggttccgacaagcgcggcggggccaacggtggccggctgcgcctggcgccgcaaaaggactgggccgtcaatcagccggcgcaactggccaaggtgctgggcgtgctggagggtatccagcgcgacgtccaaggtcagggcaagcaggtgtccatcgccgacctgatcgtgctggccggtagcgtcggggtggaaaaggccgcccaggcggcgggtcatgcgatcaccgtgcccttcaccctgggccgcgtggatgcctcccaggagcagaccgacgtcgagtccttcgggtacctggagccctgggccgatggcttccgcaactacgtgggtggtcagttcaaggtcaagccggaattcctgctggtggacaaggcgcacctgctgaacctgaccgcgcccgagctgacggtactgctgggcggcctgcgtgtgctggacatcaacgtcggcggcgccaagcacggcgtcttcacccagcggccgcagaccctgaccaacgacttcttcgtcaacctgctggacatggccaccgagtggaaggccaccggtccggacaaggccaccttcgagggtcgcgatcgcaagaccggcgccctgaagtggaccggcacccgggtcgacctggtgttcggctcccacgcccagctgcgggcgctgagcgaggtctatggcagtgccgacgcccaggagaagttcgtcaaggacttcgtcaaggtgtggaccaaggtgatggagctggatcgcttcgatctgcgctga

SEQ ID NO: 52 - DNA, 417 bp, Pseudomonas oryzihabitans
  source 1..417: mol_type = genomic DNA
atgaacattctctataccgcttccgcaaccagcaccggtggccgtgacggccgttccatcagcagcgacaaggccctggatgtgcagctgtccacgcctaaggagctgggcggcgccggcggtgccggcaccaatcccgagcaactcttcgccgccggctattcggcctgcttcatcggcgcgctcaagttcgtcggtgccaaggaaaagatcgccgtgccggcggaggtcagcgtgaccgcccaggtcggtatcggcccgatccccaccggcttcgccctggacgtcgagctggtcatcagcctgccgggcctggagcgcgccgtggccgaagacctggtcgagaaggcccaccaggtctgcccctactccaacgccacccgcggcaacgtcgacgtgcgcctgaccctggcctga

SEQ ID NO: 53 - DNA, 528 bp, Pseudomonas oryzihabitans
  source 1..528: mol_type = genomic DNA
atgaaaatctggaccgcgaccctgttggccacctgcctggtcggcaccgcccaggcagccgaatccctgacgatcccgctgaacaaggtcacgaccgacggtgtgggcgaaagcgtcggcagcgtgcaggtgacccgctccaagtacggcctggtcttcacgccggatctcaagggcctggagcccggtatccatggcttccacgtccacaccaagcccaactgcggcgcggccgaggtgaacggcaccctgaccgcagggggcgcggcgggcggccatctggatccgcgcaacactggcaagcacagcgcgccctggtcggacgacggccacctgggcgaattgccggcgctctatgtgaccgccgacggccaggcgcttcagccggtgctggcgccccgcctgaagcgcctggaagagatcaagggccatgcgttgatggtgcatgccggtggcgacaactacgccgaccagcccaagccgctgggcggtggcggcgcacgcgtcgcctgcggcgtcatcaagtag

SEQ ID NO: 54 - DNA, 615 bp, Pseudomonas oryzihabitans
  source 1..615: mol_type = genomic DNA
atgccgcatactctgcctcagctgccctacgcctacgacgcgctggaaccgcacgtcgatgcccagaccatggaaatccaccataccaagcatcaccagacctacatcaacaacctgaacgcggcgctggaaggcaccgagttcgccaacctgtccgccgaagacgtggttcgccagctggacaagctgccccaggacaagcgcggcgccgtgcagaacaacggtggcggccatgccaaccacagcctgttctggaccgtgatggcccccaatgccggcggcaagcccgaaggcgccctggccgaagccatcgagtcccagctgggcggcttcgacgccttcaaggaagccttcaccaaggctgccctgacccgcttcggcagcggctgggcctggctgagcgtcacccccgagaagaagctggtggtcgagagcaccggcaaccaggacagcccgctgatgaccggcaacaccccgatcctcggcctggacgtctgggagcacgcctactacctgcgctaccagaaccgtcgtcccgaatacatcggtgccttcttcaacgtcatcaactggccggaagtgtcccgtcgctacgaagcggcgctgaacgcctga

SEQ ID NO: 55 - DNA, 1458 bp, Pseudomonas oryzihabitans
  source 1..1458: mol_type = genomic DNA
gtgactgataccaagatcctcaccaccgccagcggcattccggtggccgacaaccagaattcccgcaccgccggtccgcgcggtccgctgatgctcgacgacttccatctgatcgagaagctggcgcatttcaaccgtgaagttattcccgagcgacgcgtgcatgccaagggctccgcggcctatggcacctttaccgtcacccgggacatcacgcacctcagcagcgccaggctgttcgccgaggtcggcaagcggaccgagaccctcctgcgcttctccacggtgggcggtgagcgcggctcggcggataccgagcgcgatccccgcggtttcgccgtgaagttctacaccgaagaaggcaactgggacatcgtcggcaacaacaccccggtgttcttcatccgcgatccgttgaaattccccgacttcatccatacccagaagcgcgatccctggagcaacctgaaaagtccgcagatgatgtgggatttctggtcgctgtcgcccgaatcgctgcatcaggtcaccatcctgttctccgatcgcggcattccggacggctatcgcttcatgcatggcttcggcagccataccttcagcctgatcaacgcccagggcgaccggcacttcgtgaagtttcacttcaagagccagcaggggatcaagaacctggcgccggccgacgcggcacgcctggccggtaccgatccggactacagccagcgcgacctgttccaggccatcgagcgcggcgaattcccgcgctggacgctgtgcatccaggtgatgagcgaacaggaagcagctagccgtgccgagaatcccttcgatgtgaccaaggtctggtcgcagcaggactatccgctgcaggaggtgggggtgctggagctcaaccgcaatccgcagaactacttcgccgaggtggagcaggcctccttcgcgccgagcaacgtggtgccgggcgtggggctgtcgcccgatcgcatgctgcagggcagggtattcgcctatgccgacgcccagcgctaccgggtgggcaccaactatcagcaactgccggtcaacgcaccccgttgcccctacgccaacaaccagcgtgacggggccatgagattcgatggcaatggcggttcgcagccgaactacgagccgaacagctatggccacacgcccaagcaggcgccccagtatcgcgagccggcgctgaacttcgccggtccggccgatcgctacgatcaccgggtggatgaggactacttcagccaggccggagcgctgttccgtttgatgaatgccgaccagcaggcgctgctgatcggcaacatcgtcggcgccctgggtacggtgacccgcgaggtgcagctgcggcagatcggtcacttcctcaaggccgatcctgcctatggcgtgggcgtggccaagggcctggggatagatcccagcgaagtagcctga

SEQ ID NO: 56 - DNA, 315 bp, Pseudomonas oryzihabitans
  source 1..315: mol_type = genomic DNA
atgttcaagctgtgtttctacgtcccggactcccacctcgaagccgtcaagcaggcgatcttcgccgtgggcggcggtcgcattggtctgtacgacagctgttgttggcaggtccagggccgcggccagtttcgcccattgcctggcagccagccgcacctgggcgagcagggcagtctcgaacaactggaggaatggcgggtggagctggtgttggccgacgagccgatcgcccgccaggccgtggcggcgctcaaggcggcgcatccctatgaaacgccggcctatgacgtggtgcaggtgctggatttctag

SEQ ID NO: 57 - DNA, 516 bp, Pseudomonas oryzihabitans
  source 1..516: mol_type = genomic DNA
atgaacatcacgcgtctgctcgtcgccagtgtcgccaccgtgctcctggccggctgctcgagctttacccgacccagcggcgaagccctgcccaaggatgcccgctggggcctggtgcccctggccaactatgcccaggcacccatggccggcgatcgcgcggcgcagatcctggtcagcgtgctcggcgagcgcggcatccgtccgcaggtctacgacgacagccagggcggcaatcccaccgacgacgaaaaggcccgccagcgcgcggccctggactgggcgcggcagcagaatctgcaatacgtgctcaccggcagcgtcgacgagtggcaatacaagaacggcctggacggcgaaccggcggtgggcgtgaccctgcaggtggtcgagccagccagcggccgggtggtctggagcaacagcggcgcccgctccggctggtcgcgcgagagcctggcggccaccgcgcaaaaggtcctgcgcggcaccgcgcaagagctgcagctgcgctga

SEQ ID NO: 58 - DNA, 1524 bp, Pseudomonas oryzihabitans
  source 1..1524: mol_type = genomic DNA
atgaaagacgcccccgccgcgaccgtcacccccgatgtctgcctgctcctggagggcacctggccctatgtgcgcggcggggtgtcgagctgggtcaaccagttgatcctcggcctgccggagctgaccttctcggtgttcttcatcggcggccagcgcgagaactacgagaagcgccactacgccatcccgcccaacgtggtgcacattgaggaacacttcctcgccgggtcctgggtgcccaaggcggcgcccatcagtccgcggcgccaggcgccggtgcagctgctacgcgacctgcacgccttcctgcaccaccccgacgaacccagcgccgcccagggcgatgccctggtggacgccttcgcccagggcagcgtgacgctggacgactttatgtacagccgcgccagctgggaggccatcaccgagggctacgagcgctattgcaccgatccctccttcgtcgactacctctggaccctgcgcgccatgcaggcgcccttgctgatgctggccgaggccgcgcgccgcctgccgcgtccgcggatgatccactccatctccaccggttacgccggcatgctcggcgccatcctgcagcggcgctggggctgcaacttcctgctcagcgagcacggcatctacaccaaggaacgcaagatcgacctggcccaggccaagtggatcgccgaagggccggacgaggccctgcgcaccgggctggacgtggacgtcagctacatccgccggctgtggatccgcttcttcgagcgcatcggcctgctcacctacaaggccgccgatccgatcatctcgctctatgacggcaaccgccgccggcagatccaggacggcgccgatcccgcgcgctgccgggtgattcccaacggcatcagcctcacccagtggcaggacgccctggagcgtcgcccggaaggggtgccgccggtggtcgggctgctcggccgggtggtgccgatcaaggacgtcaagaccttcatccgcgccatgcgcggggtgatcagcgccatgcccgaggccgaggcctgggtggtcggccccgaggacgaagacgaggaatacgccgccgaatgccacagcctggtcaccagcctgggcctggagggcaaggtgaaattcctcggcttccagaagatcggcgacatcctgcccaagctcggcctcatggtgctgacctccatcagcgaggcccagccgctggtgatcctcgaaggctgggccgccggggtgccggtggtgagcagcgacgtgggttcctgccgcgagctgatcgagggttccatccccgaggaccgcgccctgggcaccggcggcagcgtggtcgccatcgccgatccccaggccaccgcccgcgccatcctcgccctgctgcgcaatcccggtcgctggcaggccgcgcagcgcaccggcctcgcccgggtcaatcgctactacaccgagccgctgatgctggaacgctatcgcgagctctaccaggacgccatcgggagggtcgtctga

SEQ ID NO: 59 - DNA, 990 bp, Pseudomonas oryzihabitans
  source 1..990: mol_type = genomic DNA
atgaacagcaagtggctgtttagcggcgccttcgccttcgaggccagcagctgggcgctgctgttcgccaacctgccggtggcggcggcggctctggctttcgccgccgcccatgctgccggcagcgccctgctggcgggcggtgcctggctgctgctgccccgacgctatcagcgtccgctgccctggagtccgctgtttctcttcgccctggcctacttcattccgctgctgggtgcggtcggggtgatcaccgcggtgtttccggcgctctatctgccgcgcaagcagcgcgagatcgcctgggaggcgcgcagcgtgcccaatctgccgttccgcccactggagcggcgcgaggagatgctgttcagcgacggcggcctgcaggacgtgctgcgccatgcgcccagccccgacaagcgcctgaccgcgctcttcgccacccgccgcatgccggggcgtgacgccatccccatcctcaagctggccctgcgcgatccggccgacgacgtgcggctgctcgcctattcgatgctcgaccagcaggaaagccagatcaaccagcgcatcgaggtccagctcggcgagctggccagcacccccgccgagcgccagccggcgctgcacggcaccctggcccgcggctactgggaactggcctacctgggcctggcccagggcagcgtcctgcgtcacgtgctcggccaggcccgcgaacacatcgaactggccctggccggggaagaaaacgaagagttgcgcatcctcgccgggcgcatcgccctggagcagggcgagcccgagcgcgccctggagttctttcaggacgctgaagcggcgggcgtgcccctggcccagctggcgcccttccgcgccgagatcgcctttctgcgccgcgattacgcggtcattccggcgctgctcgacagcctgccggcggatctgaagaagcggccgccgttcgccgccctggtgaagtactggttatga

SEQ ID NO: 60 - DNA, 1374 bp, Pseudomonas oryzihabitans
  source 1..1374: mol_type = genomic DNA
atggccctgcaatccgtccacaaggactacaccctggcgccccgcgccagtggccgcctgtcctggctggagaccctgctggtcacggcggccgccctggggctgggcttctggctggtgccggaagatcccctgatggtcggcctggcctttccctgggtggtgttcgcgcccatcctcatgggcgtgcgctatggcttcatgcgcggcctggtgagtgccagtctcttggttgtggccctgctctatctgcaccgccagggctatccggcctacgaggagatcccgccgtcctttatcgtcggcgtgctgctcagcgccatgctggtgggcgaattccgcgacctctgggatcgccgcctggaacggctggacctggccaacgactatcgccagctgcgcctggacgaatttacccgcgcccaccacctcctgcgcatctctcacgaccgcctggagcagcgcgtcgccggcaacgacctcagcctgcgcagctcgctgctggacctgcggcgccagctgcgcgaggtgccccgcgagcaggatgccctgcaggctctggccgagcccatcgtcggcctgctgacccagtacggttcgctgcgggtagcgggcctgtaccgggtcgacgacaacggccgggtggatcgtcgcgccctcgccagccagggcgagatgcccggcatcgatcccgacgacctgctggtgcgcctgaccctggagcgcggcgagaccctgagcatccgccaggcgctgctggaacgcggcgaaacccagcattcggcgctgcaggcctgcgtgccgctgctggacaccgaggagcggctgctggcggtgctggccatcgagcagatgccgttcttttccttcaacgaacgcaccctcaatctgctgaccatcctcgccggccacatcgccgacctcctgggcagcgatccccaggcgctggccctggccgacgacgacgcccagcaattctcccagcacctcaagcgctcgctgcgcgacgcccagcagcacgccctgcccgcctgcctgttctgtttcgagatgaccgaggccgacggtggcgaacgggccctggcgctgctggaaggcagtcgtcgcggtctcgacctgcaattgcgcctgaccaatcaggccggtcacccctgcctgctggtcctgctgccgctgacctcctccgacggcctggaaggctatcggcgccggctgcgccagctgctggccgagcgccatggccaggacagcaccctggaaagcctgggcgtgcgcagccacgagcacgagctgctgcccaagacccgcgcccaggagttgcgcgtcttcctgttcaacgagtgtggcctgcatgaacagcaagtggctgtttag

SEQ ID NO: 61 - DNA, 1113 bp, Pseudomonas oryzihabitans
  source 1..1113: mol_type = genomic DNA
atgaaaaccaaatttaccgctctggccttgctgtctggcatcgtcctgcagggttgtgcctattctccgggtcagtacctggatcaggacgacctgaagagcgatccgagcatccagggcaccaaggtccagctgattccgatcaccagctcgctgctgatgagccaggattccgcggccctgtccaaggctcccgacctcaagcccctgctggactacaagccgcaggcttaccgcgtcggtgcgagcgacctgctctacatcaccgtctgggatcaccccgaactgaccgctccgtccggcgcccagcagcagctggaagccaacggtcgcctggtgcgcccggatggcaccctgttctacccctacgtcggcaccgtgcgcgccgccggcaagaccctggaagagatccgtaccgacatctcccgtcgtctggccaccttcatcgacaatccccaggtcgacgtcagcgtgctgaagttcggcagccagaaggtcaccatttccggcgccgtgaacaagggcgatgccattcccctgaccaccaagcccatcaccctggtggaagccctgggtcaggccggcgtggccaacagcggtggcgccgacctgaccggcgtgaccctggtgcgcgacggcaaggaataccgcctggacaccgacagcctgaaccgcaaggattccaagctgtacggcatctacctcaaggacggtgacagcctccacctgccctacaacgatgcgcgcaaggtctatgtggtcggtgaagtccgcgccccggcagcggtcagctacaagatcaccaatctgaacctgatggaagccctgagccaggccggcggcatccagcaggaaaccgccaacgccgatgccgtctacgtcatccgtggcccggaagacctgaaggccccgggtgccactgcccaggtcttccatctggcggccaagaaccccaccgcctacgtgctggcgcagaacttccatctgcagccgcaggacgtggtcttcgtcggcccggccggtatcacccgctggaaccgcttcgtcagccagctgttgggctcgaccaacatcctctccaccagcgccaacctgaacagcagcttcaagtaa

SEQ ID NO: 62 - DNA, 3597 bp, Pseudomonas oryzihabitans
  source 1..3597: mol_type = genomic DNA
gtgagatcgtctgcggctaagaaaacccggctcctgagtggttggacgctgctggggatcgcgctcctcaccgcactggtgctggtgctgacctttcatggcaagcaggtcttcctgcccggcgaggaaccggccgaccaggtgtccatcagctacgcccaggtgctgctcaaggcgacgccggacgacaccgggctgcgcatgaagctgatcgaccagctgatcgccctggggcgaatcgacgaggcgcgtcgccagctgaaactgttgccggcacccctggcgtcgacgcccttctatgccctggagctggacatcctgcaggcggaagcccagccacaaggcctggccgacgccgatcgcgagcggctggcccaacggctgagcgccttggacgtggcgaccctgagcacgccccagctgcaacgggtggccgaacgcgccctgcaactgggcgatccggccacggcggcgcagagttatgtcgaactggcccgccgcgatccgccccggcgccagcaatggctggaacaggcggcgcgctggagcctggccggcggtcggcagcaggaggccgcgcgcctctatctgcgcctggccgatctcgccgattcggccgaacagcgccagggctaccggcaccaggctttcgatgcctggctcgccgccggccagggtgccgaagccgccgccctgctggagcaggaattgccgcggctgcaagccgatgccagcggtctggcctggctgcaggccggggtggccgccgcccagggcagcggacgtttggatctggcccagcgcctgatcgaccgctggcgcgagtggcaaccagacgatcccgccgccctggaggccgcctaccggctggccctgggccgaggcgacaccgaacgcgcctgggaggaaggtcatcaactgctggcgctgcgtccggacgatgaaaaactgctcgcggaactggcccagctgggcgagtggaccggccatatggacgaagccctcgacctctggttgcgcctgctggcacgccaggacgatccgcaacgccgcgatcatgcctggaagctggccgcccgggcgtttcgcttcgatgccgtggtcgagttgctggccgaggcgtcccggcaacggcagctggacaagaccgaactggatgcgctgatcttcgcctacgaatccctgggcgaccccgccgccgaggagcgctggctgcgggactacttgaggcgtcaaccgaagcagcgcctggcctgggagcggctgcagcagctgctggctcgtaccgagcagggcgacgccgaagccgcaggctgggcagcgttcggcaagaggttcccgctgaccagcgcggagtatctgacctgggccggcaccctctgggagctgttcaagcccgaagaagcctggaaggtgctcgagggcatgccagccaagcagcggcagggcgtcgactactggcggctgcgggcggagctggcctgggagctggagcgcgacggcgaggcgcagctggccttcgaacgcctggccacgatcgacaagggcatgaccgccaacgacgaggagcgactgctggcgatctatctgcgcactgcaccgcgcaaagccctagccttgctggaaaagagctgggaaaagagcaagaaccagaagcgcctgaccgacgccctgcaatgggccgaacaactcaaggatacggcggcgctggagcggctgctggccagtgccgcgcgcgagccggcctcggccgacaatcccgcggtctggctggcgcggtcggggctggacttccagcgcgggcgcatcgccgaggccgaagagggctatcgccaggccttgcagcgctttccggatgacgaccgcttccgcgaacggctgctgtggctgctcatcgatcagaatcgccagaccgaactggccaccctgctgcgcgactggaagggccgggcgcgggacagcgatgtgctctggctgcccttcggcagcggtctggtgctgctgggccaggcggaagaggcgcttggctggtatcgccgctacctggacgcccatccccaggactggctggtgcaggccgcctacgccgacgccctggacgccgccggtcaccaggacgcggcgctgcggctgcgcaaggccgtcacgccgcacctggccaacgacgaggtgccagccacccccgagcgctacgccacctacctgcgcctgctctccagcctgcgcggcccccaggcggccctggcccaggcgcgtgcctggcaggatggctcgccgagcatgctgcaactctggttcgatcagtggctcgacgccctcagccagaacaacgacgacggcctcaagggcgaatggctggcctgggccaagagccgtggcctgaaggtgcgtcagtacgagcagttgcaggaagtcctgcgccggcagaatcgcggcgagctggagaaactgctggcggccggcgatctggatccggcgcagcgcgtcgaggtgctgcagcgcctcggccatgtcggcgacgcccaggccgcggccctgacggccgccggtgacgagccgccggaggtcatccagcggcagctgctgcgccaggccaccgagcaggccgagcgcacccccaacggcgtccaggccggctgggaacgccgcgactatggcggtctgatcgaacagggcaccgaggtgcgcgccgcccggcgactcagcgatgacctctatgccgatgtccagctcaagcagaatcgtgtggagagcagcggcctcaagtccgatgccctgggcaacgaacaccagatgctgctcaaggtgctgaagaatctggccgatggcggtctggaaaccaccgtggacgccagtcagcgttcggacagcaatcgcctgggcctgggcgtcgcccgcacctggcgtatcgatggcaacaccgagatcgaggcggccctggactggcaccggcaacccgacgagagcggctatctgcgcgccctcggccggcgggacagcgtcagcctggccggccgccacaacctcacgccacgcgaccagctgagctggcgagcggcgcacaatcgctattccagtcgggacggcgatgccctgggcagcggcttcgccttcaacctggagctgagccacatgatcttcttcgaaggtcccacctggcaggtacgtagtggcatcacctatcagcagaacagtgcgcgcagcaccctgcccgccagcgtcacccgctacctgcagccgctggccggcagtggcgagaacggcgaggtcaccgcggccgacctggaagccctgggcggcacccagctgttgcaggatcgctatggccagctctatgtcggcagcagctggcgccgcggcattcccggttcgctcaaccgcacccatccccagtacagctggctggtggacaccctggtcggctggcagtggaccgagcgcgaattcaactacggtttgaatgtcggcctgggcatggtagtgctcggcgacgacgaactggcgttcaccgccggctaccagtccgcaccccagggcagcggcggtcaggccggcagcaccctgggcattcaatacagcaatcgaatcggtcgctag

SEQ ID NO: 63 - DNA, 1371 bp, Pseudomonas oryzihabitans
  source 1..1371: mol_type = genomic DNA
atggccggcatcggcttcgaactgcgcaagatccttgcgcgcgactcctacaccgccaccctgcgcgcctatgtctacgccggcctgatcagttccggcccctgggtgctgtcgatcatcagcgtcatgctgatcggcgtgctggccaccggcatcgttacccccagcgtgctgatccgccagttcctggtcacggtgacctacctcatggccagctcgctgatcctcaccggcggcctgcagctgtatttcacccgcttcgtctcggaccggctgttcgaggagaaacagaccagcatcctgcccaatctggtgggcatcctgctcctggtcacgctggtcgccggcggcctgggcttcctgctgctggccaccctgttcgaccagccctttgcctaccggctgctggtgctggccaatttcgtcaccctctgcgatctctggctggtgatcatcttcctgtcggggatgaaggcctacaaccgcatcctggtggtgatgacgctgggctacgccatcatgatcgccgccgccttcgtgctgcgcttcctcggcatggacggcctgctgatggcgctgctgctgggccacgccgcgctgctgttcatgtttctctacgacatcatccgcgaatacccggccgagcgcctagtggccttcgacttcctcgaccgcaagcagatcttcatcagcctgctggtcaccgggctgttctacaacctgggcatctgggtcgacaaattcgtcttctggttcaatccgctgacctccgatgccgtcatcggccccctgcgcgcctccatcctctacgacctgccgatctttctcgcctacctggccatcattcccggcatggcggtgttcctggtgcgcatcgagaccgacttcgccgagtggtacgagcgggtgttcaacgccgtgcgcggcggcgagaccctgcagcacatcagccagctcaaggagcagatgatcctggccatccgccagggcctgctggagatctgcaaggtccagggtctgaccctggtgctggtgttcctcctggcgccccagctgctggcctggctcggcatgtcgcactactacctgccgctgttctacatcgacgtggtgggggtgagcatccaggtggtgttcatggcgctgctcaacgtcttcttctacctggaccggcgcgacaccgtgctgatgctctgcaccctgtttctcggcctcaacctggcgctgaccctgctcagcgtcgagctgggtccgagcttcttcggctacggcttcaccgtctccctggcctgttgcgtgctgctcggtctgcaccgcctggaccgggtgctggacgacctggaatacgacaccttcatgctccggcactga

SEQ ID NO: 64 - DNA, 2811 bp, Pseudomonas oryzihabitans
  source 1..2811: mol_type = genomic DNA
gtggcgtcaggcaaggcaattagggcagggtcccgcttcggttggtggcgccggctgacggtatggctgctgggctccctgtccctcatgggaacggccctggccgcgcctgccagcgtggccttctggtacgcggaaaagccgccggtggccgaactcgcccagttcgactgggtggtgctcgaacccggccatgccagtgccgccgatgtccgcgcgctgcacgacggcggtgcccagcccttcgcctacctgtccatcggcgaattcgccggcgatgcggcggcgctggagaaggccggtctcagcgcgggtgccagcccggtggccaacaaggcctggggcagccaggtgatgaacctggctgcgccggtatggcgtacccacctgctcgaacgcgccgcccagctggccaaagccggttacacggggctgttcctcgacaccctcgacagtttccagctggtggccgaagaccagcgggaaacccagcgcctggcgctgaagagcctgctggccgagctgcaccgccgccagccggcgctcaagctgttcttcaaccgtggcttcgaggtgcaaccggaattgcccggggtggctgccgccatggcggtggaatccctctacgccggctgggatgccggcaagaagacctatcgtcccgtcagcgagcaagaccgcgagtggctgaagccgcggatcgaggcggcgcgcagtgccggcatcccggtcatcgccatcgagtacctgccgccggagcagcgtgacgaagcccggcgcctggccaggcggctgcgcgacgaaggctatgtgccctatatcaccacccccgacctcaacaccctgggcatcagctcggtaaccctgcagccgcgccggctggcgctgctctacgatggccgcgaaggcgccctgcgccagtcggcggtgcaccgcttcctgggcagtgccctggagtatcagggctatcgcctggactatgtcgatgcctccaagccgctgcccgcggcctggcccagcgccctctacgccggggtggtggtgtggatgaccagcggtccgccccctcattcccgggaattcagcgactggatcggccagcgcctggacgaaaagatccccctgctgattctcggcggcctgccgctggacaacgaggccctgctcaagcgcctgggtctgggcgtcagtcgcaagccgctgcccgacggcctgaccctcaaggtgctggaccctgccctggccggcaacttcgaagcaccggtcaagttgcggacgcgtgacctgcccgccgtgcagacgctgcccggtgggccgaccccggtggtcagcctgagcggtccgggcggcaccttcgtgcccatgggcgtggcctcctggggcggcttcgccttcggcccctatgtcatggaagacggtcccgaagccagtcgctggatcatcgatcccttcgtcttcacggcgaagacgctgcaactgccgcccatgccggtgcccgatccgaccacggagaacggtcgccgcatcgccaccgtgcacatcgacggtgacgccttcgcctccaaggcggagattccgggggcgcccttttccggccaggtggtgctggagcagttcatccagccgcatccctttctgacctcggcatcgatcatcgaaggcgaggtcggacccaagggccgctatcccgagctgaccgcgcaactggagcccatcgcccgccgcctgttcgccgatcccaaggtcgaggtggccacccacaccttcagccatccgttcttctggcaaccggcggtggccgagcagagcgagaacttcgaagcccagtacggctacatgatgcagattcccggctacgacaaggtggatttcacccgggagatcgtgggttcgacccgctatatcaacgagcacctgaccaccccgcagaagccggtgaagatggtgttctggtccggtgacgcccagccggatgccgccaccctcaagctcgcctacgacaatggcctgctcaacgtgaacggcggcaactcgcacatcacccggtcgcagccttcggtgagcggactctatcccttcatccgccccaccccgggcggcctgcagttctatgcgcccatcatcaacgagaacgtctacaccaatctctggcgcggtccctactacggctttcgcgatctgctctataccttcgaacggaccgagcacccccggcgtctgcgcggcctgcatctctattaccacttctactcgggcaccaagcaggcgtcactcaaggtcatggaagagatctaccagggcatggccgccgaacatcccatttcgctgtggatgagcgactacctgagtcgcctgcgcggcttctataccgccagtctcgcccgggaagacgacggcagctggtcgatcaaggccctcgacggtctgcgtaccctgcgcctggatccgcgcctgggttggccggatctgcagcgctccaggggcatcgccggggtccgcgacctgccgcaggggcgttatgtccacctggccggcgctcaggcgcggctggtcctgcgagacagccgcgaccccacccccgccctcgaagaggccaacattccgctgcagcagtgggactaccggtcgccgacgcgcatccgcttcgccttcgccggacaattcccgctggagttgaccctgcgcgcgtcctcggcctgcgaggtgcggatcggtcgcgagcgctacaagagccagccgggtgcggccggactccagacgttcaaacttccgctaacacgagtgagtgacggtgagatcgtctgcggctaa

SEQ ID NO: 65 - DNA, 1455 bp, Pseudomonas oryzihabitans
  source 1..1455: mol_type = genomic DNA
atggctcttactgtcaataccaacattgcttccctcaacactcaacgtaacctgcagtcttcgtccaacgcgctttccacttcgatgcagcgcctttctacgggtagccgtatcaacagcgccaaggacgatgccgccggtctgcagatctccaaccgtctgaccaaccagatcaacggtttgaaccaggccactcgtaacgctaacgacggtatatccctgtcgcagaccgctgaaggcgccatgcagcagtccactaacatcctgcagcgtattcgcgacttggccgtgcaatccgccaacggctccaacagcgacgccgaccgtgccgctctgcagaaagaggtgtccgctcagcagtctgaattgacccgtatcgccgaaactaccaccttcggtggtcgcaaattgctggatggctccttcggtacttcgagcttccaggtaggctccaatgcctacgaaactattgatgttagcttgaagaacacttcttctaccgccattggttcttaccaaatgggcgctgcttctggcgccgcttctggcagtgttgcagccagcgttgcaacaggtacggcagcttctggacgttttgccactggcacgactgacattacggtgactggcggaggtaccagcaaaaaggtagatctcactcaagctcttagtgccaaggatgccgctaaagcacttgatggttcggttcagggtttaagcgctactgcacgaactgttttctctgccagtgtggacagcagcgctgctagctcgcccatttctgtaagcttcaaagtgggcggtcgagatgcggttactttggctggtgtgacttctaccgcagatttggcgaatcaacttaacgctaactcatctaagctaggtatcacggccaacctcgacaataagggtgtgctgactattagctcggccaccggtgagaacgttgaaatcggcggtactaatccggataagcttactgttggtgttaagggcgcagatggtaatgacgtgaagacggctgctgctttgactgctggccagactaatactatcaccggctacgttcagcttgactcgtcgagtcagtactctgtgtctggagccgctagtctgtttggccaaactgccggaaagctcaattccgtcgataaagtagatatctccactgccgacggtgcgcagaaggccatcgccgttatcgaccaggcgctcaatggcatcgacagccagcgtgctgacctcggtgcggtgcagaaccgcttcgacaataccatcagcaacctgaccaacatcgctgagaacgctacctctgctcgtagccgcatcaaggatactgactacgccgcagaaactgcgaacctgtcgaagaaccaggtgctgcaacaggccggtactgcgattctggcccaggccaagcagctgccgcagtcggtactcagcctgctccagtaa

SEQ ID NO: 66 - DNA, 339 bp, Pseudomonas oryzihabitans
  source 1..339: mol_type = genomic DNA
atgagcgatctcgccagcttccgcgcccgcctggcccagggcgaccatgccttcgccgacaccctggcctttgtcgccgagcactaccactaccagcccaccgcctttcgcaatggcgcggtggacaatgcagcgggccagaacgaaggctcctgcaagaccctgggcctggccaagctcgaaggtctgagcgatcaggaagccctgctggcctttggcgagcactatcgcagcgtgctgcagacccccgagggcagcgaccacgccaacatccgtgcccttatcgcccacggcctggccggggtgagcttccagggcgagcccctggcgcgtcgctag

SEQ ID NO: 67 - DNA, 798 bp, Pseudomonas oryzihabitans
  source 1..798: mol_type = genomic DNA
atggcaaccctggccagccgcggcctgaccctcggctacggcacccagaccatcatcgaggccctcgacctcgaattaccgccggggcgtgtctcggttctcatcggcagcaacggctccggcaagagcaccctgctcaaggcctgtgcccggctgctggaaccgcgccagggccaggtgctgctcgacggccaggacatccaccggcagtccaccacagccctggcccggcaattggcggtcctgccgcagacgccggtggcgcccgagggcatcagcgtgcgccagctggtcagcctgggccgctatccgtaccagaactggatgcgccaatggtcggcggacgatgccgcggcggtggacaaggcgctgcgcctcaccgacctgctggcgatggcggagcggccggtggacgacctctccggcggtcagcgccagcgcgcctggatcgccctgaccctggcccaggacaccgattgcctgctgctggacgagcccaccacctacctggacctggcgcaccagatcgaggtgctggacctgctgcgtcagctgaatcgggaggagggcaagaccatcgtcatggtgctgcacgatctaaatctcgcctgccgctacgccgatcacctggtcgccgtccatcagcgtcgtgccttcgcccagggcgcacccgcagaggtattgacggaagccctggtacgcgaggtgttcgccctggaatgccggatcatcgccgatccctatttcggcacgccgctgtgcattcccttcggtcgcgaggtaccgccatgtgcctga

SEQ ID NO: 68 - DNA, 1002 bp, Pseudomonas oryzihabitans
  source 1..1002: mol_type = genomic DNA
atgagcgcacccctcagactgctgctggtcgccctggccctggcgctgatcgccgtgctgagtctctccgtaggcgcccgctggatcgcgcccactagcgtggtggcggcgctggtgcaggacccctcgctagggctggatgcaaccctggtcaacagcacccggctgacgcgcctgctggtcgccttggtggtgggcgccaatctggcggtggccggtgccctgatgcaggccatgacgcgcaatcccctggcttcgccggggctattcggcatcaacgccggcgccaccttcgccctggtgctgggcatcaccctgctggggctgtccagcaccgaaagctgggtactctgcgcgctgctgggcgcggcggtggccggcagcctggtctggaccctgggtaaccggggccaggcgcgcctgacaccgctgcgcatcgtgctggccggcgccgccctggcggccctgttcaccgccttcagccaggcgctgctggtgatcaaccaggaggggctggacagcgtgctgttctggctggcgggttcggtgggggagcgcaacctcaccacggctgcgcccctgctggtgttcagcctgctggccctggccgccgccgtggtcctggccgggcagctcgatgtactggtcgccggtgatgacctggcccgcggcctgggccagcccatcgggctgatccggttgctggccggggtgctggtgatctgcctggccggcagcgccgtggccctggccggcaacatcggcttcatcggcctgatggtgccgcacctggtgcgcggactgttggcccgcgcgcgacacgagcatcgctggctgattcccggctgcgccctgggcggggccctgctgctggtgctggccgacagcctggcgcgggtggtgattctgccccaggaggtgcccgtgggcatcatgaccgcgctgttcggcgggcccttcttcatccatctcgcgcgccggggaggccgtcatggccgctga

SEQ ID NO: 69 - DNA, 1032 bp, Pseudomonas oryzihabitans
  source 1..1032: mol_type = genomic DNA
atggccgctgagatcgtctggcggctcggccgtttctcccgccgcctggccccggccaccctgggacggctggccgtcgccgcgctggtggccctggcggccctgctgctgtgcctctgcctgggcaaggtctggttgacgcccacccaggtgttcgccgcgctggtcgaacggcagggcggtggcctgggtttcatcgtcacccagctgcgactgccgcgggcgttgctggccgccctggtcggcagcgccctggcggtgtccggcctgctgctgcagggccaggtgcgcaatcccctggcctcgccggacctgctgggcatcaccagtggcgccagcgccggggcggtcttctatctggcggttctggccggcagcctggggccccatggcctgccgctggccgcgatgctcggcgcgggcctggcggcgctgctggtctatggcctggcctggaatcatggcgcctcgccgttgcgcctggtgctggtgggggtaggggtgtcggccatgctcgccgcggccaccaccttcctgctggtgttcagcccgctgaccaccacgttgtccgcctacgtctggctgaccggcagcgtctatggcgccagttggccggaggtgcgcgccctggggctgtggtggctggtcctgctgttgccgctggcgaccctggcgcgccacgccgtgctggcgcaactcgacgacgacctggcccgcggcctcggggtgcgcctgcagcggcagcgcgcggccttgctggcgctggccgtggccctggccggggtggccatcgcctgggggggcgccatcgccttcgtcgggctcatcgcgccccatatcgcccgccgcttgctgcccgcgggtttcgccgctcaggcgctgatggcggccctggtgggggcgttgctggtgatgctcgccgacctcctgggtcgtaccctgttcctgcccctggatctgccggccggcatcttcgtcgccgccctgggggcgccctttttcctctacctgctgatccggcagcgtccctga

SEQ ID NO: 70 - DNA, 918 bp, Pseudomonas oryzihabitans
  source 1..918: mol_type = genomic DNA
atgccccctagtgtttccccctctataacccgccgccggctcctcgggctcggcggcgttctggcaaccggcctggcgctgcagccgggcgtggctcgcgcgcagccaacccgtgtggccacgctgttccagggcgccaccgacagcgccgcggccctggggctcaggccttgcggggttgtggagtcctggagcgagaaaccggtctatcgctatctgcgcccggcgctggcgggggtgccctcgctgggcctggaaacccagccgagtctggaggacctggcgctgttggcgccggacctgatcgtcgcctcgcgctttcgccatggccggatcgcacccttgctgcagcagctgtgcccggtggtgatgctggaggaggtcttcgaattcaagcagaccctgctggccctgggcaccgccgcggggcgtgaagcggaggccacggccctgctgcaggcctggcaggcgcgcatcgcccacctgcgcgaggcactgcaacggcactacggggcccagtggccgccgacggtggcggtcctggacgtgcgcgccgatcacctgcgcagctacctgcccgacagtttcgccggccgggtactcagcgagctgggcttcgcctggccggcggccagccagggcagcgccgcgccctcgatcaagctgacctcgcgggaaagcctgccggtggtggaggccgacgtcttcttcgtcttcctgcgcgccgaccaggccgcggtgcagcgcaactacgagcgtctgctcgagcatccgctctggcaacgcctgagcgccccccggcgcgggcaggtctggcgggtcgatggggtggcctggagcctgggcggcggcttgctcgcggcgaatcggctgctggacgatatcgagcgcgtcctggtcgaccagggggccgcatga

SEQ ID NO: 71 - DNA, 612 bp, Pseudomonas oryzihabitans
  source 1..612: mol_type = genomic DNA
atgcccggccccctgagcgagctgccggccgaactgatcgccgggtacgctgaggtagctgcctcgaccctgggccatctcgggcgcacgggctatctgcccgaactcaagccggtggtagccaatacgcgcctgctgggtcgggtggtgacggcgcgcattcccttgccccatggcgccctgttgcgcgaggctctgatcgccagtcgcccgggcgacgtcctggtgatcgaggccgtgggcgatccccactgcgcctgctggggcgaattgcgcaccctggccgccttgatcaagggcctggccggcgtggtggtgaatggcgccatcaccgacgtccaggcgcttcgtcaactcggcctgccgatcttccaccgcggtatcagcgccgtcaccacccagggtggcgaggcgctgggcgaattgaacgtcgaactccagctcggcgagacccgcgtctgccccggtgacctggccctcggagacgacgatggcctgttcgtcctgtcgcccgcgcgggccgcagccttgctgcccggtgcgctggccaaggaggccgcggaccaggcgcggcgtgcgcaactgctgcagcggctgaccgaagggcgctga

SEQ ID NO: 72 - DNA, 777 bp, Pseudomonas oryzihabitans
  source 1..777: mol_type = genomic DNA
atgctgaggcgcaatcgactcaaggccgccctggcggccggtacgcccagccacggcctgttcgcctcgctgcccacgcccgccagcatcgagctgatcgccgaagccggctacgacttcgtgatcatcgacatggagcacgtgctgatcaatccggaaaccctggagaacatgatccgcaccgccgagagctacgacctcacgccgctggtgcgggtgccggacgccgagcccaagcggctgctgcgcctgctcgatgccggggcccaggggatcgtgctgccctgcgtggaggacccggcggtgctggccgccggggtgcgcgcctgcaagtaccacccggagggcgagcgtagcctcaacgccgggcgcccgggctccttcggcaaggcgagcctggccgactacgtgaaccgcgccaatgcgcagattcttatagtcgccatgatcgagagcgccgcgggcgtcgcccgggcggcggaaatcgccgcggtgccgggggtggacctgctgctcgaaggggcggcggacctgtcgcaatccctcggccacccctggcgcatcgccgatcccgcggtgcaggaggctctgcgccagacctggaccgccgcccagcgccagggtacgccctattgcgccatcccccggcagccggaggacctcgacctctggcgcgcccggggcgtcaccaccttcgtgctcggcgacgagcgcggcatcgcctttcgggccctgcaggcccgcctgaccgcccattcctgcggagaatccccatga

SEQ ID NO: 73 - DNA, 513 bp, Pseudomonas oryzihabitans
  source 1..513: mol_type = genomic DNA
atgagtgatatggctctcgcgtccacgcgccaccttcatcggctctatctcgaccacagcgggtggctgcaggcctggttgcgccggcggctgggcagcgaatgggatgcggccgatctcagccaggaagcctttctgcggctgttgcgcaatcccgaagtgctcggtgaactgcaggagccgcgggcctatctggtgaccatcggcaaacgcctgctgatcaatttccagcggcgcaagagcctcgagcaggcctacctcgatgccctgatggcattgcccgaagcctgcgtgccgtcgcccgagcagcgttggctgctgctggaaaccctgcaggcgttggacgagctgctcgatggcctgcccgctgcggtgcggcgggcctttttgctcagccagctcgaggacctcacctatcgcgaaatcgccgaacgcctgcacgtctccgagcgcaccatcaagagatacatggcgcaggcctacgagcattgcctgctggcggagttgtgctga

SEQ ID NO: 74 - DNA, 1209 bp, Pseudomonas oryzihabitans
  source 1..1209: mol_type = genomic DNA
atggctgagctacctgccgcggtccgtgccgccctggtggaggcccaggcgcagtccggcgatccgctggcggccttcgtctacgacctcgaggccctgcggcggcacgtcgccgcgctgatggccgaattacccccgggcgtggagctgtactacgccatcaaggccaacagcgaggcgccgatcctggcggccctggcgccgctggtgcatggcttcgagatctcctccggtggcgagatcgatcgcctcgccgcctgcccgcagcgcaagccgttcatcttctccggtccgggcaagctggattccgatctgcgcaccgccctgagcgcgggcgtcgaagccatccacctggagagcctcggcgagatccagcgcctgcaacgcctggcgctttccctgggacggctgcagccggtgtacatccgcatcaatccgcaattgccggccgggctgaccagcaccctggccatggccggcacggcgacgcccttcggcttcgacgaagccgatctgcacgccgcggtggcggcggtagaggcggccagccacctgcagctgcagggcttccatgtgcatgccctgtcgcaccagcactcggtggagcgccatctgcaactgctggacttctatctgcagcgctggccgcactggtgcggcctggcccggcgcccggaaagcgtggtgcggctcaacgtcggtggcggcattggcgtggattaccgtgaaggccggcgattcgactgggcgcggctgtgcgggcacctgcgcgcccgcttggccgaacaggcgcagccgccgctgatccgcttcgaaccgggacgtttcctcgcggccttctgcggctactacgccatggaggtgctggataccaagaccagccacggccagcacttcctggtctgtcgcggcgggacccaccagttccgcctgccggtggcccaggggcacgatcatccggtgctgcacctgccccgcgaggggcgggcgaccgcgactggaggcaaggcctggacagtggtgggtcagctctgtacccccaaggacatcctcagccgcggccagccgctgggtgaggtacgggtcggcgacctgctggtgctgcccctggccggcgcctatggctacaacatctcccacgcggatttcctctgccatccgcgcccgcggcagctgttcctcgccggcaacgggagtgtcccggcgtga

SEQ ID NO: 75 - DNA, 942 bp, Pseudomonas oryzihabitans
  source 1..942: mol_type = genomic DNA
gtgctgagcggtcaggaccggcggcgggcgatccgcgaggccgcggaatggctggcgctgctggagtccggcgccgccggcgagcgcgagcggcagcagctgcaggcgtggcgccagggccatcccgagcacgaacgcgcctggcaggcggcccagcagctgcaacagcgcttcgccgcggtgccgtcgcggctggccatggccagtctgcagccggccgagcccactcggcgtaccgccctgcgacagttgctgggcctggcggtggtggtaccgaccggctggtggctgacccgggaattgccgctggacgcctggaccgccgatctcagcaccgccaccggtgaacgccgcagcctgaccctggcggatggcagcctgctgcaactcaataccgcgaccgccgtggacctggatcagatcaggcggcgcctgacgctggtgcgcggcgaactttcgctgcgcgtacccggtacccaggcgctgacgctggatacccgcttcggcagcctgacggtggaacaggccgaggtctgcgtgcagcaggacgatgaaggctgcgacgtgcgcgtggtcagcggcagcgtcgaggtgcggccgctgatgggcctcggcttggcgttgggcaagggccagcagctgcgcctgagtaccctgggcatcggcgccatcgagccgttttcgccgaccctgctgagctggcgccagggcgtgctgatcgcccaggaccagcccctgggcgaattcctggagcaattcagtcgctatcgtcctggcctgctgcgctgggatcccgcggtggccgacctcagggtcaccggcagctttcagctcgccgataccgaccgggtactggcgctgctggccgcgacgctgccggtggagctgcagtggcgtacccgcttctgggtgaccctgaaaccccgttcggtcgccgtctga

SEQ ID NO: 76 - DNA, 1374 bp, Pseudomonas oryzihabitans
  source 1..1374: mol_type = genomic DNA
atgcttcaaccatccctcagtcgtgaaaccgcaacagccgacaacgccttctttctcgctcgccaggcgcgcttcgaatccagggtccgcagctacccgcgcaagctgccgctggccatcgccaaggccgccggggtctgggtgaccgacgtcgaaggcaagacctacctggattgcctggccggagccggcaccctggccctggggcacaaccatccggccgtcatcgaggccatcaccgactttctcggcagcggcctgcccatgcacagcctggatctcaccacgccgctcaaggacgccttcagcgagcgcctgctgggcctgctgccgggccgcgcggaagactactgcctgcaattctgcggtccgtccggtgccgatgcggtggaggcggcgctgaagctggccaagaaggtcaccggacgcagcaacgtggtcgccttttccggcggctaccacggcatgacccacggcgccctggcggtgaccggcaatctcgcgcccaagcagggcgtggccgggctgatgcccggggtgcaatttttgccctatccccacgagtaccgctgcccgctggggctgggtggcgagcagggcgccgcggccctggcgcgctatctggaaagattcttcggcgacgtggaaagcggcgtctgccggccggcggcggtgatcgtcgaggcggtgcagggggagggcggcgtcaatccggcaccggtggcctggctgcggacgctgcgccaggtcacccgggagcacggcatcctgctcatcgtcgacgaggtccagaccggtttcggtcgcaccggcgcgctgttcgcctgtcagcatgccggcatcgagccggacatcctggtgctgtccaaggccgtgggcggtggcctgccgctggccctgctggcgattcgccgtgaattcgacgcctgggagcccggtggccataccggcaccttccgcggcaaccagctggccatggccacggggctcgccaccctggaggtcatcgagcgcgacggcctggtcagccatgcggcccagctcgggggctggctcaggcgccatctggagcggctgcgcgagcgtttccccgcgatcggcaatgtccgcgggctggggctgatgctgggcctggaaatcgtcgaggcgggtgccgtggcggatgcgctcggcagcctgccggccgatcccgccctggcggcggccatccagcgccactgtttcgcccagggactgctgctagaacgcggcggccgcgacggcaacgtggtgcggctactgccgccgctgatcctccaggaaagccattgcctggtgctgctcgaacgcctggaggcggccctcgtggcggccctggccgagccccgtggctga

SEQ ID NO: 77 - DNA, 2397 bp, Pseudomonas oryzihabitans
  source 1..2397: mol_type = genomic DNA
atggtgacgttggtattgcgtccgttgctgcgcacgggcttgctggtggcgttgagtggtactccctggtgggccgcgtcggccctggcccaggaggtggcccgccggcattacgagattcccgcgggcagtctcgcccaggcgctgacgcgcttcgccgccgagtccggcgtcaacctggcggtggatccgggactggtgggcaagcgcaacagcgctggcctcaatggcgactttggcgtcgaggagggcttcagccggctgctggccggctcggggctgcggctgcagccgctgggtgagcgtgacttcaccctggcgccggtcccccaggacagcggcgtccaggagctggccagcacttccatcgtcgcctccagcctgcaggcggacgacgccccctacgccggtggccaggtcgcgcgacaaggctcccaggggttgctgggcaatcgcgacttcatggacacgcccttcagccagacgtcctacaccgcccagaccgtgcagaatctccaggcccgcaccctgaccgacctgatcgccagcgatccctcggtgcgctccaccaatccgtcgggtgggcgcttcgagcaattcaccatccgcggtttcagcctgttcaacagcgatgtggcctacaacggtctctatggcgtgctgccgacctattccatcgacatggagatggccgagcgggtcgacatcctcaaggggccgagccagctgctcaacggcatctcgccccgcggcagcgtcggcggcggcatcaacgtggtgcccaagcgcgccaccgaccagcccatcaccgaaatcaccggcagctacgcgtccgacagccaggtgggcggggccgtggacatcggtcgtcgcttcggcgaggacaatcgcttcggtatgcgcttcaacggtgtcaagcaagcgggcgacaccacctgggatcaccagcacgtcgatcgccagatgggtgtgctcggcctggactatcgcgtggagcgcctgcgcctgggtctcgatctgggccacaccgagcgtgacaccgacgcgccccaggaacgggtgctggtgggcgccaacgcccgggtgcccgatgccgacgacgtgcgccacaactatgcccagcgctggacccgcgcccagaccaaggacaccttcggtgccctgcgcggcgaattcgacatcgacgactcgctgatggtctatggcgccgtgggcgcgcgccgcagcgatcacgacttcctccgccacaacgtttccatcaccaacaacgccggcgatttcagcgtccagccgcgcgacttcacccgcgacgagaacgtgcgcaccgccaacctgggcgcgcgcaaatggctgcagaccggaccggtcagccacgagctcaacgtcagcgccgactacttctacatggatttcgaaaacggcggcggtcgctacgccagtgggccgagcaacctgtacaaccccagtgacctgcccgcgccgggtgtccagacccgctccgacggcaaggactacaccgagaaccgcttcagtggcgtggccctggccgacaccctgggcttcttcgacgaccgcctgctggtcaccctcggtgcccgctggcagcgggtcaaggtggacgactggtccgatggcgtgaagcaacccaccgcctacgacgaggaaaaggtctcaccctcggcgggcgtgctgttcaaggccaccgagcggctgtcgctctatgccaactacatggaaggcctcagccagggcaagatcgcgccgtccaccgcgctgaacgaggacgagatcttcccgcccttcgtcagccgccaggcggaagtgggggccaagtacgactttggcgcggtggccgtgaccgccagcgccttccgcatcaagcagccggcctacgagaccaatgccaccagccgcgtcttcggtcccaacggcaagcgcgtcaacgacggggtggagctgagcgtgttcggcgagccgctggccggcttccgcgtactcggcggcctgatgtacatcgacagcgaactcaaggacaccgtcggcggctccttcgatggcaatcgcgccccggccacgcccaggctcaatgccaacctcggcgccgaactggacatcccggcggtgccgggcctgaccctgaccggacgggggatctacaccagctcccagtacctggaccaggccaacagcaaggaaatcgacgcctggcatcgcttcgacgtgggggcgcgctacgccttcaaggtcgacgccacccgcgtgaccttgcgtgcctcggtggaaaacgtgatgaacgagcgctactgggcctccgccggcgcctcggacgacagcgaaccgggcctgaccatctccacgccgcggaccctagtcttttccaccaccctggcgttctga

SEQ ID NO: 78 - DNA, 1773 bp, Pseudomonas oryzihabitans
  source 1..1773: mol_type = genomic DNA
atgacttctttcgaatccacgctgctttcccgcatcgtcagcgagctggcgtcttcccacgccctgatgaattgcctcatcaaggaattcgccctgccggaacggtgcctgtcttatgcctggccggaagaccggcgcggtatcgctccggccaactatctcggctggttgcaagacggctgcgtgcccctgctgatcgcctttcccggcgaccgccagttcttcctcgtcgtcgatcggcaggatgaactcggcagccagcgttatctctccgatatctatatccggcgcggggaacaggcctggcattgcccggacttcgccgccttcatcgattttctgctggaggcctgcgaagaactcgccggcgcccacaatggcgaattgctgcagcaggtcctgcagagccagcacctgaccgcggccatcgtcgaccacgtgcaggtctcgcgccatcccgcgccgctcagcgactacctggccagcgagcagggcctgtggttcggccatcccaatcacccggcacccaaggcacggcgctggccggagcccctgccggccgaggcctatgcgccggagttgcacaccagcacccccatgcacgtgctggaagtgccccgcgccgggttgcaggtggccggcaacggcctgagcgacgcccaggtgctgcagggtttcgtggaccaggcgcaggccgcccctgagcgggcgcgcatcgtgctgcacccggtccaggcgcagctgttcctcggcgatccccgggtccgggcgctggtcagccagggggtgatccgcgacctcggcaccagcggcgccctggccagtcccaccgcctccatgcgcacctggtaccgcccaggccatgccttcttcatcaagggctcgctcaacgtgcgcatcaccaattgcgtgcgcaagaacgcctggtacgaactgcaaagcaccctgatcgtcgaccgcctcatgcagcgcctgcaagggcgggtggcggggctggacatggtgcgcgagccgggtgccctgagctgggcgccgccggccgccagtgccgaggacgagcgctggttccgcgagcagaccggcgccatcctgcgcgagaatttctgcctggagcatggcgccgactgctgcctgctggccggcaccctgttcgcccgcgacacccgcctgcagccgctgctgcaggacttcctcagccgctgcggcggcgagccggtcagcgacgaaacccggctggcctggttccaggactaccagcggctgctgctcgggccggtgctgcggttgttcttcgagcacggcgtggtgctggagccgcacctgcagaattgcgtgctggtgcatgacaacggtcggcccgtccgactgctgctgcgcgacttcgaaggcatcaagctgaccgataccctcggcgccgaggccctggacgcccacgtccagccgcgggtgcgccagtcgttgctctacagtcgcgaacagggctggcggcgaatcgcctattgcctgttcgtcaacaacctcgccgaggcggtgctggcgctgagctgggagcgtccgcacctggcgccgcgcctgtggcggcaggtggaagccgagctgatcgccatccgccgggacctgcaacgcgccgcgcccgagctggatgcgctgatcgccggccagccgattccctgcaagaccaatctcaaggtgcgcctcgccgcccaggccgatcgtcacgccggctacgtgcagttgccttgcccctggggcgcggaggtgcgtcatggctga

SEQ ID NO: 79 - DNA, 1842 bp, Pseudomonas oryzihabitans
  source 1..1842: mol_type = genomic DNA
atgaccgctcagctttcactccccgcgcagtcctggccatcgcccgccgacgccgctctctatcgccaggtcgagcagcgcgtggtggcgcagttgctgcagacgctgatctacgaagaggtgctcagggccgaggtccagccggtggccgagggtctggcagcgtatcgcctggccggtaccgccgccgatggcacacccgtgcagtacctgggctatgcgcccgccgctgccagcttcggcctgatccgcctggatccgcagcgcctggtgcgccaggacgcccaggggagccgcgcgccggcgctgcacgagaccctggccgaattgctcggcgagcagagcgattcgccgctgtggccgcgcttcgtccaggagctggagcagacgctgctcaaggacctgcagtcgcgccgtcaggattatcgtcctgaccgcccggcccacgagctggacgtggacgccctggagcggcacttcatggacgcccatggctaccacccctgctacaagtcgcgcatcggcttctcgctggccgagaatcgccgctacggaccggaattcggcgagtcgatccagctggtctggctggccctggcgcgcgcgcgggcctcggtggggcactcccgccgcctggactttccggccttcatcgccgcggagttcggggtggagcgctggacggccctggccgccgagtggcgcgaacagggtcgggcgttggacgactatcagttgatcccggtgcatccctggcagtgggagcagcacctggccgcgctgttccagcccgaactggtgagcggcgagttgctctacctgggcacctcccgcgatcagtacgcggcccagcagtccatccgcaccctggccaatcgcagcgcgcccgagcggccctacgtcaagctggcgatgtgcctgaccaatacctccagcacccgcatcctggcgcgccacacggtgctcaacggcccactcatcaccgactggctgcagcgcctgatcgcaaccgatgccacggcccgcgacctggacttcgtggtgctcggcgagatcgccggcgccgcctacgacagtcgtgcgttgccggtcagccgggcggggcaggtctacggcaccctcggcgccgtctggcgcgagagcatccacgcctatctgcgcgcggatgaacaggcggtacccttcaacggcctgactcaggtggagaatcgctacggccagggcgcgccatggcccttcgtcgccgcctggatcgagcgccacggcctcgacgcctggctgcggcagctgctcagggtcacggtgacgcccctcatgcacatgctccatgccgaaggcatcggcatggagtcccatggccagaatatcgtgctgatccaccgcgacggctggccgctgcgcatcgccctcaaggacttccacgatggtgtgcgctacgccgagcgccacctggcgcgcccggaattgcgtccgaccctggagcccttgccggcgagtcatgcgcggatcaaccgcaattccttcatcctcaccgaggacgtggcggcggtgcgcgacttcacctgcgatgccttcttcttcatcgccctgggcgagctggcggtgttcctgcgtcagcacttcgccctggccgaggccgacttctggcaggcgaccgccacggtcatcctcgactaccagcgcgcccatccccagcaccgggaccgctatgcgctgttcgacgtcttcgcccccaccttcgaggtggaggagctgaccaagcggcgcctgctgggtgacggcgagcggcgcttcaaggcggtggccaaccccctgcatacctatcggcccgccgcatgctga

SEQ ID NO: 80 - DNA, 1851 bp, Pseudomonas oryzihabitans
  source 1..1851: mol_type = genomic DNA
atgaacgctcagaccctcgccaccgacctgatcctgcagggcctgttcgactgcctgctggccgaagacgtcttcgcccccatgcctgtgaccctggcggccgcgaccacggaacatcccgccgcgctgcagccggccgccccggaggagcgcctctgggagtgctgctgcgatccccgcgagctgcgtttcatcgccgcgcgggtgcgcccgggcatcacccaggcctgggtgaaggtgcccggtacgccgatcctggcgcgccagggcgacgcctggagcaccctcacgccggaggccttcgtctccctggtgttcgccgaggcggccgccgatccggagcaggcgcggggtatcgcgctgttgcgcgagatcctggccaccagtctgcggcagacccggctgtcgctggaacaatccctggtccccggtccgttgctggagggcgacggtaaggccgccttcctgcagctggagcgctgggcggccctgcgggatcgaccctatcaccccctggccaaggccaagctggggctgagcgacaccgactaccaggcctaccaggccgaattcggccaacccgtgcgcctggcctgggtcgcggtgcgccgcgatcagctgctgtgcggagagggcgtggcggccgattcccagggaccggcggccgacttgctgaccccggcggcgctgggcgggttgcaggccgaattgcagcagcgcggcctggcggcgagtcacgtggcgctgccggtacatccctggcaactcgccgagggtctgccgggtcggctggacgaggccttcgccagcggcgtctgccagcagctggacttcgccggcgcacgctgccacgcgacctcgtcgctgcgatccatgctgatggaggagggcgcgggcgtggcccagctgaagttgcccatggccgtgtattccctgggcgcctcgcgctacctgccggcggtgaagatgatcaacggctcgcgcagcgaagccttgctgcgccaggcgcgggccctggacccggtgctcgccgagagcctgcacctgtgcgacgagtcgcgctggtgggccttcatgccgccggcggcgaccctgttcgacgaggcaccgcggcatctctcggccatggtgcgcggctatcccgcagcgctgctggccgatcccgactgccgcctgctgcccatggccgcgctcggcacaccgctgccgggcagtcgccggcacttcttcgacgactggctggcggcccgggcgctggcgccgaccccggccaatgtcctgctgttgctgggtgagctgtgccacagcttcatcgacctcaacctgcggctgttccgcctcggcctgctcggcgaggtgcacgggcagaacgccgtgctggtctggcgcgccggacgtatccagggtctgctgctacgcgaccacgactccctgcgcctgtacgtgccctggctggagcgccaggggctggccgatccgcagtaccggatcaagcccggtcatgcccagacgctctatcacgagcatccgcgcgacctgctgttctggttccagaccctgggcatccaggtcaacctcagggccatcttcgagaccgtcgcgagctgctacgctgtcccgctgaccgccgcctggacgctgctgcgcgaggtgctggaggagcgcatcgtggccctggacttcgacgccgaggcccgggcactgctccgagagaccctgttcgaggcaccggactggccgcagaagtggctgctgcgcccgatgatcgagcgggccggtgggcccggcagcatgccgttcggcaagggcagggtggtcaatccctttcatcaggtgagccatgccccctag

SEQ ID NO: 81 - DNA, 786 bp, Pseudomonas oryzihabitans
  source 1..786: mol_type = genomic DNA
atgtgcctgaggccggccctcgacagcgcccagcgggacgagctgcgcgccaccttcggcctgcgcgaagccagtgagcgcgacgggcagcacagccagccggtggccgcctggctggacgccgcacgctgcgccgagttgctcgacgacctggcggcgcggatggaggcgcccacgcggcgggtcgcagcgtcgctgctgaccaagcgcctgggctttctcaccaccggggtcgccttccacgccctgtcggcctatgaccggcgcctggacctgacgccgggcaatgtctggatcgaggatggccacgtccaggggcgctggcgatcggccctgccgctcagcgatacccggccgctgcccgccttggaggatcacgccacggcccgggcgttgctggcccgcgccctgttcggcgagctgctgcggccgctctgggagaccctggcgcgggttggccgcgtctcgccccgcatcctctgggagaacgccgcggtgcggctctattcgctgtacgaccggcgcctcgccgaactggaggatccggccattcgtgcccgctgcgccgaggatttcgcctggctgctggcggcgacgccggcggaacttgggctggagaccaatccgctggcgcagttccgccggcccgcaaccgtcaacaccctcgggcgctacgttcgcttccggcgcacctgctgcttttactaccaggccacggcgcccgccgaatactgcagcaactgcccgctgatccgcccccgggaggccgcatgcccggccccctga

SEQ ID NO: 82 - DNA, 1407 bp, Pseudomonas oryzihabitans
  source 1..1407: mol_type = genomic DNA
gtgagcgttgcgatcccgcgggtctgggtggcggtgaacgtgctgctgggcacggtcaccgtcagcctggccaataccgcgctcaatccggcgctgccggccttcatcgccgccttcgacctggggccgctgctggccagctggatcgtcgccggcttcatggtcgccatgggcatcaccatgccgctgaccggctttctcgccgggcgcatcgggcggcggcgactctatcgcctcgggctgctggccttcatcgccggctcggcgctgggcgccctggccgattccatcgccggcgtgctgctggcgcgcatggtccagggggtggccagcggcctgatgattcccctggcactgggcatcatcttttccgtctatcccaaggaggagcgtggccgggtgaccggctggtggggtggggcggtgatgctggcgccggcggtggggccgctgtgcggcagtctgctgctggaggtgttcgactggcgcgccctgttcctgctcaacgtcccggtgggcctgctggccctggccatggggcaggtggtgctgcccgcggatggcgcccgcgaacgcaagcccttcgacctggccggctacctgctgatcgccagtggcctggggctgctgctggtgaccctcggccggctgcgcgagctggcggcgctggccgaccccctcaatctgctcgccctgggcgccggactcctctgcctgctggccttcgtccggctgcagctgcagcgcagccatccgctgctgccgctgcgcctgttcgccctgcgcggctatcgggccagcgtcatcatcgccgtggtccaggcggtgggcatgttcgaatgcctggtgctgctgccgctgctggtccagctggtgctgggccatagcgccctctggaccggcctggcgctgctctgcaccgccctggcggcggcgctgttcggccaggtcggcggtcgcctgctcgaccgccgcggaccccgcggggtgatcgccaccgggctggcgctcagcggtctcgccaccctggccctcggtgtggtcggcagccatgccggactcgcctggatctgcgcgctgatggtgctgcgtggcgtcggtctggggctgtcctacatgccggccaccaccgccggcctcaatagcctgccggatgcccaggtcacccagggcgcggccatgaacaacatcgcccggcgcctggtgtcctcggtggccgtggtggccgcctccctgtggctggaactgcgcctgggcggcgcggccggctggggcccgcgccaggccgccaccggcgtcgccatccaggacgccttcatcgccaccggcctgttcatcctgctggcactgccctgggcctggcgctttcccgccgctcaacccctttccgttcggaggtactcatga

SEQ ID NO: 83 - DNA, 975 bp, Pseudomonas oryzihabitans
  source 1..975: mol_type = genomic DNA
atggacagggtcttgctgagcgagcagagtcgggtcttcacggcctgtgcccccggccaggtctcggaatacgtcggtcgtcatctgggcagccatcgcctgcagatagggcgcgacagtgctgcgcgggccagtctcgcccatcgtcctttcgccacccttgacctctgccggctgcattacgccggccaggtacgcatcctcgcgcctgcgctcgacgagctctaccacctgcagatcctcctgcgcggtcgctgcctgtggcaggggcgcgatggcgcgcgctgctatggaccgggcgagttgatgctgctcaatcccagcgagccggtggacctgatctactccgacgactgtgagaaattcatcgtcaagttgccggcgacgctgctggagcgggtctcccaggcccgtggctggacattgccggccgccggcatccgcttcacccgatccgaggcgcactatccatcaagcgacgttctcgacctgctgagcctgatctgtcacgaggccgaggccgcgctgcctggcggcttccacgaaccctatctgcagatcctggcgagcaagctgctgctgcaattgccgagcaacctgaccgtgccagcgagccggggcgaaccctgcggccgtttcgcacacctggtggagcacatcgagacgcacctgggcgaagcgctcactcctcgccagctggcggcccaggcgcatctcagtgagcgcggcctgttcggtctgttccagcgcgaggtcggctgcgcgccgctggagttcgtgcggcaacgccgactggagcgggtacaccaggtgctgcgcgatccccaggcaggcgcgcgcagtgtgaccgaagtggccctggcccatggcttcctgcatctggggcgcttcgcccagcagtacaaggcgcgctttggtgaaacgccatcggcgacctggcgcggacgctcgcaccagacggcagtaggcggatag

SEQ ID NO: 84 - DNA, 726 bp, Pseudomonas oryzihabitans
  source 1..726: mol_type = genomic DNA
atgaccactacctatctgttgatccatggttcctggcacgacggtcgtgcctgggacggcgtcgcccagtccctgcgtgcccagggggccgaggtgcatgctccgaccctggccggccacggtctgggcgcggatctcgcagtcagccatgctgactgcgtcgactccctggccgactacgtgcgccgccacgatctgcatgacgtggttgccctcggccacagctggggcggcaccgtgctgcagcgcctggccgagatcgagaccgcgcgcctcaggcgcctggtgttccacaacgccttcgtgctgcgcgacggcgaggcgctgttcgacctggtgccgccgcactaccaggcgctatggcgccagctggaacagcccgatggcggcatcatgctgcccttcccggtgttccgcgatgccttcatcggcgacgccagcctggagcaggcccaggcggtctatgccaggtacctcaccccgaccccggcgcgcagccacttcgacgccgtgccgctgaagacctttgacagcctgccgattccccgcagctggctctacgcccaggacgacgtggccctgccacccggccagtacggctggcatccgcggctgagcgaacgcctggggggttatcgcctggtgtccctggccggcagccacgaggtgctcttcacccgccccgaggccctggccgaggccatccgcctggccggtcgcgactag

SEQ ID NO: 85 - DNA, 1185 bp, Pseudomonas oryzihabitans
  source 1..1185: mol_type = genomic DNA
atgtccaagcctttcgcgttttccgtcggcacggctctgcccgtcgcctccgccttgctgctcggcctcggcgccagcctgccggtccaagccaacaatggtgtccaactgcccgcctatggcgccaaggccatgggcatggccggggtctccatcgcgttaccgcaggatgccgccgcctcggccaacaatccggccggcatggccctgctgggtgatcgcttcgacgccgacctgaccctgctacgcgccccgatccgcaccgaagtcggcagcaaccgctacgccgacaatgccgtggtggccgtacccaccggcggcttcaaccgggtcatcaacgagaatatgagcgccggtctttcggtgttcggccagggcatcgctctggactacggcgaaccggtattcggcagccacgacctcaagtccagtctgcagcaggtggtgctggcacctaccgtcacctggcgcctggcgcccggtcactatgtgggtttctcgccacgactggcctaccagcgtctggagatcgccgggctggaaggcttcggcttcgccagtccgggggcggacaaggcctacggcggcggcttcgctctcggctatcagggcgccctgagcgagcgcctcagcctgggcgtgagctacgccagcccgctgtggttccagcgcctggagcgctatcgcgggctgttgccggacgggcgcctgaacctgccgcagcaggccggcgtcggcctggcgttcaaggccacgccccagctgaccctggccgccgatgccctgtggatcgattggtccggccagggctcctacggcaatcgcctcaccgagggtggtccactgggcgccagcaacggccccggctttggctggcgcgatcagaagatcctgagagtcggcgccagttacgcgctgaacacgcagtggacgctgcgcgcgggtgcctcattttccaaccacttcatccccagcagcgaagccaccttcgccaccctggcgccactggcccagtacgaccactacagcgttggcgccagctaccggctgggcgacggctgggaagtcactggcagctacctctacgccgtcaacgaccggctcaagggcacgggggcgagccaaggcgtcatcgtcggcaccgacgtcaactatctcaatttcggcattggctatcgcttctaa

SEQ ID NO: 86 - DNA, 1281 bp, Pseudomonas oryzihabitans
  source 1..1281: mol_type = genomic DNA
atgaacgtgaacgctcccctcaacgtcgccatcgtcggcggtggcatcgccggcgtcggcctggccctcggcctgaaggatgcgccgcacctcaaggtcaccctgttcgaatccgctgccgccttcggcgagatcggcgccggggtctcctttggcgccaacgcggtacgcgccctggccgggctgcgcatggccgacccctaccacgccctggccgaccgcacgcccgagccctggcaggacgtctggttcgaatggcgtcgcggcagcgatgcgggttatctgggcgccaccctggcgcccggtgtcggccagtcctccatccaccgcgccgacttcctcgacgccctggcgcgccgtttgccggacggcatggccgtgttcggtaaacgcgcttgcggcctggagcaggacgccacgggggccaccctgagtttcaccgacggcaccacctaccgttgcgacctggtgctggccgccgatggcatcaagtccggcttgcgcggcacggtgctgggcgggcatggcctgagcgatccgggaccgcgcttcaccgggagcgtcgcctatcgtggcctggtggagcgtgacgctctgcgcgagcgcttccgtgccaccggactcgaccagcacctgctcgacgtgccgcagatgtacctggcccagaacggccacatcctgacctttcccatcaagcaggggcggatcctcaatatcgtcgccttccgcactgcccagccgcgctcggcggtctggccggcggaccaaccttgggtgcgcaacgccagccgtgccgaggtgaaagaggccttcgccgattggggcttggcggcccgtaccttggtggaggccatcgagtcaccgacgctctgggcgctgcacgacctcgaggaactgccctattacgtgcacggccgcgcggcgctactgggtgacgccgcccacgccatgctgccgcaccagggcgccggcgccggtcagggcctggaagacgcctggttcctgcgcgaactgctgagtgatccgcagctgacgcggggcaacctcgagcgagtattgcaggcctacgaacactggcgcctgccacgtgcctgccgcacccagcgcacctcctgggaggcaggtgagctctatgagtatcgcgatagaaccgtaggcgacgacgaagctcgcctcggccagaccctggcccagcgcttcgactggctctggcggcacgatctcttgagcgacgtgcacgaggcgcggcgttggctgggctgggtgttgcaacctgtctga

SEQ ID NO: 87 - DNA, 450 bp, Pseudomonas oryzihabitans
  source 1..450: mol_type = genomic DNA
atgatcccctggaccctcgccgagctggtgccccacgccggcgacatgctgctgatcgacgagatcctcgccttcgacgagagcggcatcgagacccgcctggtggtcaggcccggcctcttcaccgatgccgcgggcgccctgccggcctggatcggcgtggagctgatggcgcagagcgtggccgccttcgccggctgccaggcgcgccgtcgcggcgaggccccggcactgggctttctgctcggcacccgccagttcgcctgcgacgtgccggcctttcccgccggtggcgaattgcgcatccgcgcccagccggcgctggaaaacgacgatggcatggccatcttcgactgccacctgcagggccctggctgccaggccagcgcccgcctgaacgtctaccgtccaccccaggtggatctgtacctagaggagcccgcgccatga

SEQ ID NO: 88 - DNA, 921 bp, Pseudomonas oryzihabitans
  source 1..921: mol_type = genomic DNA
atgagcggccactgggcgcagcagcgcgagcgcggcagccccgtgctgatgcgcctcaccgcctggctggcgcggcacctgggccgccgcgccatcgccccgctgctgcggctgatcgtgctgtacttctttctgttcggcgcccgcgcccgccgtggcatccgcgagtaccagcagcgcctggccgactggagcggtcgtcccgagctgcagcccagctggcgcagcggctatgcccagttcatggccttcgccgaagccctgctggacaagctcgatgcctggaacggccgcctcggcctggatcaggtgcaactgcacgatccggatcaggtgcacagccgcatgcacgggccgcgcggcgagatcctggtcaccgcccacctgggcaacctcgaggtctgtcgcgccctggcccagctggggcggcgggtacgcctcaacgtgctggtgcacacccgccacgccgaggccttcaatcgcctgctggaagaagccggcgccagcgacttgcggctgatccaggtcagcgaactggacccggcggtgatgctgcagctgagcgagcgcctggagcgcggcgaatggctggccatcgccggcgaccgggtgccgctgcatggcggccgcaccgtggcggtggattttctcggcgccccggcgccctttccccagggaccctggctgctggcgcacctgctgcgctgcccgaccaacctgctgttctgcctgcgcgaagccgacggctaccacctctacctggaagacttcgccccggcgcccaactggcgccgccaggagcgcgccgccggcatccagggcctggcccaggcctatgccgagcgcctcgccgcccattgcctcaaggcgccgcggcagtggttcaacttctatcccttctggagtcgcgatgaacgctag

SEQ ID NO: 89 - DNA, 2325 bp, Pseudomonas oryzihabitans
  source 1..2325: mol_type = genomic DNA
gtgatccgcctgcagcgccccttcctgctgttcctcttcgccctgctggcgctcagcgcctggcagtggcggcacggtccgccggtggccgccgatctgctggcgctgctgccccagggcgccggtgatgccctcaccctgcaggccgaggcgcgcatggccgagccgctcaatcgcgaggtgctgctgctggtcggccatccccagcgcgagcgactgccggccctggccgagcgcctgggccaggcctggtcgcgggagccgctgttcgaaagggtgcagtggcaacttacccctgacctgcccggcctgcgccagcatctcctggtcagtcgcctggcgctggcaccaggaccggcccgtgaccagctcctgcatgacccggacagctatctgcaagcccgcgccgcggccctcttcgatcccttcgccggcgccggtgccctgcccctggaagaggactggttcggccttggcctgctggtgcagcgccagctcaccccggccagcaaggtgcaattcgacgccggcagcggcctcttgctgacccagggcgacggcctgagctgggcgctgatccgtgcccgcacccgcgccgatgccttcgacttcgatgccccgccgcaggtggaagccctgatcgaggccgcccgccgcgaggtggtggccgacggcggtcagttgctggccgccagcggcctgagatatgccgctgccggccaggccaccgccagtcgcgagatgtcgctgatcggcggcctggccaccttcggtaccctggccctgctgctggggctgttccggcgttggcgggtgctgctcagcctcctggcggtgggcgtggccctcttggccggcagcgctgcctgcgtgctgctgttcggccagatcaacgccctcaccctgatcctcggcgccagcctgaccggggtggccgccgactatccgctgcactacctcagcaagagctggaagggcgggccctgggacgccacggccatcctgcgcgagaccctgcccggcctgtccctcagcctggccaccaacctgctcggttatctggcgctggcctgcacgccctttccggcgctgacccaggtggcggtgttttccgccgccggcctgatcggcgcctacctcaccaccgtctgcctcttgccggcctggtggcagcgcctggacctggcgccgcccgccgcgccgctgcgcgtcatgcaacgcctgctcgacctgcgcctgcgcctgctggcgcgcaccggaagcctgccgctgctcttggccctgctggccttttgcggcgccggtgtctggcagctgcacctgcagaacgacctgcgcctctggctcggccaggacccgacattgacccgcgaagcccaggccatcgcccgcctcaccggcctgcaacccaccagccagttcttcctggtgcgtggcgccgatgccgaccaggtgctggagcgccagaccgccctgggccagcgcctcgacgccctggtcagcgccggccagctgcagggctatcgcgccctcagcggtctgctcgctcccgccgcggcccaggccgaattgcgccaggccctggccggttggggcgaacgcctgcaaccgctgctggccgtgggtatcccggcggaggcgctgcaggccgaactcaagcacctgcagcagctgcccgacctgagtctcgaccaggccctggccggccccttgggcgaaccctggcgaccgctctggctgggccgcacgaccgagggcggcgcggccggcctggtcagcctgcaaggcctgggcaacgcccaggtgctacagacgctggccgagggcctgcccggcgtgcaactggtggatcgcctgggcgaattgcgcggactgttcgtccacacccagcgcctggcggtggaactcaagctgctggcctcgggcgccatcttcctcctgctgctctgggccttcggccgccgcgcggcgctgcgcatcgtctgcctgccgctgctggcggccctggcggccctggcctgcctgggctggctgggtcagccgctgaccctgttcagcctcttcgccctgctgctcatcaccgccatcggcgtggactacgccatcctcatgcacgaggccatcggcggcgcggcggtgagtctgctcggcggcctgctgtccggcgtcggcagctggctgtcctttggcctgctgatgctcagcagcaccccggccatcgccaacttcggcctggccatcagcctgggcctggtgttcagctttctgctggcgccctgggcctcgccctccgtctcccacgaaaaggaccttcgtcatggttga

SEQ ID NO: 90 - DNA, 738 bp, Pseudomonas oryzihabitans
  source 1..738: mol_type = genomic DNA
ttgagctttcgtgcctgcgcggtgatcccggtgttcgaccacgagcacgccctgccgctggtggtccaggcgctgcgccagcgcgccctgccctgcgtgctggtggacgacgcctccagccccgcctgcgcacaggtgatggacgaactggccacgcaacccgacatccacctgctgcgcctgccggtcaaccagggcaagggcggcgcggtgatggccggcctcgccgaggcgcagcgcctgggcttcagccatgccctgcaggtggacgccgacggccagcacgacctggccgacgtggccgcctttctcgccgaggcccaggcttatccagacgcgctgatctgcggctatccgcaattcgacgactcggtgcccaagggccggctctatgcccgttacctcacccatgtctgggtctggatcaacagcctgtcgctggagatccgcgacagcatgtgcggctttcgcgtctatccgctggcaccgaccctggcggtgatccgcgccggcggcctgggcaagcgcatggatttcgatccggagatcctggtgcgtctggcctggcgcgagcagcccatgcgctggcgtccgacccgggtgcactatccgctggatggccgctcgcactttcgcctctggcaggacaacgtactgatctcgcgcatgcacacccggctgttcttcggcatgctgctgcgcgcgccgcgcctgctctggcgccgggtgcgcggatga

SEQ ID NO: 91 - DNA, 585 bp, Pseudomonas oryzihabitans
  source 1..585: mol_type = genomic DNA
atgcgcacgctgatcgctctgctgctcattctcgccgcccccctggcccaggccttcgatctcgacgacctggccgcccagctggcgcgtccggccgtggtcgcgggcagcttcgtccagcaacgctatctgcgcgccctgccgcagccgctcaccagcagcggccacttcaccctggcccgcggtctgggcctgctctggcggctggaaaagccactgacccagacctatcgcatcacccccggcgccatcgccaaagagacccccgccggctggacgccgctgcccggcagcgacctggccgcgcgccagagtgcgctgttcctcgccgtgctcggcggcgatcgcagcggcctggagcgcgacttcgaactggccctgagcggtgacgcccgccactggcagctgcgcctgaccccgcgcggcgccctgctcaagcaggtgttcgacggcatcctcatccagggtggtgccttggtggaacaggtggagatccgcgagacccagggcgatcgcagcctgctcaggctcgacggccaggccagcgacgccctctccgccgaccagcgcgcggccttccagtga

SEQ ID NO: 92 - DNA, 1527 bp, Pseudomonas oryzihabitans
  source 1..1527: mol_type = genomic DNA
atgaacgctagtgtgcgctttggtagccaggccctcgctctcgaagacctggtggccctggccgagggccgggcccgggccgacctgcaggacgatgcggcctttcgcgacggcatcgcccgcggcgccctcttcgtcgattcgctgctggcccgcgaaggctcggtctatggcatcaccaccggctatggcgattcctgcgtggtcgccgtgcccctggcccaggtcgaggcactgccgcgccagctctacaccttccacggctgcggcctgggtcggcacctggacccggcggcgacccgcgcggtgctggccgcgcggctgcagtcgctgtgccagggtgtctccggggtgcgcgtcgagttgctcgaacgcctcaccgccttcttgcgcgaagacatcctgccgctgatccccgaggagggctcggtgggcgccagtggcgatctcaccccgctgtcctatgtcgccgccgctctctgcggcgagcgtcaggtgctctggcgcaacgaaatacgggacgcggccgaggtccacgccgaactgggctggacgcccctggtgctcagacccaaggaagccctggccttgatgaacggcaccgcggtgatgaccggcctggcctgcctggccttcgcccgcgccgagtacctgctgcgcctggccacccgcatcaccgccctcaacgtggtggccctggccggcaatcccgagcacttcgaccagcgtctgttcgccgccaagccccatcccggccagggccaggtggccgcctggctgcgcgcggacctcgccgccgaaggcccggccgcgcccctgcaccgcctgcaggacaggtattcgctgcgctgcgcgccccatgtgctgggggtgctggccgacagcctgccctggctgcgccaattcatcgagaccgaactcaacagcgccaacgacaatccgctgatcgacgccgaggacgagcgggtgctgcacggcggccacttctatggcggccacatcgcctgcgccatggacagcctcaagaccctggtggccaacgtcgccgatctgctcgaccgccagctcgccctgctggtggacgcgcgctacaaccacggcctgccgggcaatctctccggcgcgccggccgcgcgggccatgctcaaccacggcttcaaggcggtgcagatcggcgccagcgcctggaccgccgaggcgctcaagggcaccctgccggccagcgtcttttcccgctccaccgaatgccacaaccaggacaaggtcagcatgggcaccatcgccgcccgcgatgccctgcgcgtgctggagctcaccgagcaggtggccgccgccaccctgctggccgcccagcagggcgtctggctcaggtgccagcagggcgtggagccgcccgcccccctggccgccatgcaccgcgacctgggcgagacctttgcgccgctgatcgaagaccgcgccctggaggccgaattgcgccagaccctgaccctgatccgcgcccgccactggaggctctatgcgtaa

SEQ ID NO: 93 - DNA, 723 bp, Pseudomonas oryzihabitans
  source 1..723: mol_type = genomic DNA
atgcacttccagattagcgattggcgcgcctgggcacctggtcttggcgaccaggacgcctggcggcagtggtgcgccgcgccttggcgtccggcggacgacggcagccagcccgatgccagcttcctgcccgccatgcagcggcgccgcctgagccggctggcgcgcatgaccttccaggtcgcctggccgctggccgacgcccatggcgagccgctgccgctgatcttcgcctcgcgccatggcgagaccccgcgcaccctggccatcctccaggaactggcccgcggcgagccgctctcgccgacccagttcagcctctcggtgcacaacgccatcatcggccagtggtcgatcctgcgcggcgaccacagcgagatgaacgccctggccaccggtcgcgacggcctcgaacacgccgtgctggaggcctgcaccctgctcgccgagggtgccagcggggtgctggtggtgatcgccgaggaggccccgccgaccctctatgccccccagatcgacgacgtcccctttccctatgccgtgggcctgctgctgaccccgggcggcagccatggcctgagcggcgcgccggcgccggcggaggccgcgcccagcgcctggccccatgccctggagttgctgcgcctgctggaagcgcctggcgccctgcacctcgcctatgccgggcgcgcctggcactggcaggcggaggcccgcgggtga

SEQ ID NO: 94 - DNA, 1527 bp, Pseudomonas oryzihabitans
  source 1..1527: mol_type = genomic DNA
ttgcacctggacgatgccgaagacctggcctgcgccctgctcggcgcctggcgcgccggggtggaggtgatcctgccggcggatgcccagcccgccacccgcgcgcgcctggcgccgacgctcgatgcctggctcgacgacctcgacggctggaccgcggccgaacccctgacgcccgcccggctcgatttgcaggcgccgctgctgaccctgagcacctcgggctccagcggtgaacccaaactcatcgccaagcagctgttccagctggccaacgaggtcgccgccctggagtgcctctggggcgcgtcccttggcgcgacgaccgtccttggcagcgtctccacccagcacatctatggcctgctgtttcgcgtgctctggccgctctgcgccgagcggcccttcgcccgccaggcgctgcccttcaccgaggaattgcagcgcgagaccgccgccctgtcgcgccagggtcggcgcgcggtgtggatcagcagcccggcattgctcaagcgtctgggcgagaatctcgacgatgccgtcctcggccaggtggtgcaggtattctcttctggcggcgtgctgccaggcgcggccgccaaggcctgtcagcaacgcttcggtcgttatcccacagaagtctatggcagctccgagaccggcggcatcgcctggcggagagggccgcaaccctggcaggcctttgccgacatcgagctgggccaggatgccgagggcgccctctggctgacctcgccctacctgcccccgggcatgcgcgagcagaccatggacgacgtgcgcctgctgggcgacggccgcttcgagttgctcggccgcctggatcgcatcgtcaagctggaagaaaaacgcatcgccctgccagccctagaagcacggctgctcggccatcccgccatcgccgatgtccgcctgggcgtggtgcagcaggggcgcgccctgctcggcgccctggtggccctgagcgagcgcggcctgcaccagctgcgcaacggcggtcgccgcgccctggtggccgagctgcgcgaacacctgatcggccattgcgaggccatcgccctgccgcgccgctggcgcctgctgctggcgctgccctacagcgcccagggcaagctggcccaggccgaggtggagcggctgctggcccagccccggccggtggagatcgagcccctcagtgtcgagcagaccgcagatggctggcggctggagctggaagtcgccccggacctggcgttcttttccggccacttccccacggcgccggtggtacccggggtggtccaggtgggctgggcccagcgcctggcgcgccagcacctggatctaccggcggacttcgccggcatggaggtgctgaaattccagcagctgctgcgccccggcgatcgggtgaccctgaccttccacttcgacgccagccgcaacaagttgcacttcgcctttcgccagggcacggcggcctgctcgtccgggcgcatcctgctcaaggaggcgcggtcttga

SEQ ID NO: 95 - DNA, 1233 bp, Pseudomonas oryzihabitans
  source 1..1233: mol_type = genomic DNA
atgagcgcgcgccgcgtcgtgatcaccgggatggccggcgtcaccgccctgggcagtgactggccgaccatccgcgaccatttcctcgccggccacagcggcatccgccgcatggacgcctgggatcgctacaccgagatgaacacccgcctgggcggccccatcgtcgacttccaggtgccaggccactggacccgcaagcagttgcgcagcatggggcgggtgtcccagctggcggtggccgccggcgagcgcgccctggccgatgccgggctgctggacgacgcccgcatcaccgacggtcgcatgggcgtggcctgcgggtcctccaccggcagcaccgacgacatcaaggcgctggccaacatgctgctcagcgacgccgcggtgggcctcaacgccaacacctatgtgcgcatgatgccgcacacggcggccgccaacctgagtctgttctttggtctcaagggccgcttgatccccacctccagcgcctgcaccagcggcagccagggcatcggctacgcctacgaggccatcaagttcgggcgcctgccgctgatgctggccggcggcgccgaagaactctgtcccagcgaggccatggtcttcgacaccctctatgccaccagcctgcgcaacgacgccccccagacctcgccgcgtccctacgaccgcagtcgcgacggcctggtgatcggcgaaggcgccggcatcctggtactggaagaactggaacacgcccgggcgcggggtgcgcacatccatgccgagatcgtcggcttcggcagcaatgccgatggccagcactccacccgccccgagcaggccaccatgcagcgcgccatggagctggccctggaagacgccggcctgaccccggacgccatcggctacgtcaacggccacggcaccgccaccgaacagggcgacatcgccgagacgcgcgccacccaggcgctgttcggctcacgcatgcccatcagctcgcagaagagctacctgggccataccctgggtgcctgcggcgccctggaatcctggttcagcatcgccatgatgaacgaggagctgttcgtgcccaccctcaacctcgacgaactggatccccagtgcggcgaactggactatctgcgcggcgggccgcgcgcgctgcgcaccgaccatgtgatgaacaacaatttcgcctttggcggggtgaacacctcgctgatcttccgccgctggtcctga

SEQ ID NO: 96 - DNA, 1185 bp, Pseudomonas oryzihabitans
  source 1..1185: mol_type = genomic DNA
ttgagcgcctacctgaatgccctgggcctgctctgcgccctgggcctgggcaaggccgaggtggcccgtggcctgttcgccggtgatacggccggcatgcagcctacggcgggctggattcccgagcgccagccgccggtgggtaccgtcaccgcgccgctgccagcctggccgctggagtggacaccttttttcagccgcaacaaccagctgctgctggcggccctgaccgagatcgaaccccaggtgcgccaggccatcgagcgccacggcccggcgcgtatcggcgtggtgctgggcaccagcacctcgggcatccacgaggccagcctgggcatcgccgtgcaccagcgcagcggccagttgcccgagggctatgaatacgcccagcaggaactggtggcgccggcggacttcctcgcccgctacctgggcttgagcggcccctgctacggcctttccaccgcctgcaccagcagcgcccgcgccctgctcagcgcccggcggctgctggtccaggggcattgcgacgccgtgctctgcggcggggtcgacagcctctgcggcctgaccctgaacggcttcgccgccctcgaagcggtcagcgaatcgctgtgcaatcccttctcggtcaatcgctgcggcatcaacatcggcgagggggcggcgctgttcctactgacccgcgaacccggccccatcgccctgctcggcggcggcgccagttccgatgcccaccatatctccgcccccgatcccagtgggcgcggcgccgtccaggccatgcaggcggccctgcgcgccagcggcctgcaaccgggggacatcggctatctcaacctgcacggcaccgccacgccgcataacgacgccatggaaagccaggccacccaccaggtgtttccggccggggtgccctgctcctccaccaagccgctgaccggccataccctcggcgccgccggcgccctggaagccgccttcgcctggctgaccctggacccgcggctcaatcccgccggccagttgccgccgcagcgctgggacggccaggccgatccggccctgccacggctggcgctgacggatgccgacagccggctggacggtcgccgccacgccatgagcaacagcttcgcctttggcggcagcaacgtcagcctcatcctcggagccacgccatga

SEQ ID NO: 97 - DNA, 255 bp, Pseudomonas oryzihabitans
  source 1..255: mol_type = genomic DNA
atgcaaagccgtgaagccatcttcgagaccctgcgcagcgccctcgtcgaactcttcgaactggagcccgagcgggtgaccctggaggccaacctctacgaggacctggagatcgacagcatcgacgccgtcgacctgatcgaccacctgcgccgccagaccggccacaagatcgccgccgagcaattccgccaggtgcgcaccgtgggtgacgtggtcgaggccgtccatcgcatcagccaggcggacgcctga

SEQ ID NO: 98 - DNA, 738 bp, Pseudomonas oryzihabitans
  source 1..738: mol_type = genomic DNA
atgagcgtcgcccccgctccggtcctggtgaccggttccagccgcggcctgggccgcgccatcgccctgcgcctggccgccgccggccatgacctggtgctgcactgccgcagccgccgcgaggaagccgaggccgtgcgcgccgaggtcgaggccctgggccgcaacgcccgggtgctgcaattcgacgtcagcgaccgcgccgcctgcgccgccatcctggaggccgacaccgaggcccacggcggctactacggggtggtctgcaacgccggcctgacccgcgacggcgcctttccggcgctgaccggcgaagactgggacctggtcctgcgcaccaacctcgacggcttctacaacgtgctgcacccggtggtcatgccgatgatccgccgccgcgcgccggggcgcatcgtctgcatcacctcggtctccgggctgatcggcaatcgcggccaggtcaactacagcgcctccaaggccggcctgatcggcgccgccaaggccctggccgtggagctggccaagcgcaagatcactgtcaactgcgtggccccggggctgatcgacaccgagatcctcgacgagcacgtccccgtagagaagatcctcgagatgatcccggccgggcgcatgggcacccccgaggaggtggcccacgccgtggccttcctgctcgcccccgaggccggctacatcacccgccaggtgctggcggtcaacggaggactgtgctga

SEQ ID NO: 99 - DNA, 261 bp, Pseudomonas oryzihabitans
  source 1..261: mol_type = genomic DNA
atgactgacctcaatctcgagctcaaaggcctgatcatcgaggcactcggcctcgaggacgtcaccgtcgacgacatcggcgacgaccagatcctgttcggtgacggcctgggtctggattcggtggacgccctggagctgggcctggcgatccagaagcgctacggcatccgcatcgacgccgaagccaaggacacccgcacccatttcgccagcgtcaacgcccttgcggcctttgtcgccgcccagcgcgccgcctga

SEQ ID NO: 100 - DNA, 501 bp, Pseudomonas oryzihabitans
  source 1..501: mol_type = genomic DNA
atgaccctgccccgtccgttcgtcttcgcgctggcctgcctgctgctgctcgccgcctgcgccagccagccgccgctgcccagcagtccgccgccgctggcgcgtgccctggtctaccaggtggagcgccagaccgccgagggcagcgacgccctgctgctggccatccagccggaaggcgccgccctgcgcttttcgctgttcgatccccttggcgtgccccaggcgcgccagcaactgatcgacggcgcctggcacgccgacggcctcttgccgcccaatccccgggcgcgcaccttcttcagcgtgctgctgttcgccctgaccccgaccgaccagttgccacgggcctatgccgcgggcgactggcagagggccgccgacggcagccgcaccctcaaggactggcaggtgcgctatcccgccgccgaccgcctggcgctgcaggcgccggatgggtccagctatcacctgacgctcttgccggagtccgcgccttga

SEQ ID NO: 101 - DNA, 573 bp, Pseudomonas oryzihabitans
  source 1..573: mol_type = genomic DNA
atgagtgccctgccttcccgctctcccctgggcctggtcgccagtgccctgctgctcctgctcggcctggcctatcccttcgccgtttacttcggcctgcagcacctctcgccgcgcctcttcgcggccggcctcggcgccctctggggcctgcgcctgctgcaacccggtctcaacggcctgcagcgcggcaccgccctggtcgccctgggtttctgcctgctgctggccctgagcgacgccgccgtcctgctgcgctggtatccggtgctgctcagcctcttcctgctggcggtgttcggcctgagcctgctgcgcggccagccgctgatcgagcgcctggcgcggctgcgcgaacccgagttgccgccgcgcgcggtgcgctatacccgccgggtgacccaggtctggtgcctgttctttctgggcaatgcgctgaccgccgccggcctggcgctgtgggcgccgctggcctggtggacgctctataccggcgtcatcgcctatggcctgatgggcctgctgttcgccggcgaatggctggtccgccagcgcgtgcggaggctgccatga

SEQ ID NO: 102 - DNA, 723 bp, Pseudomonas oryzihabitans; identical to SEQ ID NO: 93
  source 1..723: mol_type = genomic DNA

SEQ ID NO: 103 - DNA, 435 bp, Pseudomonas oryzihabitans
  source 1..435: mol_type = genomic DNA
atgcgtaagaccggtgccctgcaggtcgaggtggagatgcagatccccttcttcgacgtcgacatgatggaaatcgcctggcacggccattacgtcaaatacctggaagtggcgcgctgcgccctgctcgaccgcctggaccacaactacctgcagatgcgcgactccggctacggctggccggtgatcgatctgcagatccgctatatccgccccctgctgttccagcagcgcgtgcgggtaaaggccgatctggtggagtgggagaaccgcctcaagctcaactacctgatcagcgatgccgccaccggcgagcgcctgacccgcgccagcaccgtacaggtggccgtggacctggccagccgcgagatgcagctggcttcgcccagggtcttcatcgacgccgtggagagggccctggcatgcgcacgctga

SEQ ID NO: 104 - DNA, 1248 bp, Pseudomonas oryzihabitans
  source 1..1248: mol_type = genomic DNA
atggttgaacatcatcccctgatcgtcatcggtgccggcccggcgggcgccgtggtcgccgccctgctcaagcgccgcggccatccggtgctggtgctggaagcccagcactttccgcgcttttccatcggcgagagcctgctctcccacagcctggacttcgtcgaggaagccgggatgctgcccgcggtcgaagccgccggcttccagaccaagctcggcgcggccttcgcctggggcgagcgctataccgacttcgactttcgcgacacctatagcggcggccgcagcaccttccaggtgcagcgcggccccttcgacaagatcctggccgacgacgccgcacgccaaggggttacgatccgctacggtcagcgcgtcaccgccgtgaccctgggtgaagacggcgaaaggacccggctcgaggtgcagggcgacgacggccaggcctatgcgctgaccaccgacttcctgctcgacgccagcggctacggccgggtgctgccgcgcctgctggatctggaggcgccttcggacttccccgtgcgccgcgccctgttcacccatgtcgaggatcgcatcgacgagcccggcttcgaccgccagcgcatcctcatcaccacccatccgaccctgcgagatgtgtggttctggaccattcccttcagcgacggccgcacctccatcggggtggtcgccgccgccgagcgctatgccggacgcgccgccgatctcgccacctgtctgcgcgactgggtggccgagaccccgagtctggcccgggtgctgcacaatgcggtctgggatacgccggtgcgcgaactgggtggctacgccgccaacgtcaagcgcctgcacggccccggcttcgccctgctgggcaacgccgccgagtttctcgatccggtgttttcctcgggcgtgaccatcgccctgcgttcggccagcctggccgcaccgctggtgaatcgccagctgcgcggcgagtcggtggactgggaggccgaattcgcccggccgctcaaggcgggcgtcgatacgttccgtgcctatgtggagggctggtacgatggcagcttccaggacgtcatctatttcgaacacgccgatcccgagatcaagcgcatgatctgcgccattctcgccggctacgcctgggacgttcgcaaccccttcgtcaaggagccccggcggcgcctgcgcctgctcgtcgagctctgtcagctgaattcggcccatcctgcatga

SEQ ID NO: 105 - DNA, 399 bp, Pseudomonas oryzihabitans
  source 1..399: mol_type = genomic DNA
atgttgcgtcgcctgttgctcgtctccgctctgctgttcctggcggcctgcacccgcgcgcccctggtgacgccccgggaggtctttccggcggatcgtgcggaaaacgccgccgatgtccgccgcgccatcgtcgacaccctcgaacgccgtggctggagcgtcggccaggagagccccggcctggtggtcgccagcatcgtggtgcgcgatcgccaccaggcctgggtcgacatcccctacagcaccaagggctaccagatccgctaccgcgacagcgccggcctcgactacgacggcgagcgcatccatcgcaactacaacaaatgggtccagctgctcgacgccgacatccgccggcaactgcagttgcctgcccccgcagccgccgcggagtga

SEQ ID NO: 106 - protein, 250 aa, Pseudomonas oryzihabitans
MDLTGKTALVTGSTSGIGLGIAQRLAAAGATLILNGFGDPAAAQASLPGRSGFHGADLSRPEEIEELFAYAQRDFGGVDILVNNAGIQHVAPVEDFPVERWDAVIALNLSAVFHTTRLALPGMRERDWGRIINISSVHGLVASTGKAAYVAAKHGVVGLTKVTALETARTGITCNALCPGFVLTPLIQQQLDSRGSDPDQARRDLLSEKQPSQEFVTPSQLGELALFLCSQAAAQVRGAAWTMDGGWTAQ

SEQ ID NO: 107 - protein, 337 aa, Pseudomonas oryzihabitans
MSLDLEKRFPRIKLGYFPSPLHKLERMSKDLGIELWAKRDDVSSGLAYGGNKVRKLEWLAADALAQGCDTLVSIGNIQSNHTRQVAAVAAVLGMKCRLVQEEWTKWEDPVYDKVGNILLSRLMGAQTLLEGEGYSTAVKATWERALDEVRREGGKPYAIPAGASDHPLGGLGYAHFADELAAQERDQGLFFDTVVTATCTGSTQGGMVVGFRAQERERRLIGIDTAADAGMTRAAVTKIARNTAEMIGLDKEIRDEDVIIEPRFCGPDYGLPDGPTVEAIRYTAQMEGMLTDPVYEGKSMAGLIAMARSGEIAKGSRVLYVHLGGAPALNAYHNAFA

SEQ ID NO: 108 - protein, 307 aa, Pseudomonas oryzihabitans
MTSLPPAALQEVQLAALAARDLRLAVLRLDQRPAAHNGNKGYKLRPWRERLARGEGRGLISLGGAHSNHLHALAALGRTEGFVTVGLLRGEPCLTPTVQDLQGKGMTLHWLGYGGYRRRHDADFWQPWQARYPGLLPIPEGGCDEQAAAACAAIVTELRQGLAALDWPDCQQVWLAAGTGTTLAGVIRAADPAWQVVGGLAVPPGHGVEANLDRLLAQHMAPNWRLLDASRGGFGRLDAEVARAMAEFEAQTGIALEPLYTGKLWLALRQAIEGGAIAPGSRLVLIHSGGLQGRRALQPQLAKWVGG

SEQ ID NO: 109 - protein, 486 aa, Pseudomonas oryzihabitans
MIPVILSGGSGSRLWPLSRKLYPKQFLALTSEQTMFQETINRLGCEGSIDCPIIVCNAEHRYLVEEQLKAVDCKPQALIMEPFGRNTAPAVAIAAMQLVADGKDDLMLVLPADHVIEDEAEFKAALQQAAAAAERGEMVLFGIPATAPETGYGYIKTGSNDGLPQGVSRVERFVEKPDAVTATEYVASGDYCWNSGIFLFRASRFLEELKKHDTDIYDTCLLALERSSIDGINISIDAATFAVCPDNSIDYAVMEKTTRACVVPMTAGWNDVGSWSALWDVHAKDNNGNVIKGDVVLHDSRNCLVHGNGKLVTLVGLDDVVVVETKDAVMIAHKDKVQDVKKLVNTLEKQNRNEVKAHQEVFRPWGSYDSIDMGQRFQVKRITVKPGAQLSLQMHHHRAEHWIVVSGTAEVTCDDKVFLLTENQSTYLPMTSVHRLANPGKVPLELIEVQSGGYLGEDDIVRFEDIYGRVDTQALEVAKAGKASTR

SEQ ID NO: 110 - protein, 449 aa, Pseudomonas oryzihabitans
MEQTSGRILLVDDEAAILRTFRFCLEDAGYSVATANSAAQAEALLLRQVYDLCFLDLRLGADNGLDVLQQMRIQAPWMRVVIVTAHSAIDTAVDAMQAGAADYLVKPCSPDQLRMAAAKQLEFRQLSARLEALEGEVRKSNAGLDSRSPAMMSILETARQVATTDANVLILGESGSGKGELARAIHAWSRRAKKTFVTINCPSLSADLMESEMFGHTRGAFTGASESTLGRVSQADGGTLFLDEIGDFPLALQPKLLRFIQDKEYERVGDPVTRRADVRILAATNRNLEQMVAENEFREDLLYRLNVIVLNLPPLRERKEDIVDLAERFLARFVKDYNRPAHGFSEAALDALRNYGWPGNVRELRNVIERASIICGQDLVDVNHLGLGDSPASSGAASAPRVGEALSLEALERAHIAAVMATSETLDQAAKTLGIDASTLYRKRKQYGL

SEQ ID NO: 111 - protein, 175 aa, Pseudomonas oryzihabitans
MSREALLESLSAVMDNEADEFETRRVIAEVSKDPELRATWSRYAMVSAVIRGEPMLPNLDIAKGVTTTLERDEAVAAPAAPVVAQARKSGWSSLGRVAVAASVTFAVLAGVRMYNQSDVSTQGLAQQAPSQLTVPQPARSPAVLASFSEESTKANAEAKADKPMAGEKQEAPAQR

SEQ ID NO: 112 - protein, 853 aa, Pseudomonas oryzihabitans
MARGKNDKDVRKAAPRVAGLPGMGAGLLLALAGLLLAALLLWFLVLQPQGARNQEQQADQALQAQATSLNQLLVGLTRRLQGVAGDALVLQALQGDDPAARAAAESQLRERLGVVDVLVVPAGMRQIEDDRPGPLNYAALDLLKRLESGQRTPPEAYRLGDRWLVYSAQPIRRGDQLLGSAVLVEDLPAVLQGWATPPANVGQWRLLQQFPGGSVQVLASGGSPGDPALMRRLATGSPLWTLELAPAAEAGADTPLGIPLVALLLALFGVLAGFWLFSRELSRRLRDDVRSLTAYAEELEANQIAKSPTLRLAVMEPVAKSTARLASRSAGSSPDLYATAPSDAVAKTLAEFADRGRSQQSEPLFQTTDILDISILDEDQDLLGLEKPPMSTTPQAPQLNASIFRAYDIRGVVGDSLTAEAAYWIGRAIGSESLARGEPNVAVGRDGRLSGPELVAQLIKGVADSGANVSDVGMVPTPVLYYAANVLEGKSGVMLTGSHNPPDYNGFKIVIAGETLANESIQRLRERIETGDVASGQGQIKQVDVLKSYADYIRNDVVLAKKLKVVVDAGNGVAAVNAPQLIESLGCEVIPLFCEVDGNFPNHHPDPGKPENLEDLIAKVKETGADLGLAFDGDGDRVGVVTNEGKIIYPDQLLMLFAKDVVSRNPGADIIFDVKCTRRLNNLIAGYGGRPIMWKTGHSLIKKKMKETGALLAGEMSGHVFFKERWFGFDDGIYSAVRLLEILSQEKNSAQQVFDTFPVDISTPEINIQVTEENKFGIIETLQRDAQWGDAQITTLDGVRVDYQNGWGLVRASNTTPVLVLRFEAETLEELERIKTVFRKQLLAVQPDLNLPF

SEQ ID NO: 113 - protein, 248 aa, Pseudomonas oryzihabitans
MNVLIVDDEPLARERLARLVGQLDGYTALEPTATNGEEALALVENLKPDIVLLDIRMPGLDGLQVAARLCERESPPAVIFVTAHDEYALDAFQVSAVGYLVKPVRQEDLAAALSKAQRPNRMQLAALTKPPASGGPGPRSHISARTRKGIELIPLDDVVYFIADHKYVTLRHSGGEVLLDEPLKALEDEFGERFVRIHRNALVSRERIERLQRTPLGHFQLFLKGMNGDALTVSRRHVAGVRRLMHSI

SEQ ID NO: 114 - protein, 221 aa, Pseudomonas oryzihabitans
MQQPSLAARVDSESKDDTELQAKDSKQALPTQEQDQQLVERVQRGDKRAFDLLVLKYQHKILGLIVRFVHDTQEAQDVAQEAFIKAYRALGNFRGDSAFYTWLYRIAINTAKNHLVARGRRPPDSDVSAEDAEFYEGDHALKDIESPERSLLRDEIEATVHRTIQQLPEDLRTALTLREFEGLSYEDIANVMQCPVGTVRSRIFRAREAIDKALQPLLRDA

SEQ ID NO: 115 - protein, 358 aa, Pseudomonas oryzihabitans
MILERRKTPRPVKVDDFFVPALCEPEALLVLVVLAELLVLVLVLAEPFTLQFNWIRLALVSLFVQWIVLLSAALLCRLRPWLARHRPVVAGGFCCAIVVALTLLCTLVADWLQLAGPLQRVGEVRLYMRHALIALIMSMLLLRYFWLQSQWRRQQQAELQARIESLQARIRPHFLFNSLNSIASLVALDADKAERAVLDLSALFRASLAQPGTKVRWVEELELSRRYLEIERLRLGDRLQLQWDVDGVPADLPIPQLTLQPLLENALIYGVAPRIEGGLVTIFATYREGVFELVISNPYDPEVEQQPRPPKGTRQALSNIEARLTALFGPAASLKIERRDQRHTTSLRYPCERLMREA

SEQ ID NO: 116 - protein, 293 aa, Pseudomonas oryzihabitans
MATVLVPNATDNFAAALQWQRTRIDERLAELLPAGSDPVAAAIRSGVLAPGKRLRPLLMVLAAEDLGQADEAVLDLGCAVEMVHAASLFLDDMPCMDDARLRRGRPTLHVEFGEDVAMLAAVALLSHALRLVAGLAGVPAETRTQMVCQLADAVGTAGLVCGQYHDLHGGRQARPADAIALTNQLKTGALFSAALAMAGATLVTTAVQREAFHVFACQLGLAFQLLDDLDDGKGLGKDAGKDGDKSTLVSLLGRDHAQRQLHSHLKQAREALAQADCADGALAGLLDIVFRPR

SEQ ID NO: 117 - protein, 422 aa, Pseudomonas oryzihabitans
MHVALISPPLPSHLSTHLVLGEALVALGHRVTLLHQVEVGDRALPAGIEFQAIGATSHPRGSLAPLLARTASSKPWSVFGVIADMARNTELFCREGPAALRDLGVDCLIADQMEPAGGLLGDHLGLPYASLACAVPMNREPHLPLPTLPFAYPASERERQIVQGATQVFDLMMRGQGKVIQRQAQAFGLGDRQTLDDCFSPYLQLSQCLPGFDFPRRAPPPHFHEVGPLRSPAVREQRLELEIDPRRPFVFASFGTLQGGRLALFRRIAQACRQLGVQVLIAHCGRLDASGERRLLDDGATWVTDFAPQEAAIARADAVITHGGFNTVLDALAAGKPMLALPMVFDQPGIARRLERVGAGICLAPRLASKARLTQALGAVLADPGYRQAAERFVPIARAAGGVATAARLVDALAQRGLERAS

SEQ ID NO: 118 - protein, 175 aa, Pseudomonas oryzihabitans
MELLINAGIVLATVAGMEAFAWWSHKYIMHGWGWGWHESHHRPRTGWFEKNDLYAVVFAGLAILLIALGNAGYWRLQWIGAGMTLYGLLYFIAHDGLVHQRWPFRYIPRSGYLKRLYQAHRMHHAVDGKDGCVSFGFLLAPTTRQLKQQLREIHGGALDSSRERKARDQVQEGAD

SEQ ID NO: 119 - protein, 177 aa, Pseudomonas oryzihabitans
MHKTETAVSHDRFAASSSLLALGLSANAQSGYKPEFFNATQWRTLVALCAHLQADSEQADARLPEFIDRHMLTPYAHGDRSNIVDPFDEQAQVQQGANLRDLLRDGLAVVDSYCTERLGAGFAELAAGEQAQVVTAAEAGTLNPPAKEFIDLLRNESERSQYAHSLFAAYDDTPAVA

SEQ ID NO: 120 - protein, 349 aa, Pseudomonas oryzihabitans
MVDWELASRKNDHLDIVLDPHKARSAVTTGFDAYRFTHCALPELNLDEIDLGTRLFERPLAAPLLISSMTGGPERAALINRHLAEAAQTLGIALAVGSQRIALQQGGDQGLTGELRRLAPDVPLLANFGAAQLVAGYGLDEARRAVEMIEADALIVHLNPLQEAVQAGGDRRWHGILLALENLVTQLAVPVVVKEVGAGLSGRVATQLLEAGVAVLDVAGAGGTSWAAVEAERARDDQQRAIARAFTDWGIPTADSLRQVRTACPQATVIASGGIRDGIDVAKAIRLGADLAGQAAAALPGATESTEAVIAHFQVVIEQLRIACFCTGSADLAGLRQAELLDAASLRCP

SEQ ID NO: 121 - protein, 388 aa, Pseudomonas oryzihabitans
MRPDLLIVGGGLAGGLLALRLAETRPELDWRLVEAGPRLGGNHTWSFHEPDLTAPQHAWIDPLVAHRWPGYEVRFPQRQRQLGSGYASISAERFHEVLSARLPAERLLLGREVLRLQDDGVVFADGYTLAAGAVIDARGPRPDPALWLGYQKFLGQEVRLTRPHGLTEPIVMDATVDQLDGYRFVYSLPLAPDRLLIEDTYYADGESLPVERLRQHLADYAGQQGWEIAEVLREEQGVLPITLGGDLDRYWDNVTAGAPIGLAAGLFHPTTGYSLPEAVRLAEHLAAQPFTSSAVLRDSLRQYAQSRWQGQGFFRLLNRMLFLAGRPEHRVRVMQRFYGLGEPLIQRFYAGRLTAFDRLRILSGKPPVPLKPALDAALARPPQFKEAP

SEQ ID NO: 122 - protein, 498 aa, Pseudomonas oryzihabitans
MTQGNAPKRAIVIGAGFGGIALAIRLQSAGIATTLIEGRDKPGGRAYVYEDAGFTFDAGPTVITDPSALEELFTLSGRQMRDYVELLPVSPFYQLCWEDGTRFDYVNDQARLDEQIRALEPDDVAGYQRFLAYSQAVFEEGYIRLGAKPFLKVGDMLAAGPKLAQLSAWRSVYTQVSRFVKSEKLRQTLSFHTLLVGGNPFATSSIYALIHALERKWGVWFAKGGTHQLVLGLLKLFTDLGGEVRLNAPVERILTEGNRATGVCLADGSQLAADLVASNADVVHTYRKLLGHHTHGVVEGNRLKRKRHSMSLFVIHFGLSQPPVGLEHHMVCFGQRYRGLIDELFKGPGVPDDFSLYLHSPCVTDPSLAPPGHSSHYVLAPVPHLGNADVDWGVEGPRLRDKIFAYLEERYMPGLRANLVTSRIFTPADFRQELNAHVGSAFSLEPILTQSAWFRPHNRDSVIPNLYLVGAGTHPGAGVPGVVGSAKATASVILEEHG

SEQ ID NO: 123 - protein, 311 aa, Pseudomonas oryzihabitans
MPATPDVVDHAEQSIAVGSKSFAAAAKLFDPETRESAVLLYAWCRHCDDVIDGQELGHGQVEGDRRAGQERLAELERLTRAAYGEEPLQDPAFAAFQRVVRRHGIPLALPLDHLAGFRMDVEERVYVELEDTLEYCYHVAGVVGVMMARIMGAEDEETLDRACDLGMAFQLTNIARDIVEDARIGRLYLPRLWLDELGVPADELAAPRHREAVAQLAERLVRLAEPYYDSARQGLAALPLRSAWAIATARGVYREIGVQVLHLGAHAWDQRVSTSTADKLRLVCRGAARAMLSRHQRDEPRASELWTRPRR

SEQ ID NO: 124 - protein, 314 aa, Pseudomonas oryzihabitans
MTTTGTLADAALVILNGKETGNEDVREAILERRAAGHRIDVRVTWEEDDAARFVEQATREGYGTLVAAGGDGTLRAVAEAMAQNHSQARLGLLPLGTANDFANAAGVPLEPAAALALLDGPTSTIDLIEADGQLFLNMATGGFGSQVTANTPGELKRLLGGAAYFLTGLTRFAEVHSAHGRFRGPGFEWEGEFLALGIGNGRQAGGGHVLCPTAVVNDGLLDVGILPASQDVLGTLGEFLSKGFSTEEMFIRARLPWVELEAAEGLDMNLDGEPVKRDRVRFEVRPGILQVCLPVDSPLLGETAGTLAEPAATS

SEQ ID NO: 125 - protein, 742 aa, Pseudomonas oryzihabitans
MTVSLRLAPLLLATLGAAPAFTLAQNAPPVAVAGSGYDNSFKQLGAVYPFNLRGIDSRDGVGFDIRADEIVSAAKVTLNYTYSPALLPELSQLNVLVNDEVAASIPLPKEGAGTPQTRVVDIPPRLITEFNRLSIQLIGHYTMQCEDPLHSSLWAKVSNGSRLDIQVSRLDLAPDLARLPQPFFDRRDARQLELPFVIAGAADNGTLEAAGTLSSWFSALASYRGARFPSSQNALPAKGNAVVLVTSEERAKTLGLSLPAPATARVDILANPFDPQGQLLVISGRDANELKRAASAVALGHQTLSGQSMTFDTLQALQPRKPYDAPNWLPSDRPVRLGELATPKQLAVSGYDSGTLSVPLRLPPDLFLWRNQGLPLHLRYRYTPQPVATNSSLLVSFNDRFVQSIALPSQEHLDQSLLGLIKDEELPREAEVRLPLEGEALQARLQFRFMYDYLKQGECRDVIIDNMRGTLEPDSTLDLSGYRHFIALPNLGVFKDSGFPFTRLADLSETAVILPDAPSAAEIDTYLNVLGRFGSSTGYPATAVTVARAGEVDGLADKDLLLIASGADQPLLQRWAAQLPAGFTGNGQRFEVSDLAFKVRQWFGSDNAASLERSRAALSASGGAGTAFVTGFESPLRSGRSVVALVAARPEGLADISRALTTREDYAQALQGSLATVRGQQVESLVADETYHVGSLGPLLYVRWQLARHPLLMLGLSALGVALLAGLLHAALRARARQRLER

SEQ ID NO: 126 - protein, 1260 aa, Pseudomonas oryzihabitans
MTRAPLLATLVTGLLLPPLAQAAGTPEALLLEQGHFWQARKNAPRAQETWNKLLELDAQQPEALYGLGLIEVQADRLPTAQAYLRRLQALKPVPQQALQLEQDIALASGDNPQRLVDARQLVSEEKPVQALALYRQLFGGRLPQGDLAREYYDILAYTPNGWQEAGPGIERLRKLQPSDPALMLIQAKHLARFPASRSRGIQALAELSTRKDIGGEAAEYWRQALVWSGPPGPAEAPLFEAYLRQHPDDAELRAQLEKGRALSRSGGLDPQLARGIDALRRNELGAAESAFQARLKAAPEDANALGGLGIVRQRQERFDEAEALLNRATRQPGGARWQAPLAEVRYWALLAQARKAQQANDFSTARARVEQALRLDAKRPEAPLALAGLQAQTGQLDAAEAAYRRILQQDPRNLEARRSLIDLLAESERPAEALRLLDTLTPAERARLGNLDRLKATQALQEAKLAEGRGDLQGARRALEDARRADPDDVWTLLALARLQLRQGQEAAARQTLDSGLAKDPQRPEALYVRALFALEQRDPTAARALLGRIPPAQRTPAMTGLAADLDFDARVSAARDLARRGQQQAARRQLAALEPQAGERPAALGGLAAAYAEAGDPERGLRLLRDVLARERTPDPALRLQYGEVLLRSGADDEVNALLHDLQGQRLTAAQRQGYDDLLYRYRVRQADQLRERGDLVTAYDTLAPALAQRPDDDLANAALARLYLANGEADKALRLYEPLLRRAPDNPRLQLGAADAAVRARDNAYAERALERAVTLGADDVGVLTEAARLYRALGRDGRATELLRQVVAVERRDAETARPLASAPANPFGPRRGSATLASQAIPPTADQLLAAAKAAPLADAPVAPQDSAAERALDDLLQTRSARVTQGLTVRSNDNERGLGKLTDVEAPLEIDFPLGDVRLAVRVTPVSLTAGSVGSDARSRFGGGPAATQAAPDAAPGSQSDSGVGLAVAYSDPQLGLKADAGTTPLGFLYTTPVGGVSLERPLTDHSRYSLSASRRAVIDSLTSFAGSEDARTGQQWGGVTANGVRGQLGYDDSQFGAYAYASWYRLLGNHVADNSRTELGTGLYRYLINSEDSRLTLGLSLTGIAYDNNQAFFTYGHGGYFSPQRFYALGVPLTWSQRTDRWTWQLRGAVGLQRIEQDGADFYPTDARLQAAASQALGAPAVYGGQSKTSLGYSLYGATEYQLGRQLFVGGNLGVDNGRDFQQLNGGVYLRYALEPQDRALALPVSPYRSPYDN

SEQ ID NO: 127 - protein, 1005 aa, Pseudomonas oryzihabitans
MPKHLTLSLGLLALLIHADATWAAAADAAPSAAAVQALEAQLKKTPQDPDALGKLGSARLAQQRWTDAEQLLTQAVQKGGKTWQPALDEARYHHLLERAHAAENKRELDQARDLSVEAIRLKPEAVEAQLFLAGIQSQKRQWELAEATYRQVLMREPANVDAYYGRIAALNELGRTEEALQLTKNLQPSAKNQVKGLDRLRAGQAMQEAEAAEARGDLQGASRLLEQARQESPEDPWLRLAQARLEVRQGRPRAARDLVDSLVKDGAQRPEVLYASALLSNELGEYPRAMQTLMRIPQAQRSPDMNALAARITFNEQLAETVALAKQGRREEARSLMQRLEARAGRNPDLIGDLAEAFATAGDPEHGLALLKPMITGDTRPAPAMQLHYASIQLQLNQDQTVGNVLRDLQGVVLDSGEKQQYDDLLARYRIRQADRLTDQGKLAAAYDTLAPALKARPDDKAAQAALARMYLASGDTQKARQLYRDVLSDQPKDAELYLGAAEIAAKSQDSVTARQYLDQAVKLGQSDPLVLRRAALLYRDIGMAGTATGLLEQVVQVERKDRESAARAAGASDNPFAALPGQTRSDNALAAVPAAAGGNASSADYAWSDPLQAQKAANNPFSDLSVVPTSSLSSSLATEQILGQLQRERSIRITQGLSVRSYDPSGSSRQTTVSAPLEISFPAGDQRLAVRVTPTRINDSSSDGSQKENGVAASIAVEDAGRGLKGDIGVSPVGLRYSTVVGGATLERPLSSLSENLLYALSVSRRSVTDSLASYGGIRDPRTGQEWGGVTANGGLARLRYDDGRYGSYIYGAAHRLTGHDVKDNDRFEIGTGVYYYLRNGPDSLFTVGLSATAIGYDNNQNHLTYGHGGYFSPQRYFAIGVPLVWAQRGDLWAYQVQGMLGVQTIRQDAADRYPDDAALQAAAEAAGEGQYGSKSKTGVAYSLSANGEYRLSGQFALGGRLGLDNAQDERDVNGNLYLRYFFEEQEGRPQLSRPQPYRSRNEE

SEQ ID NO: 128 - protein, 732 aa, Pseudomonas oryzihabitans
MSFLDRLEQVRQRRAARAADAQPVPPAAPLWLQLFAWTAAALLGALLVSVPLALEEQAAFAVGCFGAALLLRRLPGRLPVIALILLSLLASLRYLYWRLTSTLGFETPLEMVLGYGLVAAELYALAVLVFGYLQTIWPLRRTPVPLPADPAAWPTVDVFIPTYNEALSIVKLSILAAQAIDWPRDKLRVHVLDDGRREDFRHFCATAGVSYLVRENNEHAKAGNLNAALKVTDGEYIAIFDADHVPTRSFLQVCLGWFLKDPQLAMLQTPHFFFSPDPFEKNLKTFRTVPNEGELFYGLVQDGNDLWNATFFCGSCAVIRRTMLEEVGGVATETVTEDAHTALKLNRLGYNTAYLGIPQAAGLATESLSRHIAQRIRWARGMAQIFRMDNPLLGKGLALGQRLCYLNAMLHFFYGLPRLVFLTAPLAYLLFSAQIFHASALLITCYVLPHVLHSNLTNSRIQGEFRHSFWNEVYETVLAWYILRPTLLALINPRLGKFNVTDKGGIIASDYFDWELARPYIVLLALNLLGLGVGIARLFLGDPEAVTTVAINLVWTLYNLVIASAAVAVASETRQVRAEPRVAATLPAGLVLADGSRLECSTLDFSQSGIGLKLPAGLHLPEGSAVEVELSRNGRSRRFPATVAFSRAGAVGTRFAELSVTEQRELVRMTFSRADLWAEAWGNHRPDSLLGSLREVSQIGLRGIADLNRNVWRLSRPSRRTAPSSSASLDRP

SEQ ID NO: 129 - protein, 351 aa, Pseudomonas oryzihabitans
MVRSLDIANLFRSFGGDPQRYHEFEAPEPVPHEALLPATAQPQPAPSAQVEAVVAVAEAAAQAEPDALPPLSRQLAQLHSSRQANQAVAALDQALSRTLPRLAGPVLALMSARGGTGKTVIAAGLAQALSRSGQPVLLVELDSQNVLSSLLLQEASSTTGSVRAPLSVCLAVDERLRLVPFGAPDELDLQALEQALATDTQWLTRRLQALDVPADTLVILDCPTGSTPLSRQALALATRILGVTTADATGYASLPRLERQWQRCSGQVTPLHLLNRVDPARPLSQDIAAIVAQSWGERLLGVLPESPDLEQALALGQGLASVQDAWARGVAELGEALLGDLRSPVQHAARA

SEQ ID NO: 130 - protein, 221 aa, Pseudomonas oryzihabitans
MAASLLTGLTILMIGDSHLATPDYLIGTLQDSLVQQGAKVHTLGICGTNAGDWLKVTPGTCGGAERRNGDKAVVLGGKAATQPINELIAADKPDLVLIVMGDTMASYTNPSFPKTWVWQQTTSLTKAIAATKTHCAWVGPTWGTEGGKYGKTFERVKLMSGFLASNVAPCSYIDSLSFAKPGQWATIDGQHLTGPGYKSWSSAIVEALNKLPADKLKGAAQ

SEQ ID NO: 131 - protein, 471 aa, Pseudomonas oryzihabitans
MVFASLEFLTLFLPLFLLVYALARPGGRNGVLLVGSWLFYGWLSPLFLLLHMALALLAWIGGLLVDRAREGSRTRLQLLAGLIVINLAVLCWYKYANIVAATWSQVLVTAGALPLDWQKVALPAGLSFIVLQAISYLVDVHRHVVPVERSFVNYATYISMFGHSIAGPIIRYDWVRRELNQRWFNRENFALGARRFMIGLCMKVLVADTLSPLVDVAFHLDQPSFVDAWIGCLAYSLQLFFDFAGYSAMAIGLGLMLGFHFPENFNRPYLARSIQDFWRRWHLSLSSWLRDYLYISLGGNRGGRWRTYRNLFLTMAIAGLWHGGDSWNYLLWGMLHGLALCLDRLWDELGGRPLPRPLAHGLTLLFVALAWTLFRAPDFATALSLYAGQFGLHGFALGDALAVTLRPVHGLAAALGVACILAPLWQSRIEARLPGSVLLRVLGAAWPVAGFLLCFALIASREAVPFLYFQF

SEQ ID NO: 132 - protein, 216 aa, Pseudomonas oryzihabitans
MKALLLLGLLVGGVAQAEVSLYPTGPSEDSAFLRFVNADSQPLALQASGSAARLQLEAAKPVSDYLIVPATKAIKGELVQGAAKAPLELTVAAGEFATLVVLPGTPLVQRLVREQPDDFNALKASLAFYSLDPQCATPGLQAAGRNAEIFKDVADGTLQRRSLNAVALKVQLTCAGQATGVALDLGELKAGERYSVLLLPGASGPRLLATQDAIAH

SEQ ID NO: 133 - protein, 381 aa, Pseudomonas oryzihabitans
MSAPALPPSPAPQPPSASNARLAPLAGVVFALFLAIGLLSCAWALLTDRLSLWPERVDRHALLDGEITHHIAKELAKAPLPEAAARLERGASWLLLGDSGPRVRQGCPGWLFLAEEFEVPRQAAANARARAQTVIELRQQLAARHIQLLVAVVPDKSRIAADQLCGLRRPAAFATRVADWTRMLTAARVPVLDLTTALTPLGSAAFLRTDTHWNEAGAEAAARALALRIQALPFQASPARAFTRTLLAPAPRPGDLVRLAGLDWLPPRLQPTPEVLRLTQVDSRAAAGASDDLFGDGDLPNVALIGTSFSRNSNFLPFLEQALGASVGHFAKDGGHFAGAARDYFASPAFRQTPPQLLVWEIPERDLQSPGPEALRLDPRP

SEQ ID NO: 134 - protein, 195 aa, Pseudomonas oryzihabitans
MSLKTVCVFCGAKPGASPVFAEAAAHLGRTLAERGLTLVYGGGKVGLMGVVADAALAAGGEVIGIIPQSLKTAELGHTGCTRLEVVDGMHARKARMAELADAFIALPGGLGTLEELFEVWTWGQLGYHAKPMGLLEVDGFYAQLEGFLDHLVAQGFVAAPHRAMLQVEASPTALLDALAAWQPTVPPRWAEAAPR

SEQ ID NO: 135 - protein, 202 aa, Pseudomonas oryzihabitans
MSLPEMNEFLGCRTPDAWVEAALQDLPTLLQDHANNEKKAAGAAFHYLFTYSNRAELSWKMSRIAREELRHFEQVLQIMKRRGIEHRNVSSARYAGALRKLCRNHEPLKLTDSLVIGAFIECRSCERFGAVAPHLDAELGKFYSGLLASEARHFQDYLKLAYLYGERDDVDAKIAEVRALEVELITSSDSELRFHSGIPTAA

SEQ ID NO: 136 - protein, 326 aa, Pseudomonas oryzihabitans
MTAPLPPAIFLMGPTASGKTDLAIELARLLPIELISVDSALIYRGMDIGTAKPGAELLAAHPHRLVDIRDPAESYSAAEFRADALAAMAEITAAGRIPLLVGGTMLYFKALLEGLADMPGADAEVRAEIEALAATAGWGEIHRQLAEVDPVSAARIHPNDPQRLLRALEVYRVSGQSMTEHRALQLRANADSNGAPQTQLPYTVAQLILAPGRREVLHARIAERFSLMLEQGFIDEVSALRERPDLHPGLPSMRSVGYRQVWEFLEGDCTREEMVARGVAATRQLAKRQLTWLRGWPAAHTFDSLACDNLPRILKCLAGDTISPRS

SEQ ID NO: 137 - protein, 469 aa, Pseudomonas oryzihabitans
MRGPLATDSLPRMSKKLYIETHGCQMNEYDSSRMVDLLGEREPLEVTQNPAEADVILLNTCSIREKAQEKVFSQLGRWRELKLENPDLVIGVGGCVASQEGAAIRDRAPYVDVVFGPQTLHRLPEMIDAARTTRAPQVDISFPEIEKFDRLPEPRIDGPSAFVSIMEGCSKYCTFCVVPYTRGEEVSRPLDDVLAEIIHLAEHGVREVTLLGQNVNGYRGATGDGRIADFAELLYVVAAVDGIDRIRYTTSHPLEFSDALIQAHAEIPELVKFVHLPVQAGSDRILAAMKRNHTALEYKSRIRKLKAAVPDICISSDFIVGFPGETEKDFEQTMKLIEDVGFDFSFSFIYSARPGTPAADLVDDTPDELKKQRLQILQTRIHQQGFEISRRMAGSVQTILVSDFSKRDPGMLQGRTENNRIVNFRCSDASLIGQFVQVHIDEALPHSLRGTLLAPVASGARPPVAVALA

SEQ ID NO: 138 - protein, 157 aa, Pseudomonas oryzihabitans
MSVTLDQPLPDFQAQATSGLEVSPTSLRGRQAVLYFYPKDNTPGCTTQGQGFRDLHEQFQAADTLILGVSRDSLRTHENFRTKQGFPFELISDKDETLCQLFDVMRQKKLYGKDYIGVDRSTFLIDREGVVRQIWRGVKVPGHVAEVLAAAQALNKA

SEQ ID NO: 139 - protein, 187 aa, Pseudomonas oryzihabitans
MSLINTEVKPFTATAYHNGKFVQVTEADLKGKWSAIVFYPADFTFVCPTELEDLADLYPEFQKLGVEIYGVSCDTHFAHKAWHDTSEAIKKVNYPLVGDPTARLARNFEVLIEEEGLALRGTFLINPEGQIKLCEIHDNGIGRDASELLRKVRAAQYVANHPGEVCPAKWKEGEATLTPSLDLVGKI

SEQ ID NO: 140 - protein, 519 aa, Pseudomonas oryzihabitans
MLDANLKAQLKTYLERVTRPIEIVASLDDGAKSREMHSLLQDIASLSDQVSLSTDGTDARRPSFALLTPGQNIDLRFAGLPMGHEFTSLVLALLQVGGHPSKASQDVIEQVKALDGDYQFETYFSLSCQNCPDVVQALNLMAVLNPRVKHVAVDGALFQDEVERRQIMAVPSVYLNGEPFGQGRMGLEEIVAKLDIGAAARSADKLNAKDAFDVLVIGGGPAGAAAAVYAARKGIRTGVAAERFGGQVLDTLAIENFISIKETEGPKLAMALEEHVKQYEVDIMNLQRAEQLIPAHEAGGLHEVRFTDGGSLKAKTLILATGARWREMNVPGEREYRNRGVAYCPHCDGPLFKGKRVAVIGGGNSGVEAAIDLAGIVAQVTLIEYDGQLRADAVLQRKLFSLPNVTVITSALTSEVKGDGQKVNGLVYKDRNSSEFHHLDLEGVFVQIGLVPNTDWLKGTVELSPRGEIEVDARCQTSLPGVFAAGDVTTVPYKQIVIALGEGAKASLAAFDHLIRTSA

SEQ ID NO: 141 - protein, 311 aa, Pseudomonas oryzihabitans
MTLALSQTADVQKFFEVASGFEQTAGNPRLKTLVHRILTDSIRLIEDLEVTPEEFWQAVSYFNDLGARQEAGLLVAGLGLEHYLDLLLDAQDEQAGRTGGTPRTIEGPLYVAGAPLCEGEARLDDGQDAGVPLFMTGQVRDTKGRPLAGALVDVWHANTGGTYSYFDPAQSEFNLRRRIRTDAEGRYAFRSIVPSGYGCPPDGPTQRLLDGLGRHGQRPAHIHFFISAPGHRHLTTQINLAGDKYLHDDFAYATRDELIADIHFHDDANAARARGLDGSQFAEIDFDFELQPAEEPTAEQRSARPRALEEA

SEQ ID NO: 142 - protein, 380 aa, Pseudomonas oryzihabitans
MISIERLDTCLVDLPTIRPHKLAMHTLQRQTLVLLRLTCSDGSQGLGEATTIGGLAYAGESPESIKTNLDTYLAPLVIGQDADNLNAVMQRVERNVRANTFAKSALETALLDAQGQRRGLGIAELLGGRVQQGLEVAWTLASGDTAKDVAEAERMLDLRRHRHFKLKIGAAEPARDIAHVAAIKRALGDRASVRVDVNQAWSEGVALRACQALADAGVELIEQPVPRHDVQALARVSTRSPAPVMADEAIESLPDAFALARAGAAPVFALKIAKTGGPRAVLKVAHLAQAAGIGLYGGTMLEGSIGTLASAHAFATLERLDWHSELFGPLLLTEDILVEPPTYRDFQLLLPQGPGLGVSLDEDRLAHFRRDRSRLAVATA

SEQ ID NO: 143 - protein, 709 aa, Pseudomonas oryzihabitans
MATPPKSELAGTDTLDRQNTSKKIEQLEQFRSDATGQALRTNHGVKIADNQNSLRAGTRGPSLLEDFIMREKITHFDHERIPERIVHARGTGAYGYFQPYQDWSDLTKAALFRDPNHQTPVFVRFSTVQGPRGSGDTVRDVRGFAIKFYTEEGNWDMVGNNMPVFFIQDAIKFPDFVHAVKPEPHNEIPTGGSAHDTFWDFVSLVPESAHMVLWTMTDRAIPVNLRSMQGFGIHTFRMINTAGKGVFVKIHLKPAGGVRSLVWDEAQKLAGKDTDAHRRDLWEAIEAGDYPEWEFGVQIIPEEDEHKFDWDILDATKIIPEELVPITPLGKLVLNRNPDNYFAETEQVAFCPGHVVPGIDFSNDPLLQGRLFSYTDTQISRLGGPNFHELPVNRPVVPNHNGQRDAKYRMTIDKGRASYEPNSIDGGWPKETPPAPQDGGFESYYERIDGHKVRERSETFGDHFSQATLFYNSLSEAEQAHVADAYSFELGKVERMWIRERQVNEILANIDLELAQKVAKKVGVTPPTAPTVQPRKVSIDKSPALSQLNLLSGNIKGFKVAVLVGDGVIASEVDAIKQALKAEGAHVKVLGPTAGPVKAADGSEVAVDGSAEGMPSVALDAVYVPGGAESVKAMLDDGVIKHYLLEAYKHLKAIALTGEAEQLLKAVYLDTDEALLTGSDFKAVQQDFFAAIAKHRCWARMPKIKSIPA

SEQ ID NO: 144 - protein, 522 aa, Pseudomonas oryzihabitans
MSDDKITLTTRQGHPVRDNQSLRSVGERGPATLENYQFIEKITHFDRERMPERVVHARGTAAHGWFEAYGTIGDEPASRYTCAKVLTKTGVKTPVFLRFSTVIGAKESPETARDPRGFAIKFYTEDGNWDLVGNNLKVFFIRDAIKFPDMIHAFKPDPITNRQEPWRFYDFVQHHPEALHMVTWVKSPWGIPADYRHMQGSSVNTYKLVNDQGVAVLCKFSFEPKQGIRNLTSEQAAEIQKYDVGHASRDLYDAIERGDHPEWEMCVQIMTDEAHDELPFDPLDDTKRWPEDQFPLLPVGRLVLDRNPSNVFAETEQAAFGTGVLVEGIDFSDDKMLQGRTLSYSDTQRYRVGANYLQLPINAPKCPYATNQRDGQMALQVDRSGSNPHVNYEPSSQGGLSEAPRPQHEYRQWIEGHLGRYQSRKTAADYQQTGARYRSFEDWERDDLIANLVADMQACPADIQLRMVWHFWHCDPDYGTRVARGAGIDLEKAKALPNLPGHPAPNEDVAEPTYQGGELESR

SEQ ID NO: 145 - protein, 753 aa, Pseudomonas oryzihabitans
MSTESKCPFNHAAGGGTTNKDWWPNQLNLNFLHQHSSLSDPMGEEFDYATEFKSLDLEAVKADLRAVMTDSQDWWPADFGHYGPLFVRMAWHSAGTYRVGDGRGGAGQGQQRFAPLNSWPDNVSLDKARRLIWPVKQKYGRKISWADLIVLTGNVALESMGFKTFGFSGGRQDVWEPDDAVFWGSETVWLGGDVRYGEHKQMEQPGDGVLTAQPEQHPVEQSRNLGSSRLLENPLAAVQMGLIYVNPEGPNGNPDPVASAHDIRETFGRMAMNDEETVALIAGGHAFGKTHGAGPATSVGAEPEAADLEQQGFGWQNSYGTGKGADTITSGLEVTWTSTPTRWSNEYFENMFKFEWELFKSPAGAHQWRPKDGAGANAVPDAHDPSKRHQPTMLTSDLALRFDPAYEKISRRFLENPDQLADAFARAWFKLTHRDMGPLARYLGPETPAEELLWQDPLPKAAGAPLGEAEVKALKDKLAASGLSVSELVGTAWAAASTFRGSDKRGGANGGRLRLAPQKDWAVNQPAQLAKVLGVLEGIQRDVQGQGKQVSIADLIVLAGSVGVEKAAQAAGHAITVPFTLGRVDASQEQTDVESFGYLEPWADGFRNYVGGQFKVKPEFLLVDKAHLLNLTAPELTVLLGGLRVLDINVGGAKHGVFTQRPQTLTNDFFVNLLDMATEWKATGPDKATFEGRDRKTGALKWTGTRVDLVFGSHAQLRALSEVYGSADAQEKFVKDFVKVWTKVMELDRFDLR

SEQ ID NO: 146 - protein, 138 aa, Pseudomonas oryzihabitans
MNILYTASATSTGGRDGRSISSDKALDVQLSTPKELGGAGGAGTNPEQLFAAGYSACFIGALKFVGAKEKIAVPAEVSVTAQVGIGPIPTGFALDVELVISLPGLERAVAEDLVEKAHQVCPYSNATRGNVDVRLTLA

SEQ ID NO: 147 - protein, 175 aa, Pseudomonas oryzihabitans
MKIWTATLLATCLVGTAQAAESLTIPLNKVTTDGVGESVGSVQVTRSKYGLVFTPDLKGLEPGIHGFHVHTKPNCGAAEVNGTLTAGGAAGGHLDPRNTGKHSAPWSDDGHLGELPALYVTADGQALQPVLAPRLKRLEEIKGHALMVHAGGDNYADQPKPLGGGGARVACGVIK

SEQ ID NO: 148 - protein, 204 aa, Pseudomonas oryzihabitans
MPHTLPQLPYAYDALEPHVDAQTMEIHHTKHHQTYINNLNAALEGTEFANLSAEDVVRQLDKLPQDKRGAVQNNGGGHANHSLFWTVMAPNAGGKPEGALAEAIESQLGGFDAFKEAFTKAALTRFGSGWAWLSVTPEKKLVVESTGNQDSPLMTGNTPILGLDVWEHAYYLRYQNRRPEYIGAFFNVINWPEVSRRYEAALNA

SEQ ID NO: 149 - protein, 485 aa, Pseudomonas oryzihabitans
MTDTKILTTASGIPVADNQNSRTAGPRGPLMLDDFHLIEKLAHFNREVIPERRVHAKGSAAYGTFTVTRDITHLSSARLFAEVGKRTETLLRFSTVGGERGSADTERDPRGFAVKFYTEEGNWDIVGNNTPVFFIRDPLKFPDFIHTQKRDPWSNLKSPQMMWDFWSLSPESLHQVTILFSDRGIPDGYRFMHGFGSHTFSLINAQGDRHFVKFHFKSQQGIKNLAPADAARLAGTDPDYSQRDLFQAIERGEFPRWTLCIQVMSEQEAASRAENPFDVTKVWSQQDYPLQEVGVLELNRNPQNYFAEVEQASFAPSNVVPGVGLSPDRMLQGRVFAYADAQRYRVGTNYQQLPVNAPRCPYANNQRDGAMRFDGNGGSQPNYEPNSYGHTPKQAPQYREPALNFAGPADRYDHRVDEDYFSQAGALFRLMNADQQALLIGNIVGALGTVTREVQLRQIGHFLKADPAYGVGVAKGLGIDPSEVA

SEQ ID NO: 150 - protein, 104 aa, Pseudomonas oryzihabitans
MFKLCFYVPDSHLEAVKQAIFAVGGGRIGLYDSCCWQVQGRGQFRPLPGSQPHLGEQGSLEQLEEWRVELVLADEPIARQAVAALKAAHPYETPAYDVVQVLDF

SEQ ID NO: 151 - protein, 171 aa, Pseudomonas oryzihabitans
MNITRLLVASVATVLLAGCSSFTRPSGEALPKDARWGLVPLANYAQAPMAGDRAAQILVSVLGERGIRPQVYDDSQGGNPTDDEKARQRAALDWARQQNLQYVLTGSVDEWQYKNGLDGEPAVGVTLQVVEPASGRVVWSNSGARSGWSRESLAATAQKVLRGTAQELQLR

SEQ ID NO: 152 - protein, 507 aa, Pseudomonas oryzihabitans
MKDAPAATVTPDVCLLLEGTWPYVRGGVSSWVNQLILGLPELTFSVFFIGGQRENYEKRHYAIPPNVVHIEEHFLAGSWVPKAAPISPRRQAPVQLLRDLHAFLHHPDEPSAAQGDALVDAFAQGSVTLDDFMYSRASWEAITEGYERYCTDPSFVDYLWTLRAMQAPLLMLAEAARRLPRPRMIHSISTGYAGMLGAILQRRWGCNFLLSEHGIYTKERKIDLAQAKWIAEGPDEALRTGLDVDVSYIRRLWIRFFERIGLLTYKAADPIISLYDGNRRRQIQDGADPARCRVIPNGISLTQWQDALERRPEGVPPVVGLLGRVVPIKDVKTFIRAMRGVISAMPEAEAWVVGPEDEDEEYAAECHSLVTSLGLEGKVKFLGFQKIGDILPKLGLMVLTSISEAQPLVILEGWAAGVPVVSSDVGSCRELIEGSIPEDRALGTGGSVVAIADPQATARAILALLRNPGRWQAAQRTGLARVNRYYTEPLMLERYRELYQDAIGRVV

SEQ ID NO: 153 - protein, 329 aa, Pseudomonas oryzihabitans
MNSKWLFSGAFAFEASSWALLFANLPVAAAALAFAAAHAAGSALLAGGAWLLLPRRYQRPLPWSPLFLFALAYFIPLLGAVGVITAVFPALYLPRKQREIAWEARSVPNLPFRPLERREEMLFSDGGLQDVLRHAPSPDKRLTALFATRRMPGRDAIPILKLALRDPADDVRLLAYSMLDQQESQINQRIEVQLGELASTPAERQPALHGTLARGYWELAYLGLAQGSVLRHVLGQAREHIELALAGEENEELRILAGRIALEQGEPERALEFFQDAEAAGVPLAQLAPFRAEIAFLRRDYAVIPALLDSLPADLKKRPPFAALVKYWL

SEQ ID NO: 154 - protein, 457 aa, Pseudomonas oryzihabitans
MALQSVHKDYTLAPRASGRLSWLETLLVTAAALGLGFWLVPEDPLMVGLAFPWVVFAPILMGVRYGFMRGLVSASLLVVALLYLHRQGYPAYEEIPPSFIVGVLLSAMLVGEFRDLWDRRLERLDLANDYRQLRLDEFTRAHHLLRISHDRLEQRVAGNDLSLRSSLLDLRRQLREVPREQDALQALAEPIVGLLTQYGSLRVAGLYRVDDNGRVDRRALASQGEMPGIDPDDLLVRLTLERGETLSIRQALLERGETQHSALQACVPLLDTEERLLAVLAIEQMPFFSFNERTLNLLTILAGHIADLLGSDPQALALADDDAQQFSQHLKRSLRDAQQHALPACLFCFEMTEADGGERALALLEGSRRGLDLQLRLTNQAGHPCLLVLLPLTSSDGLEGYRRRLRQLLAERHGQDSTLESLGVRSHEHELLPKTRAQELRVFLFNECGLHEQQVAV

SEQ ID NO: 155 - protein, 370 aa, Pseudomonas oryzihabitans
MKTKFTALALLSGIVLQGCAYSPGQYLDQDDLKSDPSIQGTKVQLIPITSSLLMSQDSAALSKAPDLKPLLDYKPQAYRVGASDLLYITVWDHPELTAPSGAQQQLEANGRLVRPDGTLFYPYVGTVRAAGKTLEEIRTDISRRLATFIDNPQVDVSVLKFGSQKVTISGAVNKGDAIPLTTKPITLVEALGQAGVANSGGADLTGVTLVRDGKEYRLDTDSLNRKDSKLYGIYLKDGDSLHLPYNDARKVYVVGEVRAPAAVSYKITNLNLMEALSQAGGIQQETANADAVYVIRGPEDLKAPGATAQVFHLAAKNPTAYVLAQNFHLQPQDVVFVGPAGITRWNRFVSQLLGSTNILSTSANLNSSFK

SEQ ID NO: 156 - protein, 1198 aa, Pseudomonas oryzihabitans
MRSSAAKKTRLLSGWTLLGIALLTALVLVLTFHGKQVFLPGEEPADQVSISYAQVLLKATPDDTGLRMKLIDQLIALGRIDEARRQLKLLPAPLASTPFYALELDILQAEAQPQGLADADRERLAQRLSALDVATLSTPQLQRVAERALQLGDPATAAQSYVELARRDPPRRQQWLEQAARWSLAGGRQQEAARLYLRLADLADSAEQRQGYRHQAFDAWLAAGQGAEAAALLEQELPRLQADASGLAWLQAGVAAAQGSGRLDLAQRLIDRWREWQPDDPAALEAAYRLALGRGDTERAWEEGHQLLALRPDDEKLLAELAQLGEWTGHMDEALDLWLRLLARQDDPQRRDHAWKLAARAFRFDAVVELLAEASRQRQLDKTELDALIFAYESLGDPAAEERWLRDYLRRQPKQRLAWERLQQLLARTEQGDAEAAGWAAFGKRFPLTSAEYLTWAGTLWELFKPEEAWKVLEGMPAKQRQGVDYWRLRAELAWELERDGEAQLAFERLATIDKGMTANDEERLLAIYLRTAPRKALALLEKSWEKSKNQKRLTDALQWAEQLKDTAALERLLASAAREPASADNPAVWLARSGLDFQRGRIAEAEEGYRQALQRFPDDDRFRERLLWLLIDQNRQTELATLLRDWKGRARDSDVLWLPFGSGLVLLGQAEEALGWYRRYLDAHPQDWLVQAAYADALDAAGHQDAALRLRKAVTPHLANDEVPATPERYATYLRLLSSLRGPQAALAQARAWQDGSPSMLQLWFDQWLDALSQNNDDGLKGEWLAWAKSRGLKVRQYEQLQEVLRRQNRGELEKLLAAGDLDPAQRVEVLQRLGHVGDAQAAALTAAGDEPPEVIQRQLLRQATEQAERTPNGVQAGWERRDYGGLIEQGTEVRAARRLSDDLYADVQLKQNRVESSGLKSDALGNEHQMLLKVLKNLADGGLETTVDASQRSDSNRLGLGVARTWRIDGNTEIEAALDWHRQPDESGYLRALGRRDSVSLAGRHNLTPRDQLSWRAAHNRYSSRDGDALGSGFAFNLELSHMIFFEGPTWQVRSGITYQQNSARSTLPASVTRYLQPLAGSGENGEVTAADLEALGGTQLLQDRYGQLYVGSSWRRGIPGSLNRTHPQYSWLVDTLVGWQWTEREFNYGLNVGLGMVVLGDDELAFTAGYQSAPQGSGGQAGSTLGIQYSNRIGR

SEQ ID NO: 157 - protein, 456 aa, Pseudomonas oryzihabitans
MAGIGFELRKILARDSYTATLRAYVYAGLISSGPWVLSIISVMLIGVLATGIVTPSVLIRQFLVTVTYLMASSLILTGGLQLYFTRFVSDRLFEEKQTSILPNLVGILLLVTLVAGGLGFLLLATLFDQPFAYRLLVLANFVTLCDLWLVIIFLSGMKAYNRILVVMTLGYAIMIAAAFVLRFLGMDGLLMALLLGHAALLFMFLYDIIREYPAERLVAFDFLDRKQIFISLLVTGLFYNLGIWVDKFVFWFNPLTSDAVIGPLRASILYDLPIFLAYLAIIPGMAVFLVRIETDFAEWYERVFNAVRGGETLQHISQLKEQMILAIRQGLLEICKVQGLTLVLVFLLAPQLLAWLGMSHYYLPLFYIDVVGVSIQVVFMALLNVFFYLDRRDTVLMLCTLFLGLNLALTLLSVELGPSFFGYGFTVSLACCVLLGLHRLDRVLDDLEYDTFMLRH

SEQ ID NO: 158 - protein, 936 aa, Pseudomonas oryzihabitans
MASGKAIRAGSRFGWWRRLTVWLLGSLSLMGTALAAPASVAFWYAEKPPVAELAQFDWVVLEPGHASAADVRALHDGGAQPFAYLSIGEFAGDAAALEKAGLSAGASPVANKAWGSQVMNLAAPVWRTHLLERAAQLAKAGYTGLFLDTLDSFQLVAEDQRETQRLALKSLLAELHRRQPALKLFFNRGFEVQPELPGVAAAMAVESLYAGWDAGKKTYRPVSEQDREWLKPRIEAARSAGIPVIAIEYLPPEQRDEARRLARRLRDEGYVPYITTPDLNTLGISSVTLQPRRLALLYDGREGALRQSAVHRFLGSALEYQGYRLDYVDASKPLPAAWPSALYAGVVVWMTSGPPPHSREFSDWIGQRLDEKIPLLILGGLPLDNEALLKRLGLGVSRKPLPDGLTLKVLDPALAGNFEAPVKLRTRDLPAVQTLPGGPTPVVSLSGPGGTFVPMGVASWGGFAFGPYVMEDGPEASRWIIDPFVFTAKTLQLPPMPVPDPTTENGRRIATVHIDGDAFASKAEIPGAPFSGQVVLEQFIQPHPFLTSASIIEGEVGPKGRYPELTAQLEPIARRLFADPKVEVATHTFSHPFFWQPAVAEQSENFEAQYGYMMQIPGYDKVDFTREIVGSTRYINEHLTTPQKPVKMVFWSGDAQPDAATLKLAYDNGLLNVNGGNSHITRSQPSVSGLYPFIRPTPGGLQFYAPIINENVYTNLWRGPYYGFRDLLYTFERTEHPRRLRGLHLYYHFYSGTKQASLKVMEEIYQGMAAEHPISLWMSDYLSRLRGFYTASLAREDDGSWSIKALDGLRTLRLDPRLGWPDLQRSRGIAGVRDLPQGRYVHLAGAQARLVLRDSRDPTPALEEANIPLQQWDYRSPTRIRFAFAGQFPLELTLRASSACEVRIGRERYKSQPGAAGLQTFKLPLTRVSDGEIVCG

SEQ ID NO: 159 - protein, 484 aa, Pseudomonas oryzihabitans
MALTVNTNIASLNTQRNLQSSSNALSTSMQRLSTGSRINSAKDDAAGLQISNRLTNQINGLNQATRNANDGISLSQTAEGAMQQSTNILQRIRDLAVQSANGSNSDADRAALQKEVSAQQSELTRIAETTTFGGRKLLDGSFGTSSFQVGSNAYETIDVSLKNTSSTAIGSYQMGAASGAASGSVAASVATGTAASGRFATGTTDITVTGGGTSKKVDLTQALSAKDAAKALDGSVQGLSATARTVFSASVDSSAASSPISVSFKVGGRDAVTLAGVTSTADLANQLNANSSKLGITANLDNKGVLTISSATGENVEIGGTNPDKLTVGVKGADGNDVKTAAALTAGQTNTITGYVQLDSSSQYSVSGAASLFGQTAGKLNSVDKVDISTADGAQKAIAVIDQALNGIDSQRADLGAVQNRFDNTISNLTNIAENATSARSRIKDTDYAAETANLSKNQVLQQAGTAILAQAKQLPQSVLSLLQ

SEQ ID NO: 160 - protein, 112 aa, Pseudomonas oryzihabitans
MSDLASFRARLAQGDHAFADTLAFVAEHYHYQPTAFRNGAVDNAAGQNEGSCKTLGLAKLEGLSDQEALLAFGEHYRSVLQTPEGSDHANIRALIAHGLAGVSFQGEPLARR

SEQ ID NO: 161 - protein, 265 aa, Pseudomonas oryzihabitans
MATLASRGLTLGYGTQTIIEALDLELPPGRVSVLIGSNGSGKSTLLKACARLLEPRQGQVLLDGQDIHRQSTTALARQLAVLPQTPVAPEGISVRQLVSLGRYPYQNWMRQWSADDAAAVDKALRLTDLLAMAERPVDDLSGGQRQRAWIALTLAQDTDCLLLDEPTTYLDLAHQIEVLDLLRQLNREEGKTIVMVLHDLNLACRYADHLVAVHQRRAFAQGAPAEVLTEALVREVFALECRIIADPYFGTPLCIPFGREVPPCA

SEQ ID NO: 162 - protein, 333 aa, Pseudomonas oryzihabitans
MSAPLRLLLVALALALIAVLSLSVGARWIAPTSVVAALVQDPSLGLDATLVNSTRLTRLLVALVVGANLAVAGALMQAMTRNPLASPGLFGINAGATFALVLGITLLGLSSTESWVLCALLGAAVAGSLVWTLGNRGQARLTPLRIVLAGAALAALFTAFSQALLVINQEGLDSVLFWLAGSVGERNLTTAAPLLVFSLLALAAAVVLAGQLDVLVAGDDLARGLGQPIGLIRLLAGVLVICLAGSAVALAGNIGFIGLMVPHLVRGLLARARHEHRWLIPGCALGGALLLVLADSLARVVILPQEVPVGIMTALFGGPFFIHLARRGGRHGR

SEQ ID NO: 163 - protein, 343 aa, Pseudomonas oryzihabitans
MAAEIVWRLGRFSRRLAPATLGRLAVAALVALAALLLCLCLGKVWLTPTQVFAALVERQGGGLGFIVTQLRLPRALLAALVGSALAVSGLLLQGQVRNPLASPDLLGITSGASAGAVFYLAVLAGSLGPHGLPLAAMLGAGLAALLVYGLAWNHGASPLRLVLVGVGVSAMLAAATTFLLVFSPLTTTLSAYVWLTGSVYGASWPEVRALGLWWLVLLLPLATLARHAVLAQLDDDLARGLGVRLQRQRAALLALAVALAGVAIAWGGAIAFVGLIAPHIARRLLPAGFAAQALMAALVGALLVMLADLLGRTLFLPLDLPAGIFVAALGAPFFLYLLIRQRP

SEQ ID NO: 164 - protein, 305 aa, Pseudomonas oryzihabitans
MPPSVSPSITRRRLLGLGGVLATGLALQPGVARAQPTRVATLFQGATDSAAALGLRPCGVVESWSEKPVYRYLRPALAGVPSLGLETQPSLEDLALLAPDLIVASRFRHGRIAPLLQQLCPVVMLEEVFEFKQTLLALGTAAGREAEATALLQAWQARIAHLREALQRHYGAQWPPTVAVLDVRADHLRSYLPDSFAGRVLSELGFAWPAASQGSAAPSIKLTSRESLPVVEADVFFVFLRADQAAVQRNYERLLEHPLWQRLSAPRRGQVWRVDGVAWSLGGGLLAANRLLDDIERVLVDQGAA

SEQ ID NO: 165 - protein, 258 aa, Pseudomonas oryzihabitans
MLRRNRLKAALAAGTPSHGLFASLPTPASIELIAEAGYDFVIIDMEHVLINPETLENMIRTAESYDLTPLVRVPDAEPKRLLRLLDAGAQGIVLPCVEDPAVLAAGVRACKYHPEGERSLNAGRPGSFGKASLADYVNRANAQILIVAMIESAAGVARAAEIAAVPGVDLLLEGAADLSQSLGHPWRIADPAVQEALRQTWTAAQRQGTPYCAIPRQPEDLDLWRARGVTTFVLGDERGIAFRALQARLTAHSCGESP

SEQ ID NO: 166 - protein, 203 aa, Pseudomonas oryzihabitans
MPGPLSELPAELIAGYAEVAASTLGHLGRTGYLPELKPVVANTRLLGRVVTARIPLPHGALLREALIASRPGDVLVIEAVGDPHCACWGELRTLAALIKGLAGVVVNGAITDVQALRQLGLPIFHRGISAVTTQGGEALGELNVELQLGETRVCPGDLALGDDDGLFVLSPARAAALLPGALAKEAADQARRAQLLQRLTEGR

SEQ ID NO: 167 - protein, 170 aa, Pseudomonas oryzihabitans
MSDMALASTRHLHRLYLDHSGWLQAWLRRRLGSEWDAADLSQEAFLRLLRNPEVLGELQEPRAYLVTIGKRLLINFQRRKSLEQAYLDALMALPEACVPSPEQRWLLLETLQALDELLDGLPAAVRRAFLLSQLEDLTYREIAERLHVSERTIKRYMAQAYEHCLLAELC

SEQ ID NO: 168 - protein, 402 aa, Pseudomonas oryzihabitans
MAELPAAVRAALVEAQAQSGDPLAAFVYDLEALRRHVAALMAELPPGVELYYAIKANSEAPILAALAPLVHGFEISSGGEIDRLAACPQRKPFIFSGPGKLDSDLRTALSAGVEAIHLESLGEIQRLQRLALSLGRLQPVYIRINPQLPAGLTSTLAMAGTATPFGFDEADLHAAVAAVEAASHLQLQGFHVHALSHQHSVERHLQLLDFYLQRWPHWCGLARRPESVVRLNVGGGIGVDYREGRRFDWARLCGHLRARLAEQAQPPLIRFEPGRFLAAFCGYYAMEVLDTKTSHGQHFLVCRGGTHQFRLPVAQGHDHPVLHLPREGRATATGGKAWTVVGQLCTPKDILSRGQPLGEVRVGDLLVLPLAGAYGYNISHADFLCHPRPRQLFLAGNGSVPA

SEQ ID NO: 169 - protein, 313 aa, Pseudomonas oryzihabitans
MLSGQDRRRAIREAAEWLALLESGAAGERERQQLQAWRQGHPEHERAWQAAQQLQQRFAAVPSRLAMASLQPAEPTRRTALRQLLGLAVVVPTGWWLTRELPLDAWTADLSTATGERRSLTLADGSLLQLNTATAVDLDQIRRRLTLVRGELSLRVPGTQALTLDTRFGSLTVEQAEVCVQQDDEGCDVRVVSGSVEVRPLMGLGLALGKGQQLRLSTLGIGAIEPFSPTLLSWRQGVLIAQDQPLGEFLEQFSRYRPGLLRWDPAVADLRVTGSFQLADTDRVLALLAATLPVELQWRTRFWVTLKPRSVAV

SEQ ID NO: 170 - protein, 457 aa, Pseudomonas oryzihabitans
MLQPSLSRETATADNAFFLARQARFESRVRSYPRKLPLAIAKAAGVWVTDVEGKTYLDCLAGAGTLALGHNHPAVIEAITDFLGSGLPMHSLDLTTPLKDAFSERLLGLLPGRAEDYCLQFCGPSGADAVEAALKLAKKVTGRSNVVAFSGGYHGMTHGALAVTGNLAPKQGVAGLMPGVQFLPYPHEYRCPLGLGGEQGAAALARYLERFFGDVESGVCRPAAVIVEAVQGEGGVNPAPVAWLRTLRQVTREHGILLIVDEVQTGFGRTGALFACQHAGIEPDILVLSKAVGGGLPLALLAIRREFDAWEPGGHTGTFRGNQLAMATGLATLEVIERDGLVSHAAQLGGWLRRHLERLRERFPAIGNVRGLGLMLGLEIVEAGAVADALGSLPADPALAAAIQRHCFAQGLLLERGGRDGNVVRLLPPLILQESHCLVLLERLEAALVAALAEPRG

SEQ ID NO: 171 - protein, 798 aa, Pseudomonas oryzihabitans
MVTLVLRPLLRTGLLVALSGTPWWAASALAQEVARRHYEIPAGSLAQALTRFAAESGVNLAVDPGLVGKRNSAGLNGDFGVEEGFSRLLAGSGLRLQPLGERDFTLAPVPQDSGVQELASTSIVASSLQADDAPYAGGQVARQGSQGLLGNRDFMDTPFSQTSYTAQTVQNLQARTLTDLIASDPSVRSTNPSGGRFEQFTIRGFSLFNSDVAYNGLYGVLPTYSIDMEMAERVDILKGPSQLLNGISPRGSVGGGINVVPKRATDQPITEITGSYASDSQVGGAVDIGRRFGEDNRFGMRFNGVKQAGDTTWDHQHVDRQMGVLGLDYRVERLRLGLDLGHTERDTDAPQERVLVGANARVPDADDVRHNYAQRWTRAQTKDTFGALRGEFDIDDSLMVYGAVGARRSDHDFLRHNVSITNNAGDFSVQPRDFTRDENVRTANLGARKWLQTGPVSHELNVSADYFYMDFENGGGRYASGPSNLYNPSDLPAPGVQTRSDGKDYTENRFSGVALADTLGFFDDRLLVTLGARWQRVKVDDWSDGVKQPTAYDEEKVSPSAGVLFKATERLSLYANYMEGLSQGKIAPSTALNEDEIFPPFVSRQAEVGAKYDFGAVAVTASAFRIKQPAYETNATSRVFGPNGKRVNDGVELSVFGEPLAGFRVLGGLMYIDSELKDTVGGSFDGNRAPATPRLNANLGAELDIPAVPGLTLTGRGIYTSSQYLDQANSKEIDAWHRFDVGARYAFKVDATRVTLRASVENVMNERYWASAGASDDSEPGLTISTPRTLVFSTTLAF

SEQ ID NO: 172 - protein, 590 aa, Pseudomonas oryzihabitans
MTSFESTLLSRIVSELASSHALMNCLIKEFALPERCLSYAWPEDRRGIAPANYLGWLQDGCVPLLIAFPGDRQFFLVVDRQDELGSQRYLSDIYIRRGEQAWHCPDFAAFIDFLLEACEELAGAHNGELLQQVLQSQHLTAAIVDHVQVSRHPAPLSDYLASEQGLWFGHPNHPAPKARRWPEPLPAEAYAPELHTSTPMHVLEVPRAGLQVAGNGLSDAQVLQGFVDQAQAAPERARIVLHPVQAQLFLGDPRVRALVSQGVIRDLGTSGALASPTASMRTWYRPGHAFFIKGSLNVRITNCVRKNAWYELQSTLIVDRLMQRLQGRVAGLDMVREPGALSWAPPAASAEDERWFREQTGAILRENFCLEHGADCCLLAGTLFARDTRLQPLLQDFLSRCGGEPVSDETRLAWFQDYQRLLLGPVLRLFFEHGVVLEPHLQNCVLVHDNGRPVRLLLRDFEGIKLTDTLGAEALDAHVQPRVRQSLLYSREQGWRRIAYCLFVNNLAEAVLALSWERPHLAPRLWRQVEAELIAIRRDLQRAAPELDALIAGQPIPCKTNLKVRLAAQADRHAGYVQLPCPWGAEVRHG

SEQ ID NO: 173 - protein, 613 aa, Pseudomonas oryzihabitans
MTAQLSLPAQSWPSPADAALYRQVEQRVVAQLLQTLIYEEVLRAEVQPVAEGLAAYRLAGTAADGTPVQYLGYAPAAASFGLIRLDPQRLVRQDAQGSRAPALHETLAELLGEQSDSPLWPRFVQELEQTLLKDLQSRRQDYRPDRPAHELDVDALERHFMDAHGYHPCYKSRIGFSLAENRRYGPEFGESIQLVWLALARARASVGHSRRLDFPAFIAAEFGVERWTALAAEWREQGRALDDYQLIPVHPWQWEQHLAALFQPELVSGELLYLGTSRDQYAAQQSIRTLANRSAPERPYVKLAMCLTNTSSTRILARHTVLNGPLITDWLQRLIATDATARDLDFVVLGEIAGAAYDSRALPVSRAGQVYGTLGAVWRESIHAYLRADEQAVPFNGLTQVENRYGQGAPWPFVAAWIERHGLDAWLRQLLRVTVTPLMHMLHAEGIGMESHGQNIVLIHRDGWPLRIALKDFHDGVRYAERHLARPELRPTLEPLPASHARINRNSFILTEDVAAVRDFTCDAFFFIALGELAVFLRQHFALAEADFWQATATVILDYQRAHPQHRDRYALFDVFAPTFEVEELTKRRLLGDGERRFKAVANPLHTYRPAAC

SEQ ID NO: 174 - protein, 616 aa, Pseudomonas oryzihabitans
MNAQTLATDLILQGLFDCLLAEDVFAPMPVTLAAATTEHPAALQPAAPEERLWECCCDPRELRFIAARVRPGITQAWVKVPGTPILARQGDAWSTLTPEAFVSLVFAEAAADPEQARGIALLREILATSLRQTRLSLEQSLVPGPLLEGDGKAAFLQLERWAALRDRPYHPLAKAKLGLSDTDYQAYQAEFGQPVRLAWVAVRRDQLLCGEGVAADSQGPAADLLTPAALGGLQAELQQRGLAASHVALPVHPWQLAEGLPGRLDEAFASGVCQQLDFAGARCHATSSLRSMLMEEGAGVAQLKLPMAVYSLGASRYLPAVKMINGSRSEALLRQARALDPVLAESLHLCDESRWWAFMPPAATLFDEAPRHLSAMVRGYPAALLADPDCRLLPMAALGTPLPGSRRHFFDDWLAARALAPTPANVLLLLGELCHSFIDLNLRLFRLGLLGEVHGQNAVLVWRAGRIQGLLLRDHDSLRLYVPWLERQGLADPQYRIKPGHAQTLYHEHPRDLLFWFQTLGIQVNLRAIFETVASCYAVPLTAAWTLLREVLEERIVALDFDAEARALLRETLFEAPDWPQKWLLRPMIERAGGPGSMPFGKGRVVNPFHQVSHAP

SEQ ID NO: 175 - protein, 261 aa, Pseudomonas oryzihabitans
MCLRPALDSAQRDELRATFGLREASERDGQHSQPVAAWLDAARCAELLDDLAARMEAPTRRVAASLLTKRLGFLTTGVAFHALSAYDRRLDLTPGNVWIEDGHVQGRWRSALPLSDTRPLPALEDHATARALLARALFGELLRPLWETLARVGRVSPRILWENAAVRLYSLYDRRLAELEDPAIRARCAEDFAWLLAATPAELGLETNPLAQFRRPATVNTLGRYVRFRRTCCFYYQATAPAEYCSNCPLIRPREAACPAP

SEQ ID NO: 176 - protein, 468 aa, Pseudomonas oryzihabitans
MSVAIPRVWVAVNVLLGTVTVSLANTALNPALPAFIAAFDLGPLLASWIVAGFMVAMGITMPLTGFLAGRIGRRRLYRLGLLAFIAGSALGALADSIAGVLLARMVQGVASGLMIPLALGIIFSVYPKEERGRVTGWWGGAVMLAPAVGPLCGSLLLEVFDWRALFLLNVPVGLLALAMGQVVLPADGARERKPFDLAGYLLIASGLGLLLVTLGRLRELAALADPLNLLALGAGLLCLLAFVRLQLQRSHPLLPLRLFALRGYRASVIIAVVQAVGMFECLVLLPLLVQLVLGHSALWTGLALLCTALAAALFGQVGGRLLDRRGPRGVIATGLALSGLATLALGVVGSHAGLAWICALMVLRGVGLGLSYMPATTAGLNSLPDAQVTQGAAMNNIARRLVSSVAVVAASLWLELRLGGAAGWGPRQAATGVAIQDAFIATGLFILLALPWAWRFPAAQPLSVRRYS

SEQ ID NO: 177 - protein, 324 aa, Pseudomonas oryzihabitans
MDRVLLSEQSRVFTACAPGQVSEYVGRHLGSHRLQIGRDSAARASLAHRPFATLDLCRLHYAGQVRILAPALDELYHLQILLRGRCLWQGRDGARCYGPGELMLLNPSEPVDLIYSDDCEKFIVKLPATLLERVSQARGWTLPAAGIRFTRSEAHYPSSDVLDLLSLICHEAEAALPGGFHEPYLQILASKLLLQLPSNLTVPASRGEPCGRFAHLVEHIETHLGEALTPRQLAAQAHLSERGLFGLFQREVGCAPLEFVRQRRLERVHQVLRDPQAGARSVTEVALAHGFLHLGRFAQQYKARFGETPSATWRGRSHQTAVGG

SEQ ID NO: 178 - protein, 241 aa, Pseudomonas oryzihabitans
MTTTYLLIHGSWHDGRAWDGVAQSLRAQGAEVHAPTLAGHGLGADLAVSHADCVDSLADYVRRHDLHDVVALGHSWGGTVLQRLAEIETARLRRLVFHNAFVLRDGEALFDLVPPHYQALWRQLEQPDGGIMLPFPVFRDAFIGDASLEQAQAVYARYLTPTPARSHFDAVPLKTFDSLPIPRSWLYAQDDVALPPGQYGWHPRLSERLGGYRLVSLAGSHEVLFTRPEALAEAIRLAGRD

SEQ ID NO: 179 - protein, 394 aa, Pseudomonas oryzihabitans
MSKPFAFSVGTALPVASALLLGLGASLPVQANNGVQLPAYGAKAMGMAGVSIALPQDAAASANNPAGMALLGDRFDADLTLLRAPIRTEVGSNRYADNAVVAVPTGGFNRVINENMSAGLSVFGQGIALDYGEPVFGSHDLKSSLQQVVLAPTVTWRLAPGHYVGFSPRLAYQRLEIAGLEGFGFASPGADKAYGGGFALGYQGALSERLSLGVSYASPLWFQRLERYRGLLPDGRLNLPQQAGVGLAFKATPQLTLAADALWIDWSGQGSYGNRLTEGGPLGASNGPGFGWRDQKILRVGASYALNTQWTLRAGASFSNHFIPSSEATFATLAPLAQYDHYSVGASYRLGDGWEVTGSYLYAVNDRLKGTGASQGVIVGTDVNYLNFGIGYRF

SEQ ID NO: 180 - protein, 426 aa, Pseudomonas oryzihabitans
MNVNAPLNVAIVGGGIAGVGLALGLKDAPHLKVTLFESAAAFGEIGAGVSFGANAVRALAGLRMADPYHALADRTPEPWQDVWFEWRRGSDAGYLGATLAPGVGQSSIHRADFLDALARRLPDGMAVFGKRACGLEQDATGATLSFTDGTTYRCDLVLAADGIKSGLRGTVLGGHGLSDPGPRFTGSVAYRGLVERDALRERFRATGLDQHLLDVPQMYLAQNGHILTFPIKQGRILNIVAFRTAQPRSAVWPADQPWVRNASRAEVKEAFADWGLAARTLVEAIESPTLWALHDLEELPYYVHGRAALLGDAAHAMLPHQGAGAGQGLEDAWFLRELLSDPQLTRGNLERVLQAYEHWRLPRACRTQRTSWEAGELYEYRDRTVGDDEARLGQTLAQRFDWLWRHDLLSDVHEARRWLGWVLQPV

SEQ ID NO: 181 - protein, 149 aa, Pseudomonas oryzihabitans
MIPWTLAELVPHAGDMLLIDEILAFDESGIETRLVVRPGLFTDAAGALPAWIGVELMAQSVAAFAGCQARRRGEAPALGFLLGTRQFACDVPAFPAGGELRIRAQPALENDDGMAIFDCHLQGPGCQASARLNVYRPPQVDLYLEEPAP

SEQ ID NO: 182 - protein, 306 aa, Pseudomonas oryzihabitans
MSGHWAQQRERGSPVLMRLTAWLARHLGRRAIAPLLRLIVLYFFLFGARARRGIREYQQRLADWSGRPELQPSWRSGYAQFMAFAEALLDKLDAWNGRLGLDQVQLHDPDQVHSRMHGPRGEILVTAHLGNLEVCRALAQLGRRVRLNVLVHTRHAEAFNRLLEEAGASDLRLIQVSELDPAVMLQLSERLERGEWLAIAGDRVPLHGGRTVAVDFLGAPAPFPQGPWLLAHLLRCPTNLLFCLREADGYHLYLEDFAPAPNWRRQERAAGIQGLAQAYAERLAAHCLKAPRQWFNFYPFWSRDER

SEQ ID NO: 183 - protein, 774 aa, Pseudomonas oryzihabitans
MIRLQRPFLLFLFALLALSAWQWRHGPPVAADLLALLPQGAGDALTLQAEARMAEPLNREVLLLVGHPQRERLPALAERLGQAWSREPLFERVQWQLTPDLPGLRQHLLVSRLALAPGPARDQLLHDPDSYLQARAAALFDPFAGAGALPLEEDWFGLGLLVQRQLTPASKVQFDAGSGLLLTQGDGLSWALIRARTRADAFDFDAPPQVEALIEAARREVVADGGQLLAASGLRYAAAGQATASREMSLIGGLATFGTLALLLGLFRRWRVLLSLLAVGVALLAGSAACVLLFGQINALTLILGASLTGVAADYPLHYLSKSWKGGPWDATAILRETLPGLSLSLATNLLGYLALACTPFPALTQVAVFSAAGLIGAYLTTVCLLPAWWQRLDLAPPAAPLRVMQRLLDLRLRLLARTGSLPLLLALLAFCGAGVWQLHLQNDLRLWLGQDPTLTREAQAIARLTGLQPTSQFFLVRGADADQVLERQTALGQRLDALVSAGQLQGYRALSGLLAPAAAQAELRQALAGWGERLQPLLAVGIPAEALQAELKHLQQLPDLSLDQALAGPLGEPWRPLWLGRTTEGGAAGLVSLQGLGNAQVLQTLAEGLPGVQLVDRLGELRGLFVHTQRLAVELKLLASGAIFLLLLWAFGRRAALRIVCLPLLAALAALACLGWLGQPLTLFSLFALLLITAIGVDYAILMHEAIGGAAVSLLGGLLSGVGSWLSFGLLMLSSTPAIANFGLAISLGLVFSFLLAPWASPSVSHEKDLRHG

SEQ ID NO: 184 - protein, 245 aa, Pseudomonas oryzihabitans
MSFRACAVIPVFDHEHALPLVVQALRQRALPCVLVDDASSPACAQVMDELATQPDIHLLRLPVNQGKGGAVMAGLAEAQRLGFSHALQVDADGQHDLADVAAFLAEAQAYPDALICGYPQFDDSVPKGRLYARYLTHVWVWINSLSLEIRDSMCGFRVYPLAPTLAVIRAGGLGKRMDFDPEILVRLAWREQPMRWRPTRVHYPLDGRSHFRLWQDNVLISRMHTRLFFGMLLRAPRLLWRRVRG

SEQ ID NO: 185 - protein, 194 aa, Pseudomonas oryzihabitans
MRTLIALLLILAAPLAQAFDLDDLAAQLARPAVVAGSFVQQRYLRALPQPLTSSGHFTLARGLGLLWRLEKPLTQTYRITPGAIAKETPAGWTPLPGSDLAARQSALFLAVLGGDRSGLERDFELALSGDARHWQLRLTPRGALLKQVFDGILIQGGALVEQVEIRETQGDRSLLRLDGQASDALSADQRAAFQ

SEQ ID NO: 186 - protein, 508 aa, Pseudomonas oryzihabitans
MNASVRFGSQALALEDLVALAEGRARADLQDDAAFRDGIARGALFVDSLLAREGSVYGITTGYGDSCVVAVPLAQVEALPRQLYTFHGCGLGRHLDPAATRAVLAARLQSLCQGVSGVRVELLERLTAFLREDILPLIPEEGSVGASGDLTPLSYVAAALCGERQVLWRNEIRDAAEVHAELGWTPLVLRPKEALALMNGTAVMTGLACLAFARAEYLLRLATRITALNVVALAGNPEHFDQRLFAAKPHPGQGQVAAWLRADLAAEGPAAPLHRLQDRYSLRCAPHVLGVLADSLPWLRQFIETELNSANDNPLIDAEDERVLHGGHFYGGHIACAMDSLKTLVANVADLLDRQLALLVDARYNHGLPGNLSGAPAARAMLNHGFKAVQIGASAWTAEALKGTLPASVFSRSTECHNQDKVSMGTIAARDALRVLELTEQVAAATLLAAQQGVWLRCQQGVEPPAPLAAMHRDLGETFAPLIEDRALEAELRQTLTLIRARHWRLYA

SEQ ID NO: 187 - protein, 240 aa, Pseudomonas oryzihabitans
MHFQISDWRAWAPGLGDQDAWRQWCAAPWRPADDGSQPDASFLPAMQRRRLSRLARMTFQVAWPLADAHGEPLPLIFASRHGETPRTLAILQELARGEPLSPTQFSLSVHNAIIGQWSILRGDHSEMNALATGRDGLEHAVLEACTLLAEGASGVLVVIAEEAPPTLYAPQIDDVPFPYAVGLLLTPGGSHGLSGAPAPAEAAPSAWPHALELLRLLEAPGALHLAYAGRAWHWQAEARG

SEQ ID NO: 188 - protein, 508 aa, Pseudomonas oryzihabitans
MHLDDAEDLACALLGAWRAGVEVILPADAQPATRARLAPTLDAWLDDLDGWTAAEPLTPARLDLQAPLLTLSTSGSSGEPKLIAKQLFQLANEVAALECLWGASLGATTVLGSVSTQHIYGLLFRVLWPLCAERPFARQALPFTEELQRETAALSRQGRRAVWISSPALLKRLGENLDDAVLGQVVQVFSSGGVLPGAAAKACQQRFGRYPTEVYGSSETGGIAWRRGPQPWQAFADIELGQDAEGALWLTSPYLPPGMREQTMDDVRLLGDGRFELLGRLDRIVKLEEKRIALPALEARLLGHPAIADVRLGVVQQGRALLGALVALSERGLHQLRNGGRRALVAELREHLIGHCEAIALPRRWRLLLALPYSAQGKLAQAEVERLLAQPRPVEIEPLSVEQTADGWRLELEVAPDLAFFSGHFPTAPVVPGVVQVGWAQRLARQHLDLPADFAGMEVLKFQQLLRPGDRVTLTFHFDASRNKLHFAFRQGTAACSSGRILLKEARS

SEQ ID NO: 189 - protein, 410 aa, Pseudomonas oryzihabitans
MSARRVVITGMAGVTALGSDWPTIRDHFLAGHSGIRRMDAWDRYTEMNTRLGGPIVDFQVPGHWTRKQLRSMGRVSQLAVAAGERALADAGLLDDARITDGRMGVACGSSTGSTDDIKALANMLLSDAAVGLNANTYVRMMPHTAAANLSLFFGLKGRLIPTSSACTSGSQGIGYAYEAIKFGRLPLMLAGGAEELCPSEAMVFDTLYATSLRNDAPQTSPRPYDRSRDGLVIGEGAGILVLEELEHARARGAHIHAEIVGFGSNADGQHSTRPEQATMQRAMELALEDAGLTPDAIGYVNGHGTATEQGDIAETRATQALFGSRMPISSQKSYLGHTLGACGALESWFSIAMMNEELFVPTLNLDELDPQCGELDYLRGGPRALRTDHVMNNNFAFGGVNTSLIFRRWS

SEQ ID NO: 190 - protein, 394 aa, Pseudomonas oryzihabitans
MSAYLNALGLLCALGLGKAEVARGLFAGDTAGMQPTAGWIPERQPPVGTVTAPLPAWPLEWTPFFSRNNQLLLAALTEIEPQVRQAIERHGPARIGVVLGTSTSGIHEASLGIAVHQRSGQLPEGYEYAQQELVAPADFLARYLGLSGPCYGLSTACTSSARALLSARRLLVQGHCDAVLCGGVDSLCGLTLNGFAALEAVSESLCNPFSVNRCGINIGEGAALFLLTREPGPIALLGGGASSDAHHISAPDPSGRGAVQAMQAALRASGLQPGDIGYLNLHGTATPHNDAMESQATHQVFPAGVPCSSTKPLTGHTLGAAGALEAAFAWLTLDPRLNPAGQLPPQRWDGQADPALPRLALTDADSRLDGRRHAMSNSFAFGGSNVSLILGATP

SEQ ID NO: 191 - protein, 84 aa, Pseudomonas oryzihabitans
MQSREAIFETLRSALVELFELEPERVTLEANLYEDLEIDSIDAVDLIDHLRRQTGHKIAAEQFRQVRTVGDVVEAVHRISQADA

SEQ ID NO: 192 - protein, 245 aa, Pseudomonas oryzihabitans
MSVAPAPVLVTGSSRGLGRAIALRLAAAGHDLVLHCRSRREEAEAVRAEVEALGRNARVLQFDVSDRAACAAILEADTEAHGGYYGVVCNAGLTRDGAFPALTGEDWDLVLRTNLDGFYNVLHPVVMPMIRRRAPGRIVCITSVSGLIGNRGQVNYSASKAGLIGAAKALAVELAKRKITVNCVAPGLIDTEILDEHVPVEKILEMIPAGRMGTPEEVAHAVAFLLAPEAGYITRQVLAVNGGLC

SEQ ID NO: 193 - protein, 86 aa, Pseudomonas oryzihabitans
MTDLNLELKGLIIEALGLEDVTVDDIGDDQILFGDGLGLDSVDALELGLAIQKRYGIRIDAEAKDTRTHFASVNALAAFVAAQRAA

SEQ ID NO: 194 - protein, 240 aa, Pseudomonas oryzihabitans; identical to SEQ ID NO: 187

SEQ ID NO: 195 - protein, 132 aa, Pseudomonas oryzihabitans
MLRRLLLVSALLFLAACTRAPLVTPREVFPADRAENAADVRRAIVDTLERRGWSVGQESPGLVVASIVVRDRHQAWVDIPYSTKGYQIRYRDSAGLDYDGERIHRNYNKWVQLLDADIRRQLQLPAPAAAAE

SEQ ID NO: 196 - protein, 144 aa, Pseudomonas oryzihabitans
MRKTGALQVEVEMQIPFFDVDMMEIAWHGHYVKYLEVARCALLDRLDHNYLQMRDSGYGWPVIDLQIRYIRPLLFQQRVRVKADLVEWENRLKLNYLISDAATGERLTRASTVQVAVDLASREMQLASPRVFIDAVERALACAR

SEQ ID NO: 197 - protein, 190 aa, Pseudomonas oryzihabitans
MSALPSRSPLGLVASALLLLLGLAYPFAVYFGLQHLSPRLFAAGLGALWGLRLLQPGLNGLQRGTALVALGFCLLLALSDAAVLLRWYPVLLSLFLLAVFGLSLLRGQPLIERLARLREPELPPRAVRYTRRVTQVWCLFFLGNALTAAGLALWAPLAWWTLYTGVIAYGLMGLLFAGEWLVRQRVRRLP

SEQ ID NO: 198 - protein, 166 aa, Pseudomonas oryzihabitans
MTLPRPFVFALACLLLLAACASQPPLPSSPPPLARALVYQVERQTAEGSDALLLAIQPEGAALRFSLFDPLGVPQARQQLIDGAWHADGLLPPNPRARTFFSVLLFALTPTDQLPRAYAAGDWQRAADGSRTLKDWQVRYPAADRLALQAPDGSSYHLTLLPESAP

SEQ ID NO: 199 - protein, 415 aa, Pseudomonas oryzihabitans
MVEHHPLIVIGAGPAGAVVAALLKRRGHPVLVLEAQHFPRFSIGESLLSHSLDFVEEAGMLPAVEAAGFQTKLGAAFAWGERYTDFDFRDTYSGGRSTFQVQRGPFDKILADDAARQGVTIRYGQRVTAVTLGEDGERTRLEVQGDDGQAYALTTDFLLDASGYGRVLPRLLDLEAPSDFPVRRALFTHVEDRIDEPGFDRQRILITTHPTLRDVWFWTIPFSDGRTSIGVVAAAERYAGRAADLATCLRDWVAETPSLARVLHNAVWDTPVRELGGYAANVKRLHGPGFALLGNAAEFLDPVFSSGVTIALRSASLAAPLVNRQLRGESVDWEAEFARPLKAGVDTFRAYVEGWYDGSFQDVIYFEHADPEIKRMICAILAGYAWDVRNPFVKEPRRRLRLLVELCQLNSAHPA